(19) United States
(12) Patent Application Publication
(10) Pub. No.: US 2012/0051561 A1
(43) Pub. Date: Mar. 1, 2012

(54) Audio/sound information system and method

(76) Inventors: Alexander J. Cohen, Mill Valley, CA (US); Geoffrey F. Deane, Bellevue, WA (US); Daniel A. Gerrity, Kirkland, WA (US); 3ric Johanson, Seattle, WA (US); Edward K.Y. Jung, Bellevue, WA (US); Royce A. Levien, Lexington, MA (US); Robert W. Lord, Seattle, WA (US); Mark A. Malamud, Seattle, WA (US); William Henry Mangione-Smith, Kirkland, WA (US); Nathan Pegram, Bellevue, WA (US); John D. Rinaldo, JR., Bellevue, WA (US); Phillip Rutschman, Seattle, WA (US); Clarence T. Tegreene, Bellevue, WA (US); Debra M. Warden, Edmonds, WA (US); Lowell L. Wood, JR., Bellevue, WA (US)

(21) Appl. No.: 12/927,418

(22) Filed: Nov. 12, 2010

Related U.S. Application Data
(63) Continuation-in-part of application No. 11/634,521, filed on Dec. 5, 2006, now abandoned.
Application No. 11/634,521 is a continuation-in-part of application No. 12/924,278, filed on Sep. 22, 2010.
Application No. 12/924,278 is a continuation-in-part of application No. 12/924,276, filed on Sep. 22, 2010.
Application No. 12/924,276 is a continuation-in-part of application No. 12/924,279, filed on Sep. 22, 2010.

(51) Int. Cl. H04R 3/00; G06F 17/00

(52) U.S. Cl. 381/122; 700/94

(57) ABSTRACT

Certain aspects relate to providing an at least one audio source to at least one user. Certain aspects relate to selectively modifying an at least one first sound source to be provided to the at least one user, wherein the at least one first sound source is combined with an at least one second sound source, and wherein the selectively modifying is performed relative to the at least one audio source based at least in part on at least some specific information of the at least one first sound source. Other aspects relate to selectively modifying the at least one first sound source to be provided to the at least one user relative to the at least one second sound source based at least in part on at least some specific information of the at least one first sound source.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications, including any priority claims, is incorporated herein by reference to the extent such subject matter is not inconsistent herewith.

### RELATED APPLICATIONS

For purposes of the USPTO extra-statutory requirements, the present application constitutes a continuation-in-part of U.S. patent application Ser. No. 11/634,521, entitled SELECTIVE AUDIO/SOUND ASPECTS, naming Alexander J. Cohen, Edward K. Y. Jung, Royce A. Levien, Robert W. Lord, Mark A. Malamud, William Henry Mangione-Smith, John D. Rinaldo, Jr., Clarence T. Tegreene, and Lowell L. Wood, Jr. as inventors, filed 5 Dec. 2006, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/924,278, entitled SELECTIVE AUDIO/SOUND ASPECTS, naming Alexander J. Cohen, Edward K. Y. Jung, Royce A. Levien, Robert W. Lord, Mark A. Malamud, William Henry Mangione-Smith, John D. Rinaldo, Jr., Clarence T. Tegreene, and Lowell L. Wood, Jr. as inventors, filed 22 Sep. 2010, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/924,276, entitled SELECTIVE AUDIO/SOUND ASPECTS, naming Alexander J. Cohen, Edward K. Y. Jung, Royce A. Levien, Robert W. Lord, Mark A. Malamud, William Henry Mangione-Smith, John D. Rinaldo, Jr., Clarence T. Tegreene, and Lowell L. Wood, Jr. as inventors, filed 22 Sep. 2010, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/924,279, entitled SELECTIVE AUDIO/SOUND ASPECTS, naming Alexander J. Cohen, Edward K. Y. Jung, Royce A. Levien, Robert W. Lord, Mark A. Malamud, William Henry Mangione-Smith, John D. Rinaldo, Jr., Clarence T. Tegreene, and Lowell L. Wood, Jr. as inventors, filed 22 Sep. 2010, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above, but expressly points out that such designation(s) are not to be construed in any way as any type of commentary and/or admission as to whether or not the present application contains any new matter in addition to the matter of its parent application(s).

### TECHNICAL FIELD

Certain aspects of this disclosure can relate to, but are not limited to, an audio/sound device that can selectively filter certain audio and/or sound.

### BRIEF DESCRIPTION OF THE FIGURES

FIG. 1 is a block diagram of one embodiment of an audio/sound device;

FIG. 1A is a block diagram of another embodiment of the audio sound device of FIG. 1;

FIG. 1B is a block diagram of a first plurality of modules for an exemplary implementation of an audio/sound device of FIG. 1A;

FIG. 1C is a block diagram of a second plurality of modules for an exemplary implementation of an audio/sound device of FIG. 1A;

FIG. 1D is a block diagram of a third plurality of modules for an exemplary implementation of an audio/sound device of FIG. 1A;

FIG. 1E is a block diagram of a fourth plurality of modules for an exemplary implementation of an audio/sound device of FIG. 1A;

FIG. 1F is a block diagram of a fifth plurality of modules for an exemplary implementation of an audio/sound device of FIG. 1A;

FIG. 1G is a block diagram of a sixth plurality of modules for an exemplary implementation of an audio/sound device of FIG. 1A;

FIG. 1H is a block diagram of a seventh plurality of modules for an exemplary implementation of an audio/sound device of FIG. 1A;

FIG. 1J is a block diagram of a eighth plurality of modules for an exemplary implementation of an audio/sound device of FIG. 1A;

FIG. 1K is a block diagram of a ninth plurality of modules for an exemplary implementation of an audio/sound device of FIG. 1A;

FIG. 1L is a block diagram of a tenth plurality of modules for an exemplary implementation of an audio/sound device of FIG. 1A;

FIG. 1M is a block diagram of a eleventh plurality of modules for an exemplary implementation of an audio/sound device of FIG. 1A;

FIG. 1N is a block diagram of a twelfth plurality of modules for an exemplary implementation of an audio/sound device of FIG. 1A;

FIG. 1P is a block diagram of a thirteenth plurality of modules for an exemplary implementation of an audio/sound device of FIG. 1A;

FIG. 1Q is a block diagram of a fourteenth plurality of modules for an exemplary implementation of an audio/sound device of FIG. 1A;

FIG. 1R is a block diagram of a fifteenth plurality of modules for an exemplary implementation of an audio/sound device of FIG. 1A;

FIG. 1T is a block diagram of a sixteenth plurality of modules for an exemplary implementation of an audio/sound device of FIG. 1A;

FIG. 1U is a block diagram of a seventeenth plurality of modules for an exemplary implementation of an audio/sound device of FIG. 1A;

FIG. 1V is a block diagram of a eighteenth plurality of modules for an exemplary implementation of an audio/sound device of FIG. 1A;

FIG. 1W is a block diagram of a nineteenth plurality of modules for an exemplary implementation of an audio/sound device of FIG. 1A;

FIG. 1X is a block diagram of a twentieth plurality of modules for an exemplary implementation of an audio/sound device of FIG. 1A;

FIG. 1Y is a block diagram of a twenty-first plurality of modules for an exemplary implementation of an audio/sound device of FIG. 1A;

FIG. 1Z is a block diagram of a twenty-second plurality of modules for an exemplary implementation of an audio/sound device of FIG. 1A;

FIG. 1YY is a block diagram of a twenty-third plurality of modules for an exemplary implementation of an audio/sound device of FIG. 1A;

FIG. 1ZZ is a block diagram of a twenty-fourth plurality of modules for an exemplary implementation of an audio/sound device of FIG. 1A;

FIG. 2 is a diagram of one embodiment of a directional sound clue mechanism as can be utilized with certain audio/sound devices;

FIG. 3 is a diagram of one embodiment of an audio/sound device;

FIG. 4 is a diagram of one embodiment of the audio/sound device;

FIG. 5 is a diagram of one embodiment of the audio/sound device;

FIG. 6 is a diagram of one embodiment of the audio/sound device;

FIG. 7 is a diagram of another embodiment of the audio/sound device;

FIG. 7A is a diagram of another embodiment of the audio/sound device;

FIG. 8 is a flow chart of one embodiments of an audio/sound technique;

FIG. 9 is a flow chart of another embodiment of an audio/sound technique;

FIG. 10 (including FIGS. 10a, 10b, and 10c) is a flow chart of one embodiment of a technique such as can be performed by certain embodiments of the audio/sound device; and

FIG. 11 (including FIGS. 11a, 11b, and 11c) is a flow chart of one embodiment of a technique such as can be performed by certain embodiments of the audio/sound device.

FIG. 12 is a high-level flowchart illustrating an operational flow O10 representing exemplary operations related to receiving detection, via at least in part one or more computing devices, of a first event regarding a first sound involving one or more characteristics; recording first audio information at a first original recording rate from an audio device based at least in part upon receiving the detection of a first event regarding a first sound involving one or more characteristics; receiving detection, via at least in part one or more computing devices, of a second event regarding the first sound; recording second audio information at a second original recording rate from the audio device based at least in part upon the receiving detection of the second event regarding the first sound; outputting at a rate faster than the first original recording rate the recording of the first audio information based at least in part upon receiving detection of the second event regarding the first sound; and outputting at a rate faster than the second original recording rate the recording of the second audio information based at least in part upon completion of the outputting of the first audio information.

FIG. 13 is a high-level flowchart including exemplary implementations of operation O11 of FIG. 12;

FIG. 14 is a high-level flowchart including exemplary implementations of operation O11 of FIG. 12;

FIG. 15 is a high-level flowchart including exemplary implementations of operation O11 of FIG. 12;

FIG. 16 is a high-level flowchart including exemplary implementations of operation O11 of FIG. 12;

FIG. 17 is a high-level flowchart including exemplary implementations of operation O12 of FIG. 12;

FIG. 18 is a high-level flowchart including exemplary implementations of operation O12 of FIG. 12;

FIG. 19 is a high-level flowchart including exemplary implementations of operation O13 of FIG. 12;

FIG. 20 is a high-level flowchart including exemplary implementations of operation O13 of FIG. 12;

FIG. 21 is a high-level flowchart including exemplary implementations of operation O13 of FIG. 12;

FIG. 22 is a high-level flowchart including exemplary implementations of operation O13 of FIG. 12;

FIG. 23 is a high-level flowchart including exemplary implementations of operation O14 of FIG. 12;

FIG. 24 is a high-level flowchart including exemplary implementations of operation O15 of FIG. 12;

FIG. 25 is a high-level flowchart including exemplary implementations of operation O16 of FIG. 12;

FIG. 26 is a high-level flowchart illustrating an operational flow O20 representing exemplary operations related to receiving detection, via at least in part one or more computing devices, of a first event regarding a first sound involving one or more characteristics in a first manner; generating, via at least in part one or more computing devices, a first generated audio signal to alter hearing of the first sound by a listener based at least in part on receiving the detection of a first event regarding a first sound involving one or more characteristics in a first manner; receiving detection, via at least in part one or more computing devices, of a first event regarding a second sound involving the one or more characteristics in a second manner other than the first manner; and generating, via at least in part one or more computing devices, a second generated audio signal to indicate information based at least in part upon receiving the detection of the first event of the second sound involving the one or more characteristics in a second manner other than the first manner.

FIG. 27 is a high-level flowchart including exemplary implementations of operation O21 of FIG. 26;

FIG. 28 is a high-level flowchart including exemplary implementations of operation O21 of FIG. 26;

FIG. 29 is a high-level flowchart including exemplary implementations of operation O21 of FIG. 26;

FIG. 30 is a high-level flowchart including exemplary implementations of operation O21 of FIG. 26;

FIG. 31 is a high-level flowchart including exemplary implementations of operation O22 of FIG. 26;

FIG. 32 is a high-level flowchart including exemplary implementations of operation O22 of FIG. 26;

FIG. 33 is a high-level flowchart including exemplary implementations of operation O23 of FIG. 26;

FIG. 34 is a high-level flowchart including exemplary implementations of operation O23 of FIG. 26;

FIG. 35 is a high-level flowchart including exemplary implementations of operation O23 of FIG. 26;

FIG. 36 is a high-level flowchart including exemplary implementations of operation O23 of FIG. 26;

FIG. 37 is a high-level flowchart including exemplary implementations of operation O24 of FIG. 26;

FIG. 38 is a high-level flowchart including exemplary implementations of operation O24 of FIG. 26;

FIG. 39 is a high-level flowchart illustrating an operational flow O30 representing exemplary operations related to receiving detection, via at least in part one or more computing devices, of a first event regarding a first sound involving one or more characteristics in a first manner; generating, via at least in part one or more computing devices, a first generated audio signal to alter hearing of the first sound by a listener based at least in part on receiving the detection of a first event regarding a first sound involving one or more characteristics in a first manner; receiving detection, via at least in part one or more computing devices, of a first event regarding a second sound involving the one or more characteristics in a second manner other than the first manner; and outputting, via at least in part one or more computing devices, an indication based at least in part upon receiving the detection of the first event regarding the second sound involving the one or more characteristics in the second manner other than the first manner.

FIG. 40 is a high-level flowchart including exemplary implementations of operation O31 of FIG. 39;

FIG. 41 is a high-level flowchart including exemplary implementations of operation O31 of FIG. 39;

FIG. 42 is a high-level flowchart including exemplary implementations of operation O31 of FIG. 39;

FIG. 43 is a high-level flowchart including exemplary implementations of operation O31 of FIG. 39;

FIG. 44 is a high-level flowchart including exemplary implementations of operation O32 of FIG. 39;

FIG. 45 is a high-level flowchart including exemplary implementations of operation O32 of FIG. 39;

FIG. 46 is a high-level flowchart including exemplary implementations of operation O33 of FIG. 39;

FIG. 47 is a high-level flowchart including exemplary implementations of operation O33 of FIG. 39;

FIG. 48 is a high-level flowchart including exemplary implementations of operation O33 of FIG. 39;

FIG. 49 is a high-level flowchart including exemplary implementations of operation O33 of FIG. 39;

FIG. 50 is a high-level flowchart including exemplary implementations of operation O34 of FIG. 39;

FIG. 51 is a high-level flowchart including exemplary implementations of operation O34 of FIG. 39;

FIG. 52 is a high-level flowchart including exemplary implementations of operation O34 of FIG. 39;

FIG. 53 is a high-level flowchart illustrating an operational flow O40 representing exemplary operations related to receiving detection, via at least in part one or more computing devices, of a first event regarding a first sound involving one or more characteristics in a first manner; generating, via at least in part one or more computing devices, a first generated audio signal to alter hearing of the first sound by a listener based at least in part on receiving the detection of a first event regarding a first sound involving one or more characteristics in a first manner; receiving detection, via at least in part one or more computing devices, of a first event regarding a second sound involving the one or more characteristics in a second manner other than the first manner; receiving an estimation, via at least in part one or more computing devices, of a directional orientation for origination of the second sound; and outputting, via at least in part one or more computing devices, an indication of the directional orientation for origination of the second sound based at least in part upon receiving the estimation of the directional orientation for origination of the second sound.

FIG. 54 is a high-level flowchart including exemplary implementations of operation O41 of FIG. 53;

FIG. 55 is a high-level flowchart including exemplary implementations of operation O41 of FIG. 53;

FIG. 56 is a high-level flowchart including exemplary implementations of operation O41 of FIG. 53;

FIG. 57 is a high-level flowchart including exemplary implementations of operation O41 of FIG. 53;

FIG. 58 is a high-level flowchart including exemplary implementations of operation O42 of FIG. 53;

FIG. 59 is a high-level flowchart including exemplary implementations of operation O42 of FIG. 53;

FIG. 60 is a high-level flowchart including exemplary implementations of operation O43 of FIG. 53;

FIG. 61 is a high-level flowchart including exemplary implementations of operation O43 of FIG. 53;

FIG. 62 is a high-level flowchart including exemplary implementations of operation O43 of FIG. 53;

FIG. 63 is a high-level flowchart including exemplary implementations of operation O43 of FIG. 53;

FIG. 64 is a high-level flowchart including exemplary implementations of operation O44 of FIG. 53;

FIG. 65 is a high-level flowchart including exemplary implementations of operation O44 of FIG. 53;

FIG. 66 is a high-level flowchart including exemplary implementations of operation O45 of FIG. 53;

FIG. 67 is a high-level flowchart including exemplary implementations of operation O45 of FIG. 53;

FIG. 68 is a high-level flowchart including exemplary implementations of operation O45 of FIG. 53;

FIG. 69 is a high-level flowchart including exemplary implementations of operation O45 of FIG. 53;

FIG. 70 is a high-level flowchart illustrating an operational flow O50 representing exemplary operations related to receiving detection of one or more conditions; selecting one or more characteristics as one or more selected characteristics, via at least in part one or more computing devices, based at least in part on receiving the detection of one or more conditions, the one or more selected characteristics to be subject for detection in one or more sounds; receiving detection, via at least in part one or more computing devices, of a first event regarding a first sound involving the one or more selected characteristics to be subject for detection in one or more sounds in a first manner; generating, via at least in part one or more computing devices, a first generated audio signal to alter hearing of the first sound by a listener based at least in part on receiving the detection of a first event regarding a first sound involving the one or more selected characteristics in the first manner; and receiving detection, via at least in part one or more computing devices, of a first event regarding a second sound involving the one or more selected characteristics in a second manner other than the first manner.

FIG. 71 is a high-level flowchart including exemplary implementations of operation O51 of FIG. 70;

FIG. 72 is a high-level flowchart including exemplary implementations of operation O51 of FIG. 70;

FIG. 73 is a high-level flowchart including exemplary implementations of operation O52 of FIG. 70;

FIG. 74 is a high-level flowchart including exemplary implementations of operation O52 of FIG. 70;

FIG. 75 is a high-level flowchart including exemplary implementations of operation O53 of FIG. 70;

FIG. 76 is a high-level flowchart including exemplary implementations of operation O53 of FIG. 70;

FIG. 77 is a high-level flowchart including exemplary implementations of operation O53 of FIG. 70;

FIG. 78 is a high-level flowchart including exemplary implementations of operation O53 of FIG. 70;

FIG. 79 is a high-level flowchart including exemplary implementations of operation O54 of FIG. 70;

FIG. 80 is a high-level flowchart including exemplary implementations of operation O54 of FIG. 70;

FIG. 81 is a high-level flowchart including exemplary implementations of operation O55 of FIG. 70;

FIG. 82 is a high-level flowchart including exemplary implementations of operation O55 of FIG. 70;

FIG. 83 is a high-level flowchart including exemplary implementations of operation O55 of FIG. 70;

FIG. 84 is a high-level flowchart including exemplary implementations of operation O55 of FIG. 70;

FIG. 85 is a high-level flowchart illustrating an operational flow O60 representing exemplary operations related to receiving detection, via at least in part one or more computing devices, of a first event regarding a first sound involving the one or more selected characteristics in a first manner; generating, via at least in part one or more computing devices, a first generated audio signal to alter hearing of the first sound by a listener based at least in part on receiving the detection of a first event regarding a first sound involving one or more characteristics in a first manner; receiving detection of one or more conditions; and outputting an indication based upon detection of the one or more conditions.

FIG. 86 is a high-level flowchart including exemplary implementations of operation O61 of FIG. 85;

FIG. 87 is a high-level flowchart including exemplary implementations of operation O61 of FIG. 85;

FIG. 88 is a high-level flowchart including exemplary implementations of operation O61 of FIG. 85;

FIG. 89 is a high-level flowchart including exemplary implementations of operation O61 of FIG. 85;

FIG. 90 is a high-level flowchart including exemplary implementations of operation O62 of FIG. 85;

FIG. 91 is a high-level flowchart including exemplary implementations of operation O62 of FIG. 85;

FIG. 92 is a high-level flowchart including exemplary implementations of operation O63 of FIG. 85;

FIG. 93 is a high-level flowchart including exemplary implementations of operation O63 of FIG. 85;

FIG. 94 is a high-level flowchart including exemplary implementations of operation O64 of FIG. 85;

FIG. 95 is a high-level flowchart including exemplary implementations of operation O64 of FIG. 85;

FIG. 96 is a high-level flowchart including exemplary implementations of operation O64 of FIG. 85;

FIG. 97 is a high-level flowchart illustrating an operational flow O70 representing exemplary operations related to receiving detection, via at least in part one or more computing devices, of a first event regarding a first sound as originating from a directional orientation other than a selected directional orientation; generating, via at least in part one or more computing devices, a first generated audio signal to alter in a first manner hearing of the first sound by a listener based at least in part on receiving the detection of a first event regarding a first sound as originating from a directional orientation other than the selected directional orientation; receiving detection, via at least in part one or more computing devices, of a first event regarding a second sound involving one or more characteristics and as originating from the selected directional orientation; and if generating, via at least in part one or more computing devices, a second generated audio signal to alter hearing of the second sound by a listener, then generating the second generated audio signal to alter in a manner other than the first manner hearing of the second sound based at least in part on receiving the detection of a first event regarding the second sound as originating from the selected directional orientation.

FIG. 98 is a high-level flowchart including exemplary implementations of operation O71 of FIG. 97;

FIG. 99 is a high-level flowchart including exemplary implementations of operation O71 of FIG. 97;

FIG. 100 is a high-level flowchart including exemplary implementations of operation O71 of FIG. 97;

FIG. 101 is a high-level flowchart including exemplary implementations of operation O71 of FIG. 97;

FIG. 102 is a high-level flowchart including exemplary implementations of operation O71 of FIG. 97;

FIG. 103 is a high-level flowchart including exemplary implementations of operation O71 of FIG. 97;

FIG. 104 is a high-level flowchart including exemplary implementations of operation O72 of FIG. 97;

FIG. 105 is a high-level flowchart including exemplary implementations of operation O72 of FIG. 97;

FIG. 106 is a high-level flowchart including exemplary implementations of operation O72 of FIG. 97;

FIG. 107 is a high-level flowchart including exemplary implementations of operation O73 of FIG. 97;

FIG. 108 is a high-level flowchart including exemplary implementations of operation O73 of FIG. 97;

FIG. 109 is a high-level flowchart including exemplary implementations of operation O73 of FIG. 97;

FIG. 110 is a high-level flowchart including exemplary implementations of operation O73 of FIG. 97;

FIG. 111 is a high-level flowchart including exemplary implementations of operation O73 of FIG. 97;

FIG. 112 is a high-level flowchart including exemplary implementations of operation O73 of FIG. 97;

FIG. 113 is a high-level flowchart including exemplary implementations of operation O73 of FIG. 97;

FIG. 114 is a high-level flowchart including exemplary implementations of operation O73 of FIG. 97;

FIG. 115 is a high-level flowchart including exemplary implementations of operation O74 of FIG. 97;

FIG. 116 is a high-level flowchart including exemplary implementations of operation O74 of FIG. 97;

FIG. 117 is a high-level flowchart including exemplary implementations of operation O74 of FIG. 97;

FIG. 118 is a high-level flowchart illustrating an operational flow O80 representing exemplary operations related to receiving one or more audio signals having been generated by one or more electronic devices; receiving detection, via at least in part one or more computing devices, of a first event regarding a first sound involving one or more characteristics in a first manner and as being associated with the one or more audio signals; generating, via at least in part one or more computing devices, a first generated audio signal to alter hearing of the first sound by a listener based at least in part on receiving the detection of a first event regarding a first sound involving one or more characteristics in a first manner and as being associated with the one or more audio signals; and receiving detection, via at least in part one or more computing devices, of a first event regarding a second sound involving the one or more characteristics in a second manner other than the first manner.

FIG. 119 is a high-level flowchart including exemplary implementations of operation O81 of FIG. 118;

FIG. 120 is a high-level flowchart including exemplary implementations of operation O82 of FIG. 118;

FIG. 121 is a high-level flowchart including exemplary implementations of operation O82 of FIG. 118;

FIG. 122 is a high-level flowchart including exemplary implementations of operation O82 of FIG. 118;

FIG. 123 is a high-level flowchart including exemplary implementations of operation O82 of FIG. 118;

FIG. 124 is a high-level flowchart including exemplary implementations of operation O83 of FIG. 118;

FIG. 125 is a high-level flowchart including exemplary implementations of operation O83 of FIG. 118;

FIG. 126 is a high-level flowchart including exemplary implementations of operation O84 of FIG. 118;

FIG. 127 is a high-level flowchart including exemplary implementations of operation O84 of FIG. 118;

FIG. 128 is a high-level flowchart including exemplary implementations of operation O84 of FIG. 118;

FIG. 129 is a high-level flowchart including exemplary implementations of operation O84 of FIG. 118;

FIG. 130 is a high-level flowchart illustrating an operational flow O90 representing exemplary operations related to receiving detection of a first event of a first sound, the first event of the first sound detected, via at least in part one or more computing devices, as involving one or more repetitive components; storing identification information based at least in part upon receiving the detection of the first event of the first sound as involving one or more repetitive components; and, generating, using at least in part one or more computing devices, a first generated audio signal to alter reception of the first sound based at least in part on storing the identification information.

FIG. 131 is a high-level flowchart including exemplary implementations of operation O91 of FIG. 130;

FIG. 132 is a high-level flowchart including exemplary implementations of operation O91 of FIG. 130;

FIG. 133 is a high-level flowchart including exemplary implementations of operation O91 of FIG. 130;

FIG. 134 is a high-level flowchart including exemplary implementations of operation O91 of FIG. 130;

FIG. 135 is a high-level flowchart including exemplary implementations of operation O92 of FIG. 130;

FIG. 136 is a high-level flowchart including exemplary implementations of operation O93 of FIG. 130;

FIG. 137 is a high-level flowchart including exemplary implementations of operation O93 of FIG. 130;

FIG. 138 is a high-level flowchart illustrating an operational flow O100 representing exemplary operations related to receiving detection, via at least in part one or more computing devices, of a first event regarding a first sound involving one or more characteristics in a first manner; generating, via at least in part one or more computing devices, a first generated audio signal to alter hearing of the first sound by a listener based at least in part on receiving the detection of a first event regarding a first sound involving one or more characteristics in a first manner; receiving detection, via at least in part one or more computing devices, of a first event regarding a second sound involving the one or more characteristics in a second manner other than the first manner; receiving an audio signal from an electronic device; and modifying, via at least in part one or more computing devices, the audio signal based at least in part on receiving detection of the second sound.

FIG. 139 is a high-level flowchart including exemplary implementations of operation O101 of FIG. 138;

FIG. 140 is a high-level flowchart including exemplary implementations of operation O101 of FIG. 138;

FIG. 141 is a high-level flowchart including exemplary implementations of operation O101 of FIG. 138;

FIG. 142 is a high-level flowchart including exemplary implementations of operation O101 of FIG. 138;

FIG. 143 is a high-level flowchart including exemplary implementations of operation O102 of FIG. 138;

FIG. 144 is a high-level flowchart including exemplary implementations of operation O102 of FIG. 138;

FIG. 145 is a high-level flowchart including exemplary implementations of operation O103 of FIG. 138;

FIG. 146 is a high-level flowchart including exemplary implementations of operation O103 of FIG. 138;

FIG. 147 is a high-level flowchart including exemplary implementations of operation O103 of FIG. 138;

FIG. 148 is a high-level flowchart including exemplary implementations of operation O103 of FIG. 138;

FIG. 149 is a high-level flowchart including exemplary implementations of operation O104 of FIG. 138;

FIG. 150 is a high-level flowchart including exemplary implementations of operation O105 of FIG. 138;

FIG. 151 is a high-level flowchart including exemplary implementations of operation O105 of FIG. 138;

FIG. 152 is a high-level flowchart illustrating an operational flow O110 representing exemplary operations related to selecting one or more operational states, via at least in part one or more computing devices, based at least in part on receiving the detection of one or more conditions; receiving detection, via at least in part one or more computing devices, of a first event regarding a first sound involving one or more characteristics in a first manner; receiving detection, via at least in part one or more computing devices, of a first event regarding a second sound involving the one or more characteristics in a second manner other than the first manner; conditionally generating, via at least in part one or more computing devices, a first generated audio signal, whether the first generated audio signal is generated being dependent upon which of the one or more operational states has been selected, when generated, the first generated audio signal configured to alter hearing of the first sound by a listener based at least in part on receiving the detection of the first event regarding the first sound involving the one or more characteristics in the first manner; conditionally generating, via at least in part one or more computing devices, a second generated audio signal, whether the second generated audio signal is generated being dependent upon which of the one or more operational states has been selected, when generated, the second generated audio signal configured to alter hearing of the second sound by a listener based at least in part on receiving the detection of the first event regarding the second sound involving the one or more characteristics in the second manner other than the first manner; and conditionally altering output of an audio device signal, via at least in part one or more computing devices, the altering output of the audio device signal being dependent upon which of the one or more operational states has been selected, when the altering output of the audio device signal occurs, altering output of the audio device signal based at least in part upon receiving the detection of the first event regarding the second sound involving the one or more characteristics in the second manner other than the first manner.

FIG. 153 is a high-level flowchart including exemplary implementations of operation O111 of FIG. 152;

FIG. 154 is a high-level flowchart including exemplary implementations of operation O111 of FIG. 152;

FIG. 155 is a high-level flowchart including exemplary implementations of operation O111 of FIG. 152;

FIG. 156 is a high-level flowchart including exemplary implementations of operation O112 of FIG. 152;

FIG. 157 is a high-level flowchart including exemplary implementations of operation O112 of FIG. 152;

FIG. 158 is a high-level flowchart including exemplary implementations of operation O112 of FIG. 152;

FIG. 159 is a high-level flowchart including exemplary implementations of operation O112 of FIG. 152;

FIG. 160 is a high-level flowchart including exemplary implementations of operation O113 of FIG. 152;

FIG. 161 is a high-level flowchart including exemplary implementations of operation O113 of FIG. 152;

FIG. 162 is a high-level flowchart including exemplary implementations of operation O113 of FIG. 152;

FIG. 163 is a high-level flowchart including exemplary implementations of operation O113 of FIG. 152;

FIG. 164 is a high-level flowchart including exemplary implementations of operation O114 of FIG. 152;

FIG. 165 is a high-level flowchart including exemplary implementations of operation O114 of FIG. 152;

FIG. 166 is a high-level flowchart including exemplary implementations of operation O115 of FIG. 152;

FIG. 167 is a high-level flowchart including exemplary implementations of operation O115 of FIG. 152;

FIG. 168 is a high-level flowchart including exemplary implementations of operation O115 of FIG. 152;

FIG. 169 is a high-level flowchart including exemplary implementations of operation O116 of FIG. 152;

FIG. 170 is a high-level flowchart including exemplary implementations of operation O116 of FIG. 152;

FIG. 171 illustrates a partial view of a system S100 that includes a computer program for executing a computer process on a computing device;

FIG. 172 illustrates a partial view of a system S200 that includes a computer program for executing a computer process on a computing device;

FIG. 173 illustrates a partial view of a system S300 that includes a computer program for executing a computer process on a computing device;

FIG. 174 illustrates a partial view of a system S400 that includes a computer program for executing a computer process on a computing device;

FIG. 175 illustrates a partial view of a system S500 that includes a computer program for executing a computer process on a computing device;

FIG. 176 illustrates a partial view of a system S600 that includes a computer program for executing a computer process on a computing device;

FIG. 177 illustrates a partial view of a system S700 that includes a computer program for executing a computer process on a computing device;

FIG. 178 illustrates a partial view of a system S800 that includes a computer program for executing a computer process on a computing device;

FIG. 179 illustrates a partial view of a system S900 that includes a computer program for executing a computer process on a computing device;

FIG. 180 illustrates a partial view of a system S1000 that includes a computer program for executing a computer process on a computing device;

FIG. 181 illustrates a partial view of a system S1100 that includes a computer program for executing a computer process on a computing device.

### DETAILED DESCRIPTION

At least certain portions of the text of this disclosure (e.g., claims and/or detailed description and/or drawings as set forth herein) can support various different applications. Although, for sake of convenience and understanding, the detailed description includes section headings that generally track the general concepts as contained in one or more claims, and is not intended to limit the scope of the invention as set forth by each particular claim. It is to be understood that support for the various applications thereby can appear throughout the text and/or drawings, and/or in the claims, irrespective of the section headings.

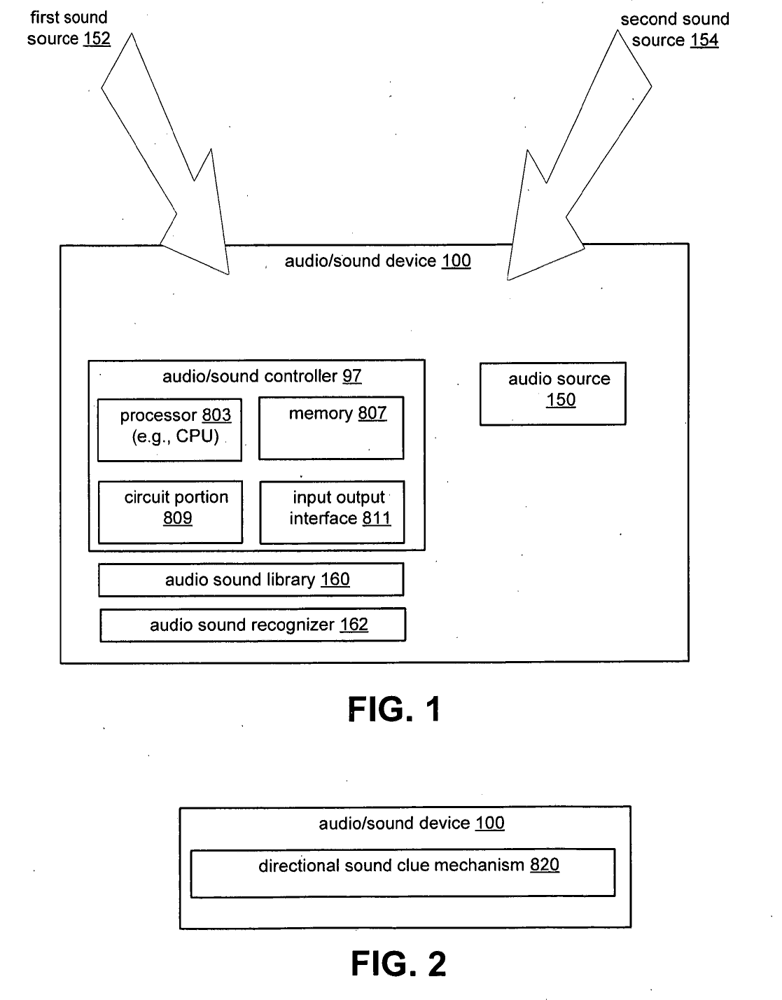

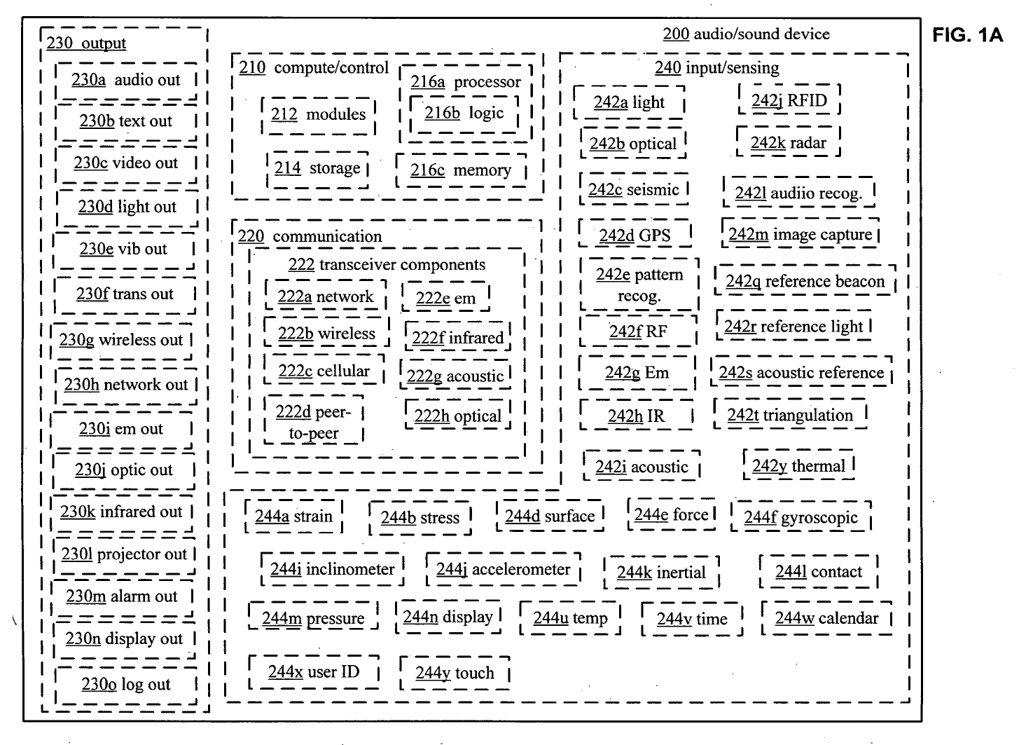

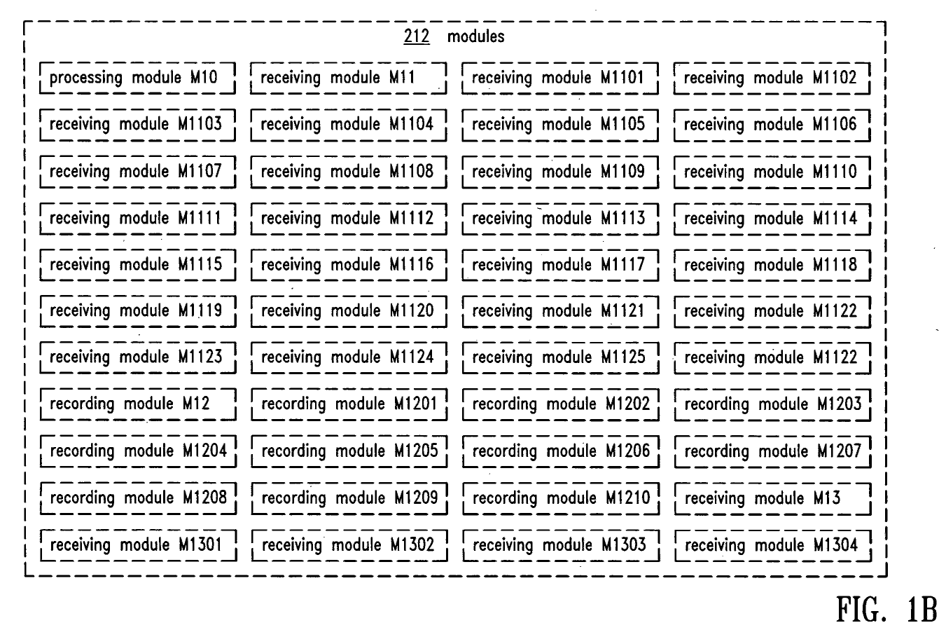

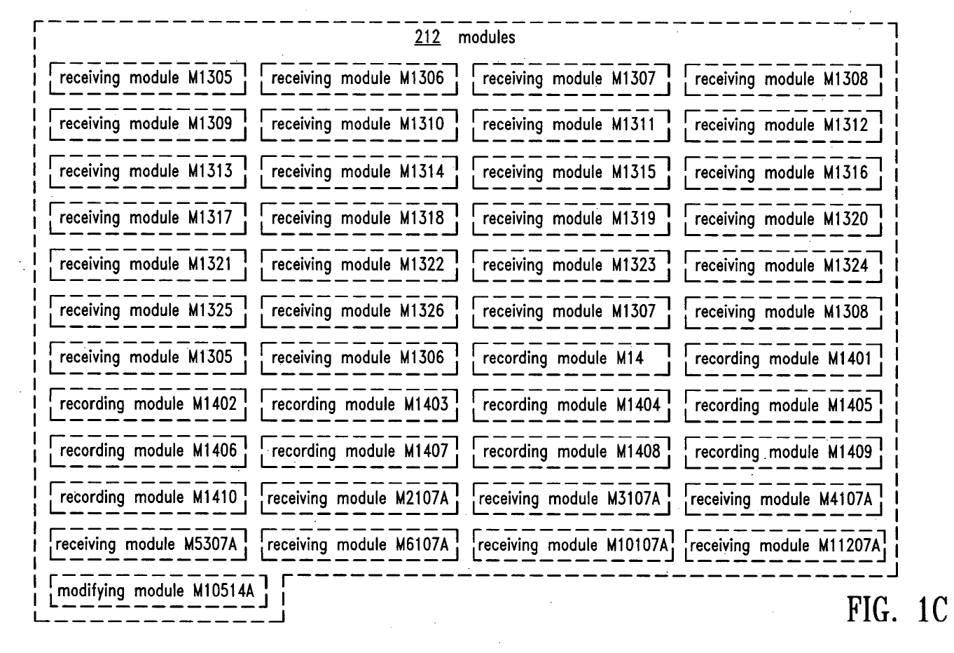

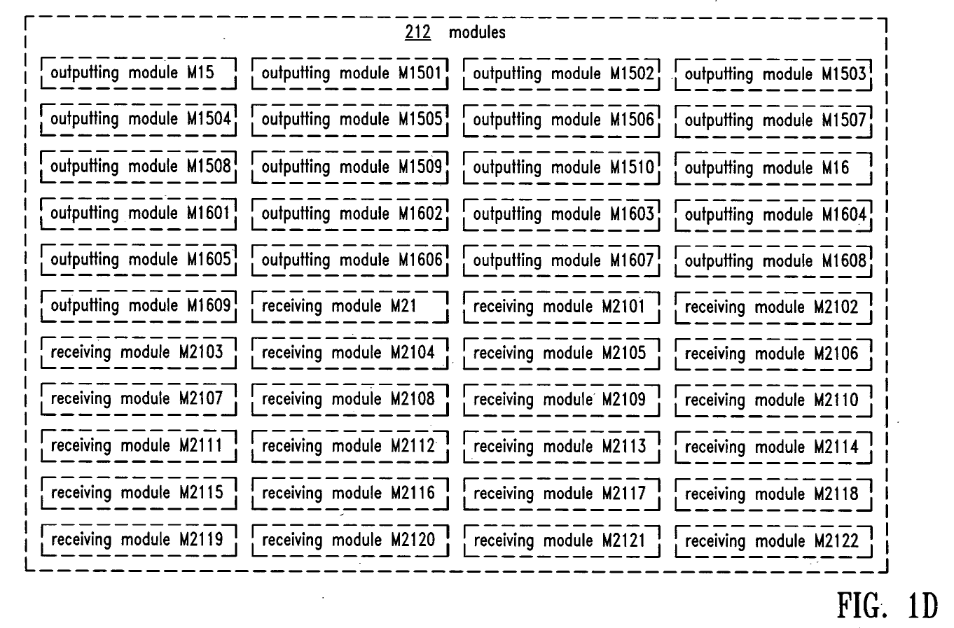

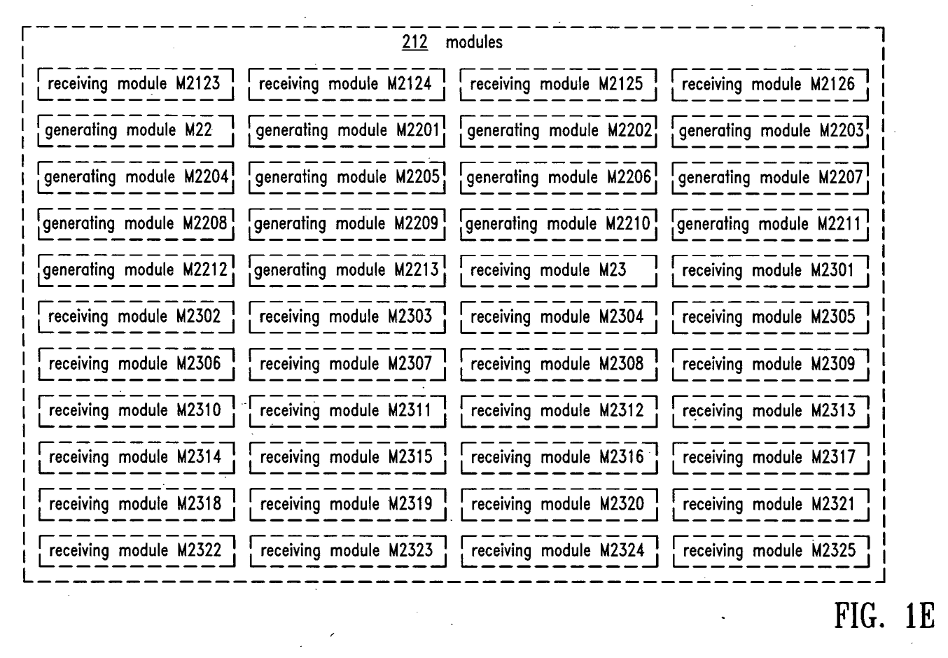

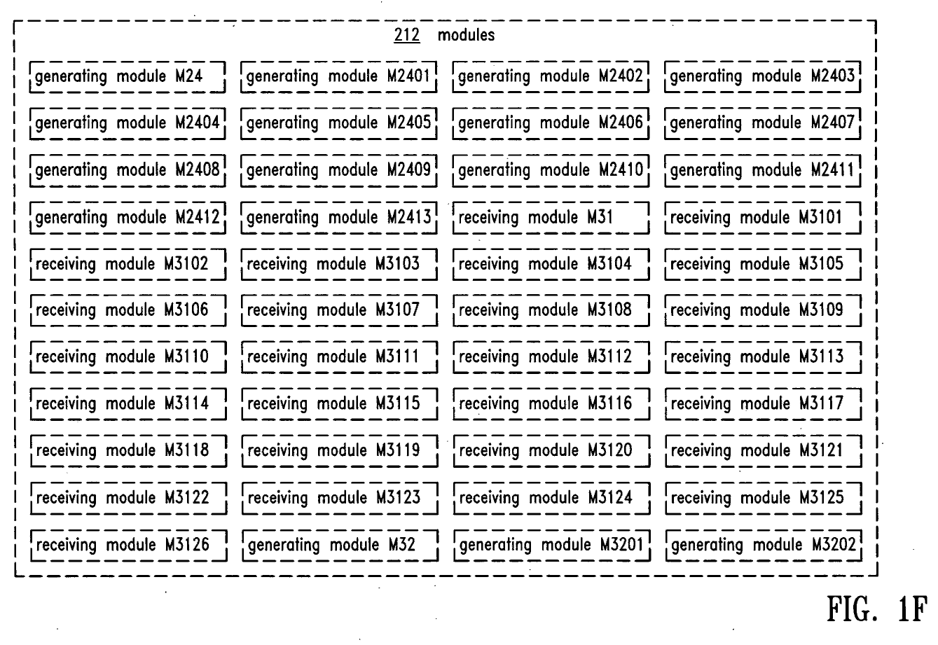

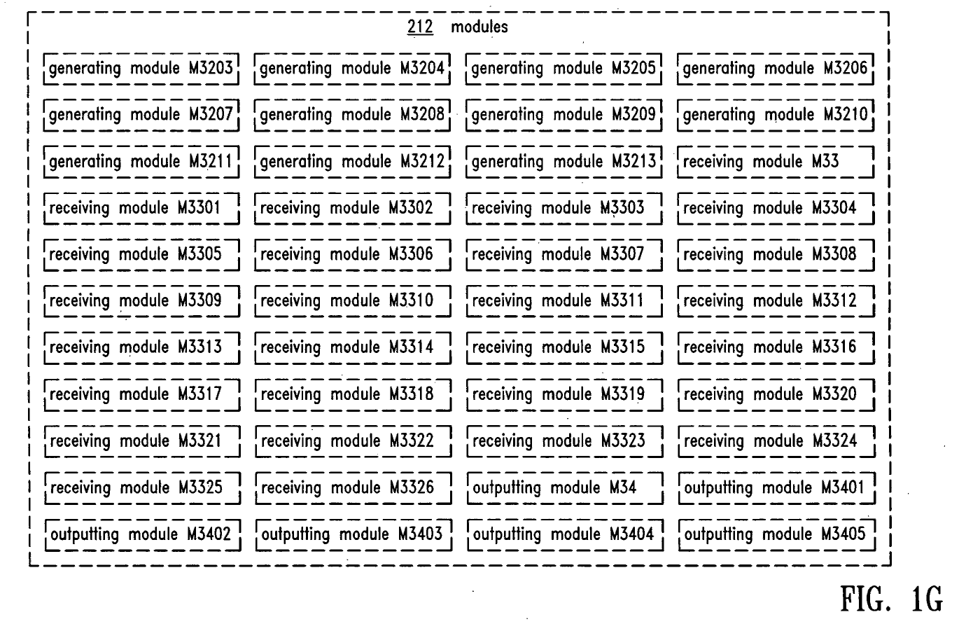

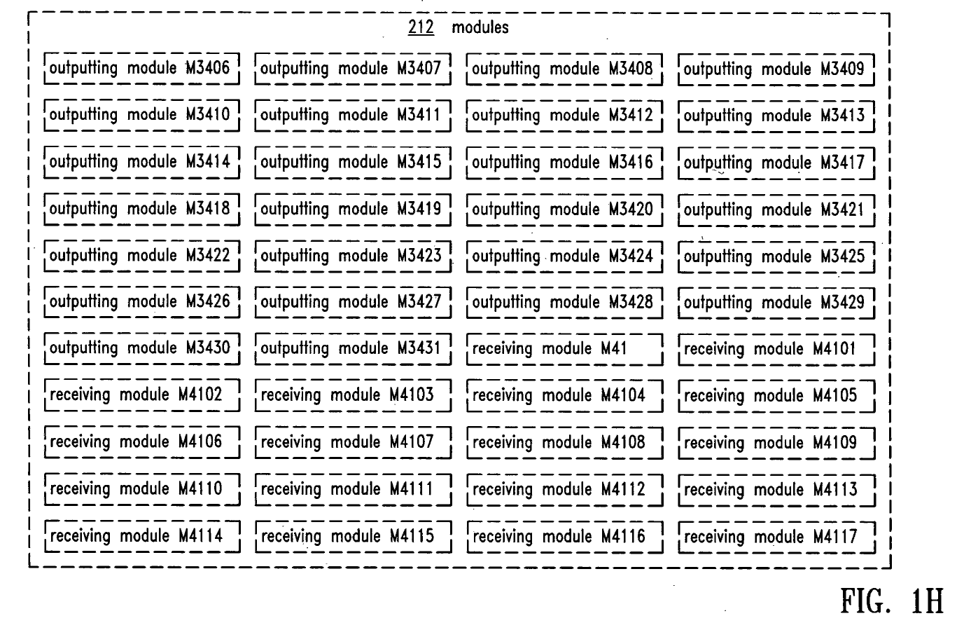

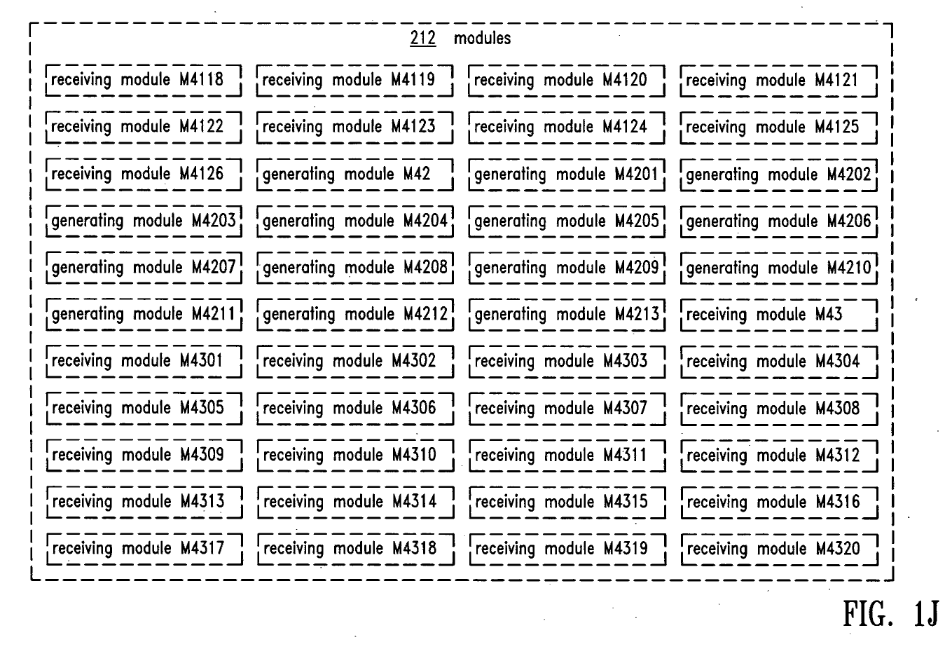

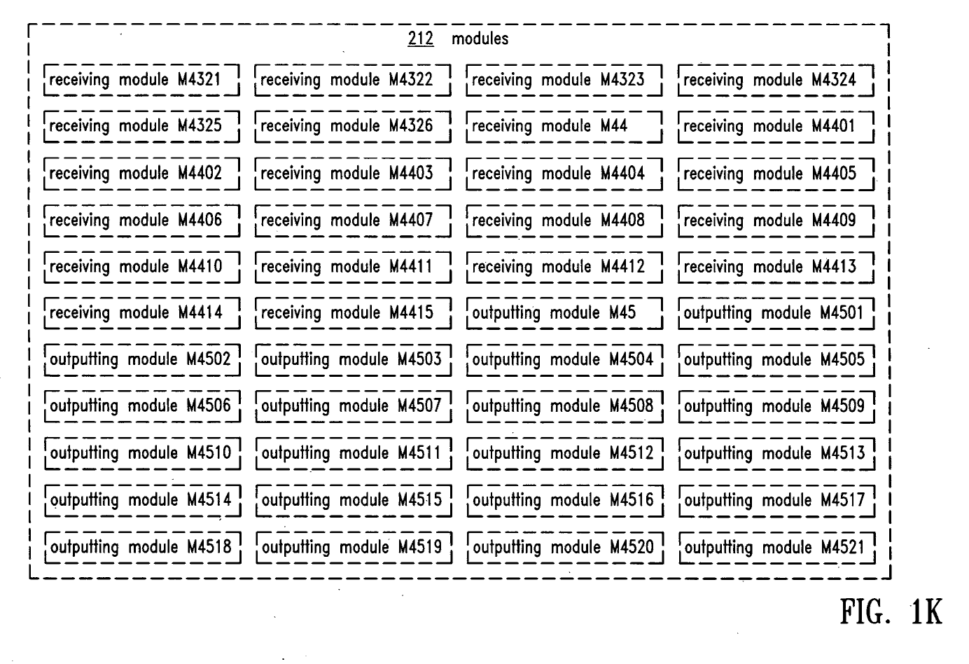

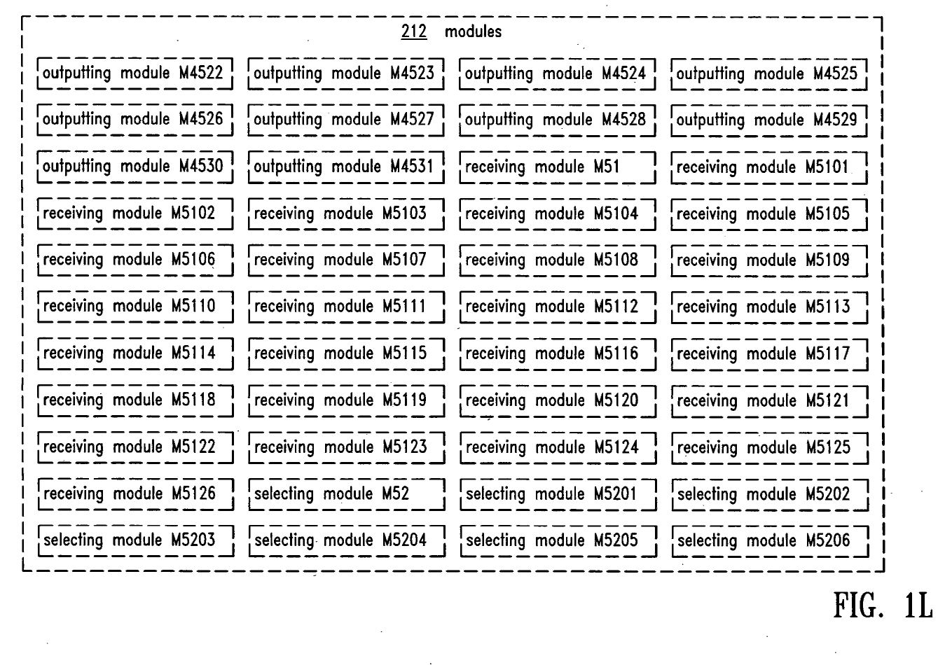

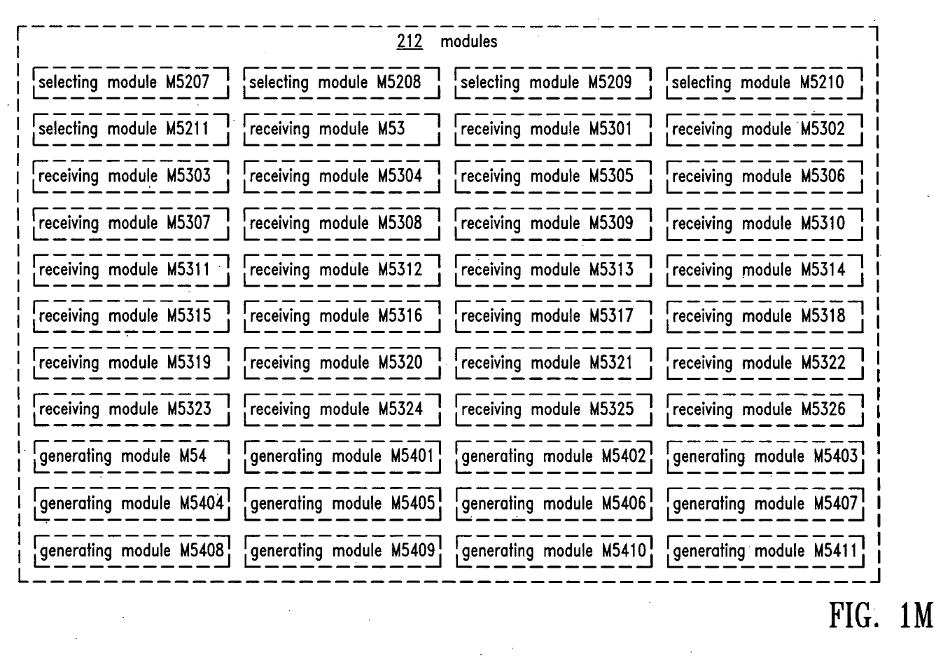

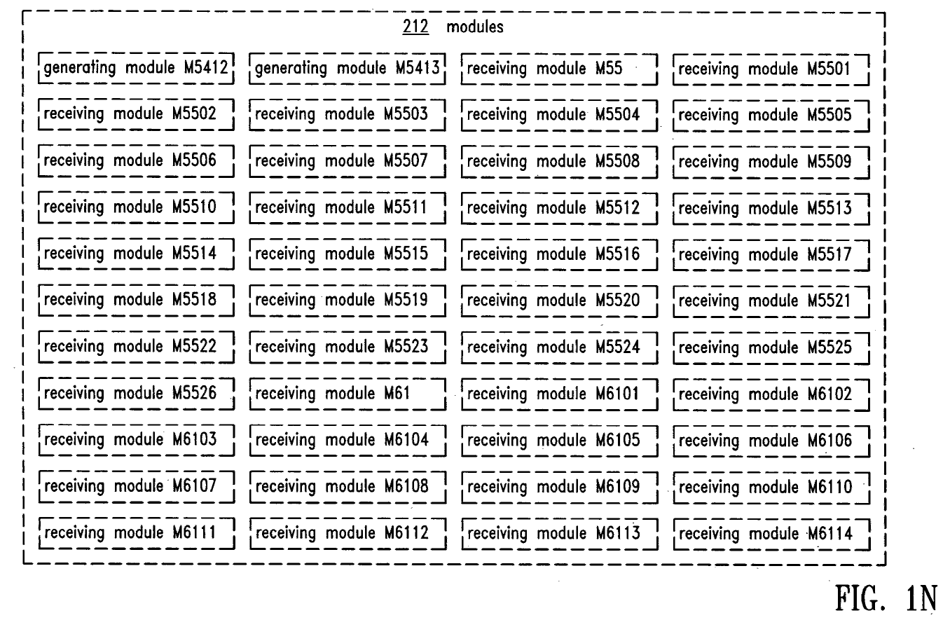

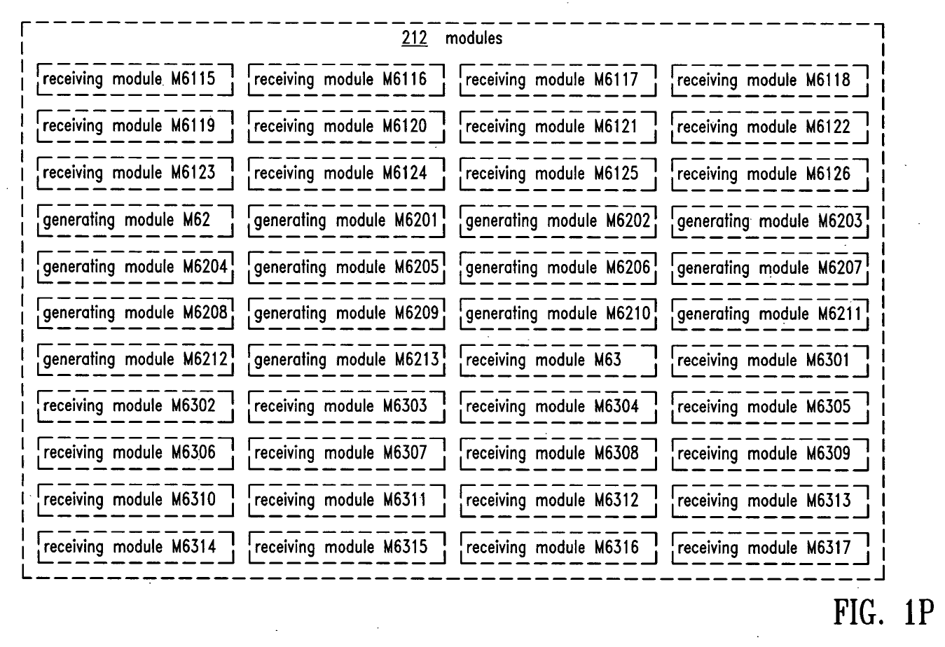

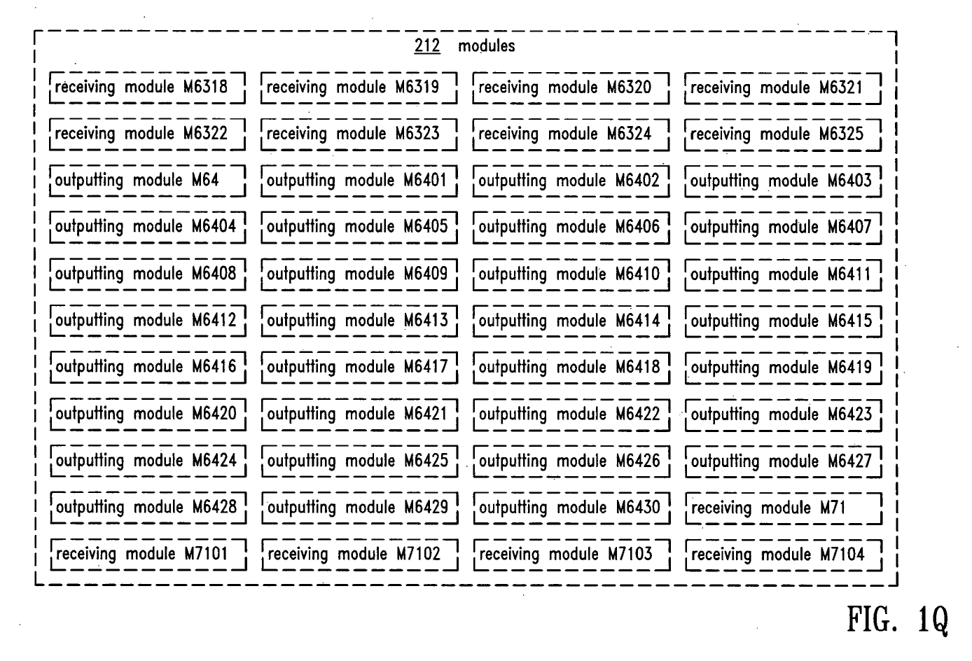

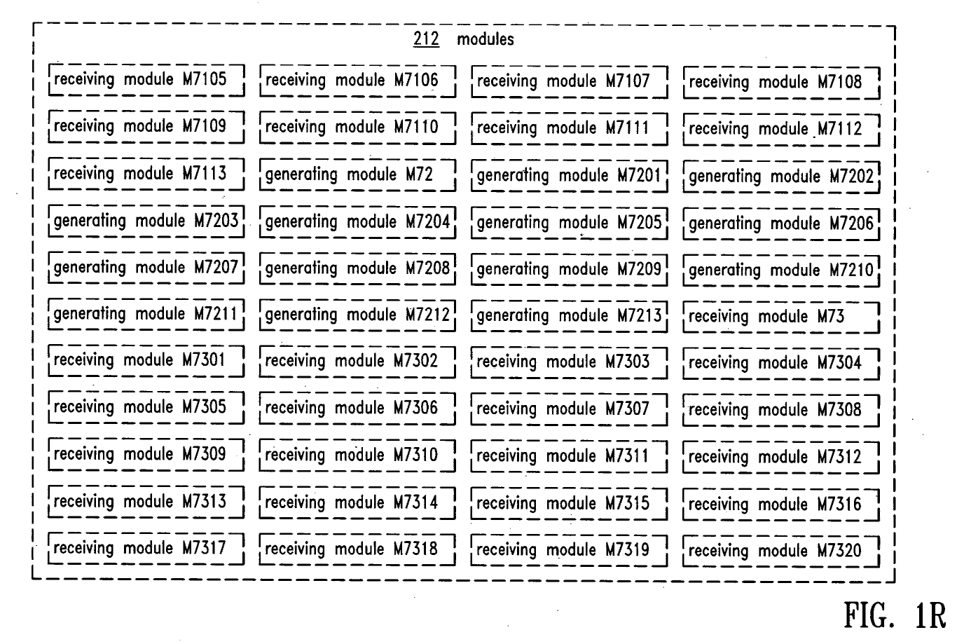

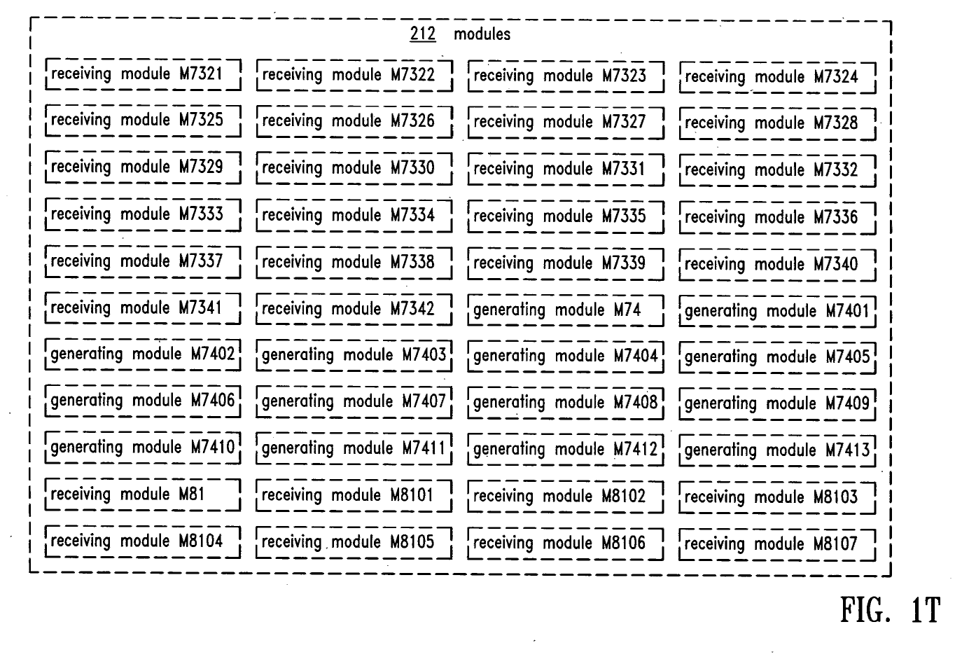

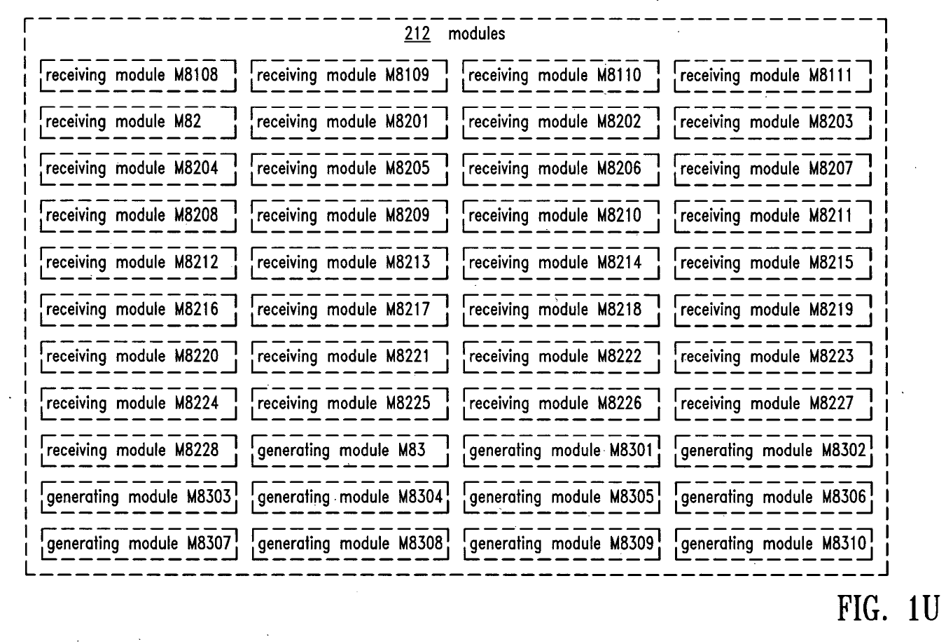

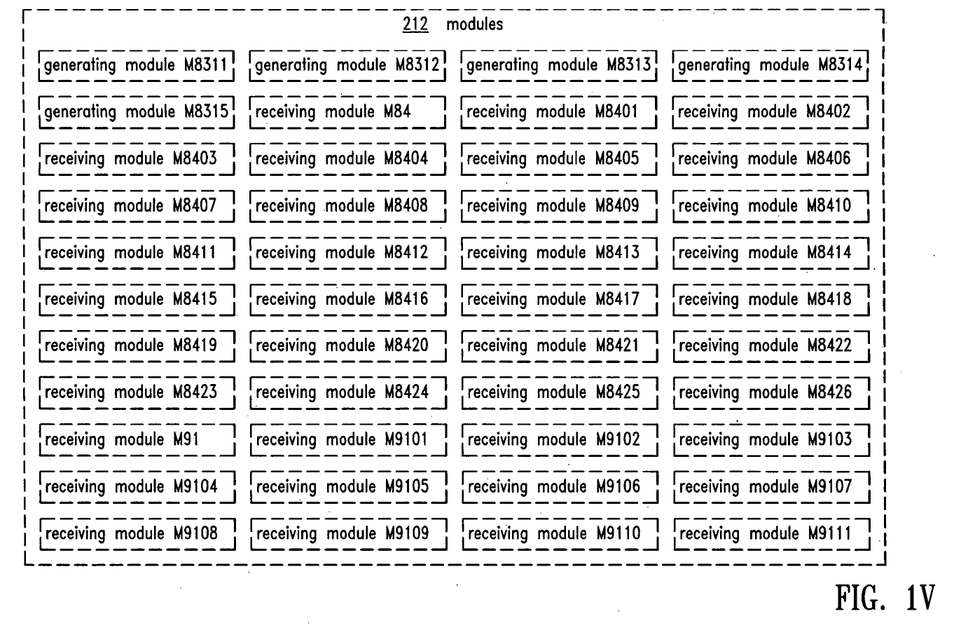

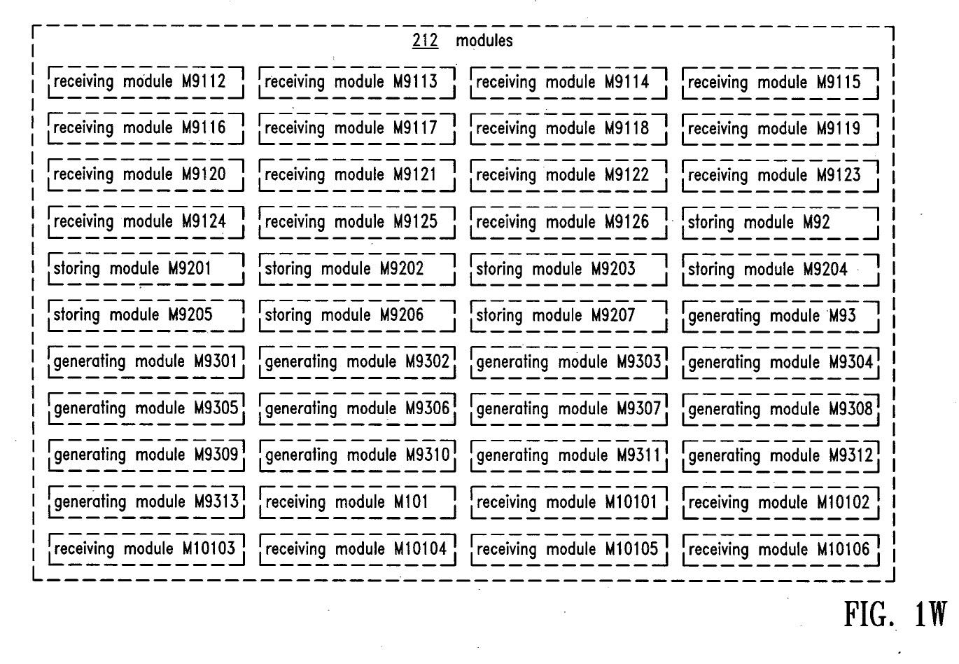

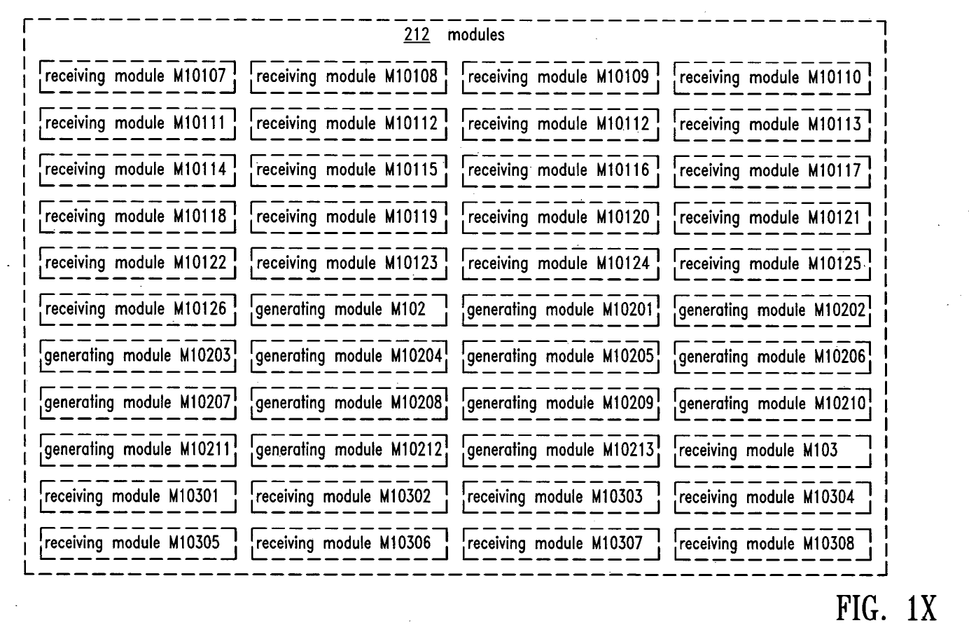

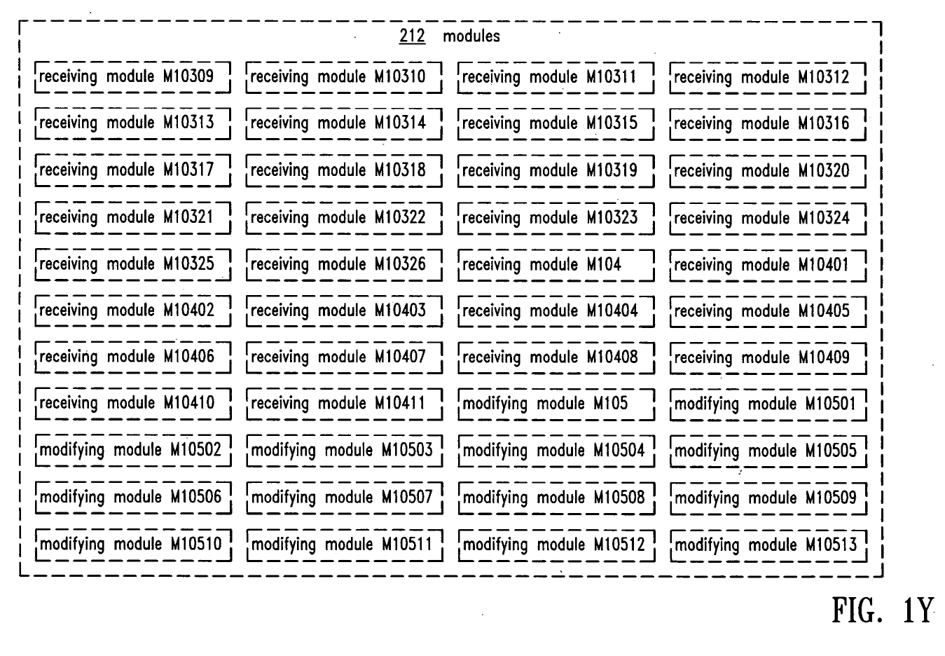

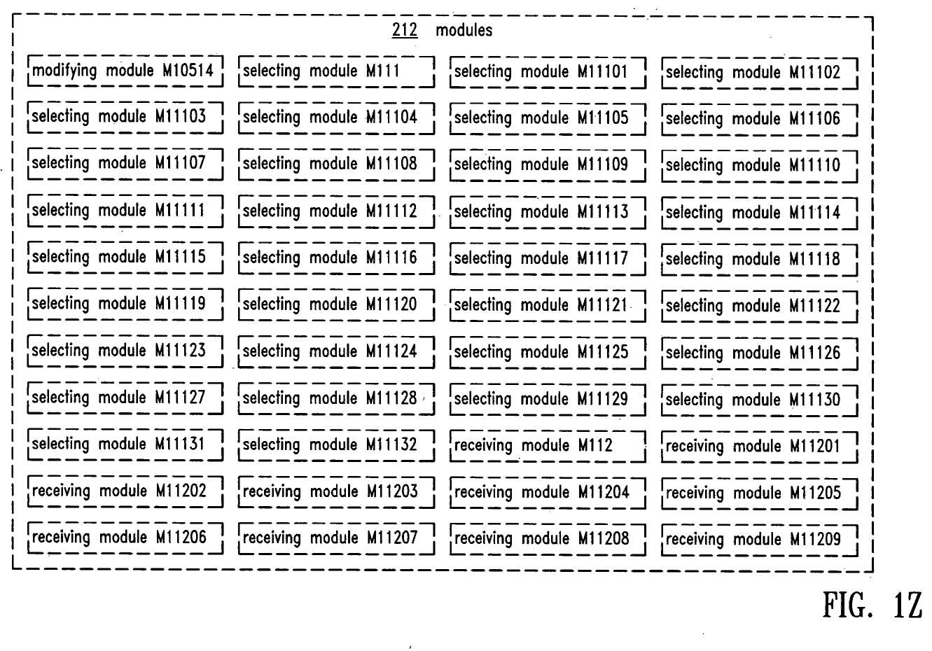

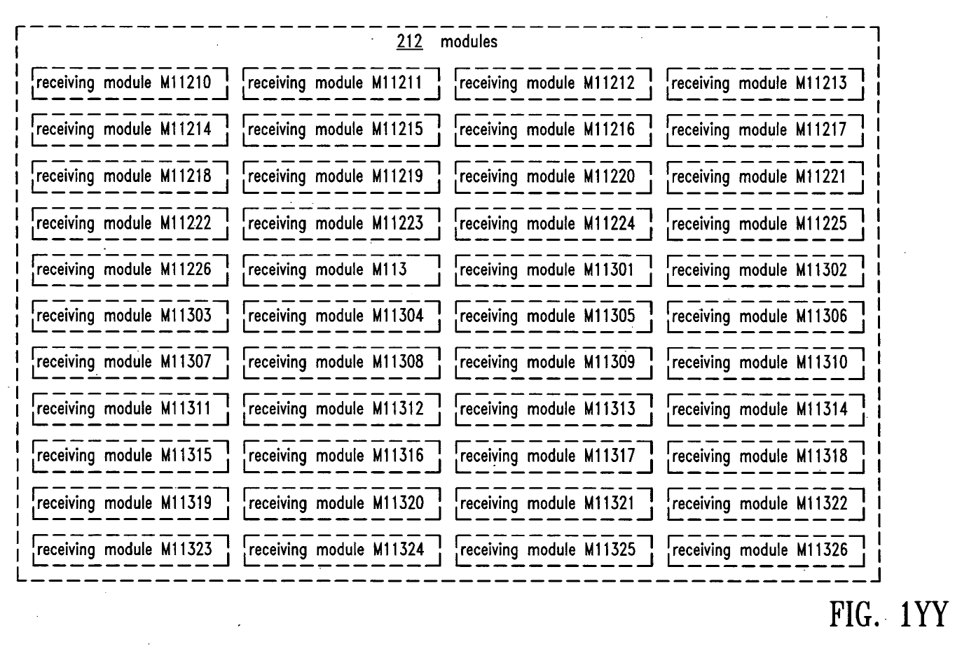

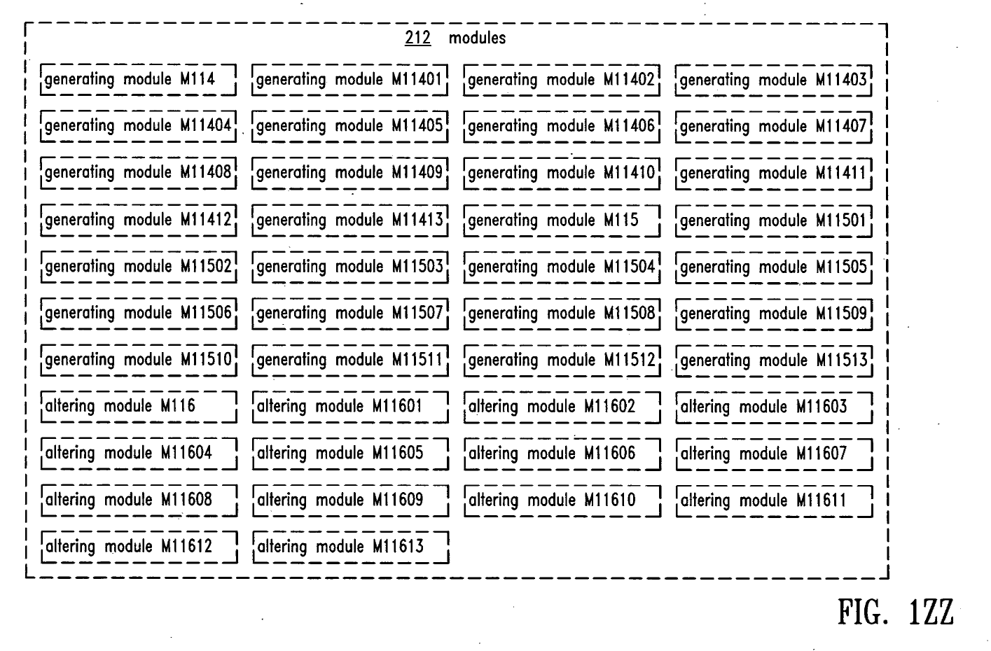

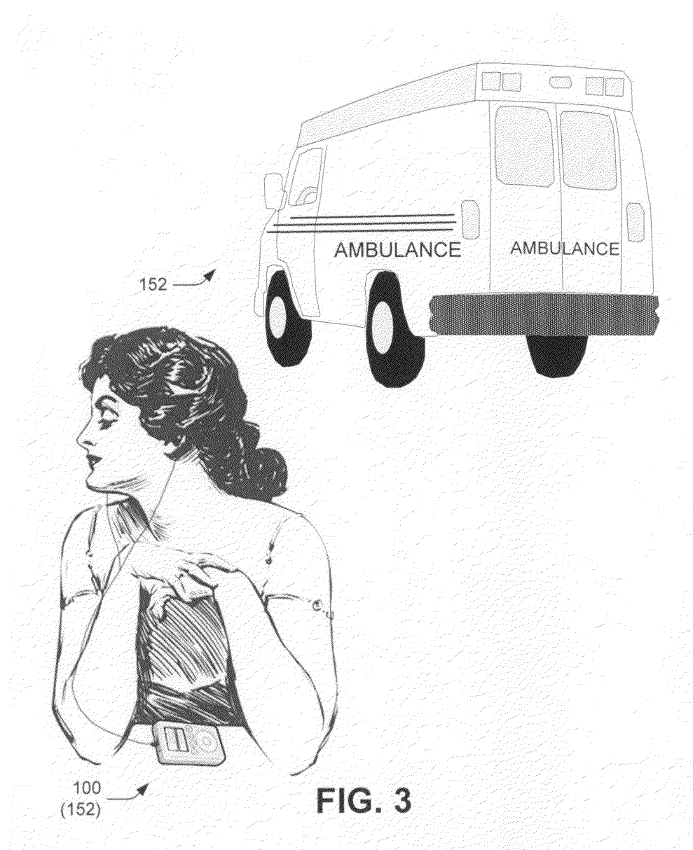

This disclosure can relate to a variety of embodiments of an audio/sound device 100 that can be utilized by a person; certain of the embodiments are as described in block format with respect to FIG. 1, and at other locations through the disclosure. Other of the embodiments include those as depicted regarding FIG. 1A, or embodiments combining aspects of those shown in FIG. 1 and FIG. 1A. Certain embodiments at particular applications of the audio/sound device are described, for example, with respect to FIGS. 3, 4, 5, 6, and 7, as well as at other locations through this disclosure. Certain embodiments of the audio/sound device 100 can include an at least one audio source 150, an at least one first sound source 152, and an at least one second sound source 154. The various embodiments of the audio/sound device 100 (as well as the respective sources 150, 152, and 154) as described in this disclosure are intended to be illustrative in nature, but not limiting in scope.

Certain embodiments of the audio/sound device 100 as described with respect to FIG. 1, in block format, can be used for a considerable variety of application involving providing one or more of: relative maintaining, relative reducing, relative diminishing, relative amplification, and other relative processing of one or more of the one or more audio source 150, the one or more first sound source 152, and/or the one or more second sound source 154, as described in this disclosure.

There may be a variety of types or classifications of sounds and/or audio corresponding to the at least one audio source 150, the at least one first sound source 152, and/or the at least one second sound source 154 that can be associated with certain embodiments of the audio/sound device that may be desired or expected by user(s) to be heard during particular periods or for prescribed directions. For instance, the at least one audio source 150 may represent the audio portion that can be heard, or is intended or designed to be heard, during normal operations of the audio/sound device 100. For example, the at least one audio source 150 may include audio for a personal audio device such as a personal computer, laptop, IPOD player, MP3 player, etc. Additionally, the at least one audio source may include speakers, mixers, amplifiers, etc. that may be used for concert systems, music systems, home entertainment units, etc. that may be heard by multiple persons. It may be desired that the at least one audio source be heard during at least some normal operation of certain embodiments of the audio/sound device.

It may also be desired that audio, or other sounds or noises corresponding to the at least one audio source 150, can be diminished, stopped, or reduced with certain embodiments of the audio/sound device 100 during certain durations such as when an emergency vehicle passes, when a loud horn or screeching tires occur, or perhaps even in certain embodiments when a particular noise, sound, or voice (or range thereof) occurs such as when a particular person is talking to the user of the audio/sound device 100. The sound characteristics (or range of characteristics) of the audio and/or sound can be stored or maintained in an audio/sound library 160 as described with respect to FIG. 1. As such, certain embodiments of the audio/sound device 100 as provided within certain embodiments of the audio sound recognizer 162 as described with respect to FIG. 1 can be used to digitize and/or characterize particular sounds, voices, noises, etc. Such sounds, voices, noises, etc., as recognized by certain embodiments of the audio sound recognizer 162, can be characterized based at least in part on the frequency, volume, direction, consistency, or other such characteristics. Such characterization of the sounds, voices, noises, etc. that are obtained by the audio sound recognizer 162 can thereupon be compared to prescribed limits that such as can be contained in certain embodiments of the audio/sound library 160. For example, for a siren or alert sound, a prescribed range of sounds within a range of frequencies, volumes, etc. as obtained by the audio sound recognizer 162 can be compared to, or classified as, sirens, alerts, emergency sounds, etc. that can be maintained, stored, and/or retrieved in certain embodiments of the audio/sound library 160. As such, a sound emanating from a siren or alarm, etc. that can be obtained by the audio sound recognizer 162 of the audio/sound device 100, that falls within the classification of sirens within the audio/sound library 160, can be characterized or recognized as a siren, alarm, alert, etc. by certain embodiments of the audio/sound device 100, and can be recognized and handled appropriately. Certain embodiments of the audio/sound device can also detect and/or indicate a direction of the direction or angle of the siren or other sound with respect to the user, using certain embodiments of directional sound clues, as described in this disclosure with respect to FIG. 2, for example.

If an actual siren is recognized by the audio sound recognizer as corresponding to these siren frequency, volume, and/or other characteristics of an emergency siren, etc., then the sound will be recognized and identified as the siren of the audio/sound library 160; whereupon the audio/sound device might be actuated such as to amplify, maintain, or otherwise emphasize the siren sound as well as provide a directional sound clue as described with respect to FIG. 2 (which may correspond to the at least one first sound source 152) with respect to the at least one second sound source 154 and/or the at least one audio source 150, as described in this disclosure.

Similarly, a voice, or other identifiable noise or sound, could be obtained, digitized, processed, and/or otherwise utilized by certain embodiments of the audio sound recognizer 162, which can thereupon be compared to the respective voice, or other noise or sound range information as may be stored or otherwise maintained in the audio/sound library 160. If the voice corresponds, to the voice range information is included or maintained in the audio sound library 160, then the voice can be amplified, maintained, and/or otherwise emphasized as the first sound source 152 as described in this disclosure. As such, prescribed voices, etc. (that may be characteristically associated with a particular person) that falls within the classification of frequency or other characteristics for a particular person within the audio/sound library should be recognized as the voice of that particular person by certain embodiments of the audio/sound device 100, and handled appropriately by the audio/sound device 100.

Such additional sounds, voices, or noises may be characterized in certain aspects of this disclosure as the at least one first sound source 152, which can, depending on context, represent that noise, voice, or sound that is not produced by the audio/sound device 100 during normal operation, but which the user of the audio/sound device may still have a desire to listen or hear. In certain embodiments of the audio/sound device 100, it may be desired to enhance such as by amplification the at least one first sound source 152 relative to the audio source 150 and/or the at least one second sound source 152. Certain embodiments of the relative emphasis between various sources 150, 152, and/or 154 can take a variety of forms including but not limited to, amplification of the first sound source 150; manufacturing the first sound source 152 as the second sound source 154 and/or the audio source is diminished or cut, etc.

The at least one second sound source 154 can, depending on context, include those noises, sounds, voices, ambient sounds, vehicle noise, white noise, etc. that are not provided by the audio/sound device to which the user of the system may not particularly wish to listen, or may decide to limit the presentation thereof. Alternatively the second sound source may obscure and/or distract the first sound source 152 and/or the audio source 150 during normal operation of the audio/sound device 100. Certain aspects of the audio/sound device 100 may thereby be configured to relatively reduce the effects of the at least one second sound source 154, while relatively enhancing the effects of the first sound source 152.

In certain instances the at least one second sound source 154 may thereby include, but not be limited to, ambient noises, extraneous voices, vehicle noises, stray voices, etc. that may otherwise interfere with the ability of the user of the audio/sound device to listen to or hear the at least one audio source 150 and/or the at least one first sound source 152. As such, it may be desired to relatively diminish the volume or other effects of the second sound source 154 relative to the first sound source 152 and/or the audio source 150. Certain embodiments of commercially-available noise cancellation systems, such as are utilized and are commercially available in aircraft, manufacturing applications, as well as other applications where there may be considerable noise, and the noise being cancelled in such commercially available devices may represent a combination of the at least one second sound source 154 and the at least one first sound source; which together may be cancelled in combination by such commercially-available noise cancellation systems.

Another technique that can be used to emphasize certain embodiments of the at least one first sound source 152 with respect to the at least one second sound source 154 and/or the at least one audio source 150 can include delaying and re-presentation of the at least one second sound source 152. For example, a voice can be spoken, a siren or aural alert can recorded and identified, or recognized as, the at least one first sound source 152, the at least one first sound source can be digitized, recorded, and/or delayed; and thereupon the at least one delayed version of the at least one first sound source 152 can be reproduced, represented, or replayed, etc. such as may be selected as being appropriate for certain embodiments of the audio/sound device 100. Such re-presentation of the first sound source 152 can be provided at a time when the at least one second sound source 154 and/or the at least one audio source 150 is diminished, or cut. As such, by representing the first sound source 152 at a substantially even or amplified level as compared to the original level as the at least one second sound source 154 and/or the at least one audio source 150 is diminished will allow the at least one first sound source 150 to be better heard.

In certain embodiments of the audio/sound device 100, the at least one audio source 150 and/or the at least one second sound source 154 can be reduced, muted, and/or cut during the representation of the at least one first sound source 152, thereby further emphasizing the at least one first sound source 152. Certain representations of the at least one first sound source 152 can occur multiple times to further emphasize the first sound source.

Certain embodiments of the audio/sound device 100 may utilize noise cancelling systems (which may include noise cancelling headphones) to reduce ambient noise and thereby allow improved hearing of the at least one audio source 150 and/or the at least one first sound source 152. Certain commercially-available active noise cancellation systems, such as noise-cancelling headphones, can reduce unwanted ambient sounds (i.e., acoustic noise) by means of active noise control. By comparison, certain passive noise cancellation headphones and/or systems can rely at least partially on sound insulative material, acoustic insulative material, and/or shape of the headphone and/or system to limit sound being applied to the user. Certain ones of the active noise cancellation headphones and/or systems can be combined with passive noise cancellation headphones and/or systems.

Essentially, certain active noise cancellation headphones and/or systems (either commercially available or embodiments of the audio/sound device 100) can utilize a microphone positioned nearby the ear of the user to detect noise or sound that can be obtained by the user. Certain active-noise cancellation headphones and/or systems can utilize circuitry (including hardware, firmware, and/or software based on design choice or expediency) to generate an “anti-noise” sinusoidal sound wave having the opposite sinusoidal polarity as the sinusoidal sound wave that can be combined with the detected noise to be applied to the user(s)' ears. The detected noise and/or sound can thereby destructively interfere with the “anti-noise” sinusoidal sound wave, thereby largely cancelling out the noise within the enclosed volume of the headphone. Reducing noise prescribed at the user(s)' ear using certain active noise cancellation headphones and/or systems (either commercially available or embodiments of the audio/sound device 100), makes it possible to hear, detect, and enjoy the audio, sound, voice(s), etc. without raising the volume of the audio/sound device 100 unnecessarily. It can also help limit the volume of the sound, audio, voice, and/or noise being applied to the user in a noisy environment such as a vehicle such as an aircraft, a factory, proximate a noisy machine, etc.

Certain active noise cancellation headphones and/or systems only cancel the lower-frequency portions of the noise; that can depend upon passive noise cancellation techniques (such as ear-cups of headsets) to prevent higher-frequency noise from reaching the interior of the headphone.

This approach benefits the user since the technological demands and/or design of the electronic circuitry are simplified; because of the shorter wavelength of the high-frequency sound, active cancellation is much less effective at higher frequencies. To effectively cancel high frequency components (directed towards at the ear from a number of directions), the sensor and emitter for the cancelling waveform should be as close as practicable to the user's ear(s).

Certain active noise cancellation headphones and/or systems (either commercially available or embodiments of the audio/sound device 100) have several characteristics including but not limited to: a) they consume power, which can be provided by a battery or other power source, b) they may be optimized for sounds that are continuous, such as the noise or hum of an engine, vehicle, or piece of equipment, but may be rather ineffective against rapidly changing audio signals such as speech, alarms, etc.; d) they may introduce additional noise, perhaps in the form of high-frequency hiss; and/or they may pick up and convert stray electromagnetic fields, such as a mobile phone signal, into unwanted noise.

Certain embodiments of the audio/sound device, as described in this disclosure, can considerably reduce the at least one second sound source 154 while maintaining, enhancing, or even amplifying the at least one first sound source 152. Therefore, the sounds of certain embodiments of the at least one second sound source 154 that may be heard by the user of the audio/sound device may be desired to be diminished as much as practicable.

Certain embodiments of the audio/sound device 100 can be configured to allow the user, operator, owner, or other person or automated mechanism to select or determine the frequencies, types, characteristics, and/or other aspects of the at least one first sound source 152 and/or the at least one second sound source 154, and thereby determine which of the sound sources should be relatively diminished, relatively accented, relatively amplified, relatively filtered, and/or have some other suitable relative operation performed thereupon. While the at least one first sound source 152 and the at least one second sound source 154 may appear in FIG. 1 as being presented from outside of the audio/sound device, in certain instances, the sound from either of the sound source(s) 152 or 154 can alternatively originate at least partially outside of the audio/sound device, at least partially internally to the audio/sound device, entirely within the audio/sound device, and/or a combination thereof. Certain embodiments of at least portions of an audio/sound controller 97 can additionally utilize hardware, software, and firmware, as well as mechanical, electromechanical, or other structure(s) to provide an effective interface with the user, owner, or other person, as well as providing some suitable automated or self-control mechanism.

Within this disclosure, certain embodiments of the sound source(s) (which within this disclosure can include, but is not limited to, the at least one first sound source 152 and/or the at least one second sound source 154) can take a variety of forms such as to be capable of performing a variety of functions. For instance, certain embodiments of the sound source(s) can include, but are not limited to, recording, storing, digitizing, accessing, playing, and/or otherwise processing one or more natural or recorded or synthesized voices, noises, and/or sounds made by persons; one or more natural or recorded or synthesized sounds or noises made by objects (e.g., sirens, hazard sounds, machine sounds, buzzers, recorded or synthesized voices, etc.), as well as one or more natural or recorded or synthesized sounds or noises made by animals or things. These embodiments of the sound sources may be digitized, recorded or synthesized, analyzed, or otherwise processed using certain embodiments of such audio conversion, voice conversion, sound conversion, or other similar conversion devices involving but not limited to microphones, recording, computing, signal analyzing processing and/or other similar equipment as generally understood by those skilled in audio technologies in a manner as described with respect to the audio/sound controller 97, as described in this disclosure.

In certain embodiments of the audio/sound device 100 as described in this disclosure, certain embodiments of the at least one first sound source 152 can represent, depending on context, certain sounds, voices, noises, etc. to which the user of the audio/sound device desires to hear or listen. For example, it may be desired for the user of certain embodiments of the audio/sound device 100 to hear or understand the at least one first sound source 152 perhaps even over the at least one audio source 150 and/or the at least one second sound source 154, thereby allowing for the relative emphasis of the at least one first sound source 152 relative to the at least one second sound source 154 and/or the at least one audio source 150.

It should be understood that certain embodiments of the at least one first sound source 152 and the at least one second sound source 154 can each take a variety of forms, but as described relative to this disclosure, both the at least one first sound source 152 and the at least one second sound source 154 can be considered inclusively, depending upon context, as sound sources. Certain embodiments of the sound source(s) can utilize such information, signal, or data transfer mechanisms as may include, but are not limited to, sound data streams, sound signals, or other acoustic computer-based information that can be readily played on an audio system, stored, recalled, transmitted, received, filtered, analyzed, or otherwise processed. The recalling of at least some of the sound source(s) in certain embodiments of the audio/sound device 100 can be at least partially controlled by the user(s), and can occur as they occur or are received, or alternately can be automated.

With certain embodiments of an audio/sound device 100, the at least one first sound source 152 can be in some manner combined with the at least one second sound source 154. Such combination of at least some of the sound sources 152 and 154 can take a variety of forms, such as output from the at least one first sound source 152 being mixed, and/or otherwise combined, with output from the at least one second sound source 154. In addition, the at least one first sound source 152 and/or the at least one second sound source 154 can include but are not limited to external noises or sound, ambient noises are sound, etc. that may be allowed to be combined.

In this disclosure, certain embodiments of the at least one audio source 150 can include that portion of the audio/sound device 100 which provides during normal operations the intended audio or sound to the audio/sound device 100. There can be a variety of the at least one audio sources 150, and a variety of applications therefore, as are described in this disclosure. For example, certain embodiments of the audio/sound device 100 can include, but are not limited to, a purely audio device which may be personal, such as an IPOD, MP3 player, a personal computer audio system, (PC), or laptop computer audio system, or certain home audio systems. Certain embodiments of the audio/sound device 100 can be configured to include the speakers, headphones, amplifiers, etc. that can thereby be utilized to provide the audio and/or sound to the one or more people listening to the audio/sound device.

Certain embodiments of the audio/sound device 100 can also provide directional sound clues. Humans rely to a considerable extent on hearing to not only determine a direction from which voices, noises, sounds, etc. are originating from; in addition to the actual contents of the voices, noises, sounds, etc. Within this disclosure, the directional sound clues can indicate, depending on context, which direction from which at least some noise, sound, voices, etc. are originating. Often, the at least one second sound source 154 as well as the at least one audio source 150 can act to hide or confuse the direction of the at least one second sound source relative to the individual. The directional sound clues may be appropriate to determine the orientation of the second sound source 152 relative to the individual. It is understood by those skilled in the audio art that certain conventional sound systems, surround sound systems, personal audio devices, stereo audio devices, headphone devices, etc. can project sound that can appear to one or more users to originate from a variety of locations or angles relative to one or more users. Using similar technology, in a manner understood by those skilled in audio technology, certain embodiments of the audio/sound device can direct the at least one audio source 150 and/or the at least one first sound source 152 to provide at least some directional clues, as described in this disclosure. In the case of voices, the directional sound clue can indicate a direction of the person speaking. In the case of sounds, the directional sound clues can thereby provide a clue as to the direction of the sound in certain embodiments of the audio/sound device. In the case of an emergency vehicle or hazard, the directional sound clues can provide a clue as to the direction of the emergency vehicle or hazard. The selection of which sounds, noises, voices, etc. that can be characterized as the at least one first sound source 152 as compared with the at least one second sound source 154 may be a design choice, or may be configurable by the user, producer, and/or designer of certain embodiments of the audio/sound device 100. For instance, certain personalized embodiments of the audio/sound device 100 can be configured to allow certain users to input voice samples corresponding to those persons that the user wishes to hear, or have conversation with, into the audio sound library 160 such as can be easily recognized over, for example, crowd voices, ambient noises, and other less significant sounds. It might be expected that parents might input the voices of their children into the audio sound library 160 of the audio/sound device, such that these voices may be emphasized relative to other voices or sounds.

By comparison, certain sirens, alarms, alerts, etc. may be provided by the provider of certain embodiments of the audio/sound device, since certain providers could more fully be able to determine which sounds, generally, fall within emergency sounds, siren sounds, etc. Certain embodiments of such emergency, alert, siren, or other such sounds may be characterized and maintained within certain embodiments of the audio sound library, and compared to the sound of the siren, emergency, alert, etc. that can be obtained by the certain embodiments of the audio sound recognizer 162 as described with respect to FIG. 1.

Another exemplary implementation of the audio/sound device 100, of FIG. 1 is depicted in FIG. 1A as audio/sound device 200 optionally including one or more compute/control components 210, one or more communication components 40, one or more output components 44, and one or more input/sensing components 54. The one or more compute/control components 210 are further shown to optionally include one or more modules 212, one or more storage components 214 for instructions, data, communication, etc, and can have one or more processors 216a, with one or more logic units 216b and one or more memories 216c. Through its components the audio/sound device 100 is able to receive one or more inputs such as from one or more radios, mp3 players, DVD players, CD players, other players, cell phones, i-Pads, PDAs, microphones, etc. The audio/sound device 200 can monitor its input to determine whether one or more new sounds are present, one or more sounds have changed, and/or one or more sounds are missing in the one or more inputs. The audio/sound device 200 can then modify or not modify one or more of the sounds. Such modification can include muting, delaying, pausing, decreasing volume, increasing volume, combining, and/or re-forming the one or more sounds. After processing, the audio/sound device 200 can output results through outputs such as sound, vibration, and/or light. Aspects of the depicted audio/sound device 100 can be combined with aspects of the audio/sound device 200 or aspects of other sound devices discussed herein. The audio/sound device 200 can be used in a variety of settings including in a vehicle, in a home, on a construction site, in a factory, in an office, in a call center, etc. In a factory setting, the audio/sound device 200 can provide such aspects as noise cancelling, which can be shut off entirely, turned fully on, or generally turned on but selectively deactivated to allow for hearing of desired sounds such as a PA system or sounds of malfunctioning equipment. In a call center setting, the audio/sound device 200 can provide such aspects as noise cancelling, which can be shut off entirely, turned fully on, or generally turned on but selectively deactivated to allow for hearing of desired sounds such as an individual phone or sounds of a conversation among call center employees.

The one or more communication components 220 are further shown to optionally include one or more transceiver components 222 having one or more network components 222a, wireless components 222b, cellular components 222c, peer-to-peer components 222d, electromagnetic components 222e, infrared components 222f, acoustic components 222g, and optical components 222h.

The one or more output components 230 are further shown to optionally include one or more audio outputs 230a, text outputs 230b, video outputs 230c, light outputs 230d, vibration outputs 230e, transmitter outputs 230f, wireless outputs 230g, network outputs 230h, electromagnetic outputs 230i, optic outputs 230j, infrared outputs 230k, projector outputs 230l, alarm outputs 230m, display outputs 230n, and/or log outputs 230o.

The input/sensing components 240 are further shown to optionally include one or more light based input/sensing components 242a, one or more optical based input/sensing components 242b, one or more seismic based input/sensing components 242c, one or more global positioning system (GPS) based input/sensing components 242d, one or more pattern recognition based input/sensing components 242e, one or more radio frequency based input/sensing components 242f, one or more electromagnetic (EM) based input/sensing components 242g, one or more infrared (IR) input/sensing components 242h, one or more acoustic based input/sensing components 242i (such as one or more microphones), one or more radio frequency identification (RFID) based input/sensing components 242j, one or more radar based input/sensing components 242k, one or more audio recognition based input/sensing components 242l, one or more image capture based input/sensing components 242m, one or more reference beacon based input/sensing components 242q, one or more reference light based input/sensing components 242r, one or more acoustic reference based input/sensing components 242s, one or more triangulation based input/sensing components 242t, one or more thermal based input/sensing components 242y, one or more strain input/sensing component—244a, one or more stress input/sensing components 244b, one or more surface input/sensing components 244d, one or more force input/sensing components 244e, one or more gyroscopic input/sensing components 244f, one or more inclinometer input/sensing components 244i, one or more accelerometer input/sensing components 244j, one or more inertial input/sensing components 244k, one or more contact input/sensing components 244l, one or more pressure input/sensing components 244m, one or more display input/sensing components 244n, one or more temperature input/sensing components 244u, one or more time input/sensing components 244v, one or more calendar input/sensing components 244w, one or more user identification input/sensing components 244x, and one or more touch input/sensing components 244y.

The one or more modules 212 are shown to optionally include processing module M10, receiving module M11, receiving module M1101, receiving module M1102, receiving module M1103, receiving module M1104, receiving module M1105, receiving module M1106, receiving module M1107, receiving module M1108, receiving module M1109, receiving module M1110, receiving module M1111, receiving module M1112, receiving module M1113, receiving module M1114, receiving module M1115, receiving module M1116, receiving module M1117, receiving module M1118, receiving module M1119, receiving module M1120, receiving module M1121, receiving module M1122, receiving module M1123, receiving module M1124, and receiving module M1125. The one or more modules 212 are shown to optionally include recording module M12, recording module M1201, recording module M1202, recording module M1203, recording module M1204, recording module M1205, recording module M1206, recording module M1207, recording module M1208, recording module M1209, and recording module M1210.

The one or more modules 212 are shown to optionally include receiving module M13, receiving module M1301, receiving module M1302, receiving module M1303, receiving module M1304, receiving module M1305, receiving module M1306, receiving module M1307, receiving module M1308, receiving module M1309, receiving module M1310, receiving module M1311, receiving module M1312, receiving module M1313, receiving module M1314, receiving module M1315, receiving module M1316, receiving module M1317, receiving module M1318, receiving module M1319, receiving module M1320, receiving module M1321, receiving module M1322, receiving module M1323, receiving module M1324, receiving module M1325, and receiving module M1326.

The one or more modules 212 are shown to optionally include recording module M14, recording module M1401, recording module M1402, recording module M1403, recording module M1404, recording module M1405, recording module M1406, recording module M1407, recording module M1408, recording module M1409, recording module M1410, receiving module M2107A, receiving module M3107A, receiving module M4107A, receiving module M5307A, receiving module M6107A, receiving module 10107A, receiving module M11207A, and modifying module M10514A.

The one or more modules 212 are shown in FIG. 1B and subsequent figures to optionally include outputting module M15, outputting module M1501, outputting module M1502, outputting module M1503, outputting module M1504, outputting module M1505, outputting module M1506, outputting module M1507, outputting module M1508, and outputting module M1509, outputting module M1510.

The one or more modules 212 are shown to optionally include outputting module M16, outputting module M1601, outputting module M1602, outputting module M1603, outputting module M1604, outputting module M1605, outputting module M1606, outputting module M1607, outputting module M1608, outputting module M1608, and outputting module M1609.

The one or more modules 212 are shown to optionally include receiving module M21, receiving module M2101, receiving module M2102, receiving module M2103, receiving module M2104, receiving module M2105, receiving module M2106, receiving module M2107, receiving module M2108, receiving module M2109, receiving module M2110, receiving module M2111, receiving module M2112, receiving module M2113, receiving module M2114, receiving module M2115, receiving module M2116, receiving module M2117, receiving module M2118, receiving module M2119, receiving module M2120, receiving module M2121, receiving module M2122, receiving module M2123, receiving module M2124, receiving module M2125, and receiving module M2126.

The one or more modules 212 are shown to optionally include generating module M22, generating module M2201, generating module M2202, generating module M2203, generating module M2204, generating module M2205, generating module M2206, generating module M2207, generating module M2208, generating module M2209, generating module M2210, generating module M2211, generating module M2212, and generating module M2213.

The one or more modules 212 are shown to optionally include receiving module M23, receiving module M2301, receiving module M2302, receiving module M2303, receiving module M2304, receiving module M2305, receiving module M2306, receiving module M2307, receiving module M2308, receiving module M2309, receiving module M2310, receiving module M2311, receiving module M2312, receiving module M2313, receiving module M2314, receiving module M2315, receiving module M2316, receiving module M2317, receiving module M2318, receiving module M2319, receiving module M2320, receiving module M2321, receiving module M2322, receiving module M2323, module M2324, and receiving module M2325.

The one or more modules 212 are shown to optionally include generating module M24, generating module M2401, generating module M2402, generating module M2403, generating module M2404, generating module M2405, generating module M2406, generating module M2407, generating module M2408, generating module M2409, generating module M2410, generating module M2411, generating module M2412, and generating module M2413.

The one or more modules 212 are shown to optionally include receiving module M31, receiving module M3101, receiving module M3102, receiving module M3103, receiving module M3104, receiving module M3105, receiving module M3106, receiving module M3107, receiving module M3108, receiving module M3109, receiving module M3110, receiving module M3111, receiving module M3112, receiving module M3113, receiving module M3114, receiving module M3115, receiving module M3116, receiving module M3117, receiving module M3118, receiving module M3119, receiving module M3120, receiving module M3121, receiving module M3122, receiving module M3123, receiving module M3124, receiving module M3125, and receiving module M3126.

The one or more modules 212 are shown to optionally include generating module M32, generating module M3201, generating module M3202, generating module M3203, generating module M3204, generating module M3205, generating module M3206, generating module M3207, generating module M3208, generating module M3209, generating module M3210, generating module M3211, generating module M3212, and generating module M3213.

The one or more modules 212 are shown to optionally include receiving module M33, receiving module M3301, receiving module M3302, receiving module M3303, receiving module M3304, receiving module M3305, receiving module M3306, receiving module M3307, receiving module M3308, receiving module M3309, receiving module M3310, receiving module M3311, receiving module M3312, receiving module M3313, receiving module M3314, receiving module M3315, receiving module M3316, receiving module M3317, receiving module M3318, receiving module M3319, receiving module M3320, receiving module M3321, receiving module M3322, receiving module M3323, receiving module M3324, receiving module M3325, and receiving module M3326.

The one or more modules 212 are shown to optionally include outputting module M34, outputting module M3401, outputting module M3402, outputting module M3403, outputting module M3404, outputting module M3405, outputting module M3406, outputting module M3407, outputting module M3408, outputting module M3409, outputting module M3410, outputting module M3411, outputting module M3412, outputting module M3413, outputting module M3414, outputting module M3415, outputting module M3416, outputting module M3417, outputting module M3418, outputting module M3419, outputting module M3420, outputting module M3421, outputting module M3422, outputting module M3423, outputting module M3424, outputting module M3425, outputting module M3426, outputting module M3427, outputting module M3428, outputting module M3429, outputting module M3430, and outputting module M3431.

The one or more modules 212 are shown to optionally include receiving module M41, receiving module M4101, receiving module M4102, receiving module M4103, receiving module M4104, receiving module M4105, receiving module M4106, receiving module M4107, receiving module M4108, receiving module M4109, receiving module M4110, receiving module M4111, receiving module M4112, receiving module M4113, receiving module M4114, receiving module M4115, receiving module M4116, receiving module M4117, receiving module M4118, receiving module M4119, receiving module M4120, receiving module M4121, receiving module M4122, receiving module M4123, receiving module M4124, receiving module M4125, and receiving module M4126.

The one or more modules 212 are shown to optionally include generating module M42, generating module M4201, generating module M4202, generating module M4203, generating module M4204, generating module M4205, generating module M4206, generating module M4207, generating module M4208, generating module M4209, generating module M4210, generating module M4211, generating module M4212, and generating module M4213.

The one or more modules 212 are shown to optionally include receiving module M43, receiving module M4301, receiving module M4302, receiving module M4303, receiving module M4304, receiving module M4305, receiving module M4306, receiving module M4307, receiving module M4308, receiving module M4309, receiving module M4310, receiving module M4311, receiving module M4312, receiving module M4313, receiving module M4314, receiving module M4315, receiving module M4316, receiving module M4317, receiving module M4318, receiving module M4319, receiving module M4320, receiving module M4321, receiving module M4322, receiving module M4323, receiving module M4324, and receiving module M4325, and receiving module M4326.

The one or more modules 212 are shown to optionally include receiving module M44, basing module M4401, expressing module M4402, expressing module M4403, expressing module M4404, expressing module M4405, expressing module M4406, expressing module M4407, expressing module M4408, expressing module M4409, expressing module M4410, expressing module M4411, basing module M4412, basing M4413, basing module M4414, and receiving basing module M4415.

The one or more modules 212 are shown to optionally include outputting module M45, outputting module M4501, outputting module M4502, outputting module M4503, outputting module M4504, outputting module M4505, outputting module M4506, outputting module M4507, outputting module M4508, outputting module M4509, outputting module M4510, outputting module M4511, outputting module M4512, outputting module M4513, outputting module M4514, outputting module M4515, outputting module M4516, outputting module M4517, outputting module M4518, outputting module M4519, outputting module M4520, outputting module M4521, outputting module M4522, outputting module M4523, outputting module M4524, outputting module M4525, outputting module M4526, outputting module M4527, outputting module M4528, outputting module M4529, outputting module M4530, and outputting module M4531.

The one or more modules 212 are shown to optionally include receiving module M51, receiving module M5101, receiving module M5102, receiving module M5103, receiving module M5104, receiving module M5105, receiving module M5106, receiving module M5107, receiving module M5108, receiving module M5109, receiving module M5110, receiving module M5111, receiving module M5112, receiving module M5113, receiving module M5114, receiving module M5115, receiving module M5116, receiving module M5117, receiving module M5118, receiving module M5119, receiving module M5120, receiving module M5121, receiving module M5122, receiving module M5123, receiving module M5124, receiving module M5125, and receiving module M5126.

The one or more modules 212 are shown to optionally include selecting module M52, selecting module M5201, selecting module M5202, selecting module M5203, selecting module M5204, selecting module M5205, selecting module M5206, selecting module M5207, selecting module M5208, selecting module M5209, selecting module M5210, and selecting module M5211.

The one or more modules 212 are shown to optionally include receiving module M53, receiving module M5301, receiving module M5302, receiving module M5303, receiving module M5304, receiving module M5305, receiving module M5306, receiving module M5307, receiving module M5308, receiving module M5309, receiving module M5310, receiving module M5311, receiving module M5312, receiving module M5313, receiving module M5314, receiving module M5315, receiving module M5316, receiving module M5317, receiving module M5318, receiving module M5319, receiving module M5320, receiving module M5321, receiving module M5322, receiving module M5323, receiving module M5324, receiving module M5325, and receiving module M5326.

The one or more modules 212 are shown to optionally include generating module M54, generating module M5401, generating module M5402, generating module M5403, generating module M5404, generating module M5405, generating module M5406, generating module M5407, generating module M5408, generating module M5409, generating module M5410, generating module M5411, generating module M5412, and generating module M5413.

The one or more modules 212 are shown to optionally include receiving module M55, receiving module M5501, receiving module M5502, receiving module M5503, receiving module M5504, receiving module M5505, receiving module M5506, receiving module M5507, receiving module M5508, receiving module M5509, receiving module M5510, receiving module M5511, receiving module M5512, receiving module M5513, receiving module M5514, receiving module M5515, receiving module M5516, receiving module M5517, receiving module M5518, receiving module M5519, receiving module M5520, receiving module M5521, receiving module M5522, receiving module M5523, receiving module M5524, receiving module M5525, and receiving module M5526.

The one or more modules 212 are shown to optionally include receiving module M61, receiving module M6101, receiving module M6102, receiving module M6103, receiving module M6104, receiving module M6105, receiving module M6106, receiving module M6107, receiving module M6108, receiving module M6109, receiving module M6110, receiving module M6111, receiving module M6112, receiving module M6113, receiving module M6114, receiving module M6115, receiving module M6116, receiving module M6117, receiving module M6118, receiving module M6119, receiving module M6120, receiving module M6121, receiving module M6122, receiving module M6123, receiving module M6124, receiving module M6125, and receiving module M6126.

The one or more modules 212 are shown to optionally include generating module M62, generating module M6201, generating module M6202, generating module M6203, generating module M6204, generating module M6205, generating module M6206, generating module M6207, generating module M6208, generating module M6209, generating module M6210, generating module M6211, generating module M6212, and generating module M6213.

The one or more modules 212 are shown to optionally include receiving module M63, receiving module M6301, receiving module M6302, receiving module M6303, receiving module M6304, receiving module M6305, receiving module M6306, receiving module M6307, receiving module M6308, receiving module M6309, receiving module M6310, receiving module M6311, receiving module M6312, receiving module M6313, receiving module M6314, receiving module M6315, receiving module M6316, receiving module M6317, receiving module M6318, receiving module M6319, receiving module M6320, receiving module M6321, receiving module M6322, receiving module M6323, receiving module M6324, and receiving module M6325.

The one or more modules 212 are shown to optionally include outputting module M64, outputting module M6401, outputting module M6402, outputting module M6403, outputting module M6404, outputting module M6405, outputting module M6406, outputting module M6407, outputting module M6408, outputting module M6409, outputting module M6410, outputting module M6411, outputting module M6412, outputting module M6413, outputting module M6414, outputting module M6415, outputting module M6416, outputting module M6417, outputting module M6418, outputting module M6419, outputting module M6420, outputting module M6421, outputting module M6422, outputting module M6423, outputting module M6424, outputting module M6425, outputting module M6426, outputting module M6427, outputting module M6428, outputting module M6429, and outputting module M6430.

The one or more modules 212 are shown to optionally include receiving module M71, receiving module M7101, receiving module M7102, receiving module M7103, receiving module M7104, receiving module M7105, receiving module M7106, receiving module M7107, receiving module M7108, receiving module M7109, receiving module M7110, receiving module M7111, receiving module M7112, receiving module M7113, receiving module M7114, receiving module M7115, receiving module M7116, receiving module M7117, receiving module M7118, receiving module M7119, receiving module M7120, receiving module M7121, receiving module M7122, receiving module M7123, receiving module M7124, receiving module M7125, receiving module M7126, receiving module M7127, receiving module M7128, receiving module M7129, receiving module M7130, receiving module M7131, receiving module M7132, receiving module M7133, receiving module M7134, receiving module M7135, receiving module M7136, receiving module M7137, receiving module M7138, receiving module M7139, receiving module M7140, receiving module M7141, and module M7142.

The one or more modules 212 are shown to optionally include generating module M72, generating module M7201, generating module M7202, generating module M7203, generating module M7204, generating module M7205, generating module M7206, generating module M7207, generating module M7208, generating module M7209, generating module M7210, generating module M7211, generating module M7212, and generating module M7213.

The one or more modules 212 are shown to optionally include receiving module. M73, receiving module M7301, receiving module M7302, receiving module M7303, receiving module M7304, receiving module M7305, receiving module M7306, receiving module M7307, receiving module M7308, receiving module M7309, receiving module M7310, receiving module M7311, receiving module M7312, receiving module M7313, receiving module M7314, receiving module M7315, receiving module M7316, receiving module M7317, receiving module M7318, receiving module M7319, receiving module M7320, receiving module M7321, receiving module M7322, receiving module M7323, receiving module M7324, receiving module M7325, receiving module M7326, receiving module M7327, receiving module M7328, receiving module M7329, receiving module M7330, receiving module M7331. receiving module M7332, receiving module M7333, receiving module M7334, receiving module M7335, receiving module M7336, receiving module M7337, receiving module M7338, receiving module M7339, receiving module M7340, receiving module M7341, and receiving module M7342.

The one or more modules 212 are shown to optionally include generating module M74, generating module M7401, generating module M7402, generating module M7403, generating module M7404, generating module M7405, generating module M7406, generating module M7407, generating module M7408, generating module M7409, generating module M7410, generating module M7411, generating module M7412, and generating module M7413.

The one or more modules 212 are shown to optionally include receiving module M81, receiving module M8101, receiving module M8102, receiving module M8103, receiving module M8104, receiving module M8105, receiving module M8106, receiving module M8107, receiving module M8108, receiving module M8109, receiving module M8110, and receiving module M8111.

The one or more modules 212 are shown to optionally include receiving module M82, receiving module M8201, receiving module M8202, receiving module M8203, receiving module M8204, receiving module M8205, receiving module M8206, receiving module M8207, receiving module M8208, receiving module M8209, receiving module M8210, receiving module M8211, receiving module M8212, receiving module M8213, receiving module M8214, receiving module M8215, receiving module M8216, receiving module M8217, receiving module M8218, receiving module M8219, receiving module M8220, receiving module M8221, receiving module M8222, receiving module M8223, receiving module M8224, receiving module M8225, receiving module M8226, receiving module M8227, and receiving module M8228.

The one or more modules 212 are shown to optionally include generating module M83, generating module M8301, generating module M8302, generating module M8303, generating module M8304, generating module M8305, generating module M8306, generating module M8307, generating module M8308, generating module M8309, generating module M8310, generating module M8311, generating module M8312, generating module M8313, generating module M8314, and generating module M8315.

The one or more modules 212 are shown to optionally include module M84, receiving module M8401, receiving module M8402, receiving module M8403, receiving module M8404, receiving module M8405, receiving module M8406, receiving module M8407, receiving module M8408, receiving module M8409, receiving module M8410, receiving module M8411, receiving module M8412, receiving module M8413, receiving module M8414, receiving module M8415, receiving module M8416, receiving module M8417, receiving module M8418, receiving module M8419, receiving module M8420, receiving module M8421, receiving module M8422, receiving module M8423, receiving module M8424, receiving module M8425, and receiving module M8426.

The one or more modules 212 are shown to optionally include receiving module M91, receiving module M9101, receiving module M9102, receiving module M9103, receiving module M9104, receiving module M9105, receiving module M9106, receiving module M9107, receiving module M9108, receiving module M9109, receiving module M9110, receiving module M9111, receiving module M9112, receiving module M9113, receiving module M9114, receiving module M9115, receiving module M9116, receiving module M9117, receiving module M9118, receiving module M9119, receiving module M9120, receiving module M9121, receiving module M9122, receiving module M9123, receiving module M9124, receiving module M9125, and receiving module M9126.

The one or more modules 212 are shown to optionally include storing module M92, storing module M9201, storing module M9202, storing module M9203, storing module M9204, storing module M9205, storing module M9206, and storing module M9207.

The one or more modules 212 are shown to optionally include generating module M93, generating module M9301, generating module M9302, generating module M9303, generating module M9304, generating module M9305, generating module M9306, generating module M9307, generating module M9308, generating module M9309, generating module M9310, generating module M9311, generating module M9312, and generating module M9313.

The one or more modules 212 are shown to optionally include receiving module M101, receiving module M10101, receiving module M10102, receiving module M10103, receiving module M10104, receiving module M10105, receiving module M10106, receiving module M10107, receiving module M10108, receiving module M10109, receiving module M10110, receiving module M10111, receiving module M10112, receiving module M10113, receiving module M10114, receiving module M10115, receiving module M10116, receiving module M10117, receiving module M10118, receiving module M10119, receiving module M10120, receiving module M10121, receiving module M10122, receiving module M10123, receiving module M10124, receiving module M10125, and receiving module M10126.

The one or more modules 212 are shown to optionally include generating module M102, generating module M10201, generating module M10202, generating module M10203, generating module M10204, generating module M10205, generating module M10206, generating module M10207, generating module M10208, generating module M10209, generating module M10210, generating module M10211, generating module M10212, and generating module M10213.

The one or more modules 212 are shown to optionally include receiving module M103, receiving module M10301, receiving module M10302, receiving module M10303, receiving module M10304, receiving module M10305, receiving module M10306, receiving module M10307, receiving module M10308, receiving module M10309, receiving module M10310, receiving module M10311, receiving module M10312, receiving module M10313, receiving module M10314, receiving module M10315, receiving module M10316, receiving module M10317, receiving module M10318, receiving module M10319, receiving module M10320, receiving module M10321, receiving module M10322, receiving module M10323, receiving module M10324, receiving module M10325, and receiving module M10326.

The one or more modules 212 are shown to optionally include receiving module M104, receiving module M10401, receiving module M10402, receiving module M10403, receiving module M10404, receiving module M10405, receiving module M10406, receiving module M10407, receiving module M10408, receiving module M10409, receiving module M10410, and modifying module M10411.

The one or more modules 212 are shown to optionally include modifying module M105, modifying module M10501, modifying module M10502, modifying module M10503, modifying module M10504, modifying module M10505, transmitting module M10506, transmitting module M10507, transmitting module M10508, transmitting module M10509, transmitting module M10510, transmitting module M10511, modifying module M10512, modifying module M10513, and modifying module M10514. The one or more modules 212 are shown to optionally include selecting module M111, selecting module M11101, selecting module M11102, selecting module M11103, selecting module M11104, selecting module M11105, selecting module M11106, selecting module M11107, selecting module M11108, selecting module M11109, selecting module M11110, selecting module M11111, selecting module M11112, selecting module M11113, selecting module M11114, selecting module M11115, selecting module M11116, selecting module M11117, selecting module M11118, selecting module M11119, selecting module M11120, selecting module M11121, selecting module M11122, selecting module M11123, selecting module M11124, selecting module M11125, selecting module M11126, selecting module M11127, selecting module M11128, selecting module M11129, selecting module M11130, selecting module M11131, and selecting module M11132.

The one or more modules 212 are shown to optionally include receiving module M112, receiving module M11201, receiving module M11202, receiving module M11203, receiving module M11204, receiving module M11205, receiving module M11206, receiving module M11207, receiving module M11208, receiving module M11209, receiving module M11210, receiving module M11211, receiving module M11212, receiving module M11213, receiving module M11214, receiving module M11215, receiving module M11216, receiving module M11217, receiving module M11218, receiving module M11219, receiving module M11220, receiving module M11221, receiving module M11222, receiving module M11223, receiving module M11224, receiving module M11225, and receiving module M11226.

The one or more modules 212 are shown to optionally include receiving module M113, receiving module M11301, receiving module M11302, receiving module M11303, receiving module M11304, receiving module M11305, receiving module M11306, receiving module M11307, receiving module M11308, receiving module M11309, receiving module M11310, receiving module M11311, receiving module M11312, receiving module M11313, receiving module M11314, receiving module M11315, receiving module M11316, receiving module M11317, receiving module M11318, receiving module M11319, receiving module M11320, receiving module M11321, receiving module M11322, receiving module M11323, receiving module M11324, receiving module M11325, and receiving module M11326.

The one or more modules 212 are shown to optionally include generating module M114, generating module M11401, generating module M11402, generating module M11403, generating module M11404, generating module M11405, generating module M11406, generating module M11407, generating module M11408, generating module M11409, generating module M11410, generating module M11411, generating module M11412, and generating module M11413.

The one or more modules 212 are shown to optionally include generating module M115, generating module M11501, generating module M11502, generating module M11503, generating module M11504, generating module M11505, generating module M11506, generating module M11507, generating module M11508, generating module M11509, generating module M11510, generating module M11511, generating module M11512, and generating module M11513.

The one or more modules 212 are shown to optionally include altering module M116, altering module M11601, altering module M11602, altering module M11603, altering module M11604, altering module M11605, altering module M11606, altering module M11607, altering module M11608, altering module M11609, altering module M11610, altering module M11611, altering module M11612, and altering module M11613.

Certain embodiments of a directional sound clue mechanism 820 as described with respect to FIG. 2, can provide directional clues as to the position, or angle, of the at least first sounds source with respect to the user. Users of conventional sound or audio devices such as IPODS, car radios, CD players, surround sound systems, etc. can have a variety of directional sound clues diminished or obscured, especially if the audio, sound, or noise is particularly loud. As such, can provide an indication to users of the audio/sound device 100, as to a direction from which the at least one first sound source 152 originated.

Certain embodiments of the directional sound clue mechanism 820 can include a multi-directional audio presentation device 822, that can present sound, audio, and/or noise in a direction or angle as described. As such, the at least one first sound source 152 should, appear to originate from a particular direction corresponding to the original sound, voice, etc., even if the first sound source is filtered, amplified, modified, and/or otherwise processed.

There may be a considerable variety of the audio/sound device 100 that can operate or are structured in a manner similar to as described with respect to FIG. 1, a number of which are now described. Certain embodiments of the audio/sound device 100 can be utilized as described with respect to FIGS. 3, 4, 5, 6, and/or 7, as well as at other locations in this disclosure. Certain embodiments of the audio/sound device 100 can be usable to provide audio to one or more person(s), and in certain embodiments groups of persons, at least partially using one or more embodiments of the selective sound/audio provider 102. Within these embodiments of the audio/sound device 100 as described with respect to FIGS. 3, 4, 5, 6, and/or 7, the location of the at least one audio source 150, the at least one first sound source 152, and/or the at least one second sound source 154 may not be illustrated, but are intended to be determinable according to the operation of the audio/sound device 100.

For instance, with an embodiment of the audio/sound device 100 that can be configured as a personal audio device such as an IPOD, MP3 player, transistor radio, etc., as described with respect to FIG. 3, it is envisioned that the at least one audio source(s) 150 can include the audio that can normally be provided by the audio/sound device 100. By comparison, the at least one first sound source 152 can include, but may not be limited to, those sounds, noises, voices, etc. that originate from outside of the audio/sound device 100 that the user of the audio/sound device may wish to hear, such as sirens, alarms, certain voices, etc. As such, a user walking down the street, in the office, in the home, or in other such locations can listen to particular important noises (e.g., sirens, alerts, voices, etc.) or voices, while they do not have to listen to other noises, voices, etc. Additionally, the at least one second sound source can include, but may not be limited to, those noises, sounds, voices, etc. outside of the audio/sound device 100 that the user of the audio/sound device may not wish to hear.

As described with respect to FIG. 3, certain embodiments of the audio/sound device 100 can be configured as a personal audio/sound device 150 that can provide at least one audio source 150 that can typically be used by a single user, but in certain instances may be used by more than one person. Examples of the personal audio/sound device 150 at least one audio source 150 can include, but is not limited to, an devices that may appear as, or may include the at least one audio source 150 that can operate similar to, for example, the audio portions of IPODs, personalized audio players, personalized radios, an MP3 player (which are commercially available), etc., such as to include a headphone, earplug, and/or other audio providing system that can enable at least one user to listen to audio, sounds, music, noises, etc.

Certain embodiments of the audio/sound device 100, may thereby be configured as a personal device, and can thereby as with other embodiments of the audio/sound device 150 limit the transmission of the second sound source 154 and/or the audio source 150 relative to the first sound source 152, as described with respect to FIG. 1 as well as at other locations in this disclosure. With certain embodiments of the personalized audio/sound device 100, the user can configure certain of those sounds of the at least one first sound source 152 that the user wishes to have emphasized relative to the at least one second sound source 154 and/or the at least one audio source 150, such as by recording voices of friends, family, etc. that can be included in the audio sound library 160 as described with respect to FIG. 1. With certain embodiments of the personalized audio/sound device 100, the device provider, producer, or administrator can configure certain of those sounds of the at least one first sound source 152 that should be emphasized relative to the at least one second sound source 154 and/or the at least one audio source 150, such as by determining those particular or range of sounds, noises, voices, etc. that can be characterized as falling within the at least one first sound source, as described in this disclosure. As such, certain individual audio listeners might utilize certain embodiments of the selective sound/audio provider 102.

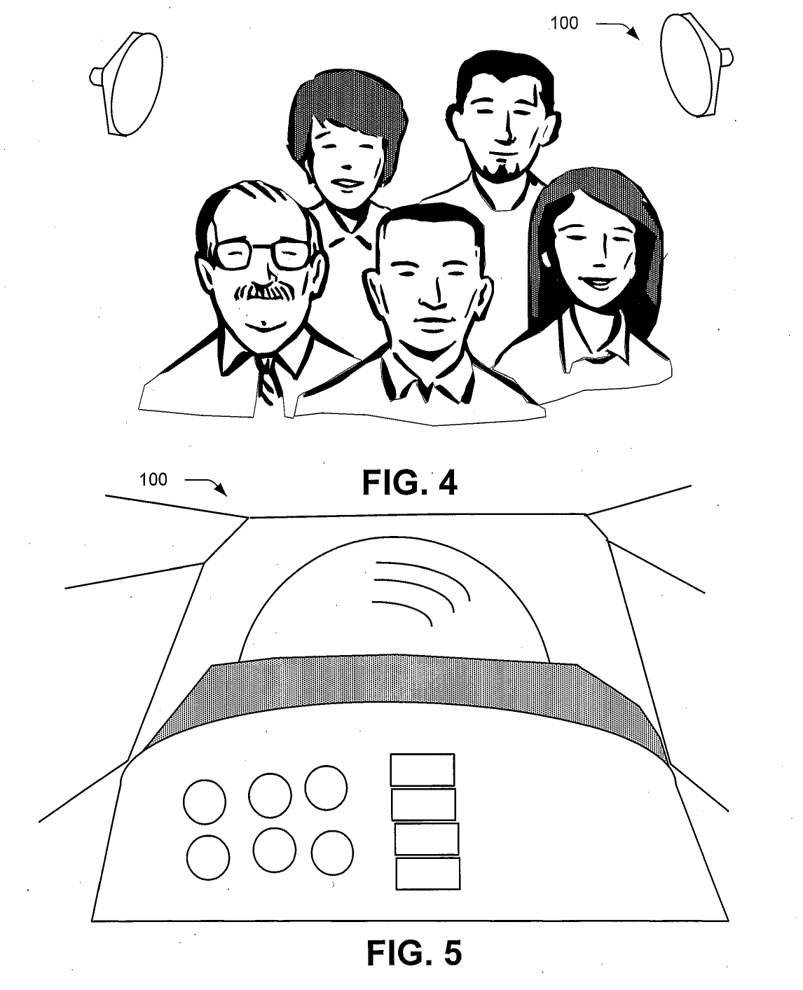

Certain embodiments of the audio/sound device 100 can provide a variety of audio sources and/or sound sources 150, 152, and/or 154 (as described with respect to FIG. 1) to a number of uses such as with a concert, a speech, a speaker phone, a speaker-based audio system, and/or other multiple user audio/sound system as described with respect to FIG. 4. With certain group embodiments of the audio/sound device 100, it is still possible to provide particular individualized settings for the members of the group members. For example, voices of certain children, spouses, friends, etc. who may get lost in crowds, etc., may have their voices recorded and maintained in the audio sound library 160 of certain embodiments of the audio/sound device 100, and if their voice is raised to a particular level, then they may be emphasized above the volume of the other group members.

Additionally, certain performers, speakers, musical instruments, etc., may have their voices, noises, sounds, etc. characterized as a first sound source 152, and such voices, noises, sounds, etc. can thereupon be amplified, maintained, or otherwise emphasized above other voices, noises, sounds, etc. During a live concert, for example, the performers and their instruments may be classified as the first sound source(s), and certain group embodiments of the audio/sound device 100 can relatively filter out, cancel, reduce the other noises of the audience or stage, and thereupon relatively emphasize (either through amplification or not) the at least one first sound source 152 corresponding to the voices or sounds of the performers, speakers, instruments, etc. Additionally, in a live concert or speech, certain group-based embodiments of the audio/sound device can be configured to reduce amplified or normal voices, noises, sounds, etc. corresponding to the audio sound source(s) 150 and/or the second sound source(s) 154 in those instances where an emergency sound, voice, noise, siren, alarm, etc. is detected by the audio sound recognizer 162 as described with respect to FIG. 1.

Certain embodiments of the audio/sound device 150 may thereby be utilized by one person, or a group of people in such environments as the home, the office, in concerts, with speeches, outdoors, in which audio and/or sound is being projected to one or more people, or groups of people. With those audio/sound device(s) 150 that are being utilized by a group of people, the volume, contacts, or other characteristics of the sound, voices, noises, etc. that can be characterized as the at least one first sound source 152, such as can be maintained in, retrieved from, or otherwise utilized by the audio sound library 160, can often selected by one or more people. Often a number of users of certain group embodiments of the audio/sound device 100 may have relatively little input into changing the sound characteristics contained in the audio sound library 160 of the audio/sound device. With certain embodiments of audio/sound device(s) 150 that can be used by groups of users, at least some of the users may be provided with headphones, earplugs, or a controllable gradient of sound and/or audio that may be distinctly controlled such as to provide for different embodiments of the at least one first sound source 152, at least partially by each particular user.

As described with respect to FIG. 4, certain embodiments of the audio/sound device 100 can thereby be configured as a group audio/source, such as to provide sound for a group of people such as in concerts, speeches, events, etc. As such, certain group members might utilize certain individualized embodiments of the selective sound/audio provider 102. With such embodiments of the audio/sound device 100 such as may be usable by groups of people, etc., the audio/sound device 100 can be configured to include the speakers and/or amplifiers, and/or the associated component, which can be utilized to provide audio and/or sound to the groups of people listening to the audio/sound device.

As described with respect to FIG. 5, certain embodiments of the audio/sound device 100 can be configured as at least on audio source which can be used by users within a vehicle (particularly noisy ones) such as a car, truck, bus, train, aircraft, ship, boat, military vehicle, etc. Certain embodiments of the audio/sound device 100 can thereby be situated in such vehicle. As such, certain drivers, operators, or occupants of the vehicle might utilize certain embodiments of the selective sound/audio provider 102. There may be a variety of sounds or noises that are peculiar to vehicle traffic, while certain embodiments of the audio/sound device can experience sounds or noises that are common to other types of audio sound device(s) (e.g., voices of people speaking).

With certain vehicular-based audio/sound devices 100, certain individuals could have their voices characterized as at least one first sound source 152. For example, a large ship or aircraft may be equipped with certain embodiments of the audio/sound device 100. A captain or officer on a large ship might thereupon have their voice characterized as the at least one first sound source 152, and such as to be emphasized above the ambient sound, the at least one audio source 150, and/or the at least one second sound source 154. Such amplification of the captain's of officer's voice may be presented at prescribed locations throughout the ship regardless of the physical location of the captain or officer. Certain embodiments of audio, sound, voices, etc. may be shared between multiple devices, such as may be similar to as described with respect to the following audio sharing application entitled: Audio Sharing, U.S. application Ser. No. 11/210,284 (incorporated herein by reference in its entirety). In addition, certain other people on the vehicle such as the ship of aircraft may have their voices presented to other locations regardless of their location based, at least in part, on having their voices characterized as first sound source(s) as maintained in certain embodiments of the audio sound library 160, as described with respect to FIG. 1.

FIG. 7 shows another embodiment of the audio/sound device 100 that is configured to be applied to industrial (particularly) environments. It is generally understood that a variety of industries can be quite noisy, and as such can utilize a variety of noise cancellation technologies. For instance, such industrial locations as factories, fabrication, construction, power generation, aircraft loading or unloading, riveting, robotics, turbines, road working equipment, etc. can provide a considerable amount of noise by their very operation. While FIG. 7 illustrates a user utilizing certain embodiments of audio/sound device 100 as described with respect to FIG. 1 such as earplugs, earmuffs, etc, who is positioned in close proximity to a power generation device (e.g., a jet engine), it should be understood that such audio/sound devices can be applied to users position in other industrial environments.

An implementation of the audio/sound device 200 is depicted in FIG. 7A as headphones including one or more of the input/sensing components 240 positioned on the headband of the headphones. In one or more versions of the audio/sound device 200 as headphones, the input/sensing components can include the electromagnetic (EM) based input/sensing component 242g, and/or the radar based input/sensing component 242k either configured to detect such as a laser and/or radar based vehicle speed detector. Location of the input/sensing components 240 on a headphone headband could improve positioning of the input/sensing components for enhanced detection of vehicle speed detectors.

It may be difficult to communicate with others within noisy areas (industrial, commercial, concerts, etc.) as a result of the environmental noise. To thereby limit the amount of noise, certain embodiments of the audio/sound device(s) 100 can thereby be configured as noise cancelling devices (headphones) by which the user can reduce some of the noise applied thereto. In a similar manner as the voice of the captain or officer of the ship being emphasized relative to other voices; so can certain foremen, subordinates, co-workers, or other persons have their voices characterized as at least one first sound source 152 in one or more audio/sound device(s) 100, and thereby emphasize their voice relative to others or relative to the ambient or other noises or sounds.

Additionally, it may be dangerous for certain workers or other persons to be situated at various locations within the work area. As such, certain alarms, alerts, hazards, etc. can be provided as first sound source(s), such as to be relatively emphasized, amplified, maintained, etc. relative to other sounds that can be included in the at least one second sound source(s) 154 and/or at least one audio source(s) 150. As such, users of certain embodiments of the audio/sound source(s) can receive enhanced hazard, emergency, and other warnings in their workplace and/or other noisy environments. Certain embodiments of the audio/sound device can also provide 1-way or 2-way radio communication (e.g., similar to a walky-talky, cellular telephone, computer-device, communication device, etc.), and certain ones of such communications can be characterized as the at least one audio source 150, the at least one first audio source 152, and/or the at least one second audio source 154 as described in this disclosure.

Certain embodiments of vehicles can provide a considerable amount of noise from such sources as road noise, wind, weather, music, audio/radio hiss or distortions, etc. and such undesirable or secondary noises could be characterized as certain embodiments of the at least one second sound source(s) 154 as described with respect to FIG. 1. Certain vehicular based embodiments of the audio/sound device could be configured to lessen the impact of such additional noises while allowing the users/drivers/operators, etc. to detect certain emergency vehicle sirens or noises, desired voices, etc. As such, certain embodiments of the audio/sound device can be configured to utilize or provide noise cancellation characteristics, similar to commercially available noise cancellation headphones.

Certain vehicular-based embodiments of the audio/sound device 100 can also enhance directional sound clues. For example, drives of cars, truck, ships, aircraft can each rely on location of outside sirens, yells, horns, other vehicle noises, etc. (e.g. first sound source) such as may be difficult to hear over the ambient vehicle noise (e.g. second sound source) and/or the audio source (e.g. car or vehicle radio, etc.). Such directional sound clues are especially significant with vehicle audio/sound devices 100, since detecting sound from particular directions may affect how the vehicle is operable.

Other non-vehicular embodiments of the audio/sound device 100 can also be configured to provide directional sound clues. Consider that conventional personal or group sound systems may be played so loudly as to obscure directions of secondary audio. Certain embodiments of the audio/sound device(s) can allow the users to obtain such directional clues either by limiting external sounds or alternately by enhancing some indication as to which direction from which certain sounds, voices, machines, horns etc. (or other embodiments of the first said source(s) 152 originated.

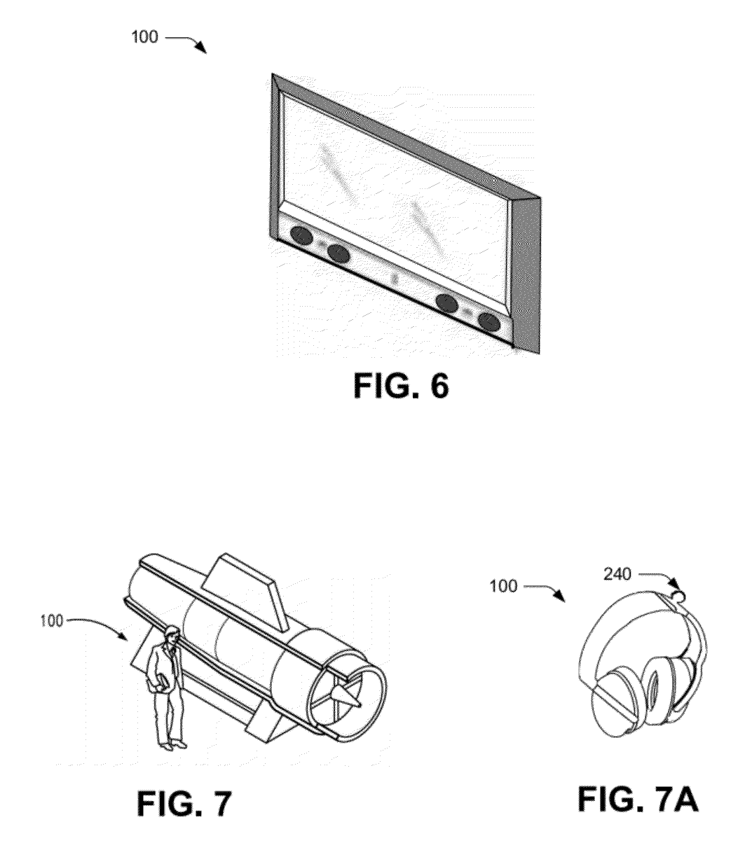

In addition, certain embodiments of the audio/sound device 100 can be utilized as a portion of video systems, television systems, graphic systems, computer systems or other systems. For example, as described with respect to FIG. 6, certain embodiments of the audio/sound device 100 can be configured as an audio/video source such as to provide visual information in both audio and video formats (which may be typically expected to be synchronized). For example, certain embodiments of the audio/sound device 100 can include, but not limited to, a portion of such systems as: a television system, a display system (e.g., a liquid crystal display (LCD) or plasma display), a computer-based system, a personal display assistant (PDA) system, etc., a vehicular system (e.g., in a truck, car, aircraft, railroad, bus, ship, military vehicle, etc.), a communication system, a controller-based system, etc. Certain embodiments of the audio/sound device 100 can thereby be utilized as portions of the systems may interface with the other portions of the systems in a variety of manners. Consider that certain embodiments of the audio/sound device 100 integrated in the television, display, or computer system as described with respect to FIG. 6 could reduce, cut, stop, or mute its audio source (output) if such an at least one first sound source 152 as an emergency sound was detected such as a siren or alert. In addition, if certain persons have their voice characterized as first sound source(s), as they speak, certain embodiments of the audio/sound device can relatively diminish the audio (or relatively enhance their voices).

With certain system embodiments of the audio/sound device that include a display portion as described with respect to FIG. 6, if operation of the audio source 150 (e.g., audio output) is muted or cease, then the corresponding video, television, display, etc. can also be ceased or frozen. In this manner, a speaker having their voice being identified as the first sound source will not act to diminish or cut the audio of certain embodiments of the audio/sound device 100 each time they talk; but may instead cause the program to freeze or stop, and the audio and video may continue together when the discussion ends.

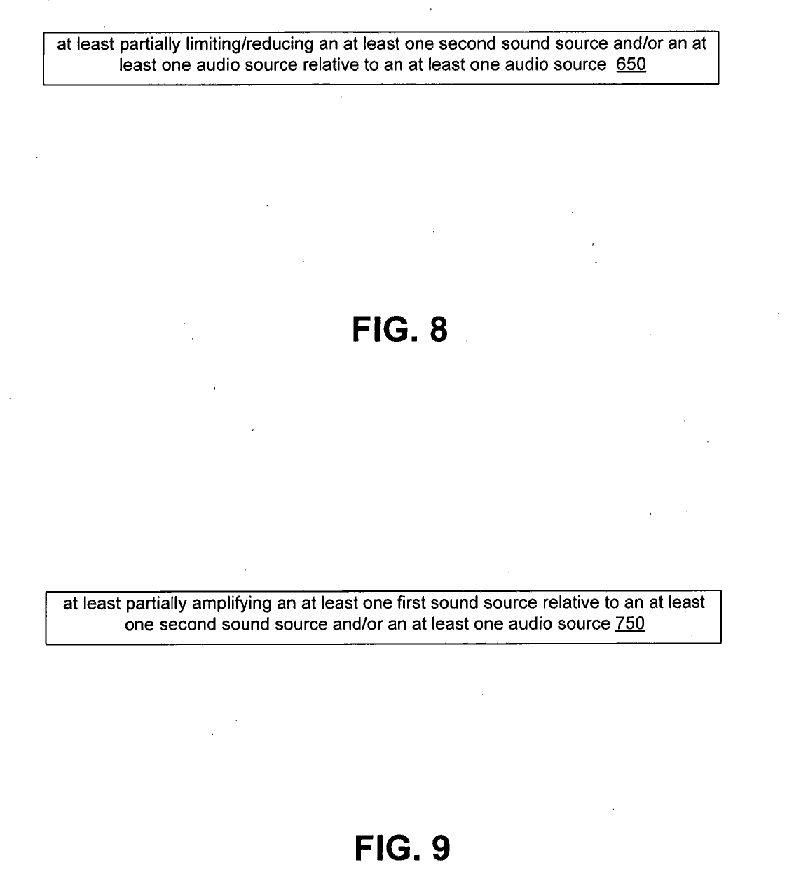

As described in flow chart form with respect to FIGS. 8 and 9, certain embodiments of the audio/sound device can utilize at least one or more from two options such as to emphasize the at least one first sound source 152 relative to the at least one second sound source 154 and/or the at least one audio source 150. In certain embodiments, as described with respect to operation 650 of FIG. 8, the emphasizing of the at least one first sound source 152 can result by at least partially limiting/reducing the at least one second sound source 154 and/or the at least one audio source 150 relative to the at least one audio source, such as by filtering the sound relative to the second interruptive (audible) at least one audio source.

In other embodiments, the emphasizing of the at least one first sound source 152 as described with respect to operation 750 as described with respect to FIG. 9, can result by at least partially amplifying the at least one first sound source relative to the at least one second sound source 154 and/or the at least one audio source 150, and in certain instances that at least one first sound source 152 may be mixed or combined with the at least one second sound source 154 or the at least one audio source 150.

Certain embodiments of the audio/sound device 100 can thereby be configured such as to include content filters, such as to allow differentiation of one or more of the at least one first sound source 152, the at least one second sound source 154, and/or the at least one audio source 150. In certain instances, the one or more of the at least one first sound source 152, the at least one second sound source 154, and/or the at least one audio source 150 can be individually sampled, digitized, filtered, enhanced, amplified, sustained, or otherwise suitably processed. Certain embodiments of the audio/sound device can thereby be considered to include content-based filters, e.g., that can be configured to operate the at least one first sound source 152, the at least one second sound source 154, and/or the at least one audio source 150 at certain prescribed or controllable levels. As such, certain embodiments of the audio/sound device 100 can be configured to allow some content in but not other content.

Certain embodiments of the audio/sound device 100 can be configured to operate other than to emphasize the at least one first sound source 152 relative to the at least one second sound source 154 and/or the at least one audio source 150. For instance, certain embodiments of the audio/sound device 100 can be configured to de-emphasize or filter out the at least one first sound source 152 relative to the at least one second sound source 154 and/or the at least one audio source 150. Consider that certain embodiments of the audio/sound device 100 could be programmed to hear certain voices or sounds (such as from the at least one first sound source 152), amplify those voices sounds, and transmit them (or representative versions thereof) into the listened-to audio stream. One example can include certain users of the audio sound device 100 that are programmed to recognize the voice of a person or noise that is not desired to listen to, and effectively filter the voice or sound; such as with use of a volume increase of the at least one audio source 150 relative to the at least one first sound source.

Certain embodiments of the audio/sound device 100 can be configured to interface with the phone. For instance, certain embodiments of the audio/sound device 100 incorporating a phone can “hear” the phone (such as by auditory or electronic signaling means such as via a network connection and out-of band communications), and thereafter diminish or in extreme instances turn off the phone, and allows the at least one first sound source 152, that may be configured as real world sound, to pass through as described with respect to FIG. 9. Alternatively, certain embodiments of the audio/sound device including the phone can be configured to boost the at least one first sound source 152 being presented to the user, while temporarily reducing noise from the phone.

Consider that certain embodiments of the audio/sound device could be considered as a selective enhancement to listening device that amplifies sounds or voices with certain prescribed characteristics, and relatively de-emphasized of certain voices, sounds, noises, etc. with other characteristics. Such characteristics can be based on the frequency, volume, direction, of other characteristic of the voices, noises, sounds, etc. As such, certain embodiments of the audio/sound device 100 should be considered to be content savvy and responsive some input from the user, or in certain instances some pre-configuration by others than the user.

Certain embodiments of the audio/sound device 100 can utilize headphones, ear cups, earplugs, or other devices that can provide sound directly to one or more users. Certain embodiments of the audio/sound device 100 that include headphones or earplugs can provide logic and processing capabilities as associated with the audio/sound controller 97 either in the audio/sound device 100, in the headphones, or in a combination thereof.

Certain embodiments of the audio/sound device may be configured to provide for mixing of audio signals and/or sound signals. Certain embodiments of the audio/sound device 100 can thereby be configured to allow the at least one first sound source 152 to be emphasized or deemphasized relative to the at least one second sound source 154 and/or the at least one audio source 150. As such, the at least one first sound source 152 may thereby be allowed to be at least partially listened to, or alternately may be desired not to listen to or to filter out.

Certain of the technologies utilized by certain embodiments of the audio/sound device 100 can be configured with similar processes or mechanisms as with conventional noise canceling devices or systems. Certain conventional noise canceling devices or systems, which are commercially available, may be used in such applications where it is desired to actively filter certain noises out such as with aviation, industrial equipment, road working, etc. Such companies as Bose, David Clark, Softcomm, among others, design and provide commercially available active noise canceling systems (which may be configured to represent certain commercially available versions or embodiments of the audio/sound device 100). Certain embodiments of the audio/sound device 100 can be configured as a noise cancelling system, as described in this disclosure. With such embodiments of the audio/sound device 100 that are configured as noise canceling systems, noise canceling headphones, noise canceling speakers, etc.

Certain embodiments of the audio/sound device 100, as described in this disclosure, can thereby be configured to limit any excessive noise, sound, etc. that can be classified as originating as the at least one second sound source 154, in a similar manner as conventional noise cancellation systems and devices can cancel or limit noise, sound, etc.

With certain embodiments of the audio/sound device 100, the at least one first sound source 152 can be modified such as by being amplified, sustained, etc. Examples of the modification of the at least one first sound source can include but are not limited to: filtering, amplifying, maintaining, sustaining, processing, etc. Such modification can be based, for example, at least in part on at least some specific spectrum of information, specific frequencies, specific spectral content, specific recognition-based, etc., of the at least one first sound source 152 relative to the at least one second sound source 154 and/or the at least one audio source. By comparison, certain embodiments of the audio/sound device 100, as described in this disclosure, can be configured to allow or enhance noise, sound, etc. that can be classified as originating as the at least one first sound source 152. Certain embodiments of the at least one first sound source 152 can be heard above the diminished at least one second sound source 154 during normal operation of the audio/sound device 100.

Such diminishing of the at least one second sound source relative 154 to the at least one first sound source 152 (or alternatively the amplification of the at least one first sound source relative to the at least one second sound source) can be especially desirable if the at least one first sound source 152 includes a voice of a person with whom the person using the audio/sound device 100 is attempting to communicate. The diminishing of the at least one second sound source 154 relative to the at least one first sound source 152 (or alternatively the amplification of the at least one first sound source relative to the at least one second sound source) can also be desirable if the at least one first sound source includes an emergency signal, noise, voice, etc. Therefore, in general, the diminishing of the at least one second sound source relative 154 to the at least one first sound source 152 (or alternatively the amplification of the at least one first sound source relative to the at least one second sound source) can also be desirable if the at least one first sound source corresponds to some desired sound to hear.

There can be a variety of mechanisms and/or techniques by which the at least one first sound source 152 can be enhanced, amplified, or maintained relative to the at least one second sound source 154. For example, a voice corresponding to the at least one first sound source can be digitalized, such as by using a microphone, an analog to digital converter, etc.

### Certain Embodiments of the Audio/Sound Controller

This disclosure describes a number of embodiments of the audio/sound controller 97, as described with respect to FIG. 1, that is intended to control operations of certain embodiments of the audio/sound device 100. Certain embodiments of the audio/sound controller 97 can provide the functionality of the at least a portion of the feedback mechanism to either certain embodiments of the audio/sound device 100. Certain embodiments of the audio/sound controller 97 can be configured as a standalone device, while other embodiments of the audio/sound controller can be configured as a networked device or as multiple networked devices.

FIG. 1 shows a block diagram of certain respective embodiments of the audio/sound device 100 that can include the audio/sound controller 97, the at least one audio source 150, and possible interfaces with the at least one first sound source 152 and/or the at least one second sound source 154 as described in this disclosure. Certain embodiments of the audio/sound device 100 thereby can include, but are not limited to, any particular configuration of the audio/sound controller 97. Certain embodiments of the audio/sound controller 97 can be computer based, controller based, mote based, phone based, and/or electronics based. Certain embodiments of the audio/sound controller can be segmented into modules, and can utilize a variety of wireless or wired-based communication and/or networking technology to allow information, data, etc. to be transferred to the various distinct portions or embodiments of the audio/sound device 100. Certain embodiments of the audio/sound controller 97 can be configured as a unitary or stand alone device.

Certain embodiments of the audio/sound controller 97 can vary as to their automation, complexity, and/or sophistication. As described within this disclosure, multiple ones of the different embodiments of the audio/sound device 100 can transfer audio and/or sound data, information, etc. Certain embodiments of the audio/sound controller 97, as well as certain embodiments of the audio/sound device 100, in general, can utilize distinct firmware, hardware, and/or software technology. For example, mote-based technology, phone-based technology, microprocessor-based technology, microcomputer-based technology, general-purpose computer technology, specific-purpose to computer technology, and a variety of other computer technologies can be utilized for certain embodiments of the audio/sound controller 97, as well as certain embodiments of the audio/sound device 100.

Certain embodiments of the audio/sound controller 97 can as described with respect to FIG. 1 can include a processor 803 such as a central processing unit (CPU), a memory 807, a circuit or circuit portion 809, and an input output interface (I/O) 811 that may include a bus (not shown). Certain embodiments of the audio/sound controller 97 of the audio/sound device 100 can include and/or be a portion of a general-purpose computer, a specific-purpose computer, a microprocessor, a microcontroller, a phone, a personal display assistant (PDA), a cellular phone, a wireless communication device, a hard-wired phone, and/or any other known suitable type of communications device, computer, and/or controller that can be implemented in hardware, software, electromechanical devices, and/or firmware. Certain embodiments of the processor 803, as described with respect to FIG. 1, can perform the processing and arithmetic operations for certain embodiments of the audio/sound controller 97 of the audio/sound device 100. Certain embodiments of the audio/sound controller 97 of the audio/sound device 100 can control the signal processing, database querying and response, computational, timing, data transfer, and other processes associated with certain embodiments of the audio/sound controller 97 of the audio/sound device 100.

Certain embodiments of the memory 807 of the audio/sound controller 97 can include a random access memory (RAM) and/or read only memory (ROM) that together can store the computer programs, operands, and other parameters that control the operation of certain embodiments of the audio/sound controller 97 of the audio/sound device 100. The memory 807 can be configurable to contain the information or individual information obtained, retained, or captured by that particular audio/sound controller 97 of the audio/sound device 100. Certain embodiments of the memory 807 can at least partially include the modifiable data/information memory locations, as described in this disclosure.

Certain embodiments of the bus can be configurable to provide for digital information transmissions between the processor 803, circuits 809, memory 807, I/O 811, and/or the image memory or storage device (which may be integrated or removable). In this disclosure, the memory 807 can be configurable as RAM, flash memory, semiconductor-based memory, of any other type of memory that can be configurable to store data pertaining to images. The bus also connects I/O 811 to the portions of certain embodiments of the audio/sound controller 97 of either the audio/sound device 100 that either receive digital information from, or transmit digital information to other portions of the audio/sound device 100 or other systems are networking components associated with.

Certain embodiments of the audio/sound controller 97 of the audio/sound device 100, as described with respect to FIG. 1, can include a transmitter portion (not shown) that can be either included as a portion of certain embodiments of the audio/sound controller 97 of the audio/sound device 100. Certain embodiments of the audio/sound controller 97 can alternately be provided as a separate unit (e.g., microprocessor-based). In certain embodiments, the transmitter portion can transmit image information between certain embodiments of the audio/sound controller 97 of the audio/sound device 100.

Certain embodiments of the audio/sound controller 97 of the audio/sound device 100 as described with respect to FIG. 1 can include an operation altering portion (not shown) that can be either included as a portion of certain embodiments of the audio/sound controller 97 of the audio/sound device 100 can be provided as a separate unit (e.g., microprocessor-based). Examples of operation altering portions include, but are not limited to, altering a resolution, altering a contextual library, altering an initial condition, altering an aspect ratio, altering a color intensity and/or brightness or particular parameter or characteristic of the audio/sound device 100.

Certain embodiments of the memory 807 can provide one example of a memory storage portion. In certain embodiments, the monitored value includes but is not limited to: a percentage of the memory 807, a number of images that are stored in the memory 807, or for data storage or recording interval (audio or video recording intervals).

To provide for overflow ability for the memory 807 of certain embodiments of the audio/sound controller 97 of the audio/sound device 100, the image storage device can be operably coupled to the memory 807 to allow a controllable transmitting of memory data from certain embodiments of the audio/sound controller 97 of the audio/sound device 100 when the monitored value of data within the memory 807 (e.g., the memory storage portion) exceeds a prescribed value. The prescribed value can include, e.g., some percentage amount or some actual amount of the value.

In certain embodiments, a secondary communication link can be established between the certain embodiments of the audio/sound controller 97 of the audio/sound device 100. The secondary communication link can be structured similar to as a communication link, or alternatively can utilize network-based computer connections, phone connections, Internet connections, etc. to provide information and/or data transfer between certain embodiments of the audio/sound controller 97 of the audio/sound device 100.

In certain embodiments of the audio/sound controller 97 of the audio/sound device 100, the particular elements of certain embodiments of the audio/sound controller 97 of the audio/sound device 100 (e.g., the processor 803, the memory 807, the circuits 809, and/or the I/O 811) can provide a monitoring function to convert raw data as displayed by an indicator. A monitoring function as provided by certain embodiments of the audio/sound controller 97 of the audio/sound device 100 can be compared to a prescribed limit, such as whether the number of images contained in the memory 807, the amount of data contained within the memory 807, or some other measure relating to the memory is approaching some value. The limits to the value can, in different embodiments, be controlled by the user or the manufacturer of certain embodiments of the audio/sound controller 97 of the audio/sound device 100. In certain embodiments, the memory 807 can store such information as data, information, displayable information, readable text, motion images, video images, and/or audio images, etc.

In certain embodiments, the I/O 811 provides an interface to control the transmissions of digital information between each of the components in certain embodiments of the audio/sound controller 97 of the audio/sound device 100. The I/O 811 also provides an interface between the components of certain embodiments of the audio/sound controller 97 of the audio/sound device 100. The circuits 809 can include such other user interface devices as a display and/or a keyboard. In other embodiments, the audio/sound controller 97 of the audio/sound device 100 can be constructed as a specific-purpose computer such as an application-specific integrated circuit (ASIC), a microprocessor, a microcomputer, or other similar devices. A variety of vehicles, factories, machines, medical devices, devices, locations, etc. could be configured as and/or include certain embodiments of the audio/sound device 100. A variety of vehicles, seats, etc. can also be configured with certain embodiments of the audio/sound device 100.

Certain Embodiments of Audio/Sound with Relevant Flowcharts

Within the disclosure, flow charts of the type described in this disclosure apply to method steps as performed by a computer or controller. The flow charts can also apply to apparatus devices, such as an antenna or a node associated therewith that can include, e.g., a general-purpose computer or specialized-purpose computer whose structure along with the software, firmware, electro-mechanical devices, and/or hardware, can perform the process or technique described in the flow chart.

FIG. 1 shows one embodiment of the audio/sound device 100, which can be configured to provide audio and/or sound to a user, owner, listener, etc. of the audio/sound device 100. Certain embodiments of the audio/sound device 100 can be configured as a personalized audio/sound device, a group audio/sound device, an audio/sound portion of an alternate device, a vehicular audio/sound device, a user audio/sound device, or another type of audio sound device similar to as described with respect to FIGS. 3 to 7, and at other locations within this disclosure. Certain embodiments of the audio/sound device may be configured to allow the user to hear or listen to a first audio/sound source, while relatively reducing or relatively enhancing a second audio/sound source.

Certain portions of different embodiments of the audio/sound device 100 can be under the control of the owner, or under the control of another person or device. For example, certain embodiments of the audio/sound device 100 can be actuated at prescribed times when an emergency vehicle is traveling past the user, or the user is talking with another person with whom they may wish to talk with, or alternatively may not wish to communicate or talk with.

Certain embodiments of the audio/sound can be utilized by the user, owner, or possessor of the card as the true owner utilizing a remote and/or automated mechanism. Certain embodiments of the audio/sound can also utilize positional information (such as GPS-derived information) to detect where the audio/sound device 100, as well as the associated owner or user is situated. In certain embodiments, the positional information can be transmitted between the personalized device and other computer, controller, or communication devices using networking or other communication techniques and/or systems.

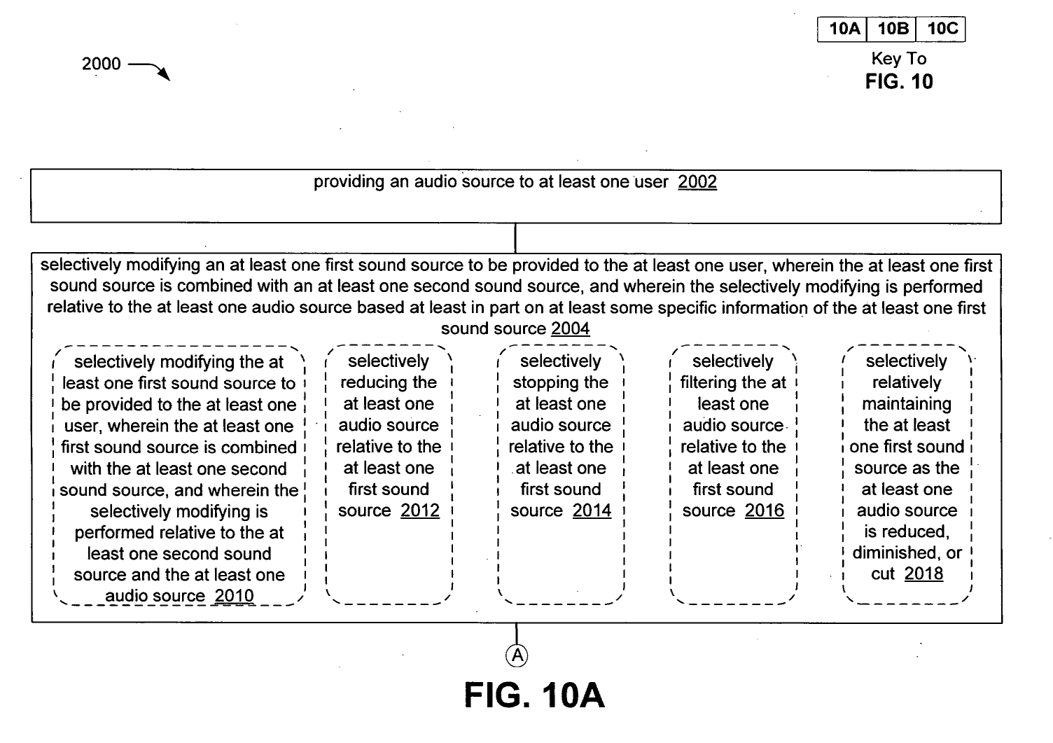

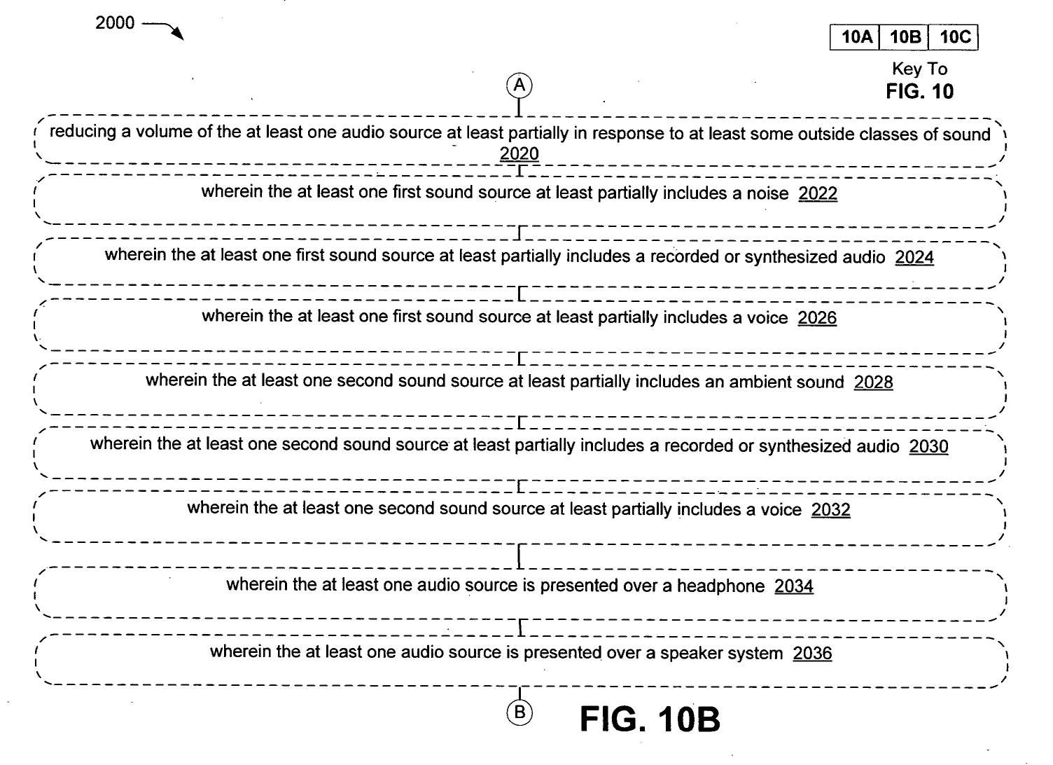

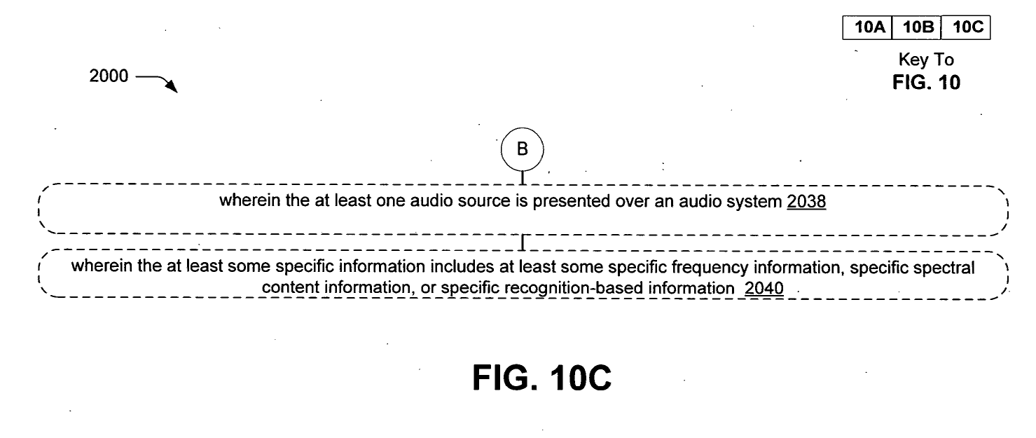

Certain embodiments of a high-level flowchart of a audio/sound technique 2000 is described with respect to FIG. 10 (including FIGS. 10a to 10c) and can include, but is not limited to, operations 2002 and 2004, and optional operations 2020, 2022, 2024, 2026, 2028, 2030, 2032, 2036, 2038, and/or 2040. Certain embodiments of operations 2004 can include, but is not limited to, optional operation 2010, 2012, 2014, 2016, and/or 2018. The high-level flowchart of FIG. 10 (including FIGS. 10a to 10c) should be considered in combination with the embodiments of the audio/sound device 100, as described with respect to FIG. 1.

Certain embodiments of operation 2002 can include, but is not limited to, providing an at least one audio source to at least one user. For example, the at least one audio source 150 can be provided within certain embodiments of the audio/sound device 100, as described with respect to FIGS. 1 and 2. Certain embodiments of the audio/sound device 100 are described in this disclosure with respect to FIGS. 3 to 7. Certain embodiments of the audio/sound device can be configured to utilize hardware, firmware, and/or software versions of the audio/sound controller 97 as described in this disclosure. Certain embodiments of operation 2004 can include, but is not limited to, selectively modifying an at least one first sound source to be provided to the at least one user, wherein the at least one first sound source is combined with an at least one second sound source, and wherein the selectively modifying is performed relative to the at least one audio source based at least in part on at least some specific information of the at least one first sound source. For example, certain embodiments of the at least one first sound source 152 can be modified relative to the at least one second sound source 154. Certain embodiments of the modification can include, but are not limited to, amplification, maintaining, filtering, clarification, etc.

Certain embodiments of the selectively modifying an at least one first sound source to be provided to the at least one user, wherein the at least one first sound source is combined with an at least one second sound source, and wherein the selectively modifying is performed relative to the at least one audio source based at least in part on at least some specific information of the at least one first sound source of operation 2004 can include operation 2010, that can include but is not limited to, selectively modifying the at least one first sound source to be provided to the at least one user, wherein the at least one first sound source is combined with the at least one second sound source, and wherein the selectively modifying is performed relative to the at least one second sound source and the at least one audio source. For example, wherein the selective modification relative to the at least one audio source 150 is performed in combination with the selective modification relative to the at least one second sound source 154. Certain embodiments of operation 2004 can include operation 2012, that can include but is not limited to, selectively reducing the at least one audio source relative to the at least one first sound source. For example, the selective modification of the at least one first sound source 152 can include, but is not limited to, selective reduction of the at least one audio source 150 as described with respect to FIG. 1. Certain embodiments of operation 2004 can include operation 2014, that can include but is not limited to, selectively stopping the at least one audio source relative to the at least one first sound source. For example, the selective modification of the at least one first sound source 152 can include, but is not limited to, cutting or stopping the at least one audio source 150 as described with respect to FIG. A1. Certain embodiments of the operation 2004 can include operation 2016, that can include but is not limited to, selectively filtering the at least one audio source relative to the at least one first sound source. For example, the selective modification of the at least one first sound source 152 can include, but is not limited to, selectively filtering the at least one audio source 150 relative to the at least one first sound source 152. Certain embodiments of operation 2004 can include operation 2018, that can include but is not limited to, selectively relatively maintaining the at least one first sound source as the at least one audio source is reduced, diminished, or cut. For example, the selective modification of the at least one first sound source 152 can include, but is not limited to, relatively maintaining the at least one first sound source as the relative amplitude of the at least one audio sound source 150 is reduced, diminished, or cut.

Certain embodiments of operation 2020 can include, but is not limited to, further comprising reducing a volume of the at least one audio source at least partially in response to at least some outside classes of sound. For example, reducing the volume of the at least one audio source 150 relative to the at least one first sound source 152, the at least one audio source including a different type or class of sound as compared to the class or type of sound of the at least one audio source 150. Certain embodiments of operation 2022 can include, but is not limited to, wherein the at least one first sound source at least partially includes a noise. For example, wherein the at least one first sound source 152 at least partially includes a noise. Certain embodiments of operation 2024 can include, but is not limited to, wherein the at least one first sound source at least partially includes a recorded or synthesized audio. For example, wherein the at least one first sound source 152 at least partially includes recorded or synthesized audio. Certain embodiments of operation 2026 can include, but is not limited to, wherein the at least one first sound source at least partially includes a voice. For example, wherein the at least one first sound source 152 at least partially includes a voice, such as can be recognized in certain embodiments of the audio sound recognizer 162, as described with respect to FIG. 1. Certain embodiments of operation 2028 can include, but is not limited to, wherein the at least one second sound source at least partially includes an ambient sound. For example, the at least one second sound source 154 at least partially includes ambient sound. Certain embodiments of operation 2030 can include, but is not limited to, wherein the at least one second sound source at least partially includes a recorded or synthesized audio. For example, the at least one second sound source 154 at least partially includes recorded or synthesized audio. Certain embodiments of operation 2032 can include, but is not limited to, wherein the at least one second sound source at least partially includes a voice. For example, the at least one second sound source 154 at least partially includes a voice, or multiple voices, such as which the user may not wish to emphasize as described with respect to FIG. 1. Certain embodiments of operation 2034 can include, but is not limited to, wherein the at least one audio source is presented over a headphone. For example, wherein the at least one audio source is provided over a headphone or other personal device, as described with respect to FIG. 3. Certain embodiments of operation 2036 can include, but is not limited to, wherein the at least one audio source is presented over a speaker system. For example, wherein the at least one audio source is provided over a speaker or other group audio/sound device, as described with respect to FIG. 4. Certain embodiments of operation 2038 can include, but is not limited to, wherein the at least one audio source is presented over an audio system. For example, wherein the at least one audio source is provided over a group audio/sound device, as described with respect to FIG. 4. Certain embodiments of operation 2040 can include, but is not limited to, wherein the at least some specific information includes at least some specific frequency information, specific spectral content information, or specific recognition-based information. For example, wherein the at least some specific information can include the at least some specific frequency information, specific spectral content information, or specific recognition-based information, which can be maintained in certain embodiments of the audio sound library 160, and can be recognized in certain embodiments of the audio/sound recognizer 162, as described with respect to FIG. 1 in this disclosure. The order of the operations, methods, mechanisms, etc. as described with respect to FIG. 10 (including FIGS. 10a to 10c) is intended to be illustrative in nature, and not limited in scope.

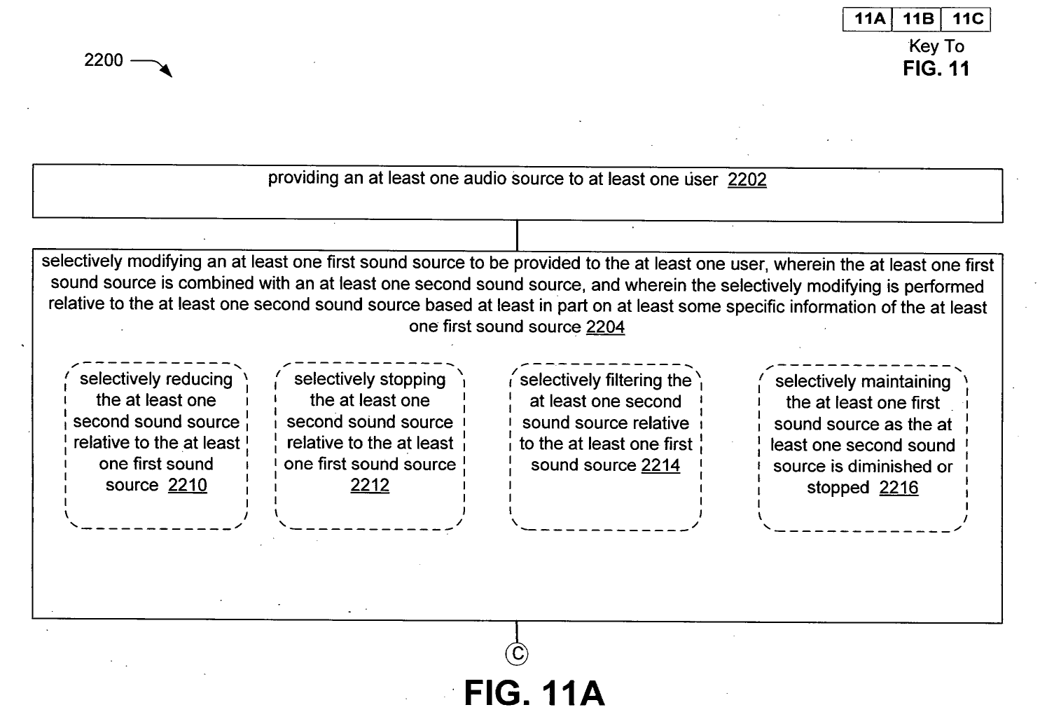

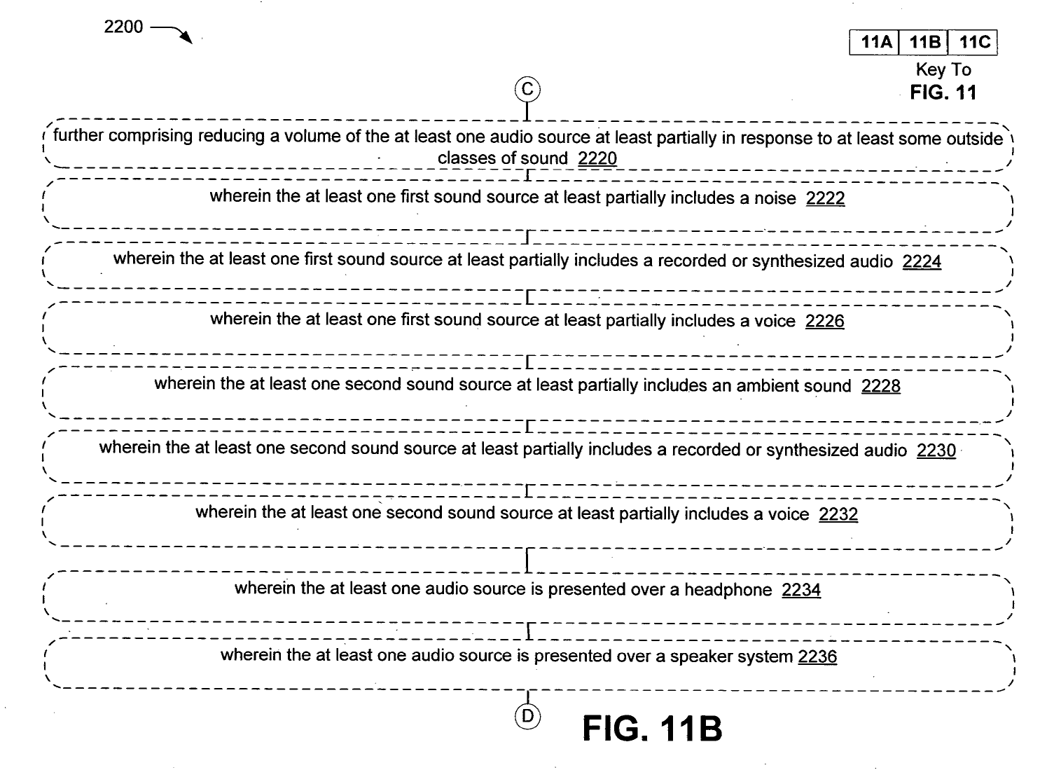

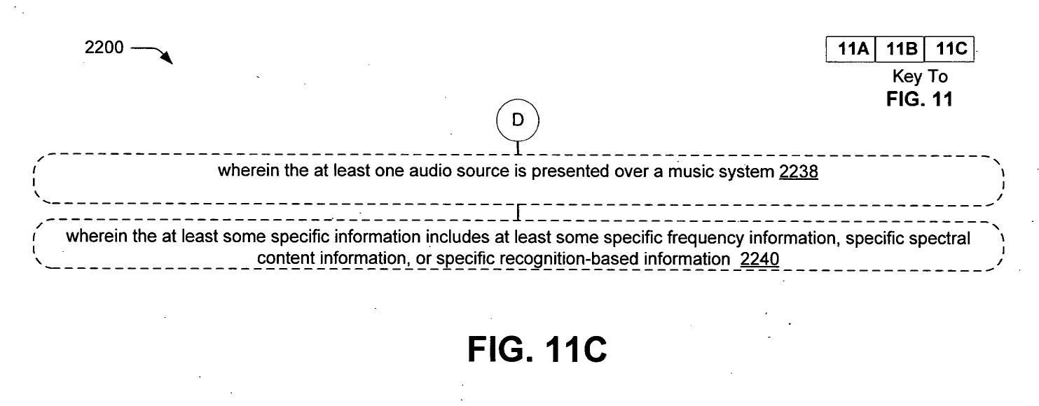

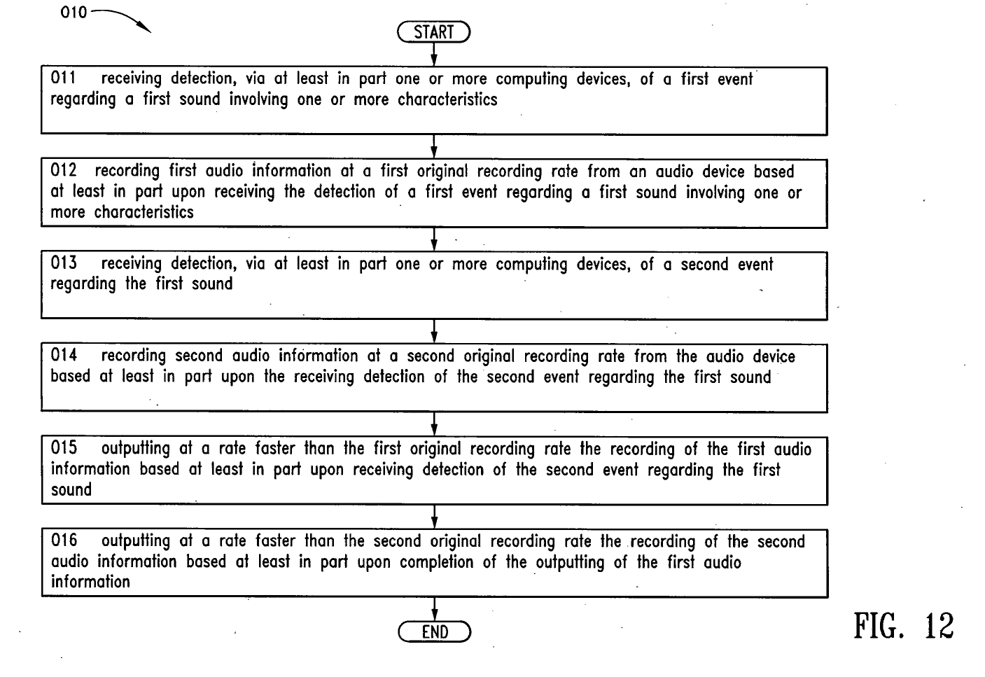

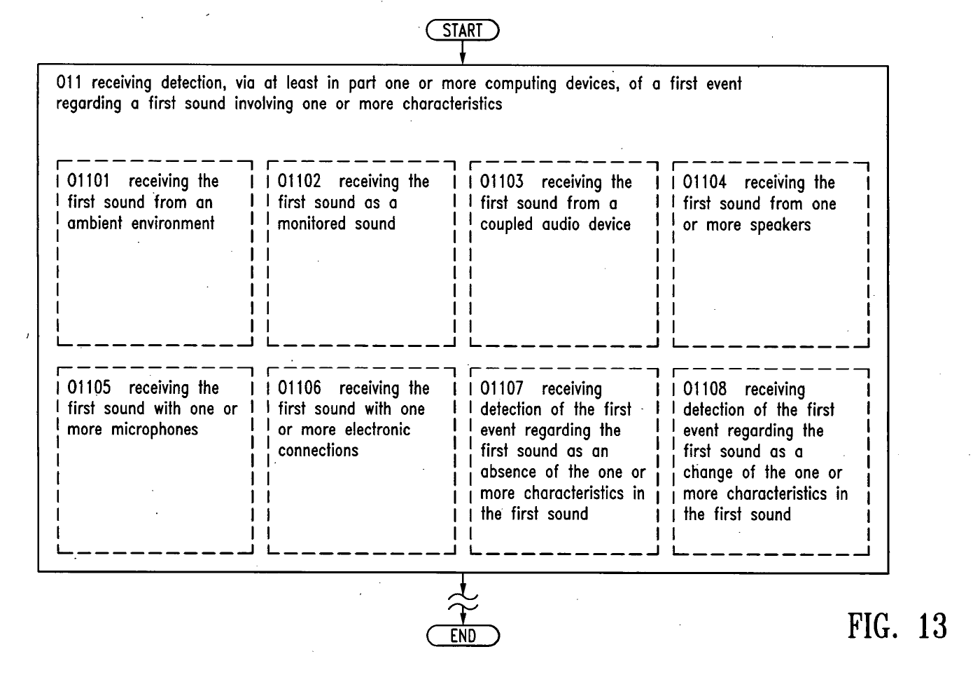

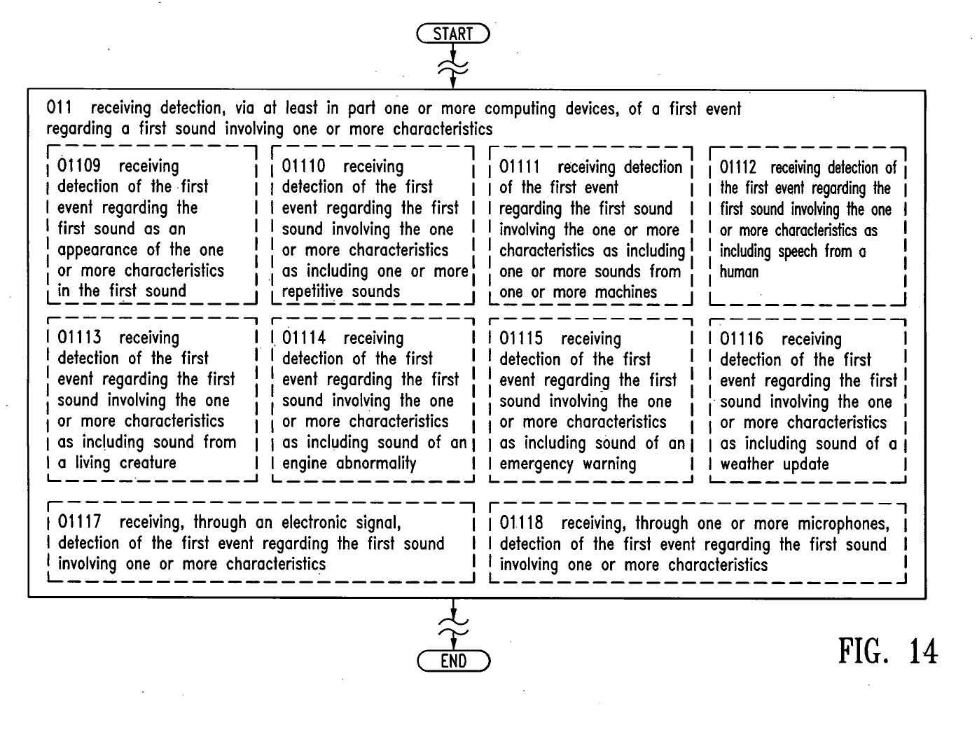

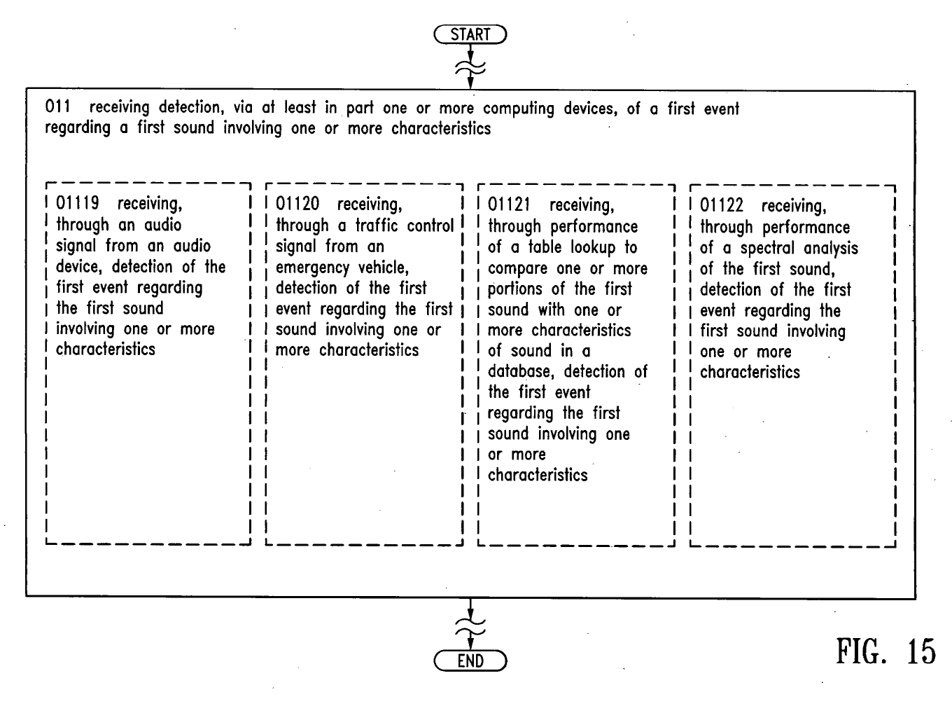

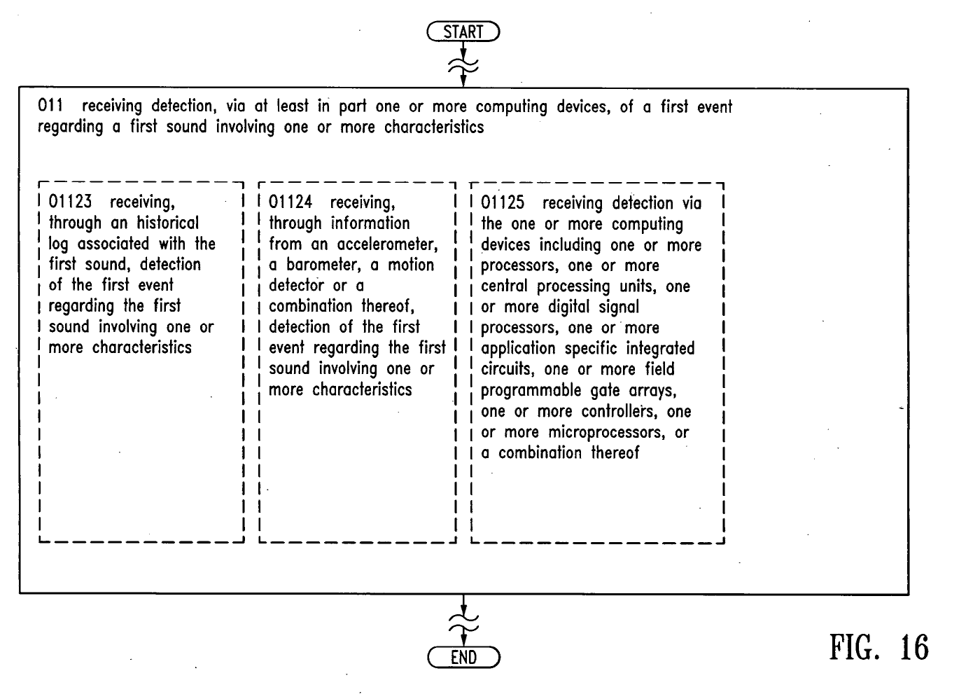

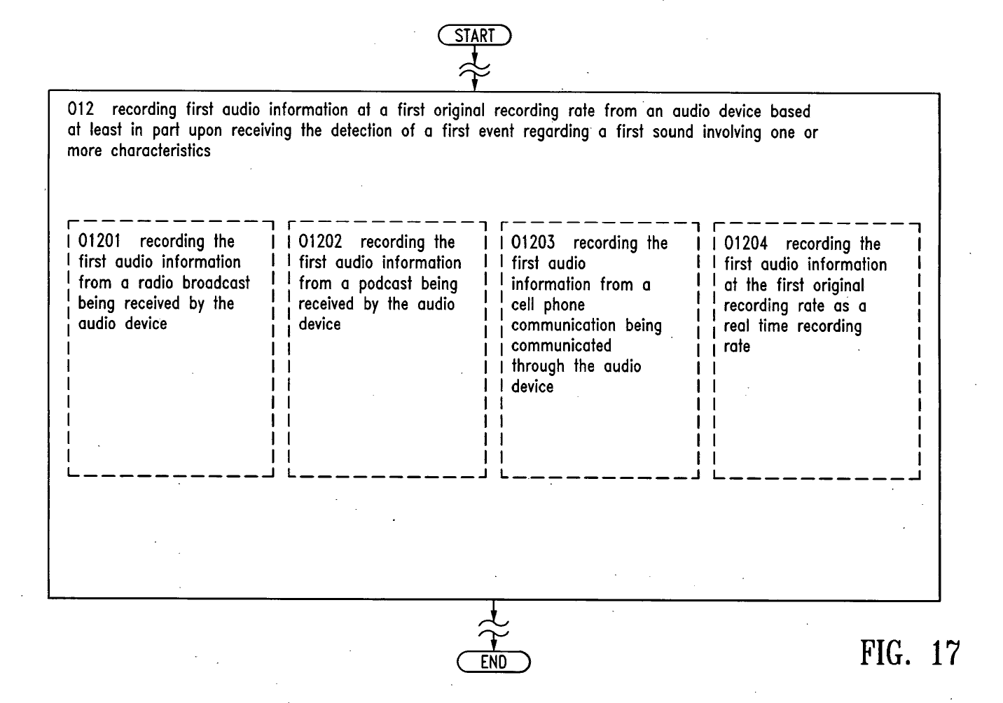

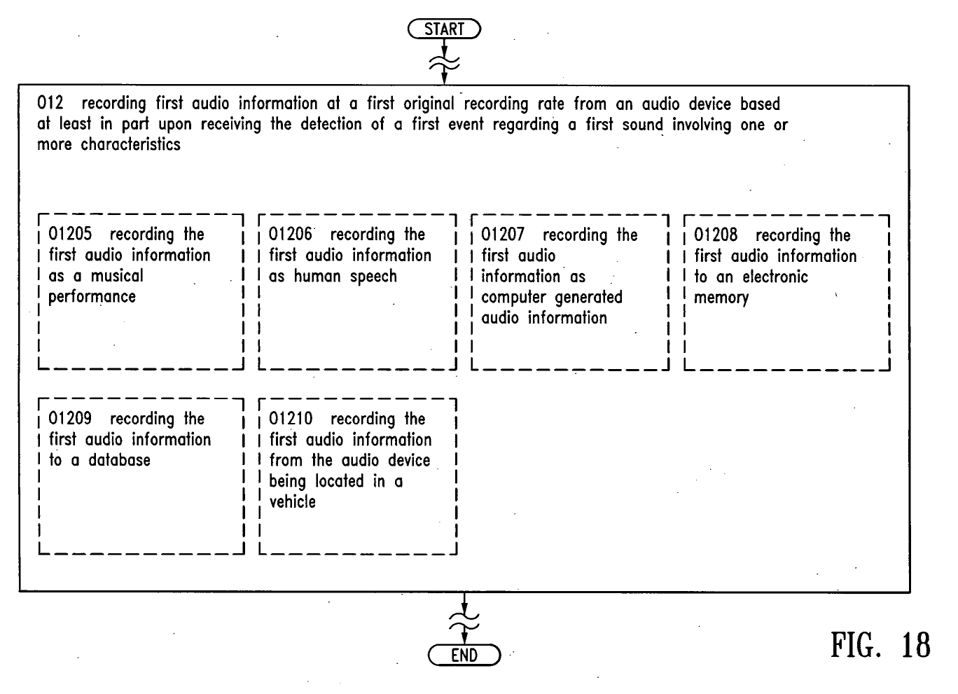

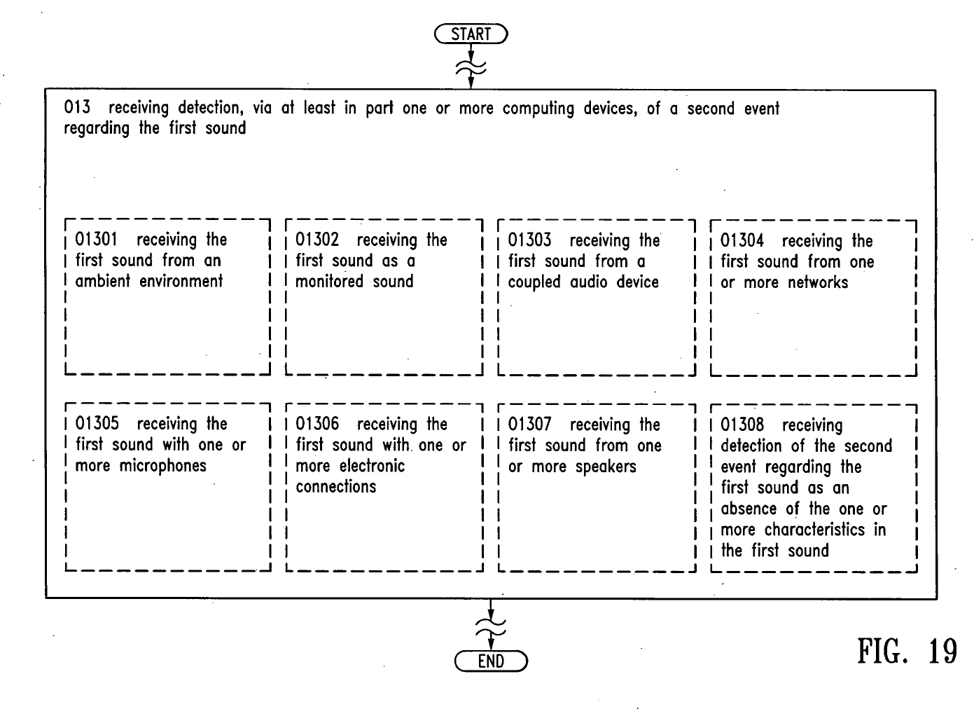

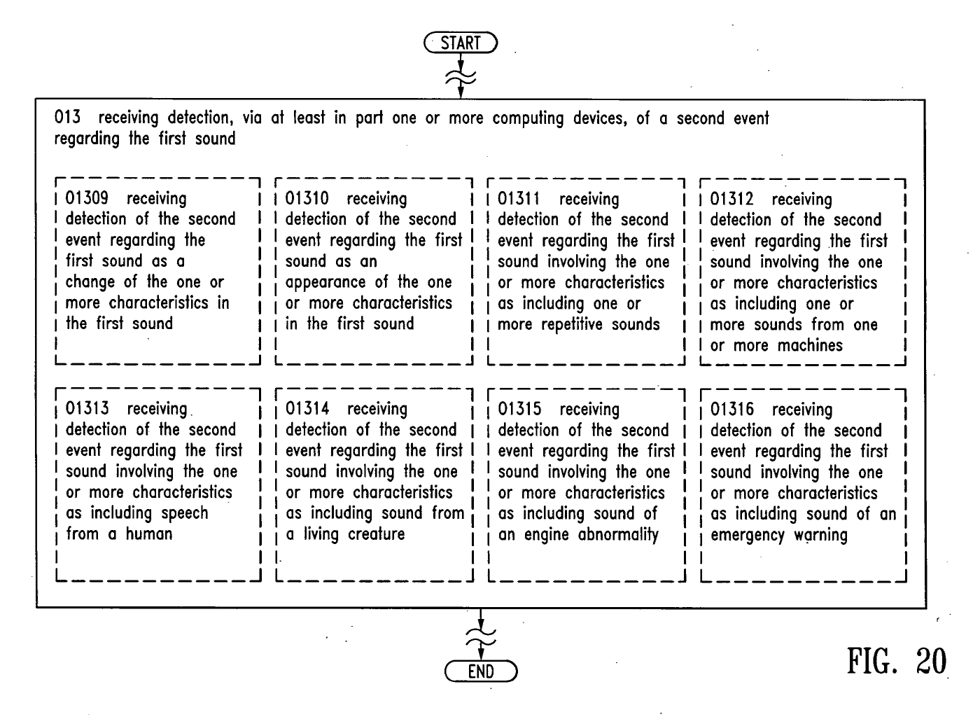

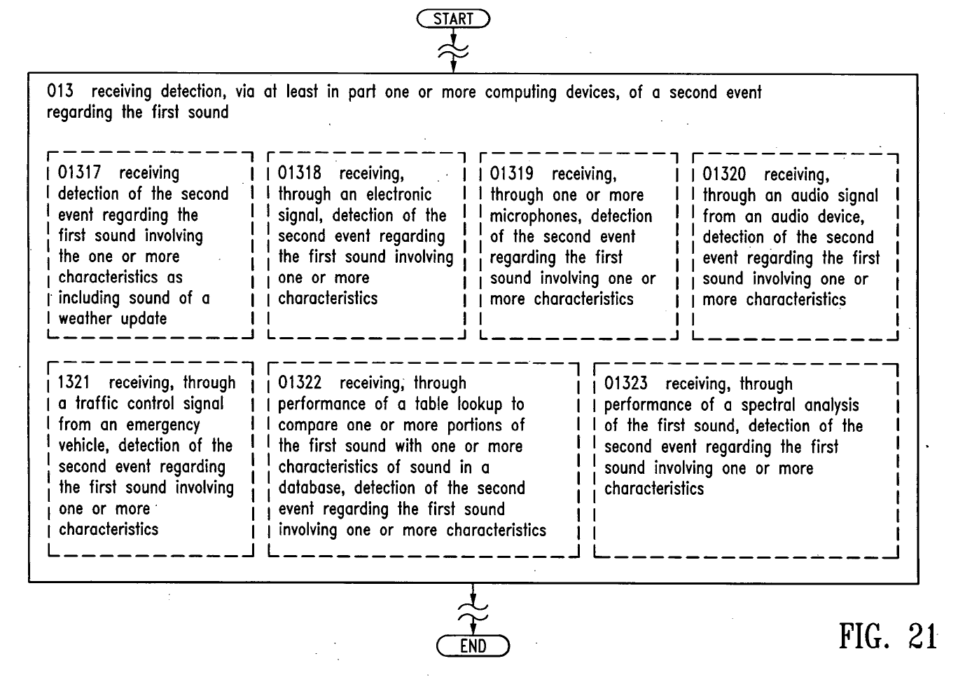

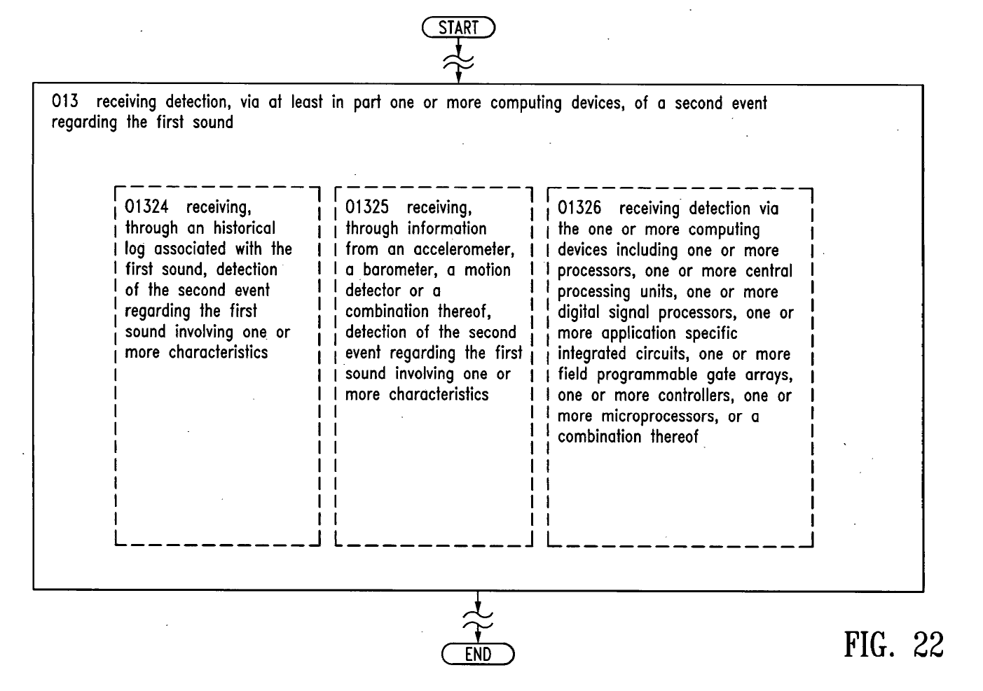

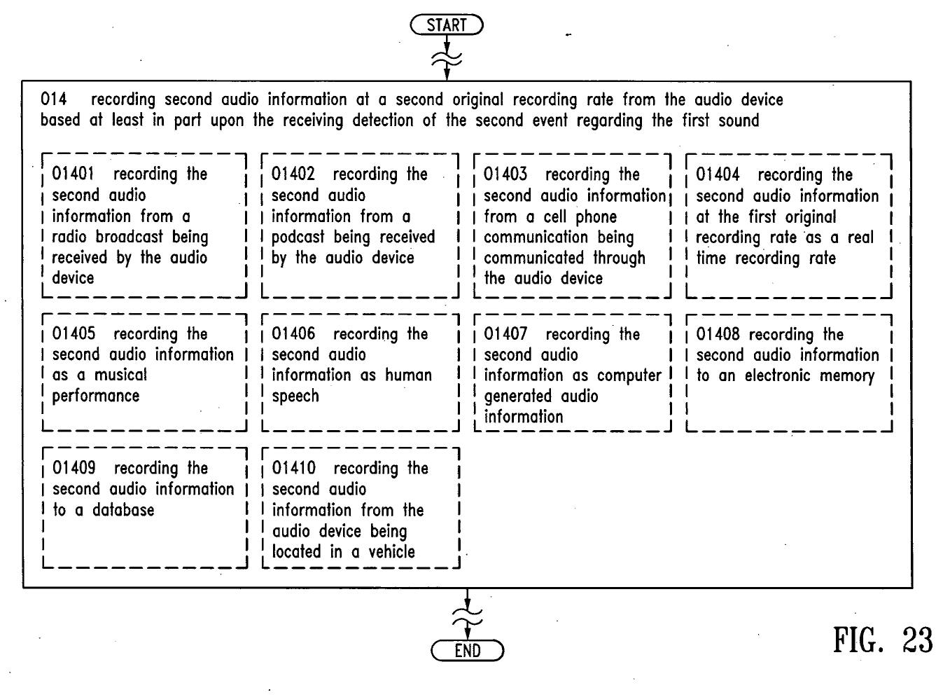

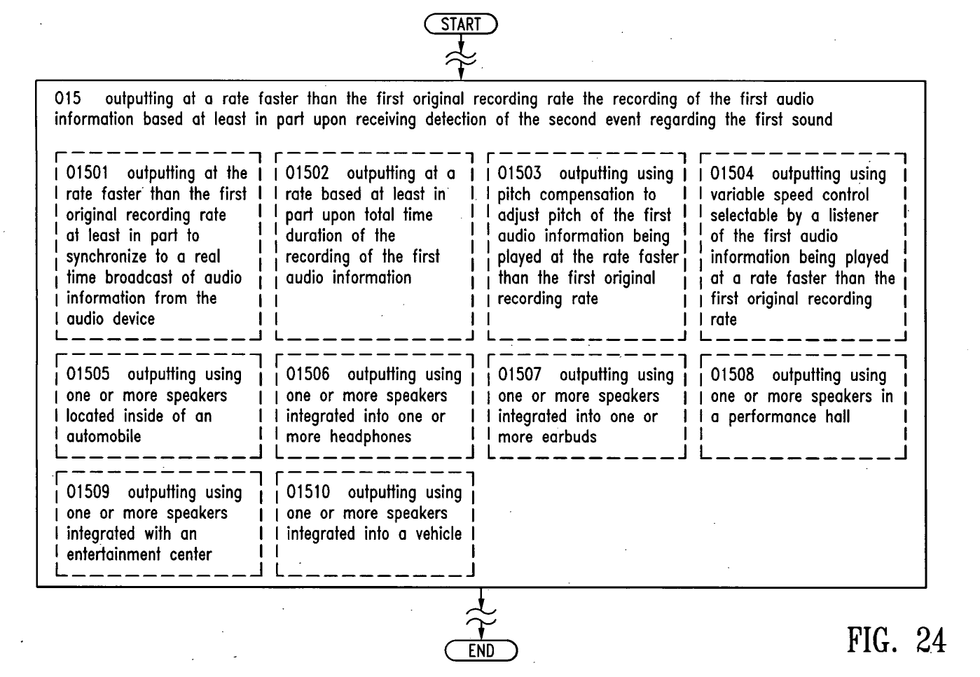

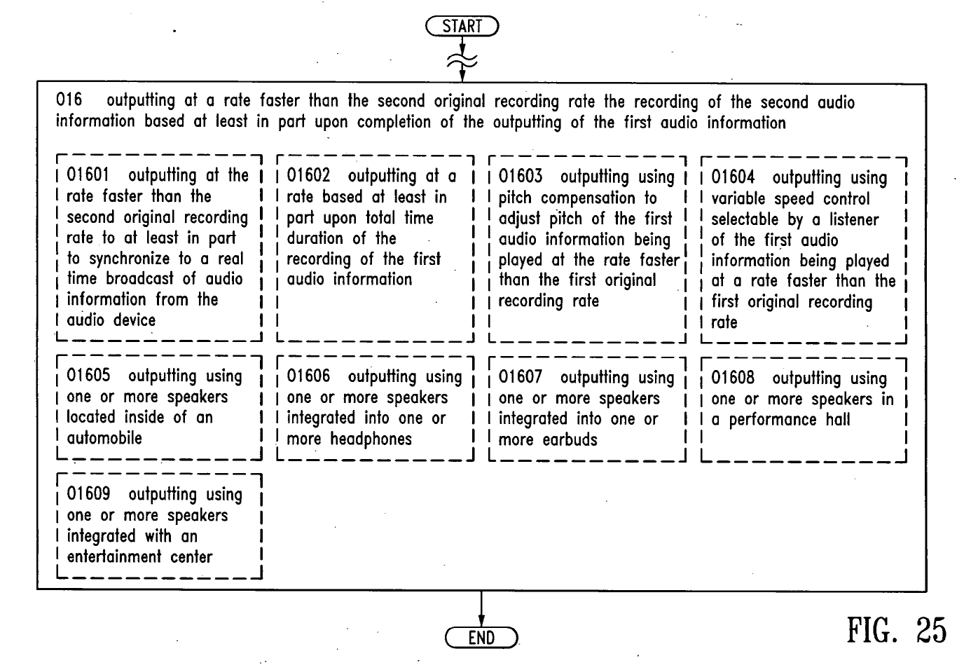

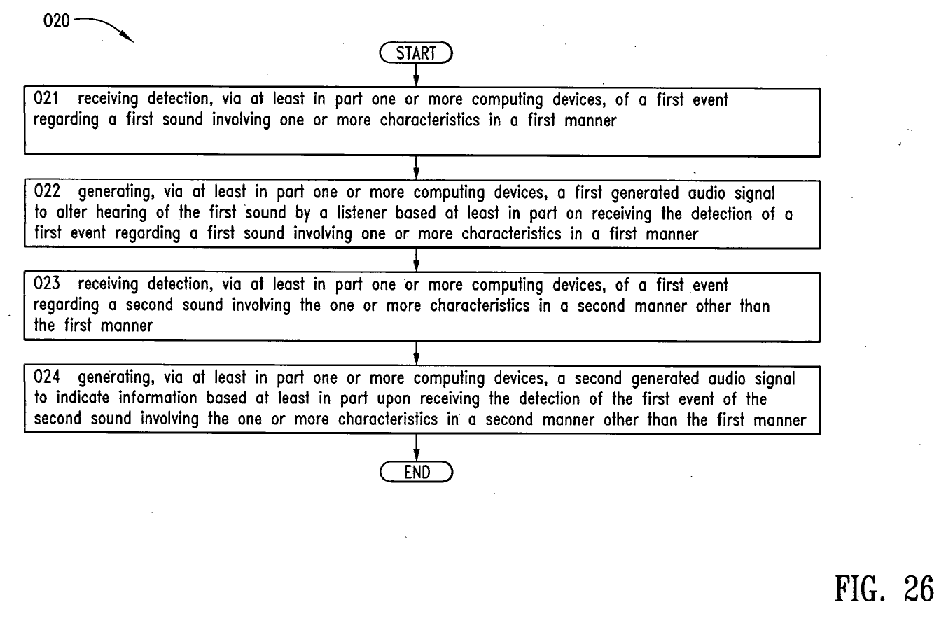

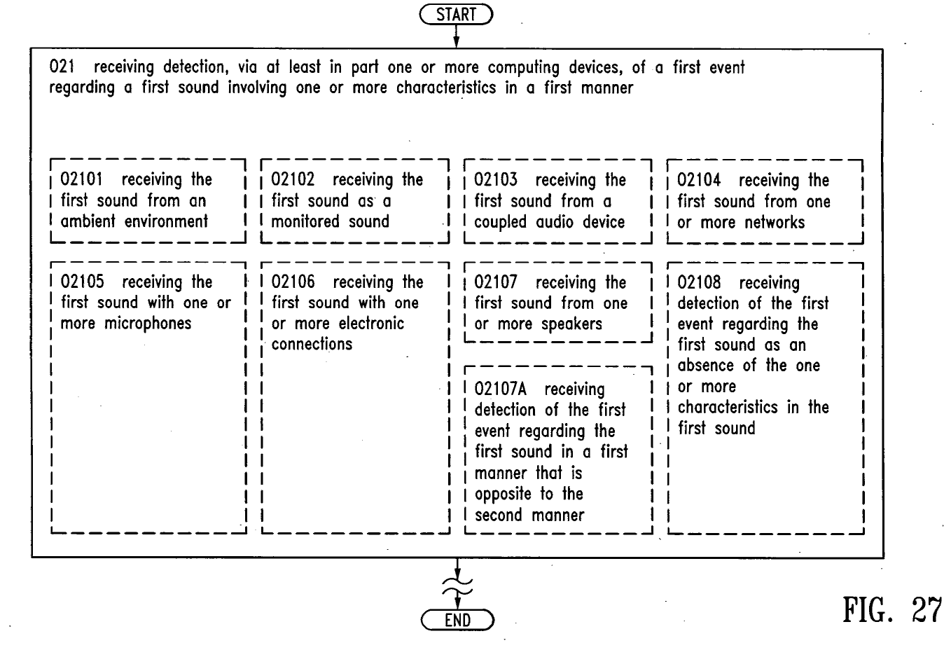

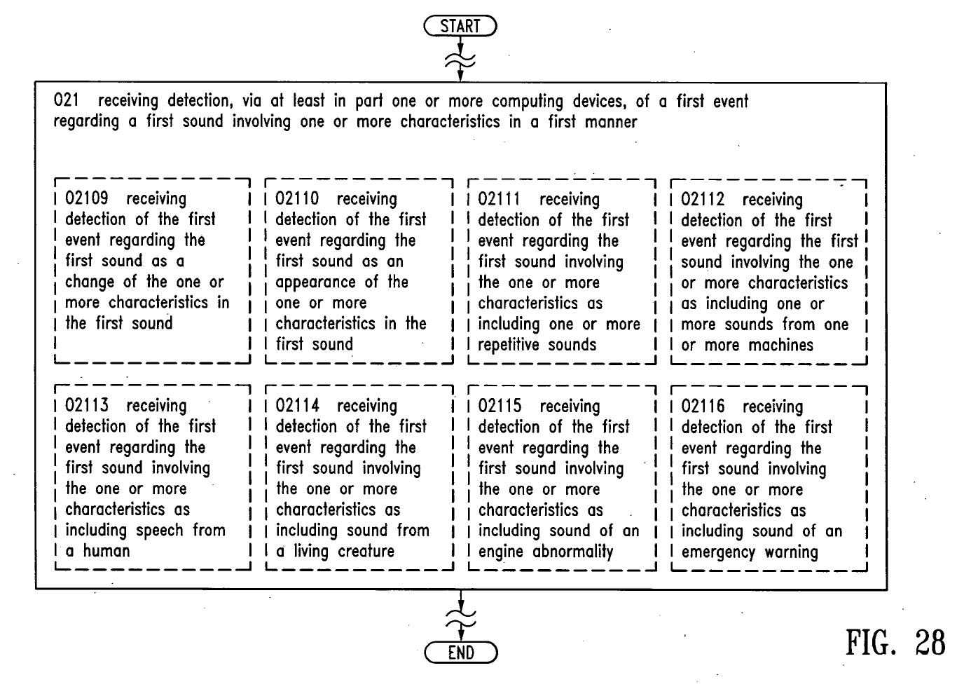

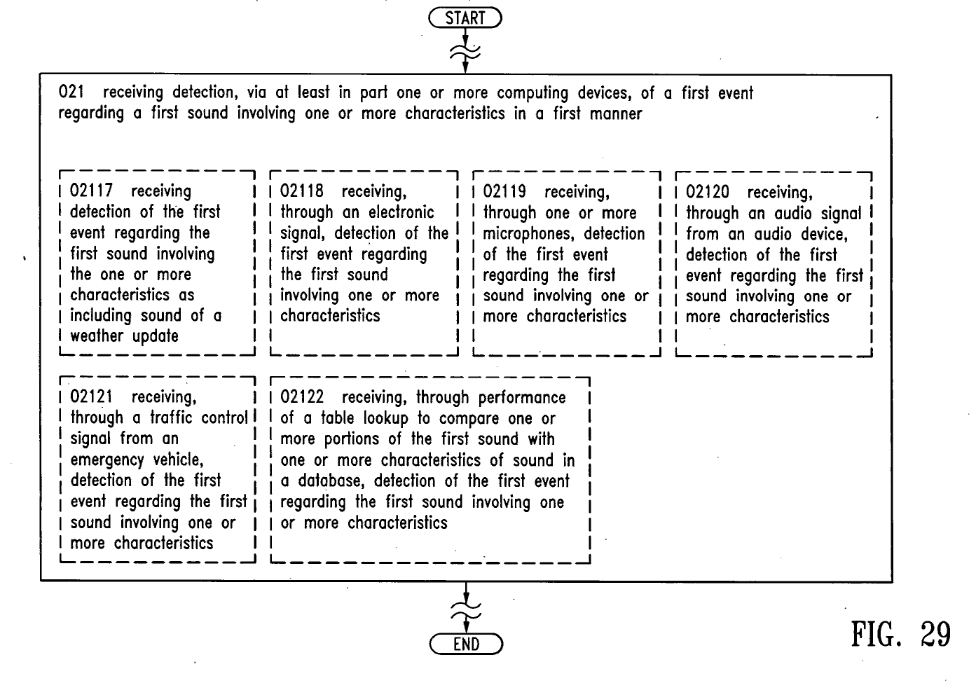

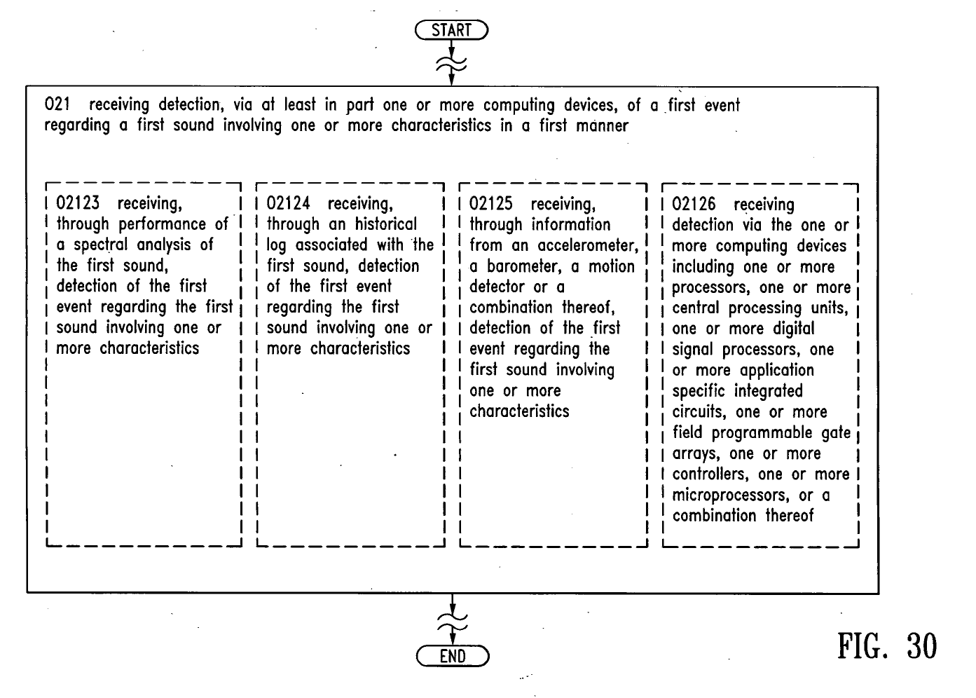

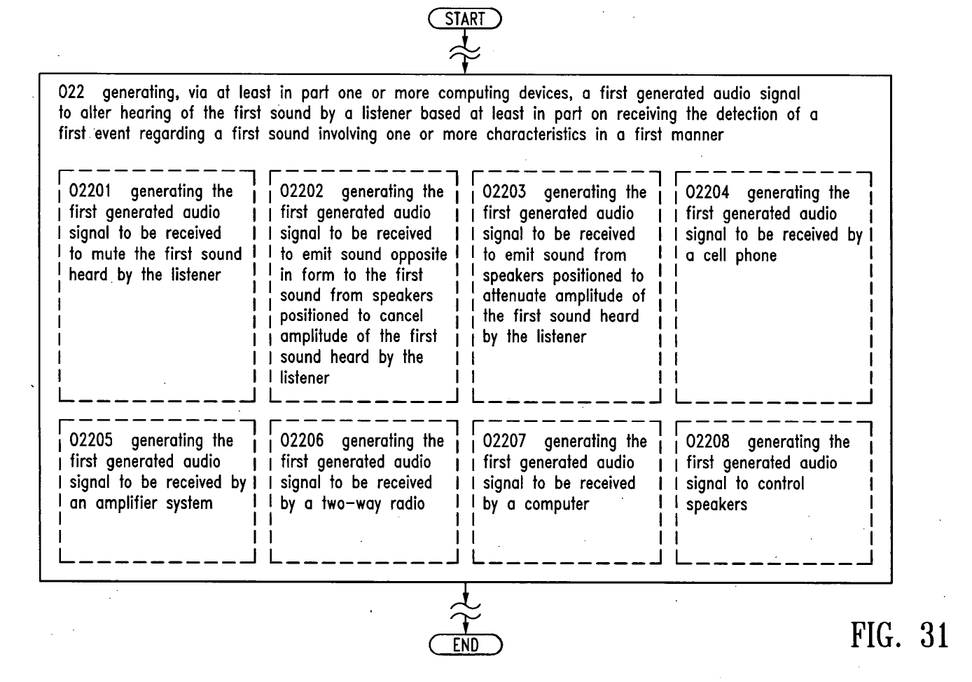

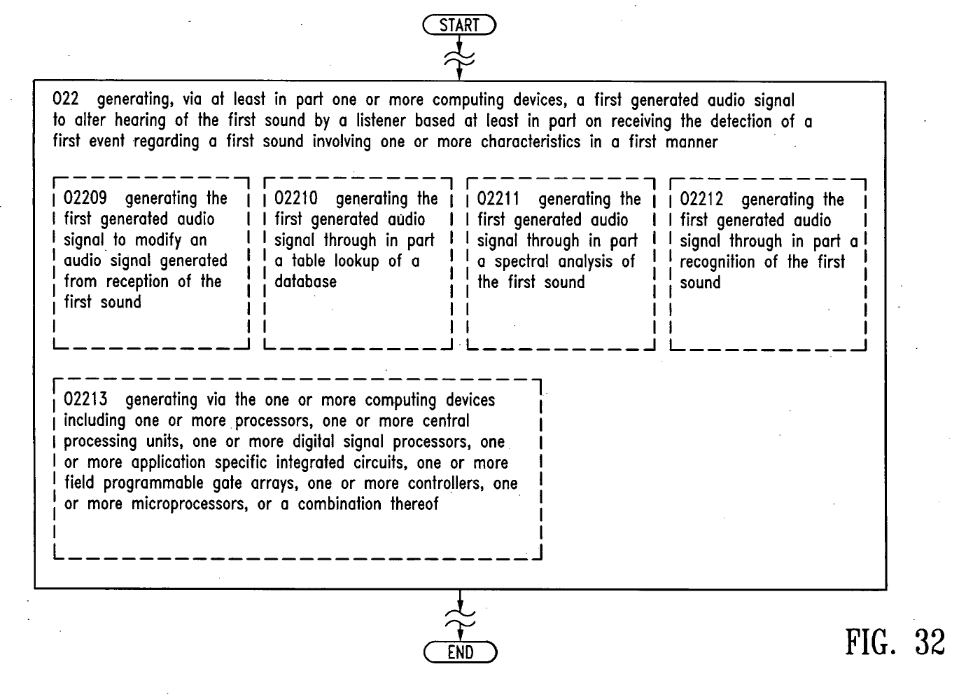

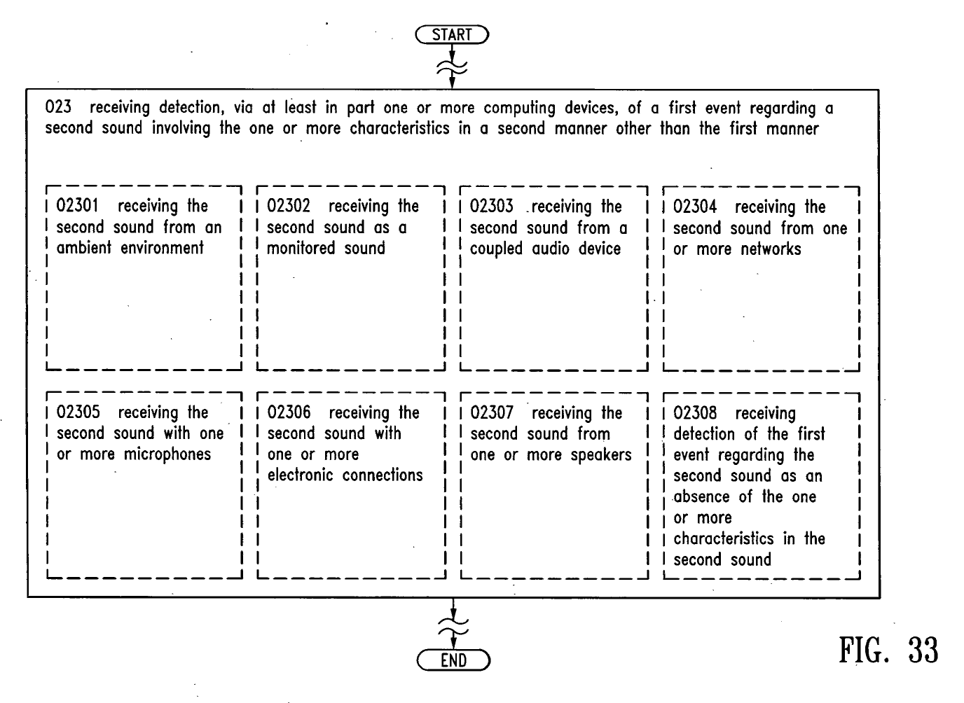

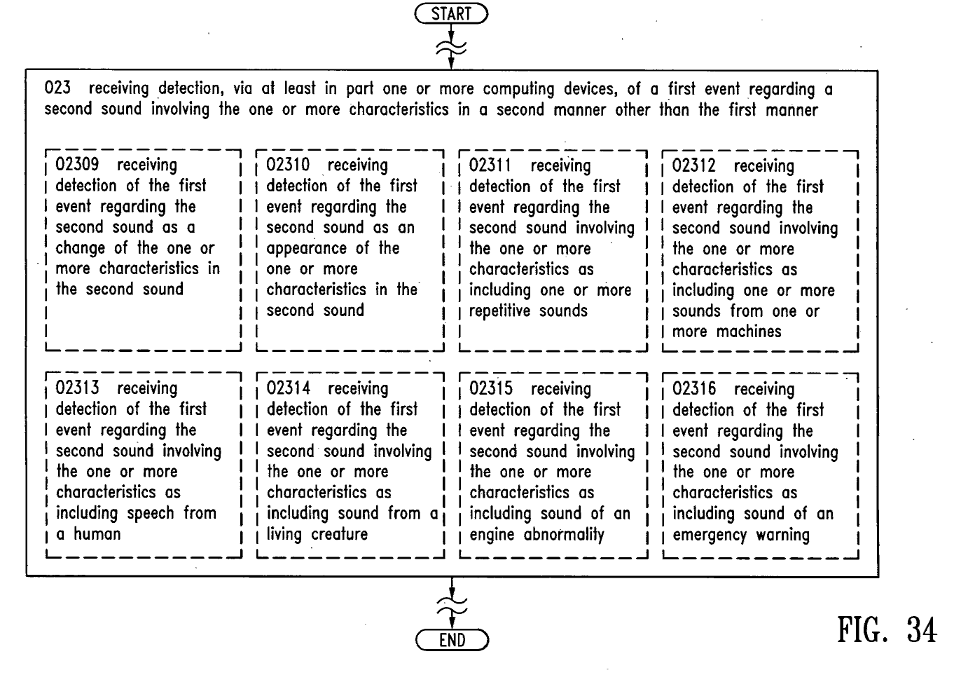

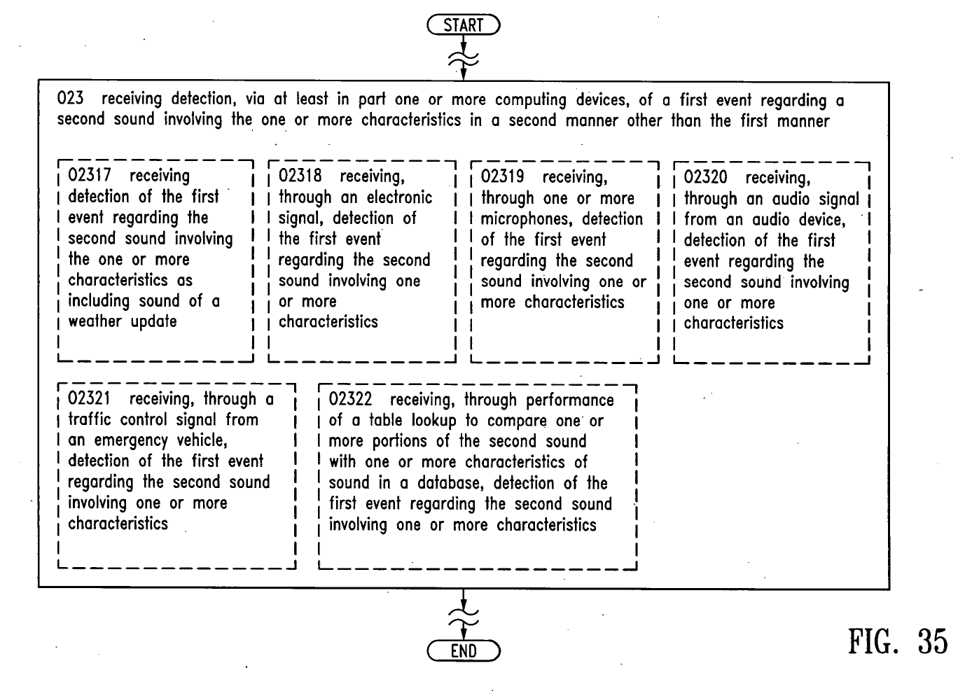

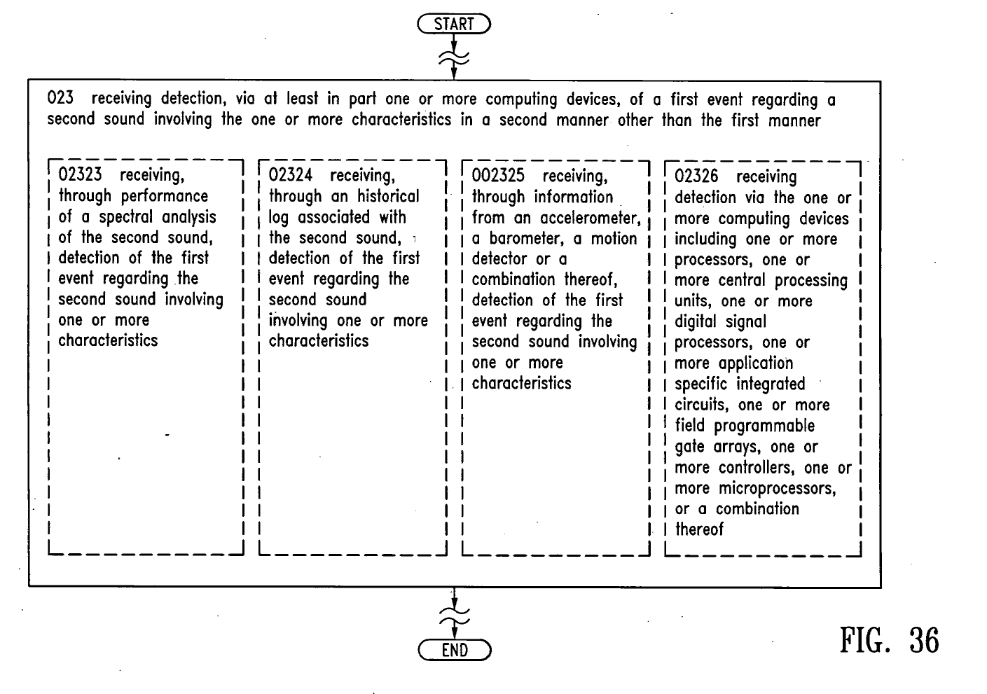

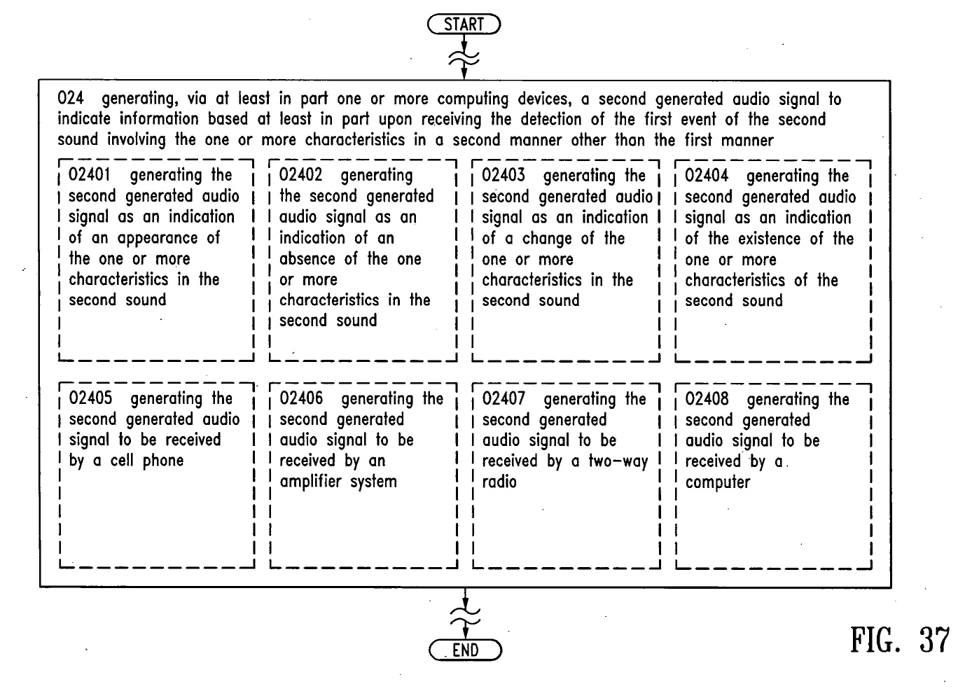

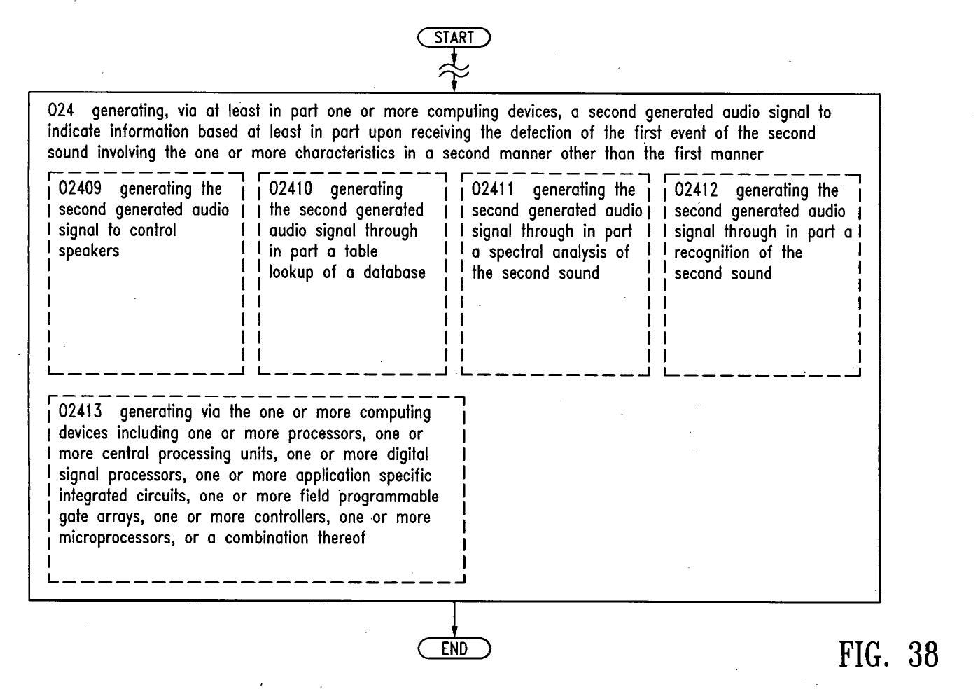

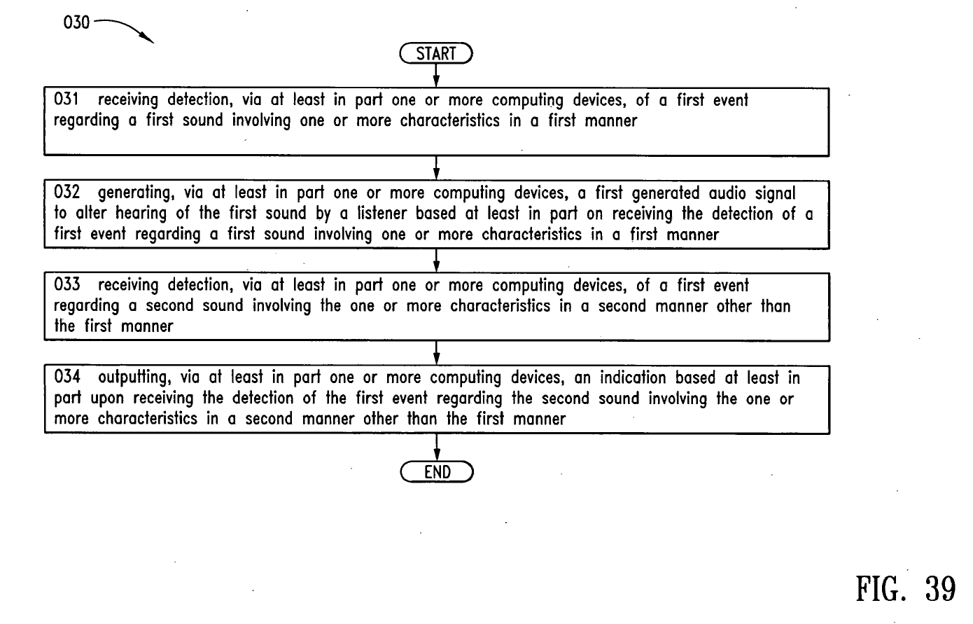

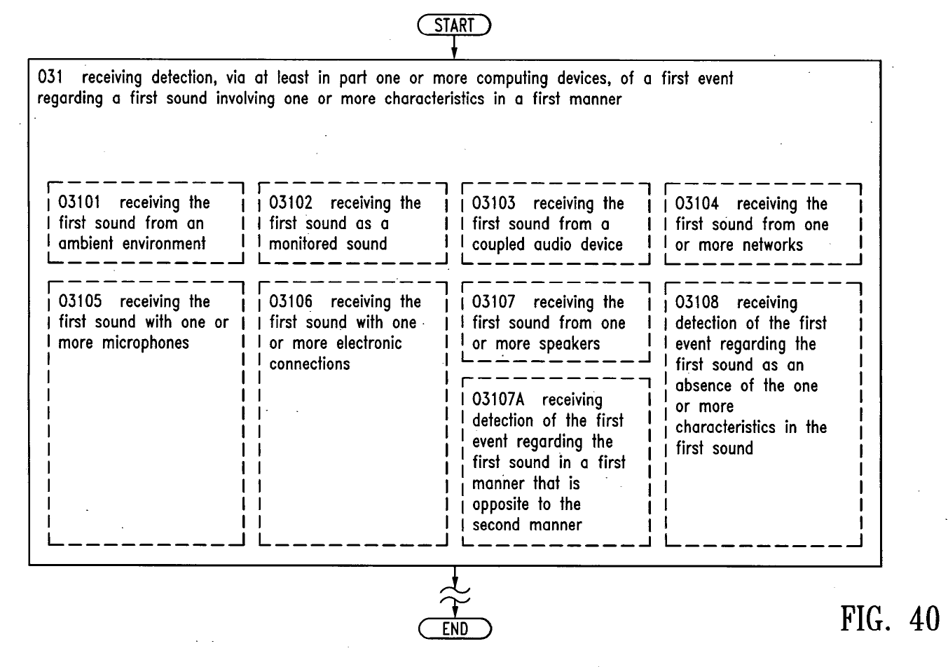

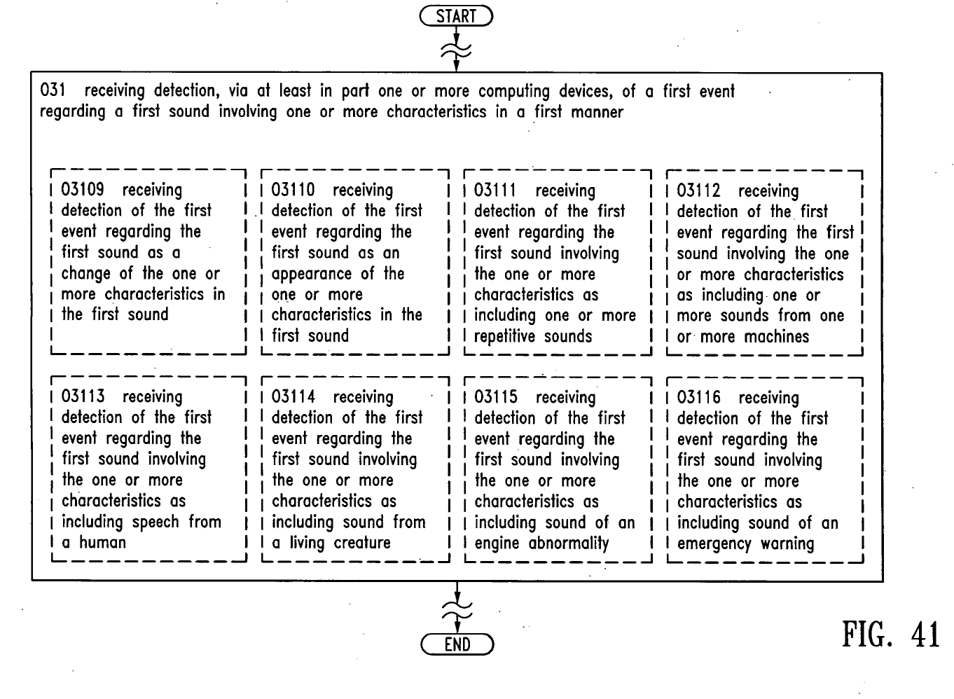

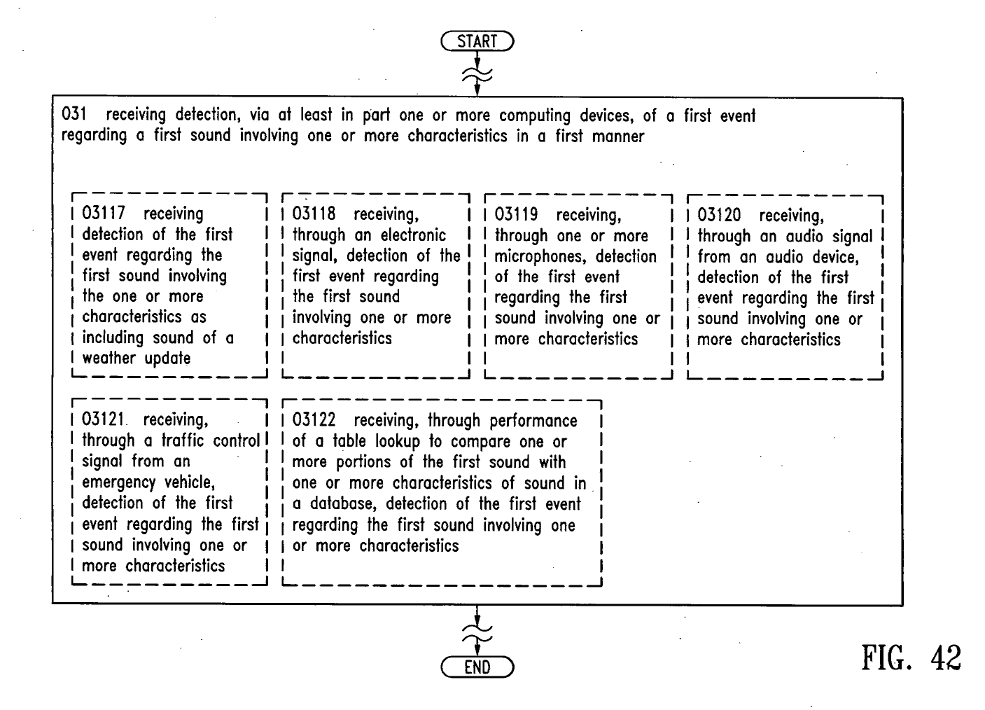

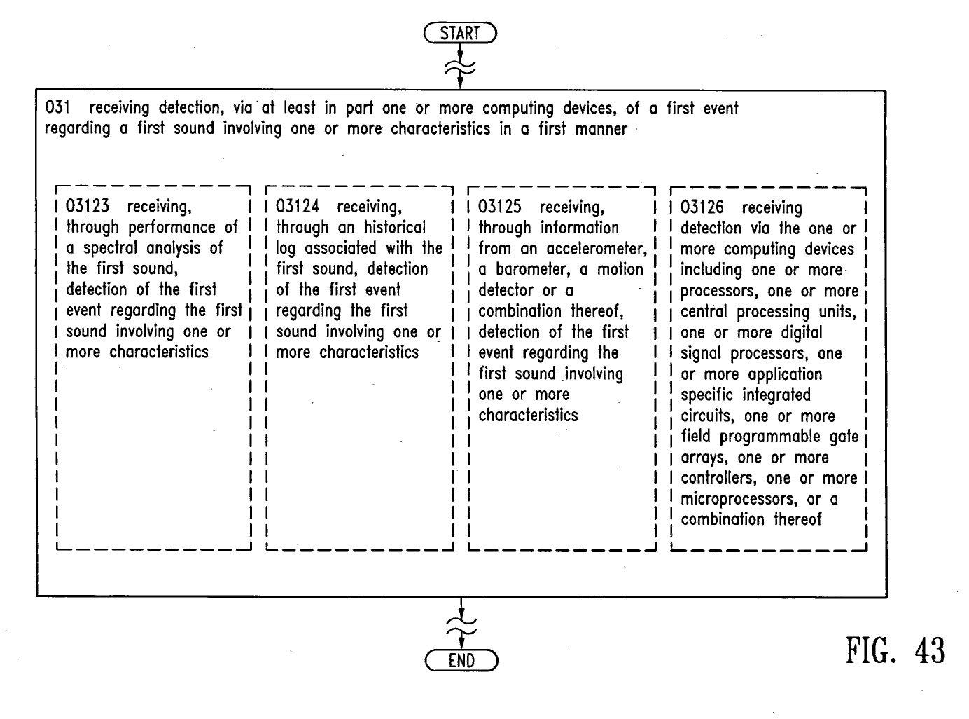

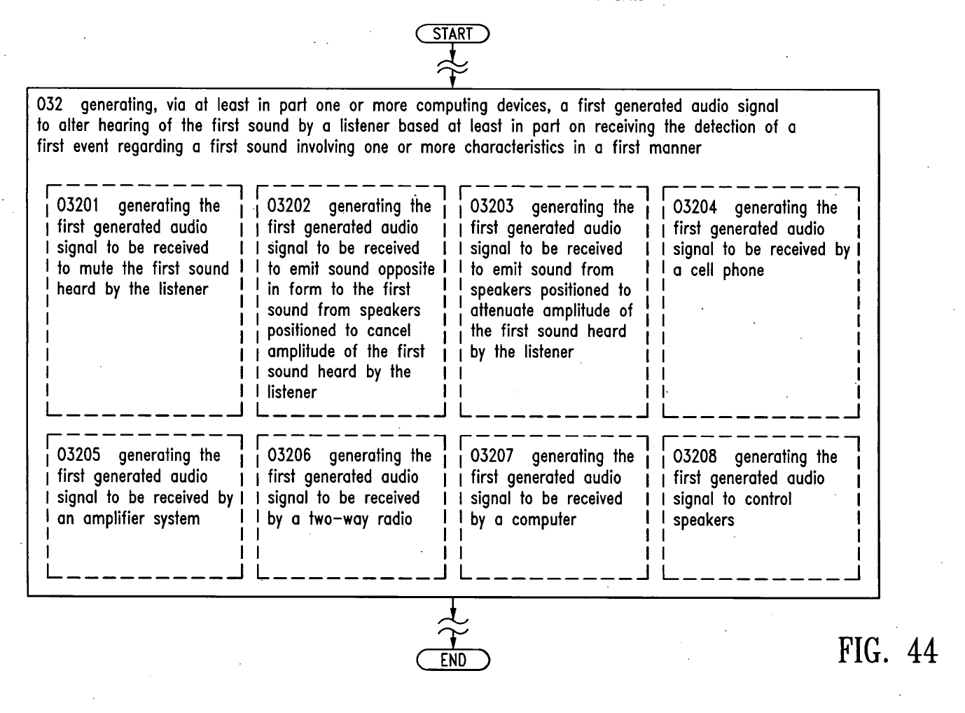

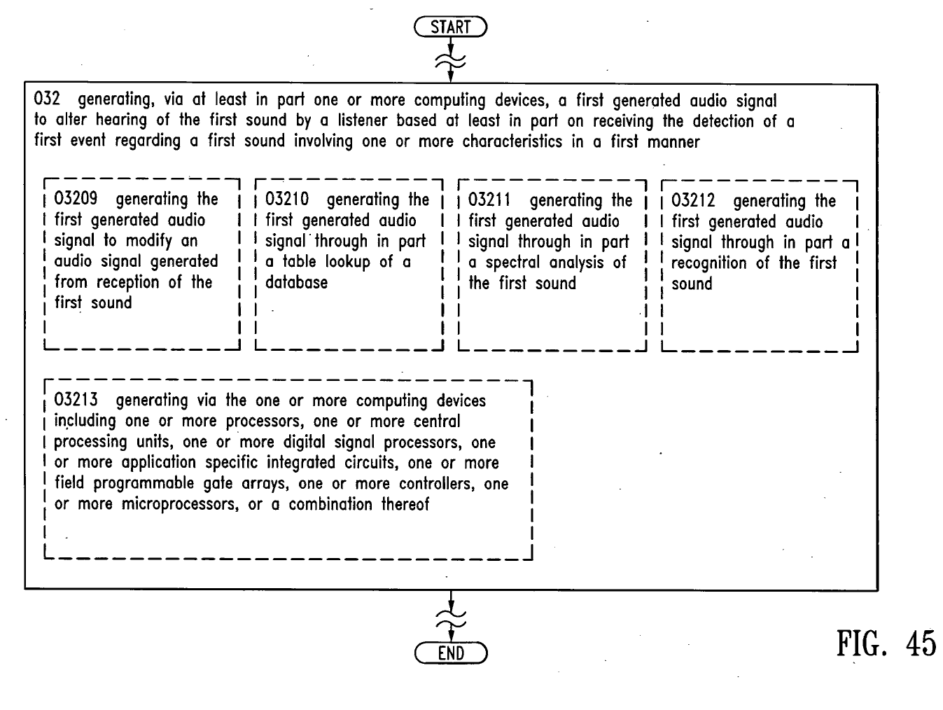

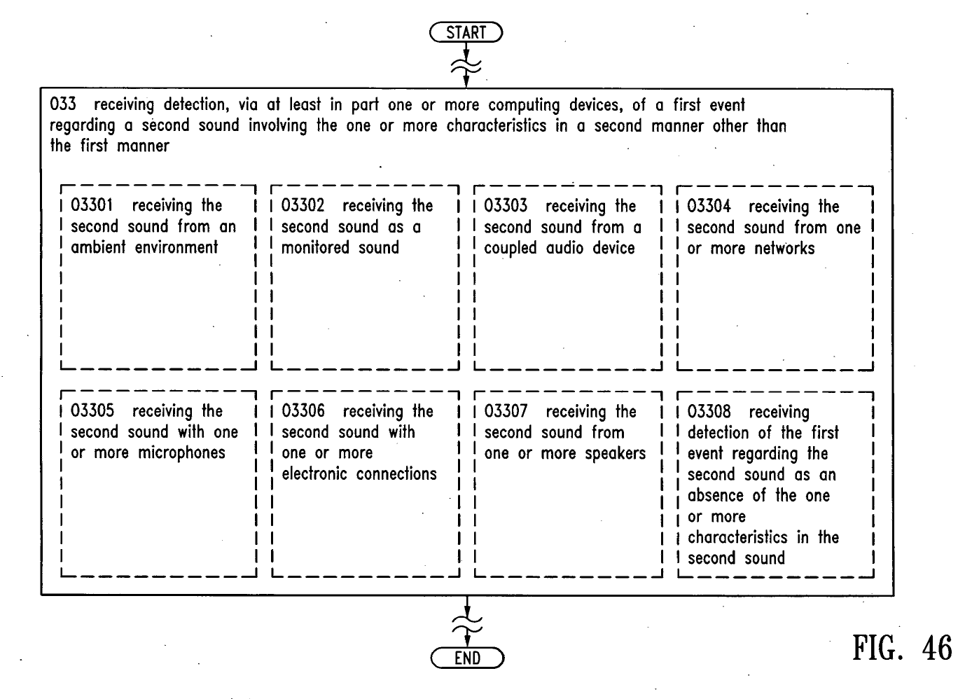

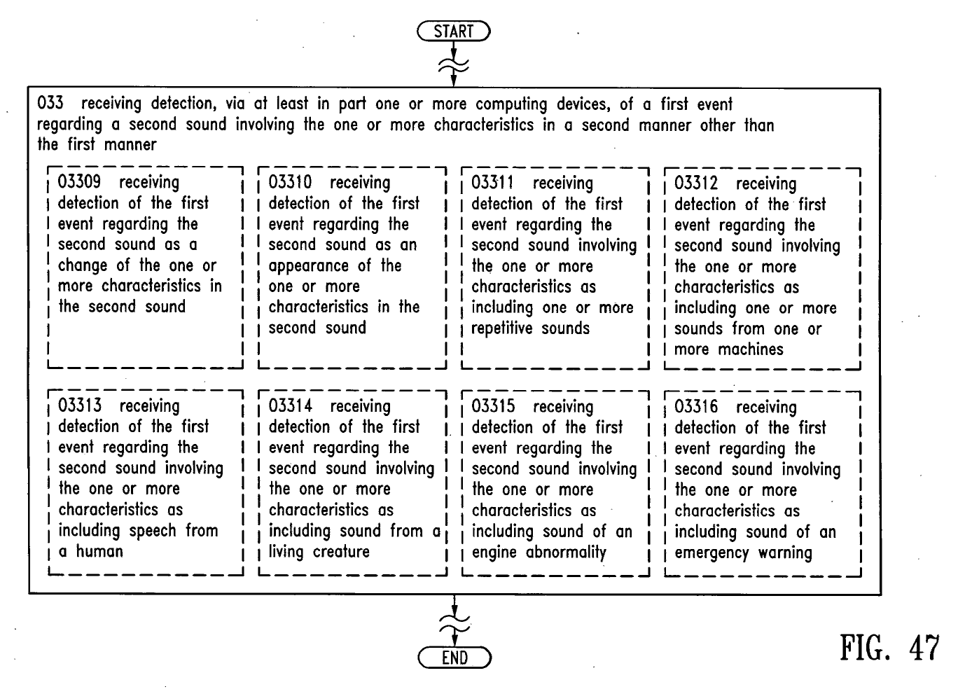

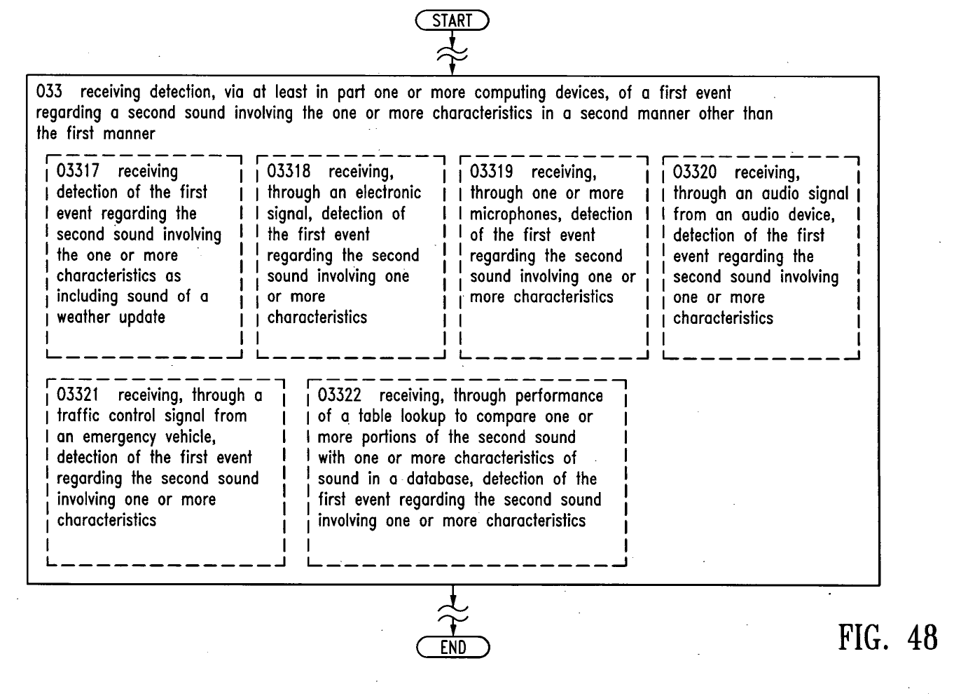

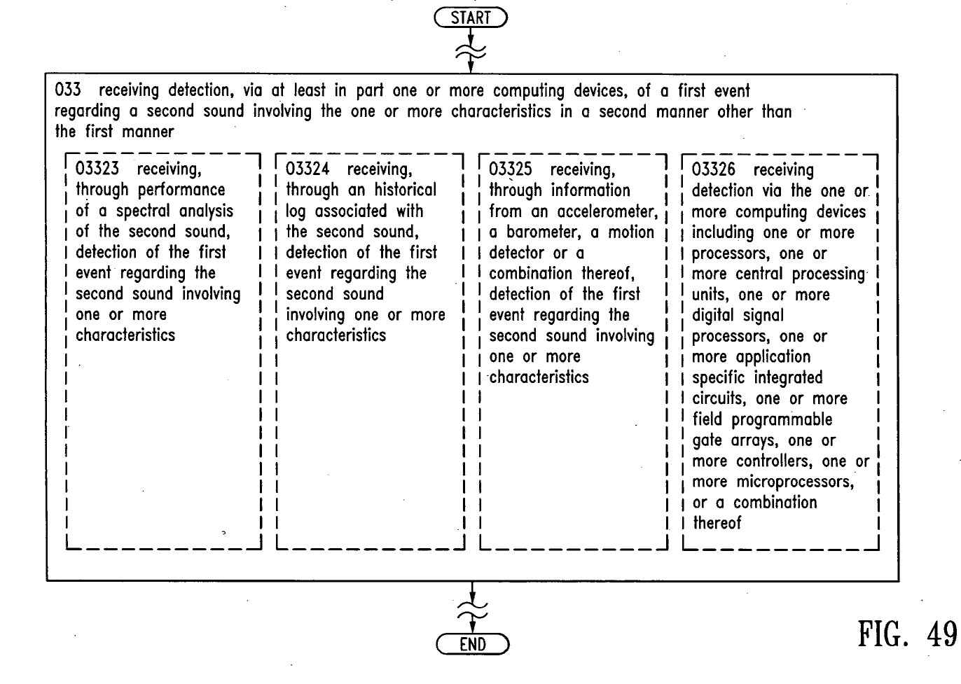

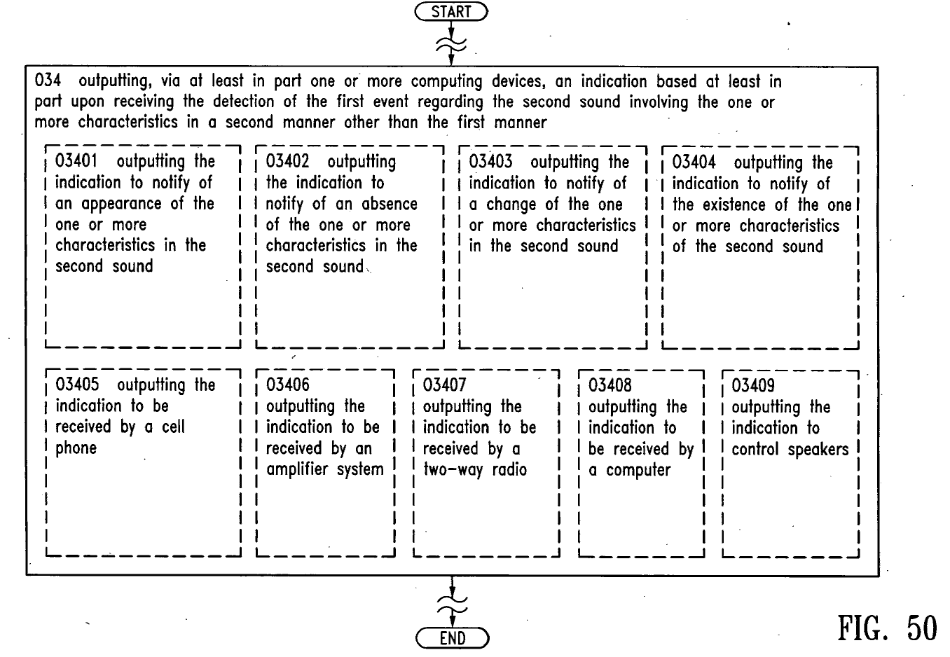

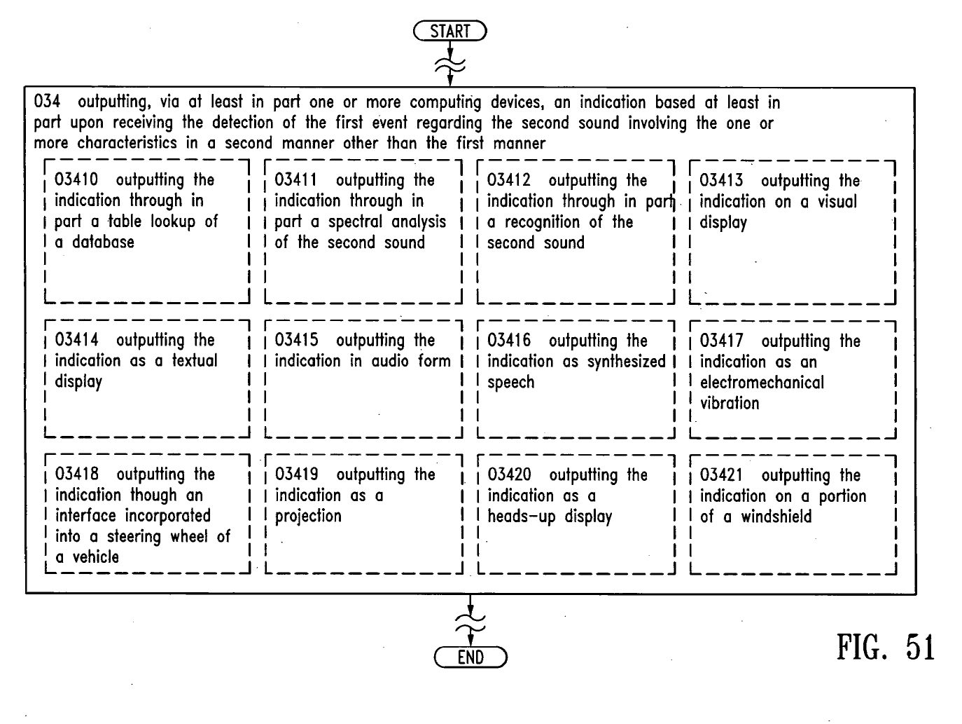

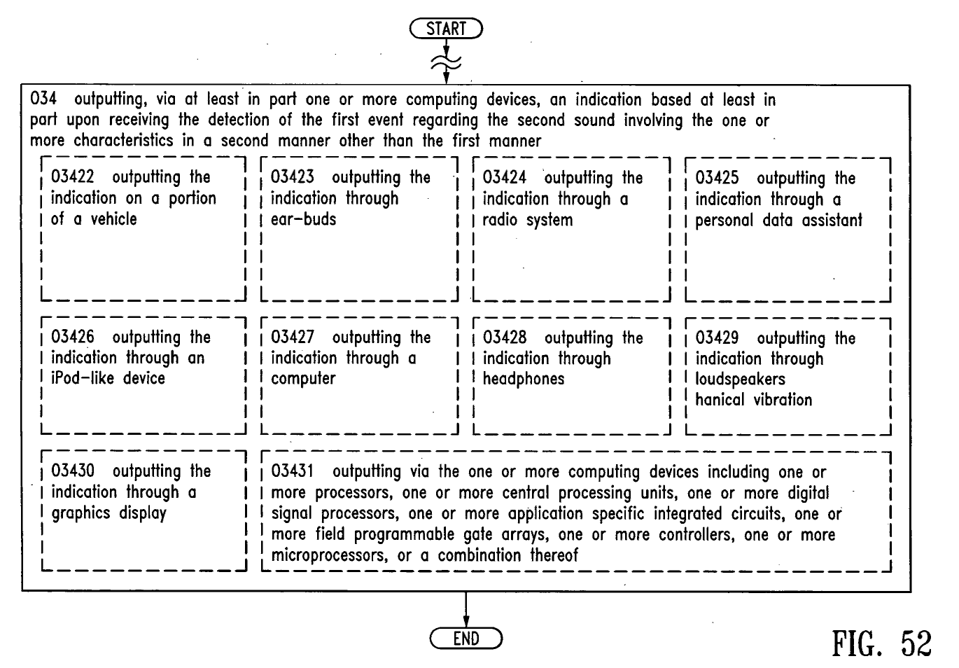

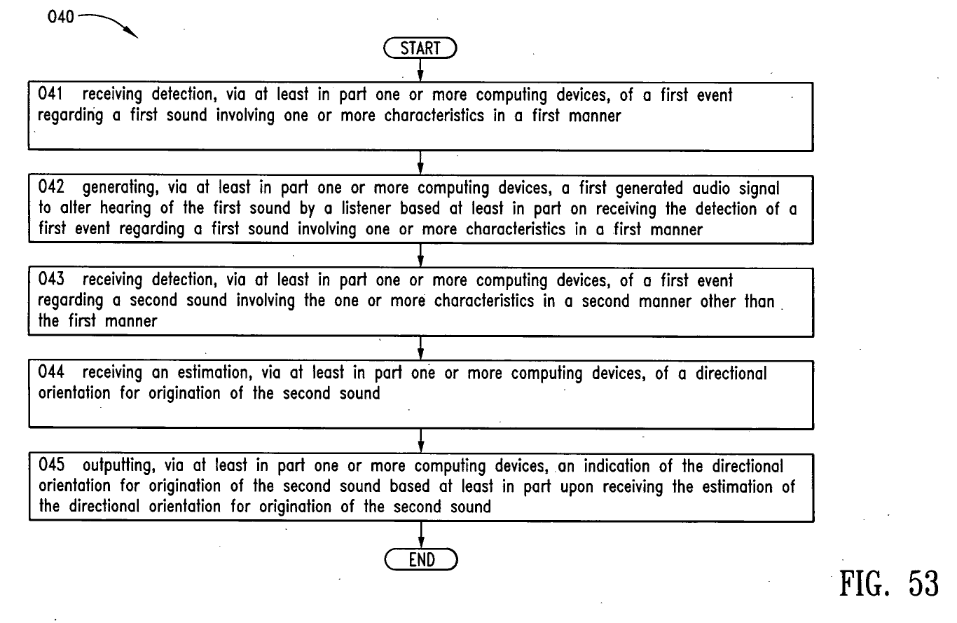

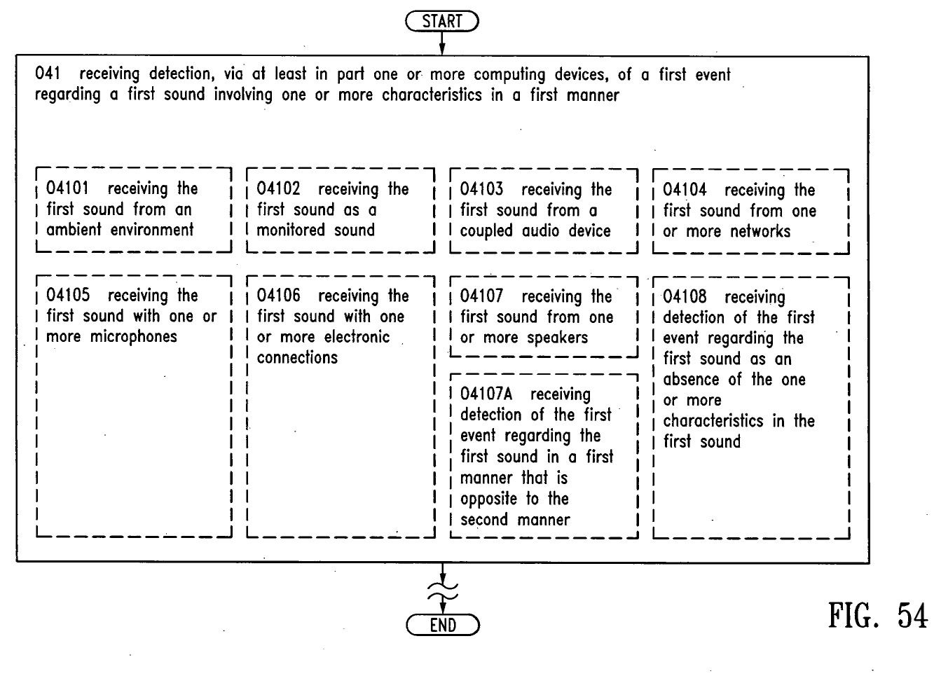

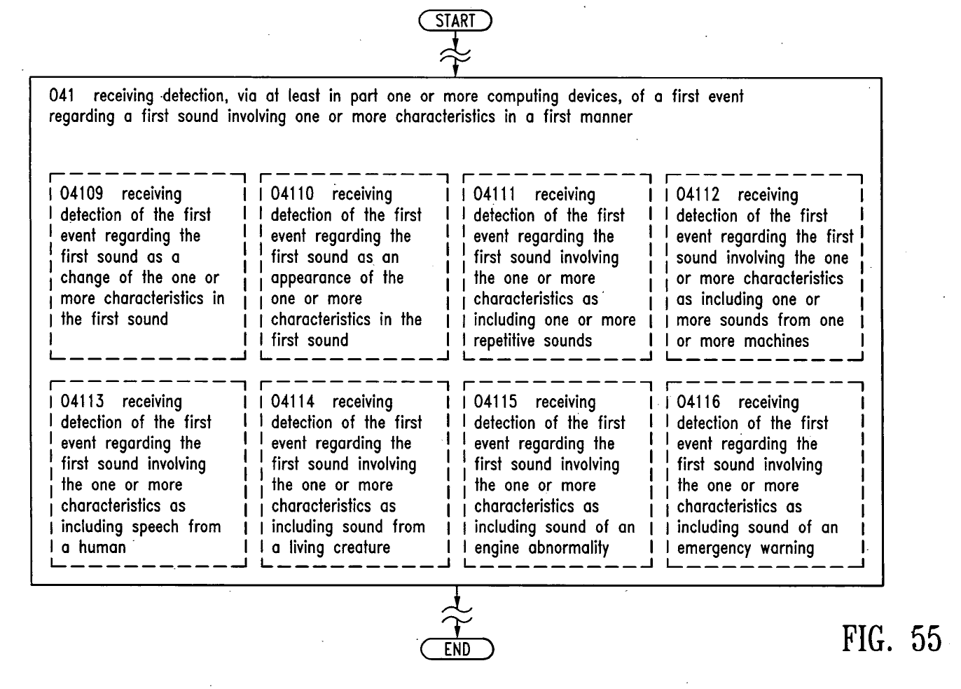

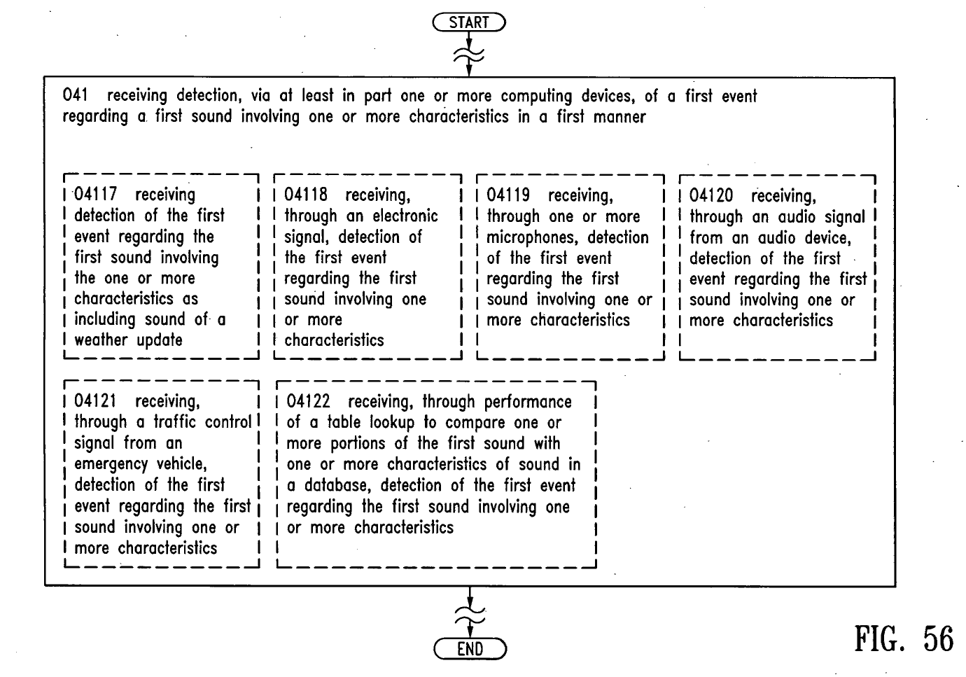

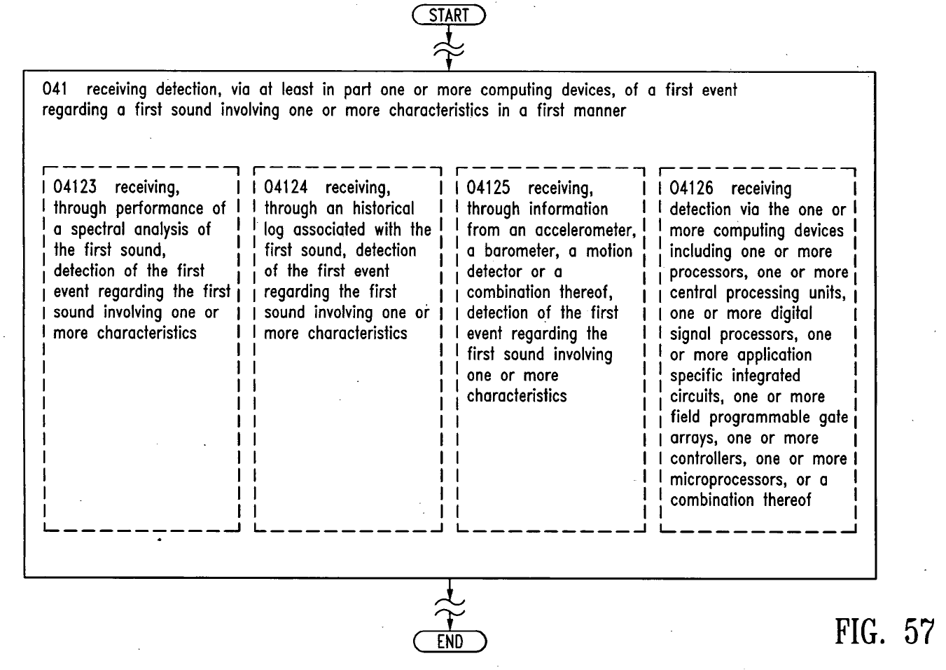

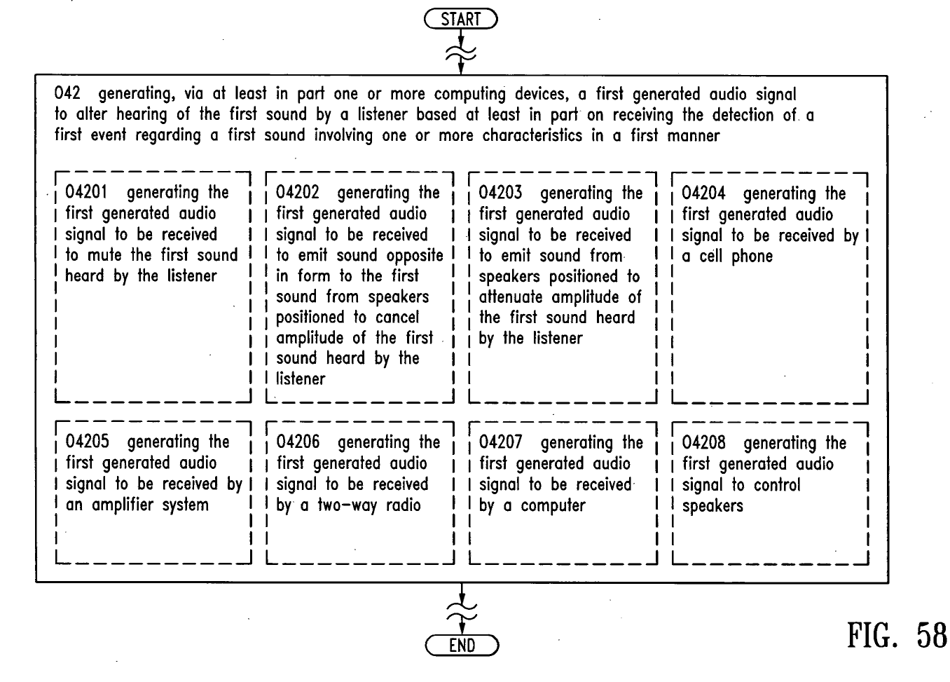

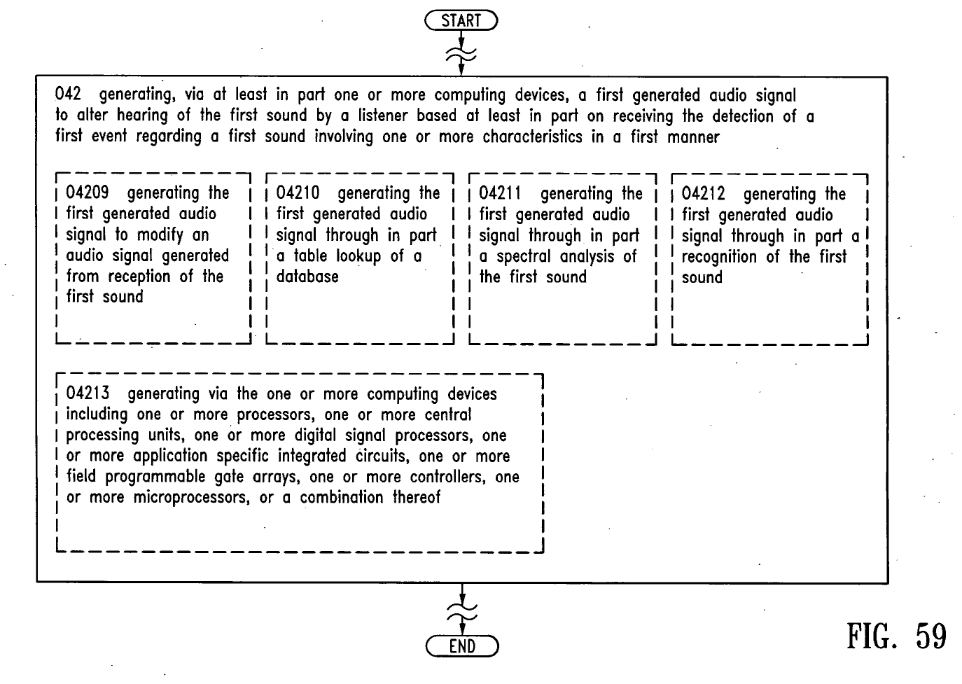

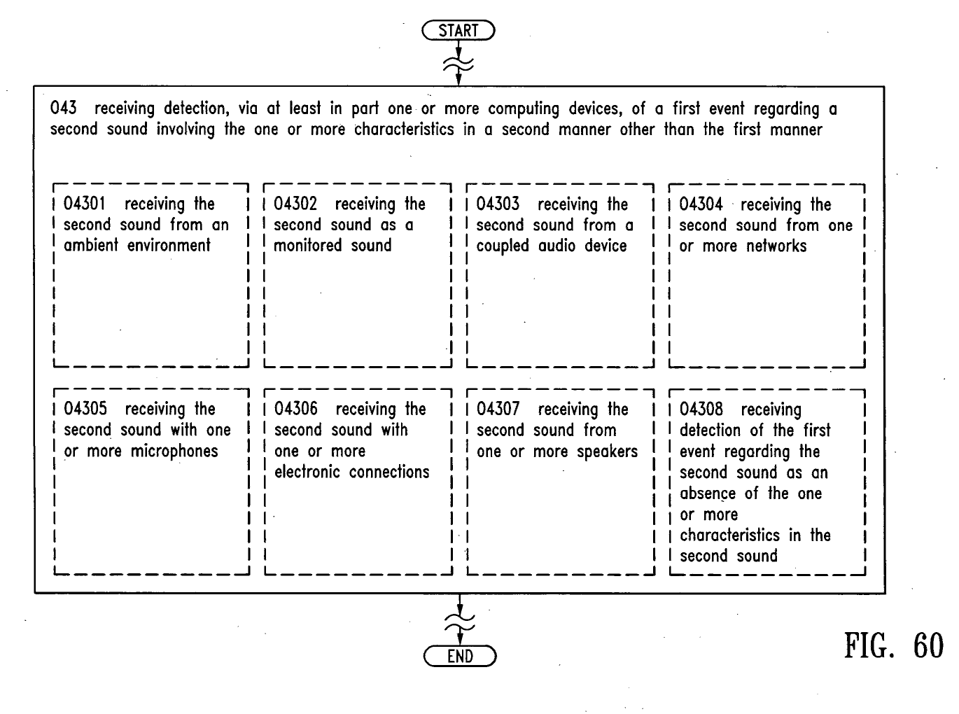

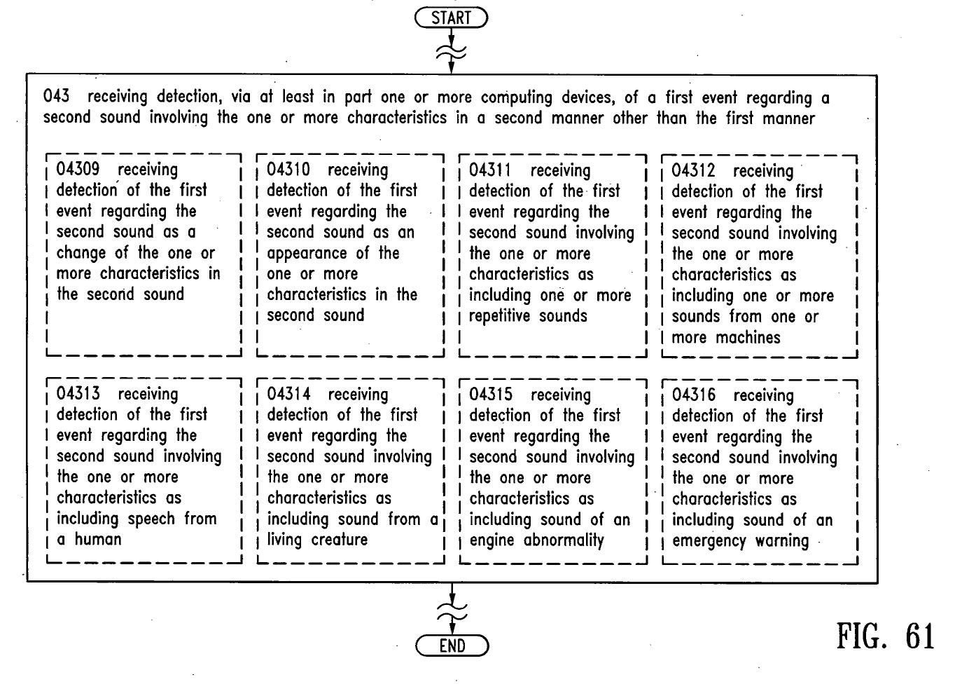

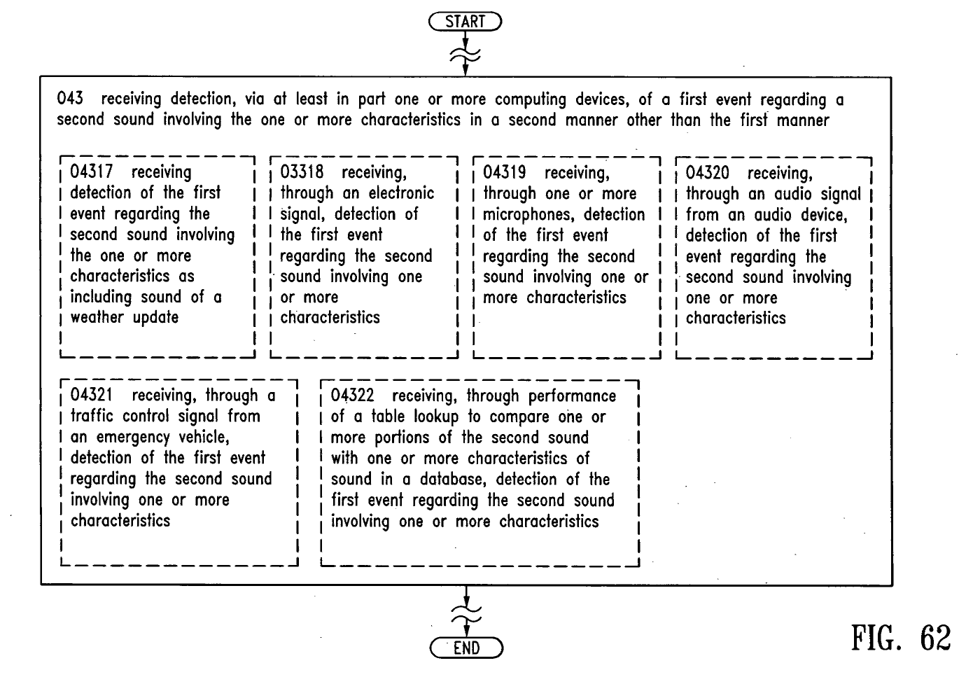

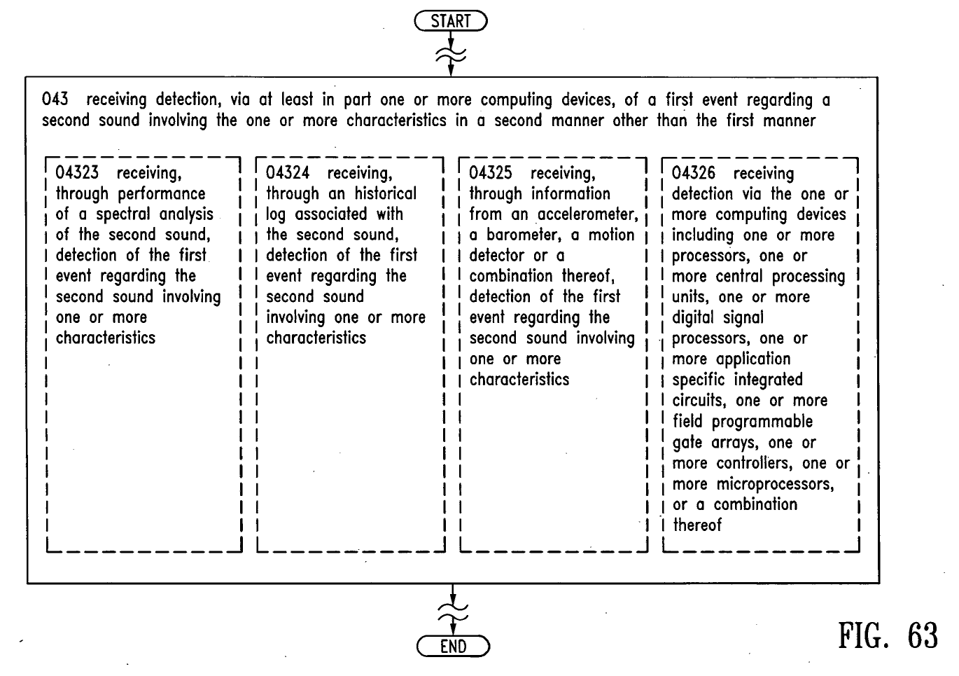

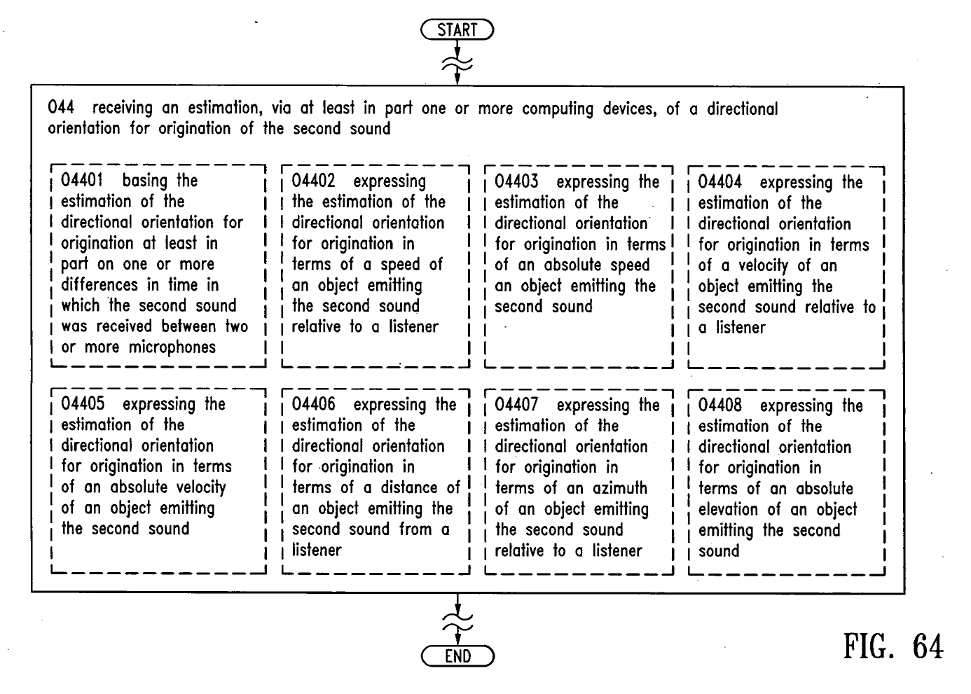

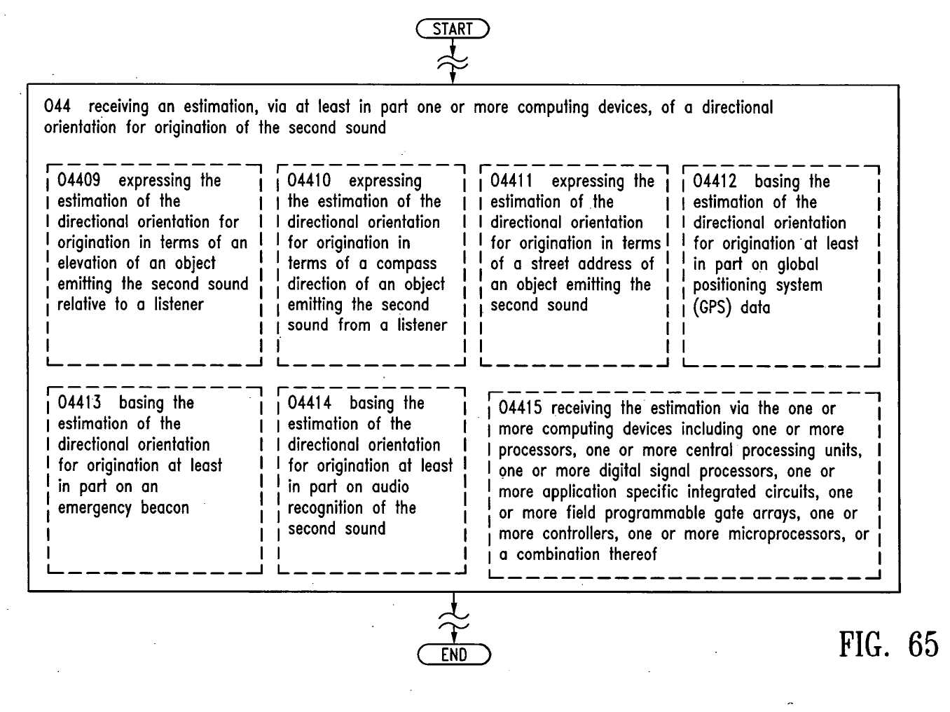

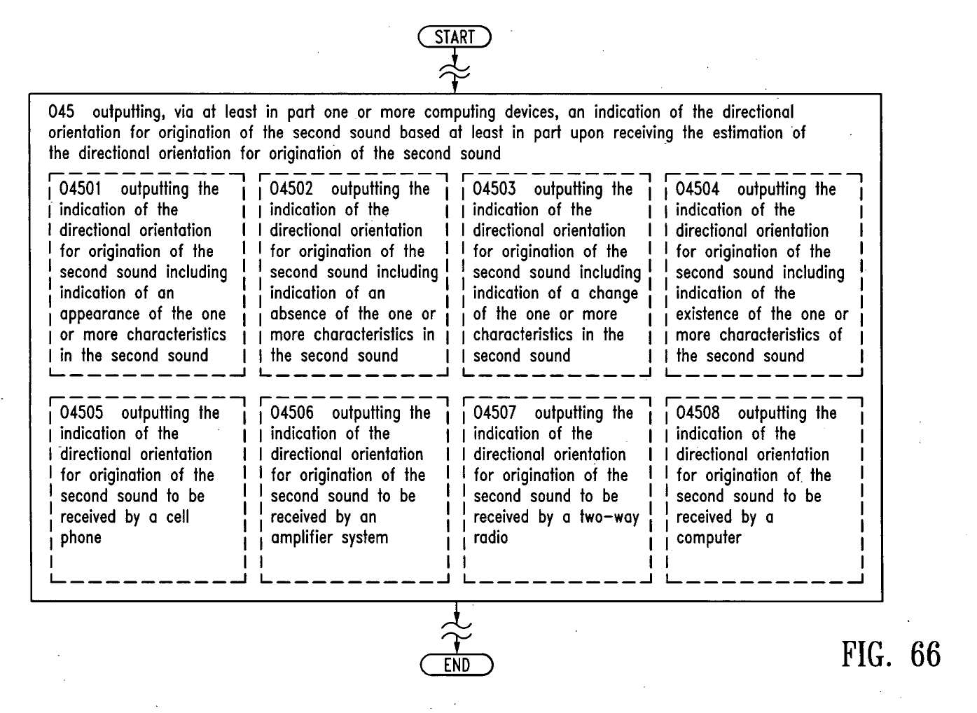

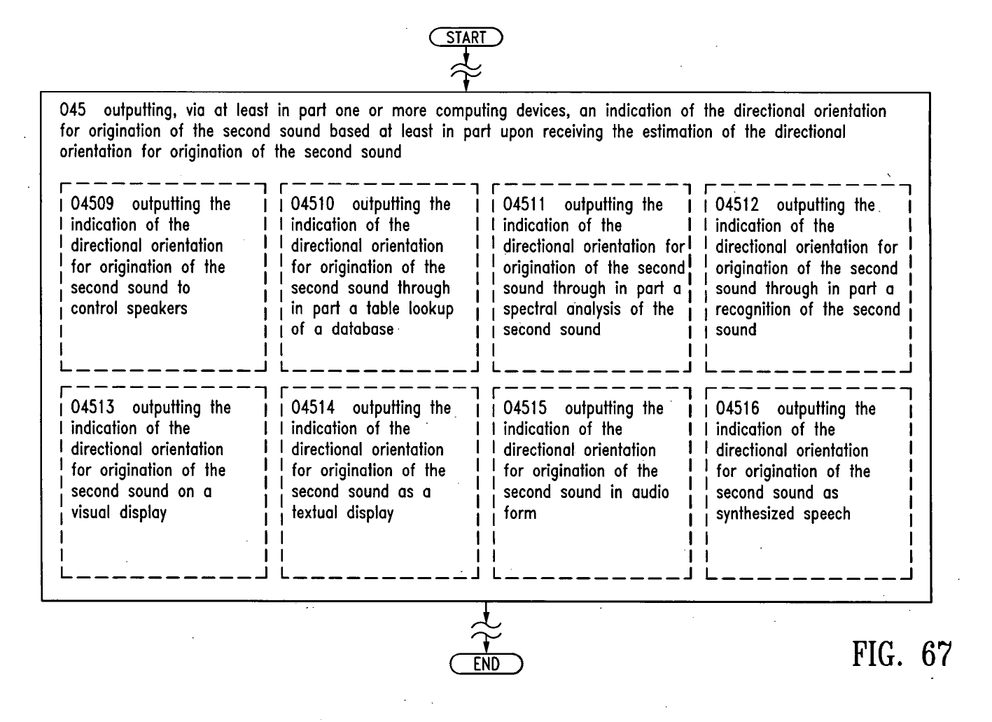

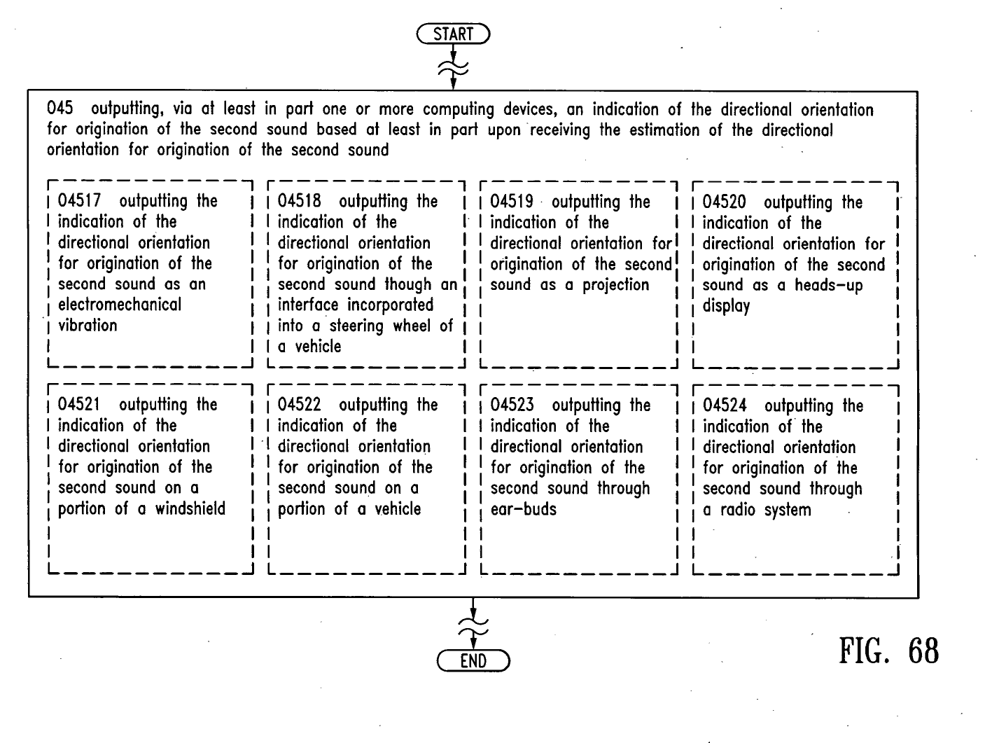

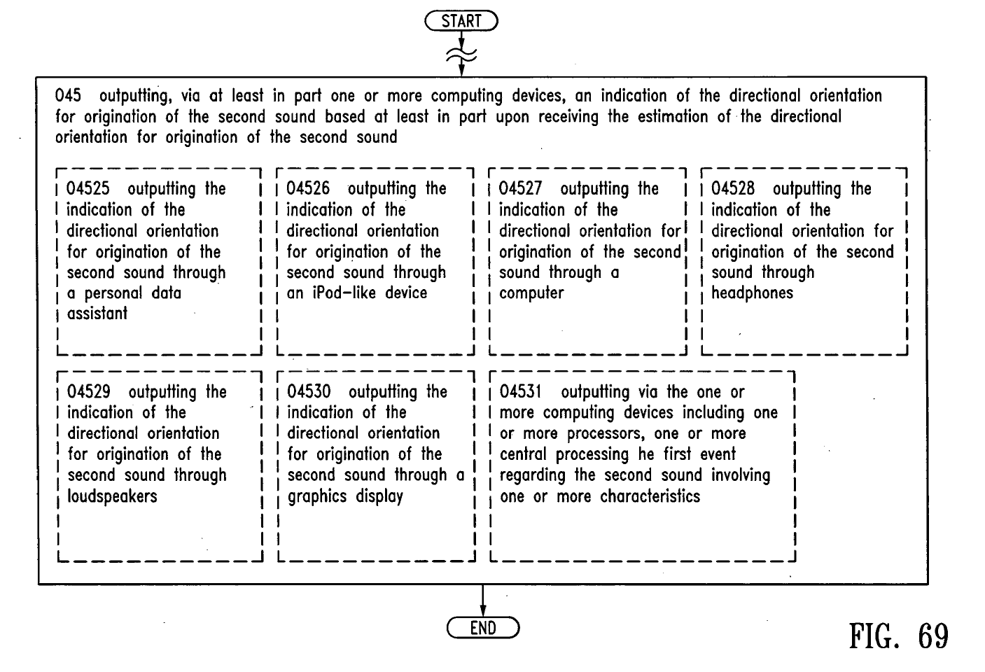

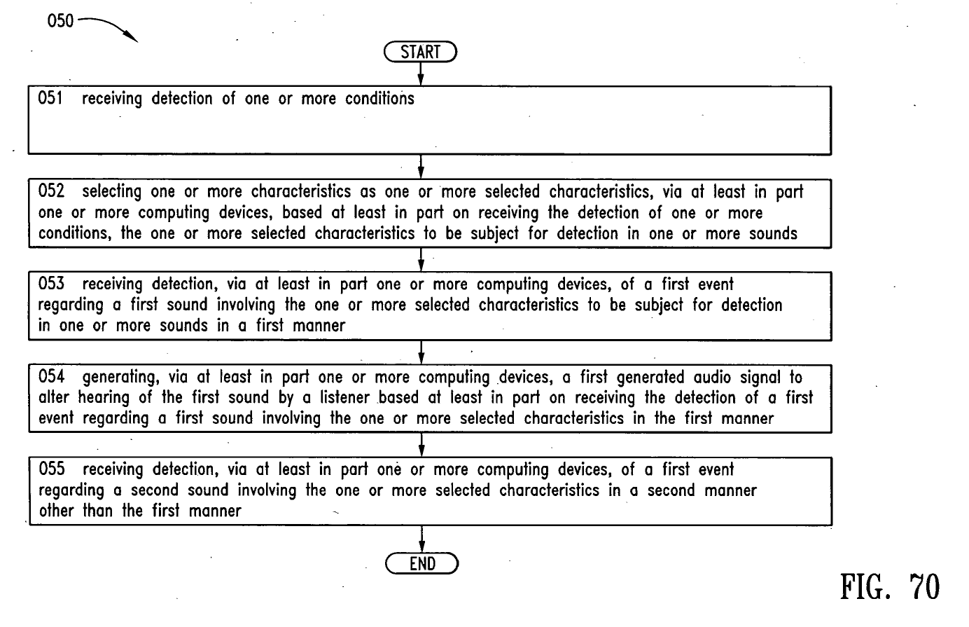

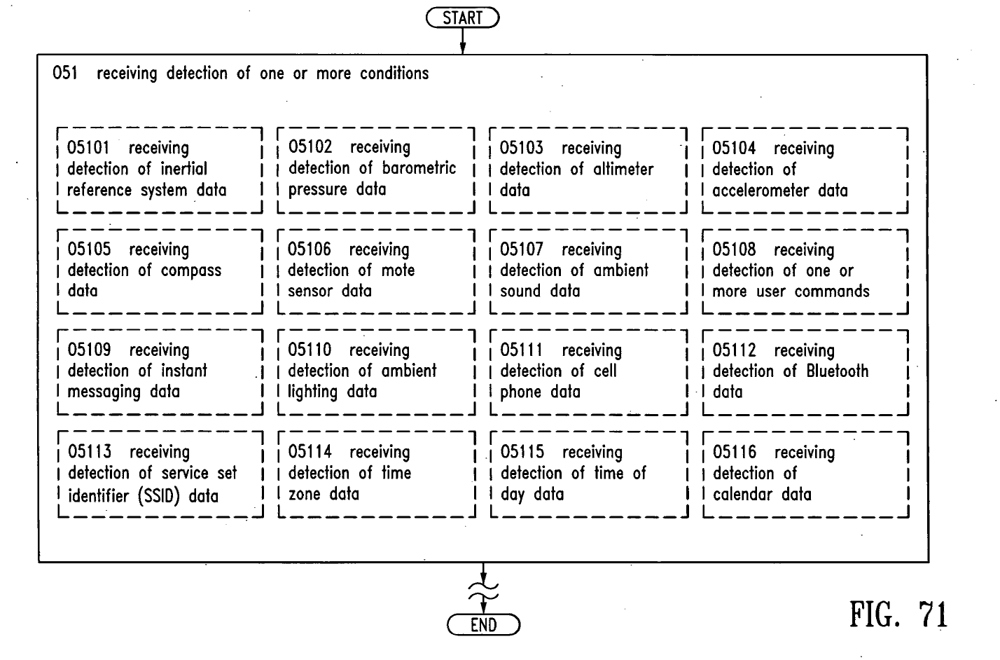

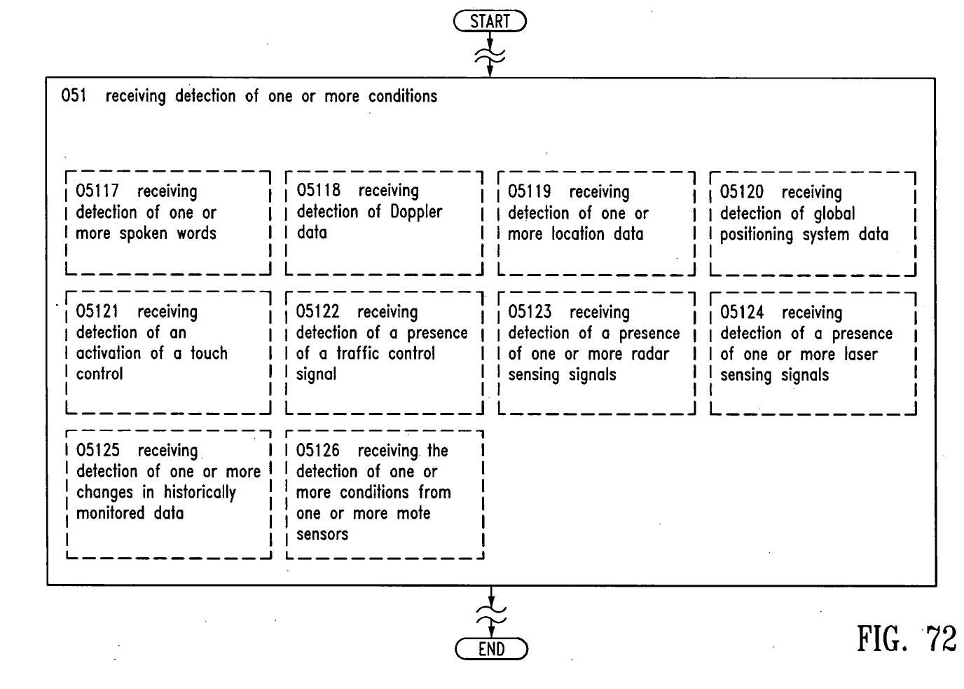

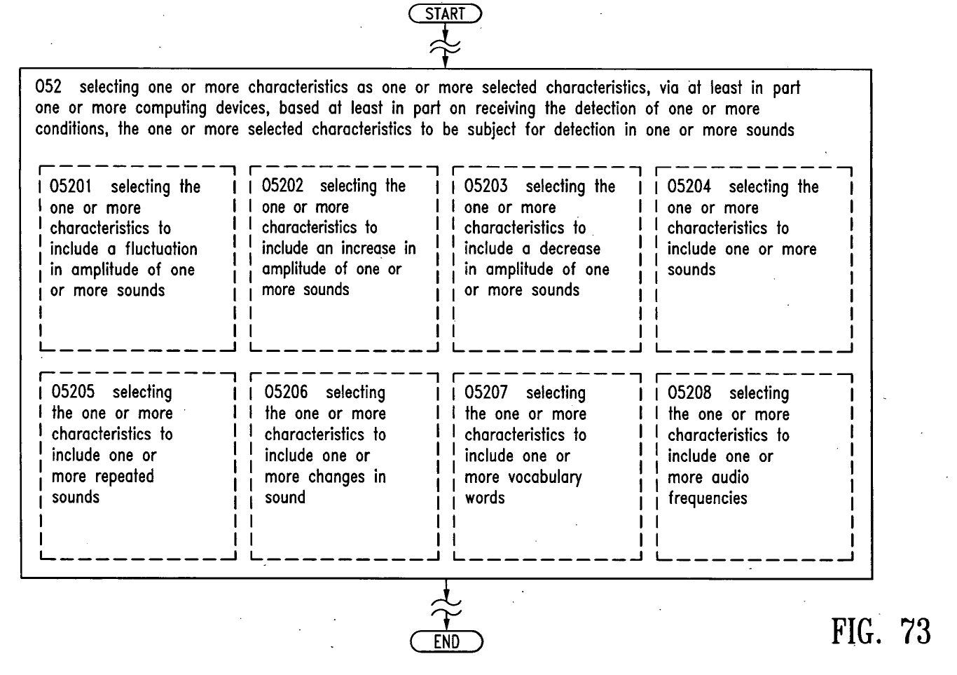

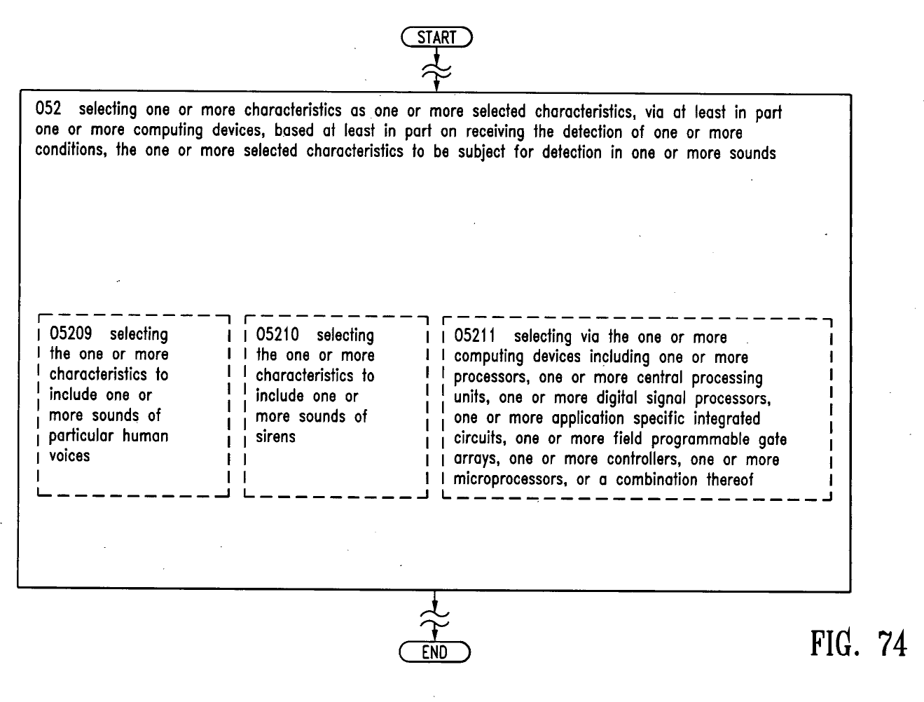

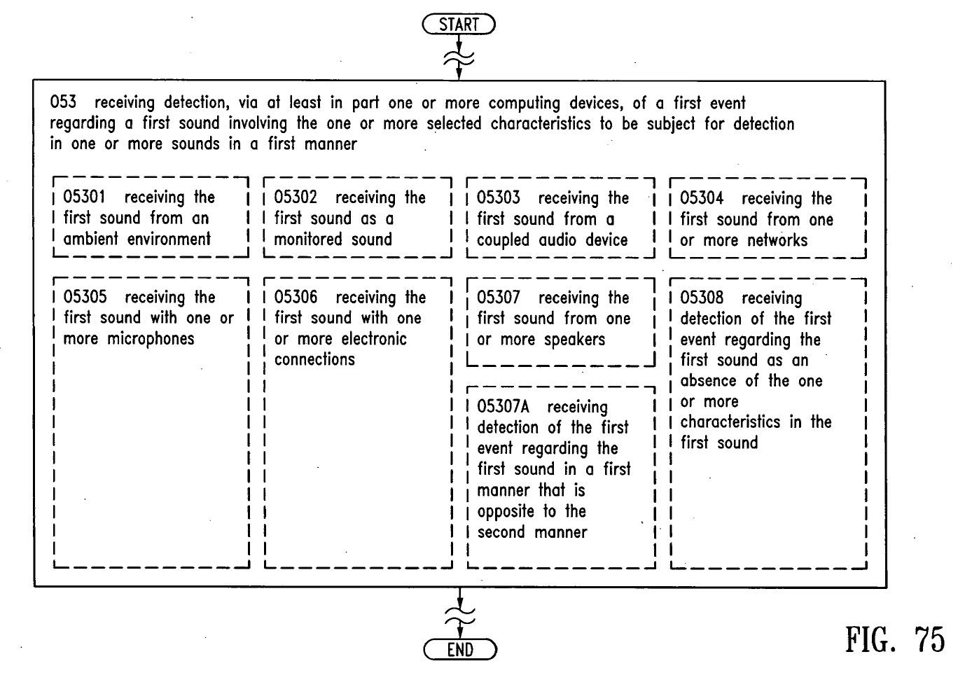

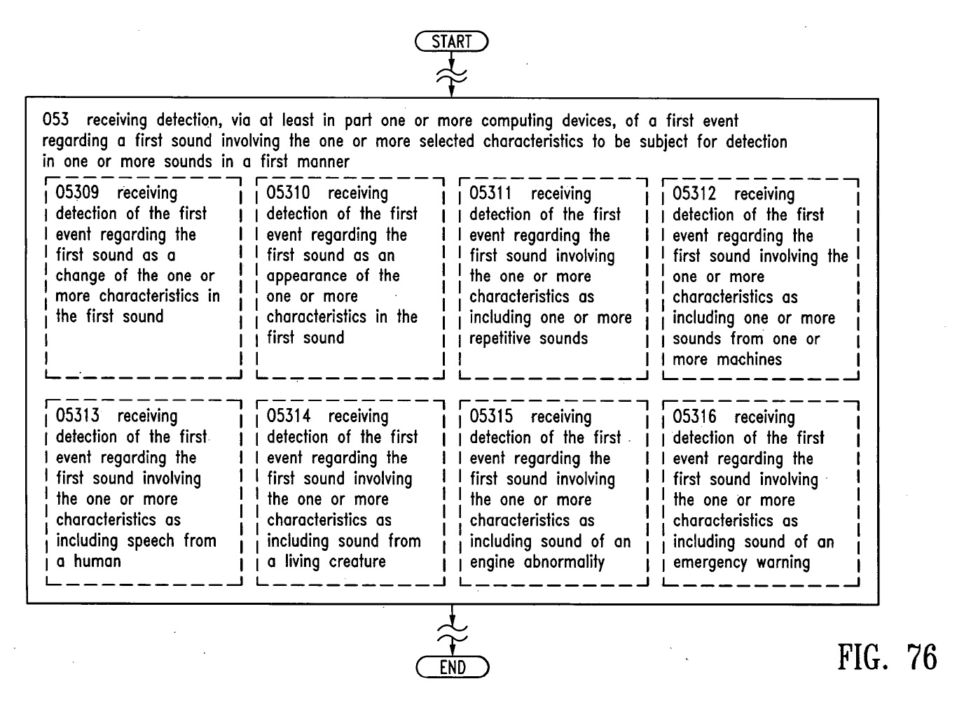

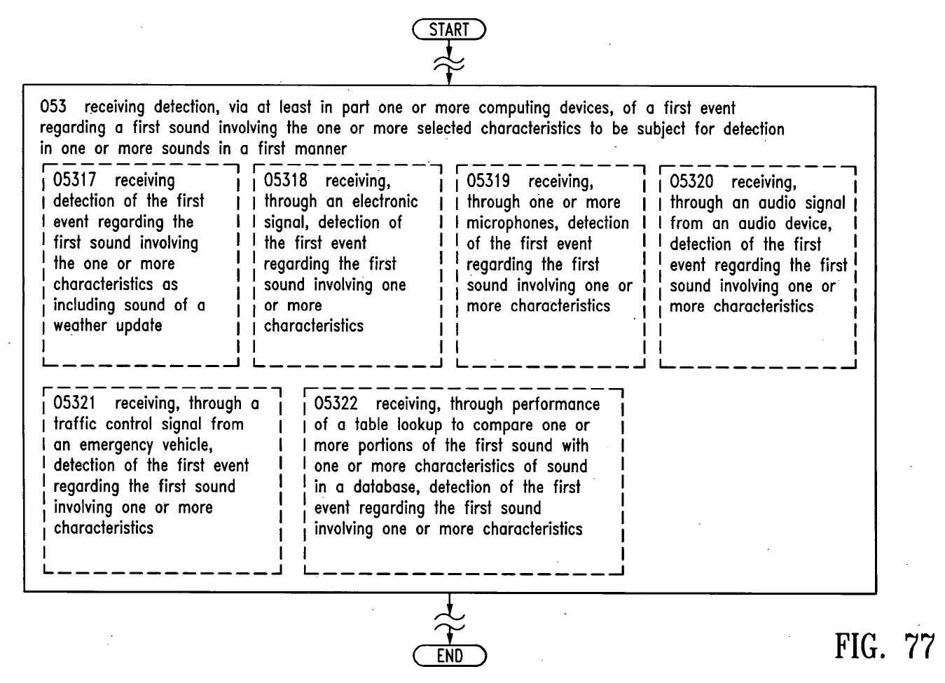

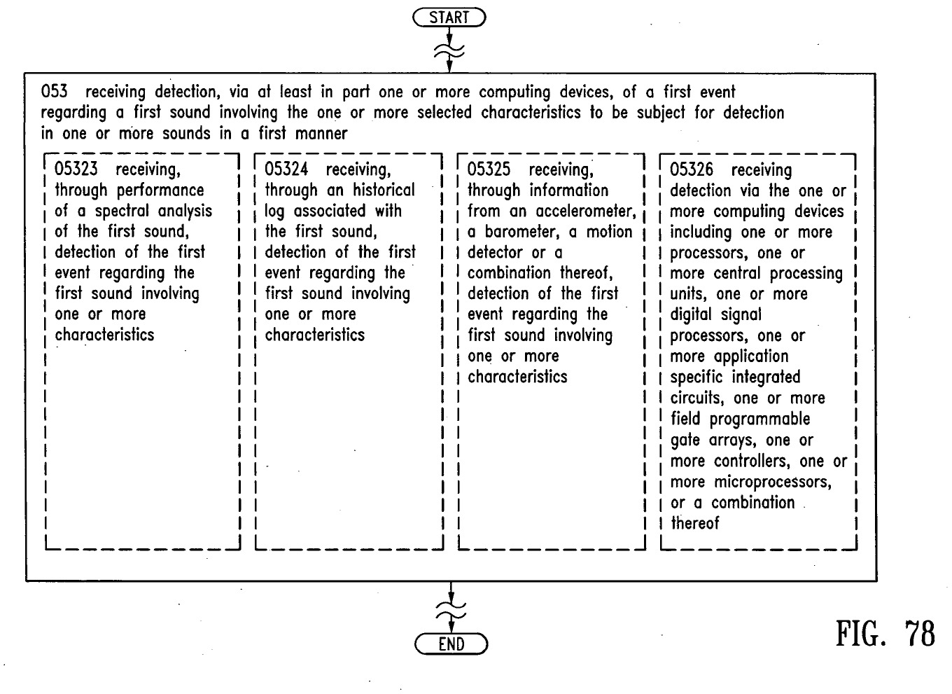

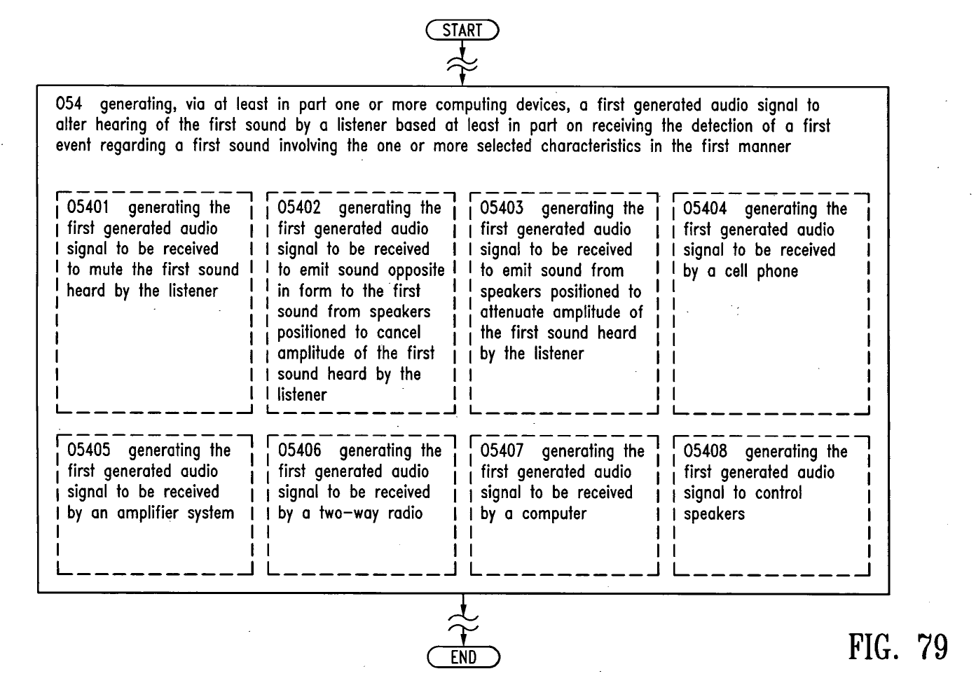

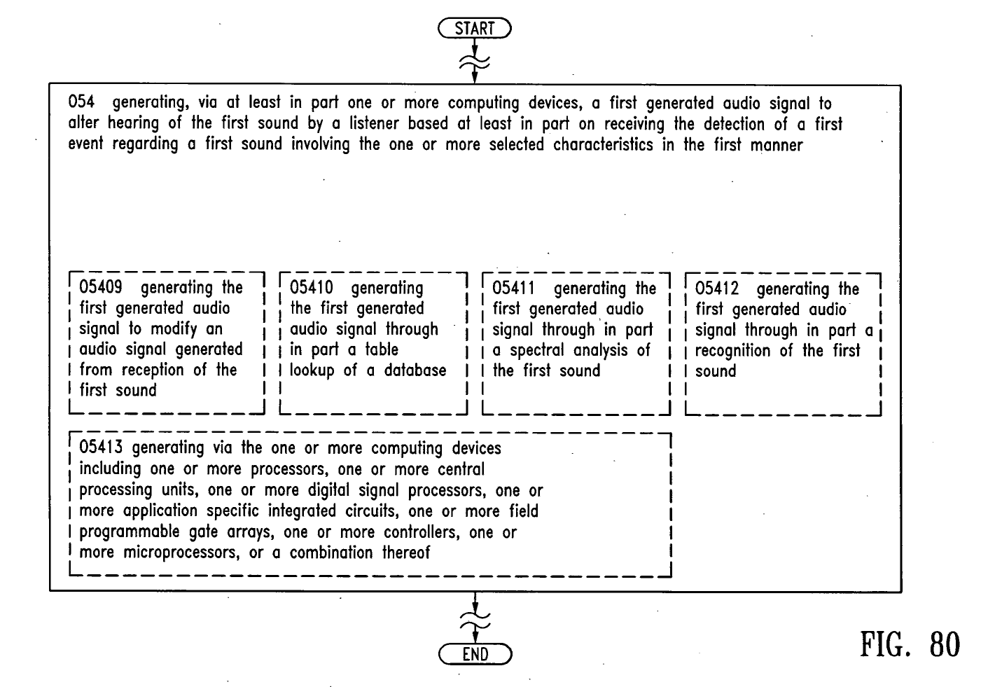

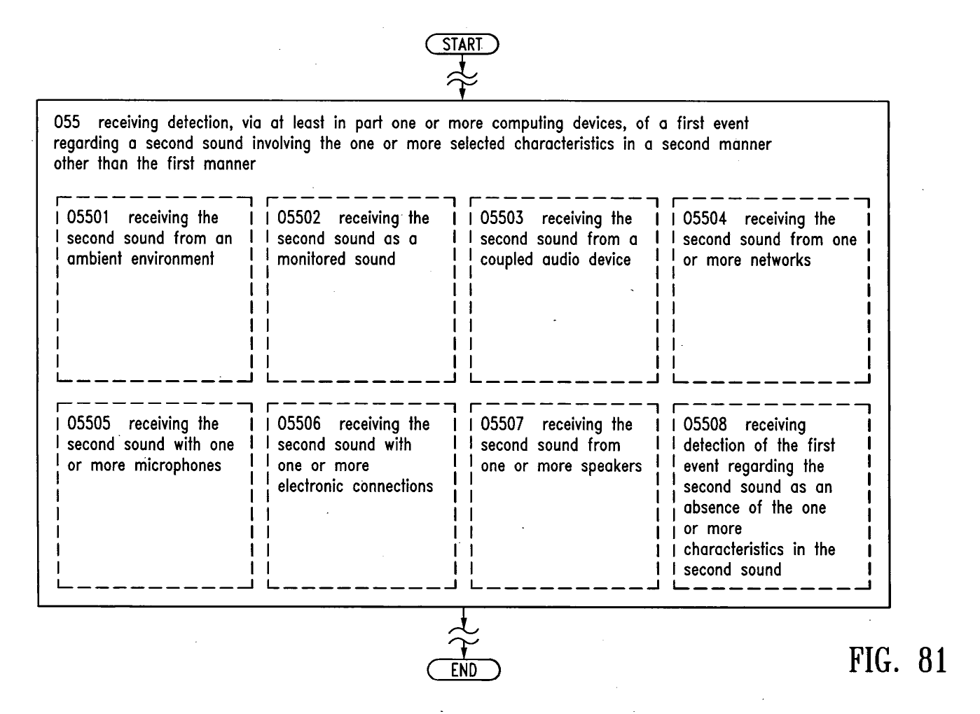

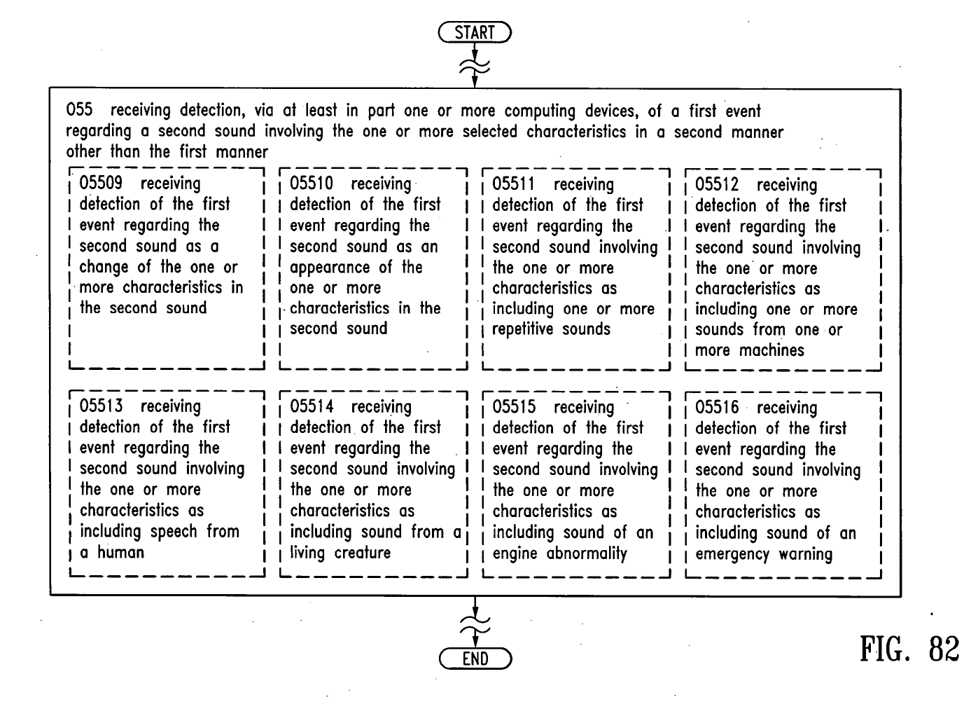

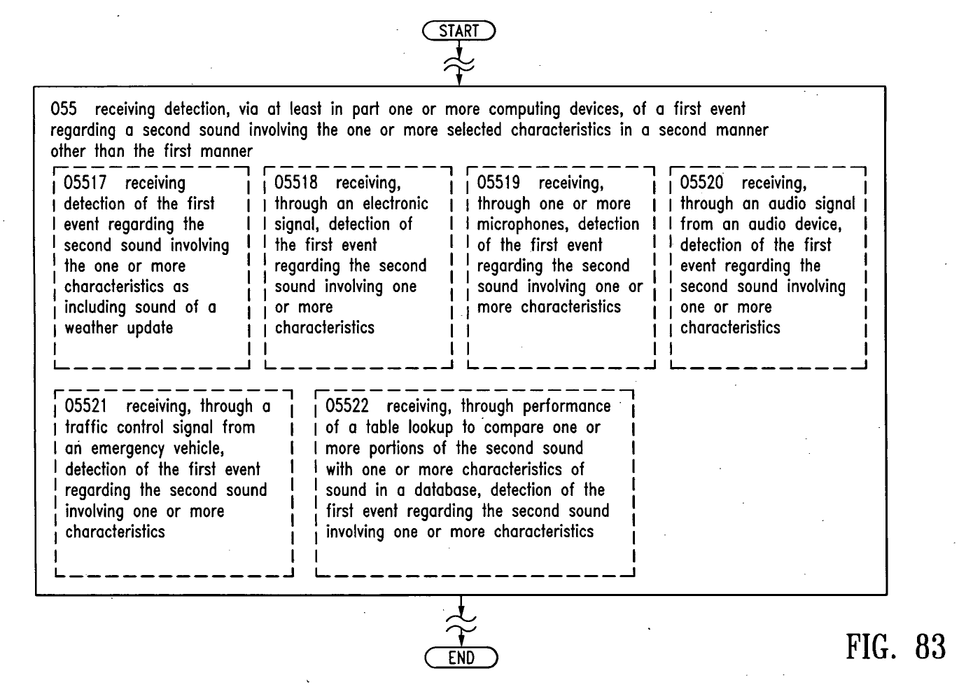

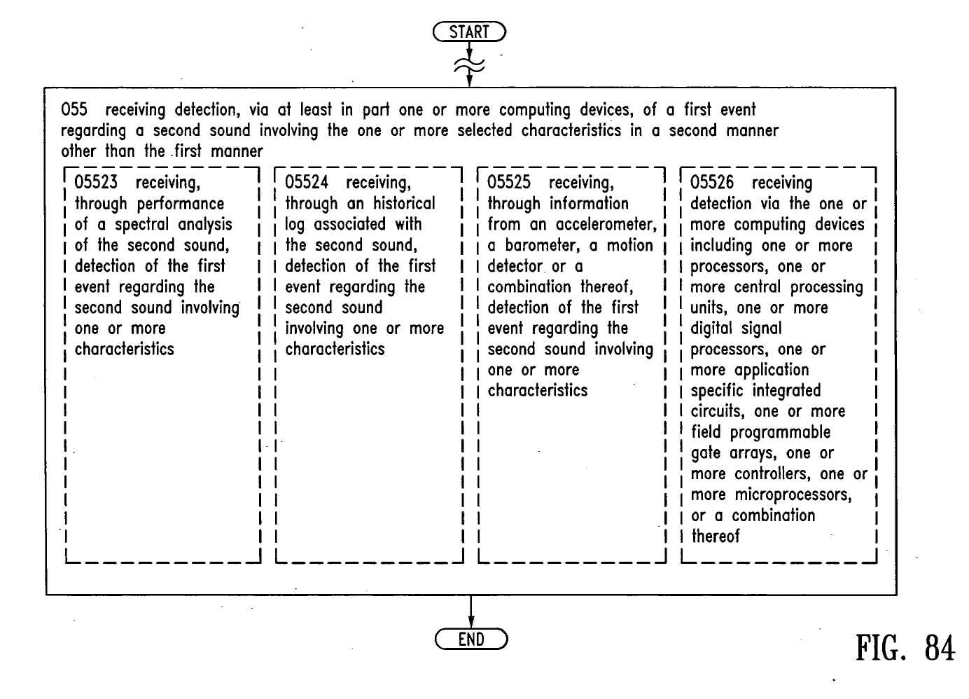

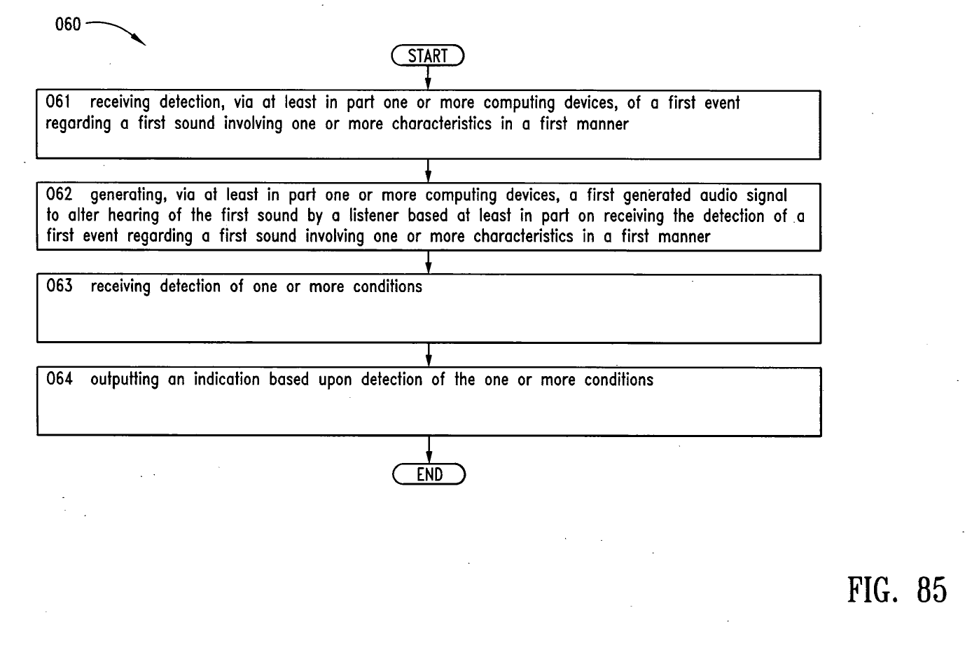

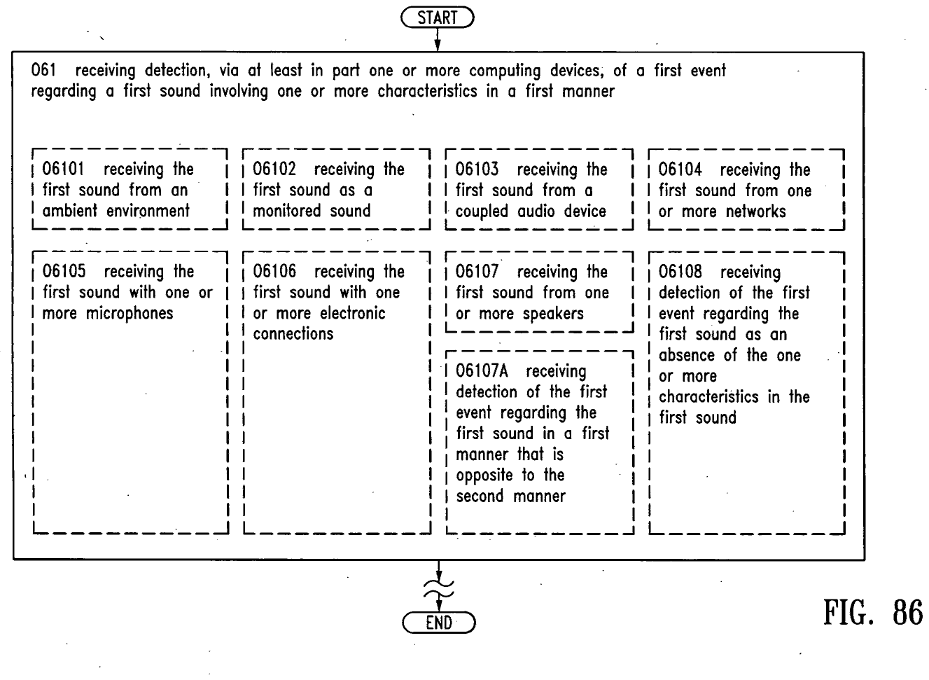

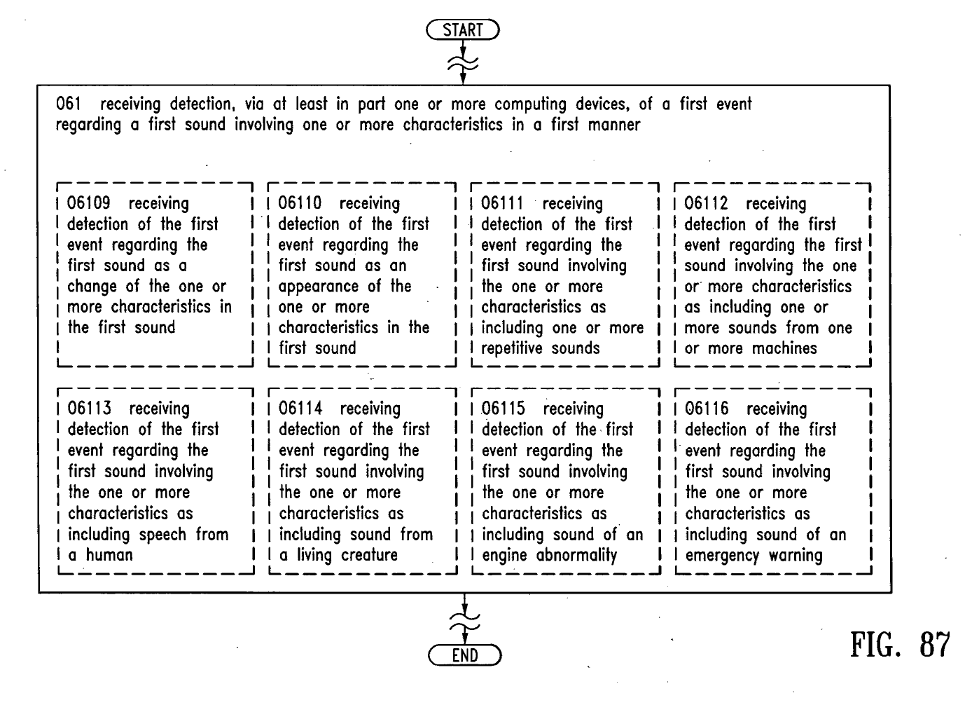

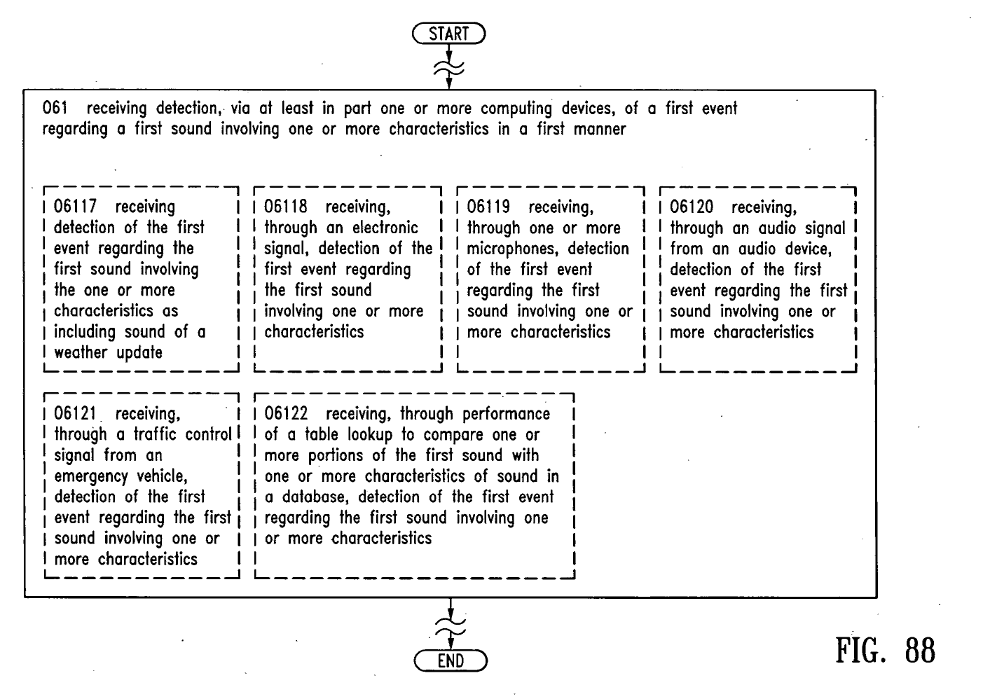

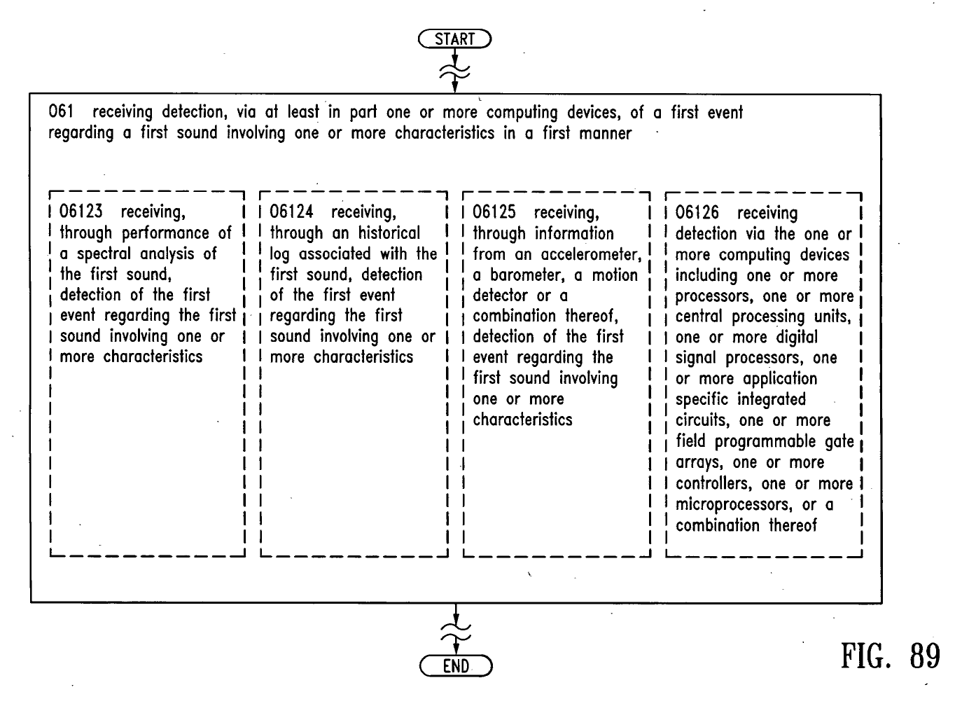

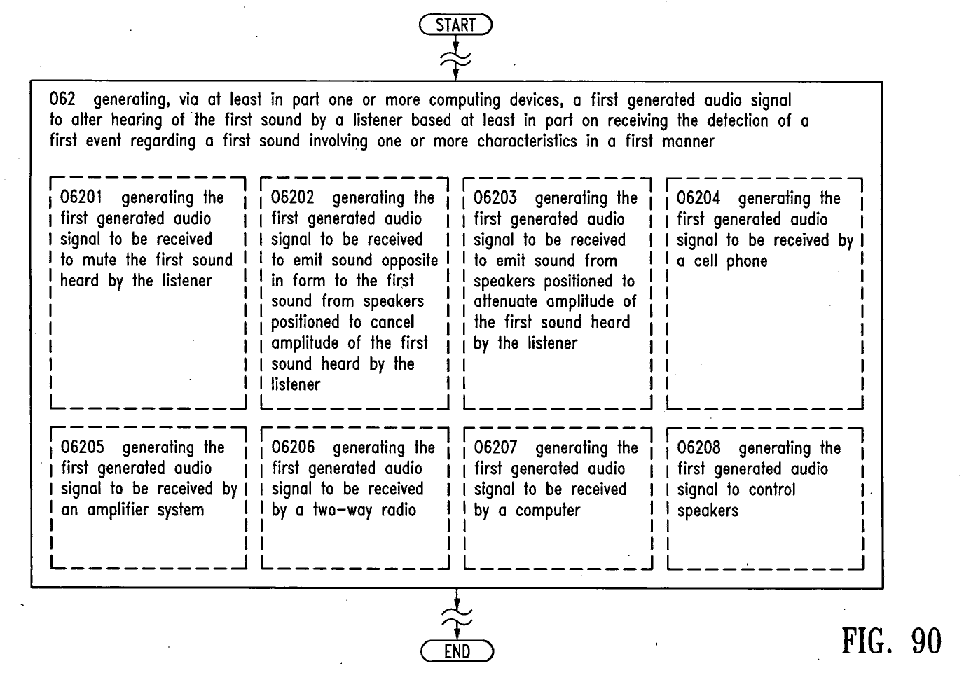

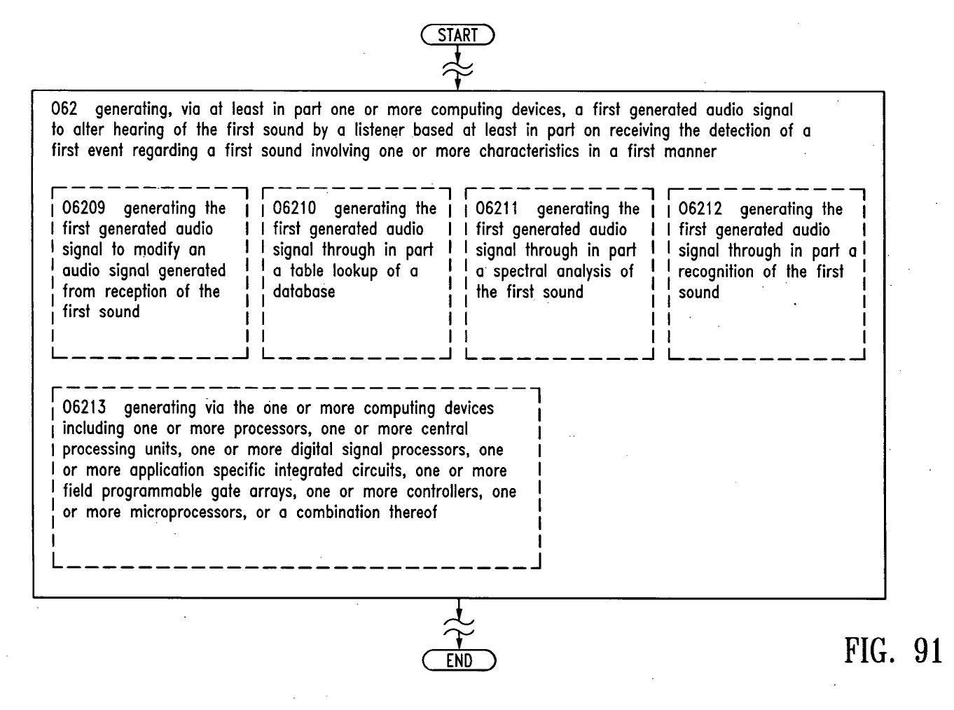

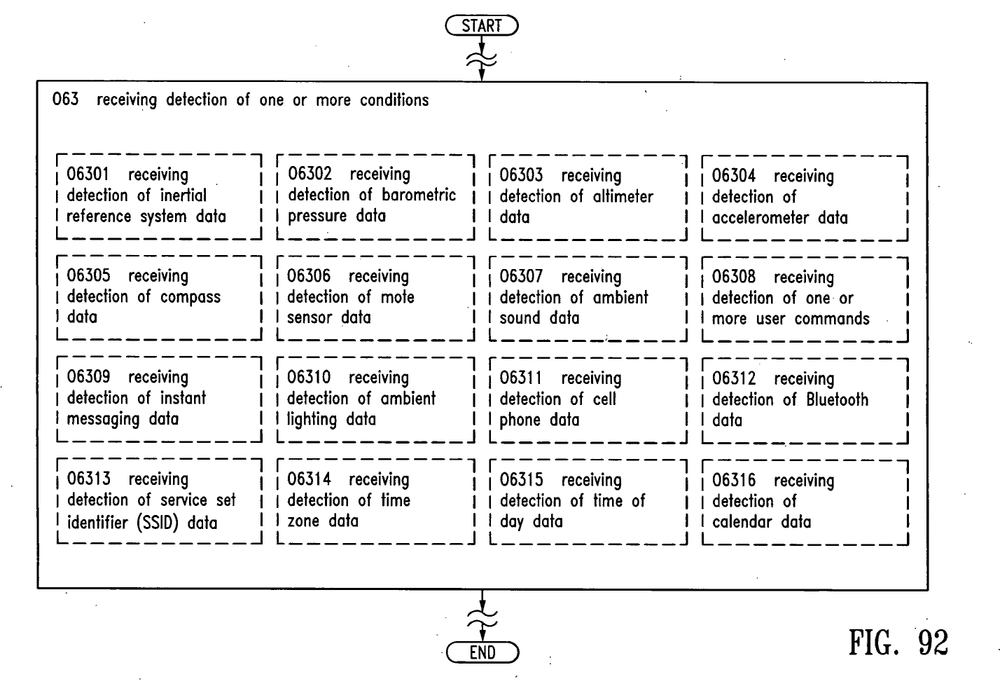

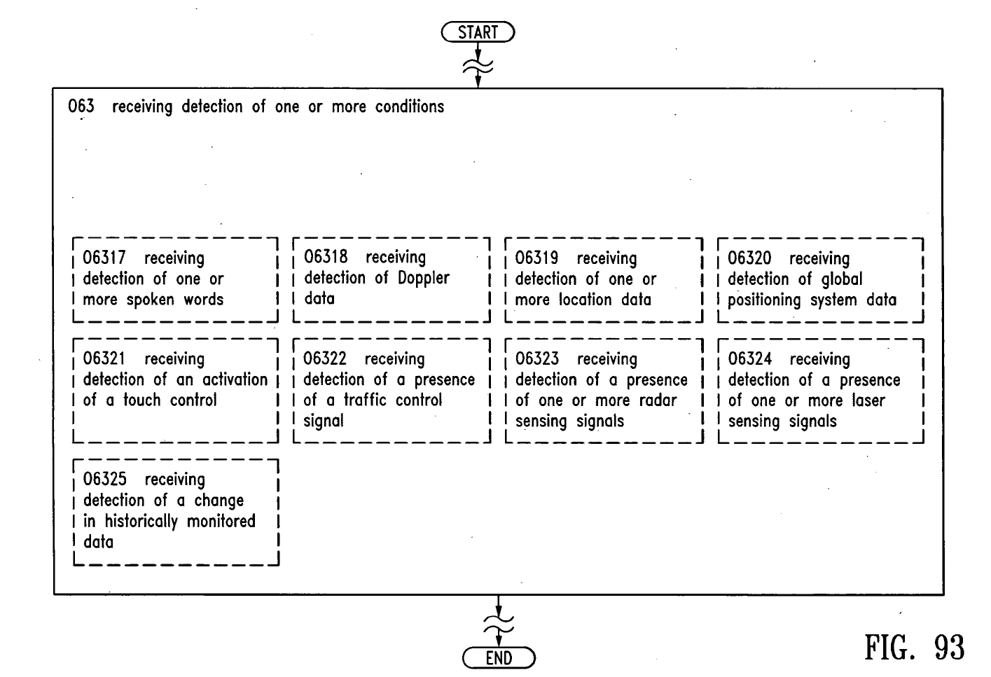

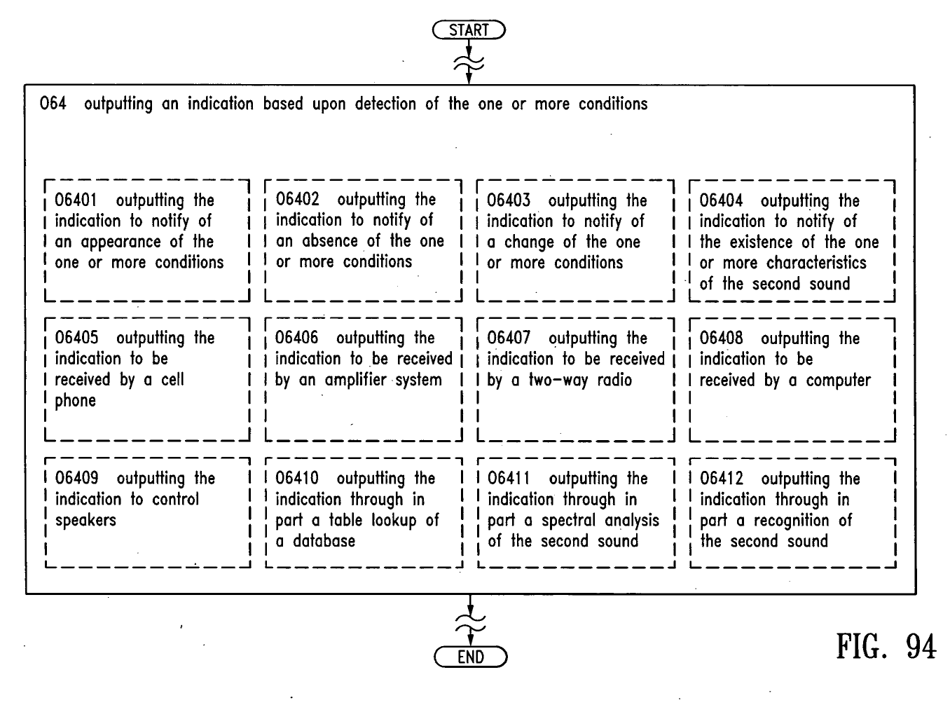

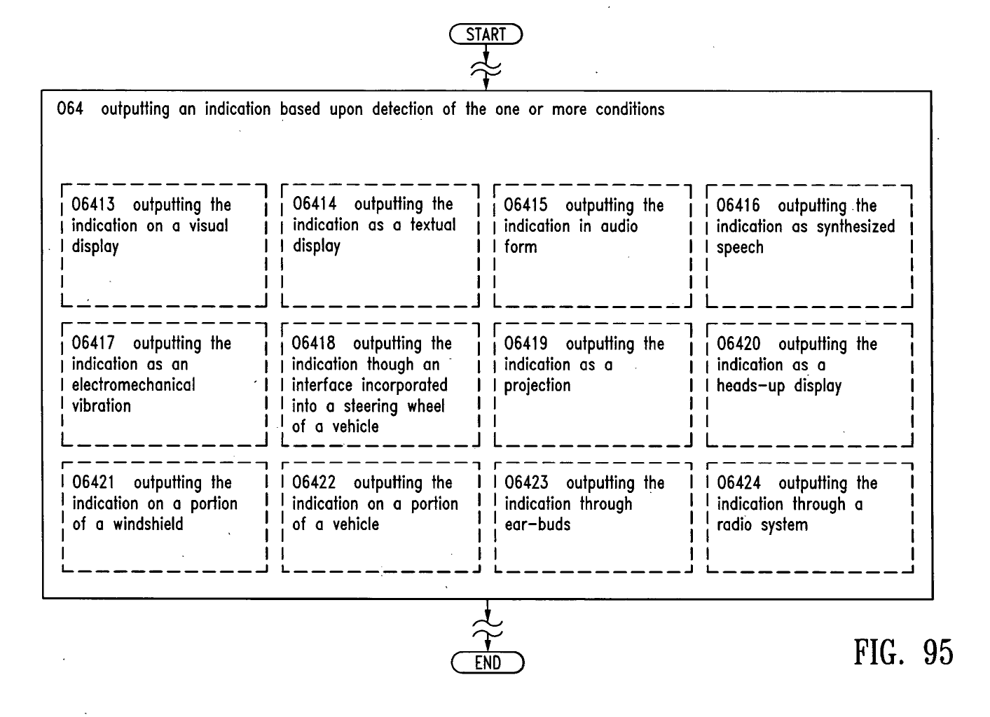

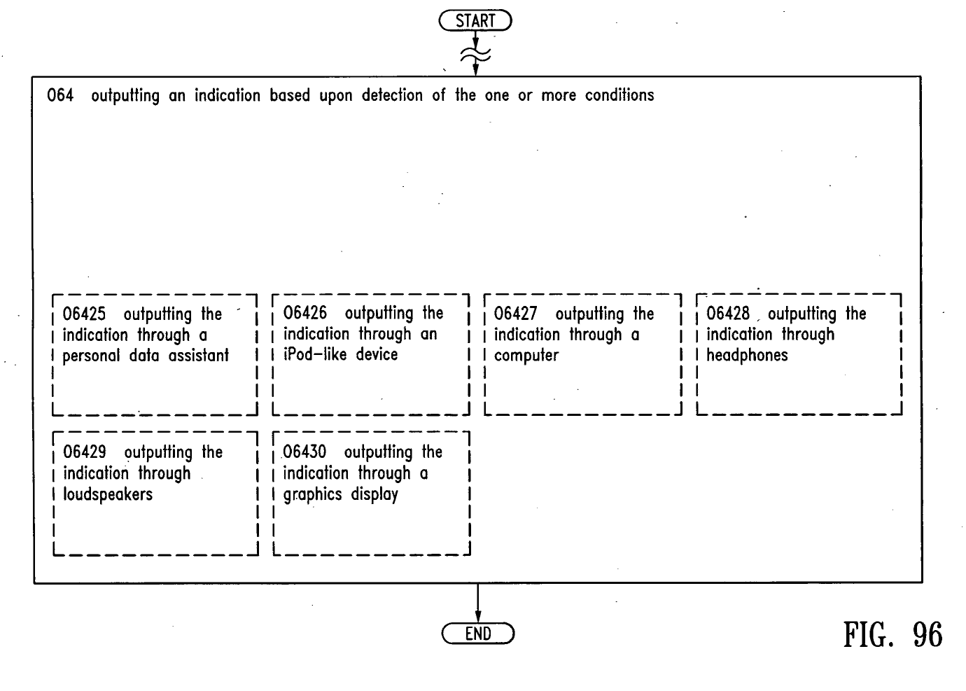

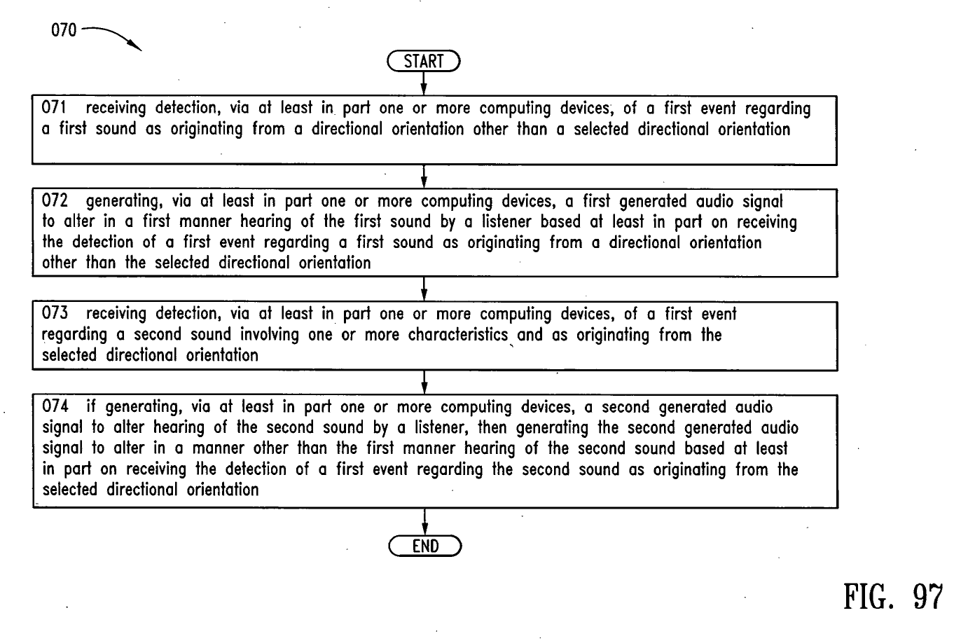

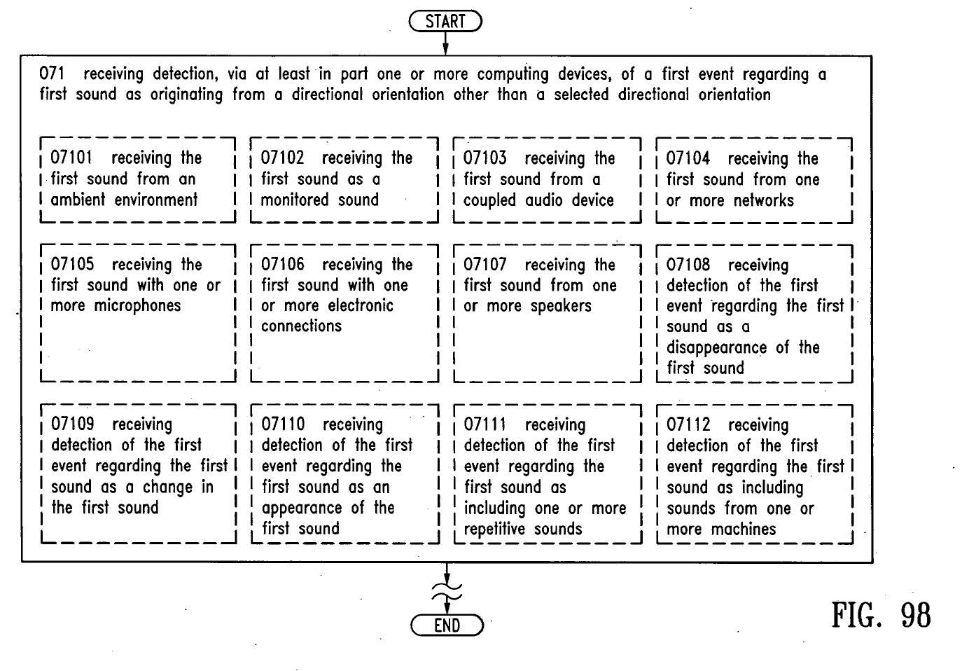

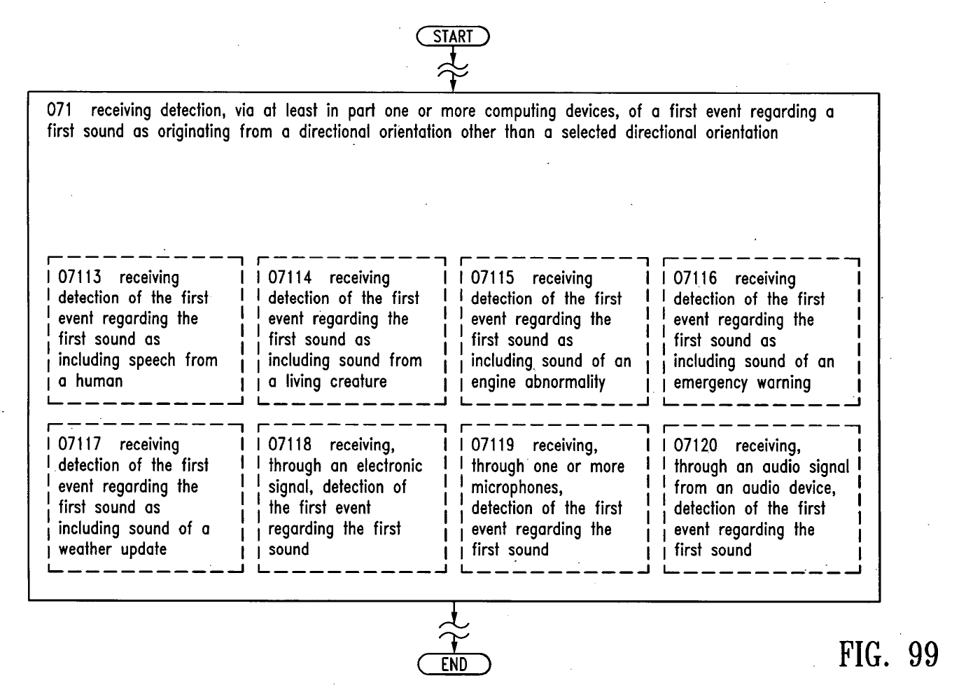

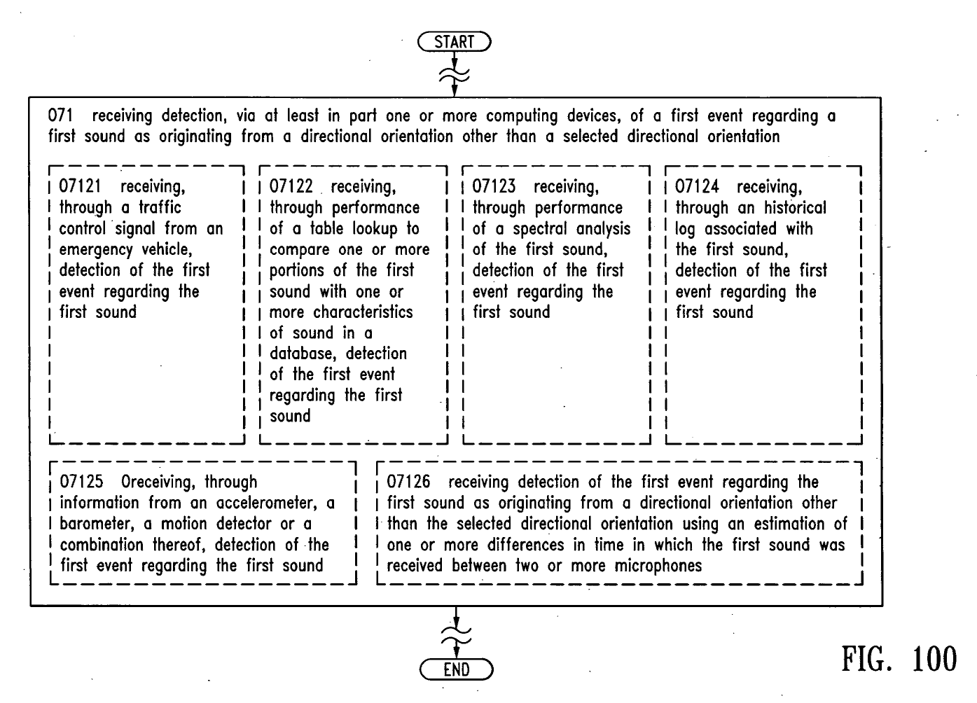

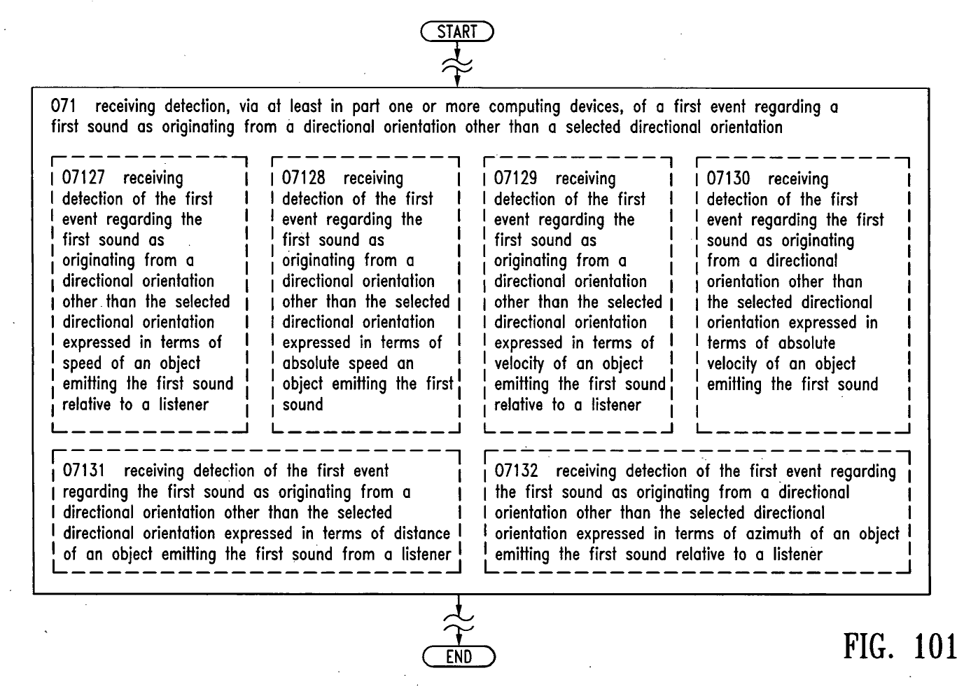

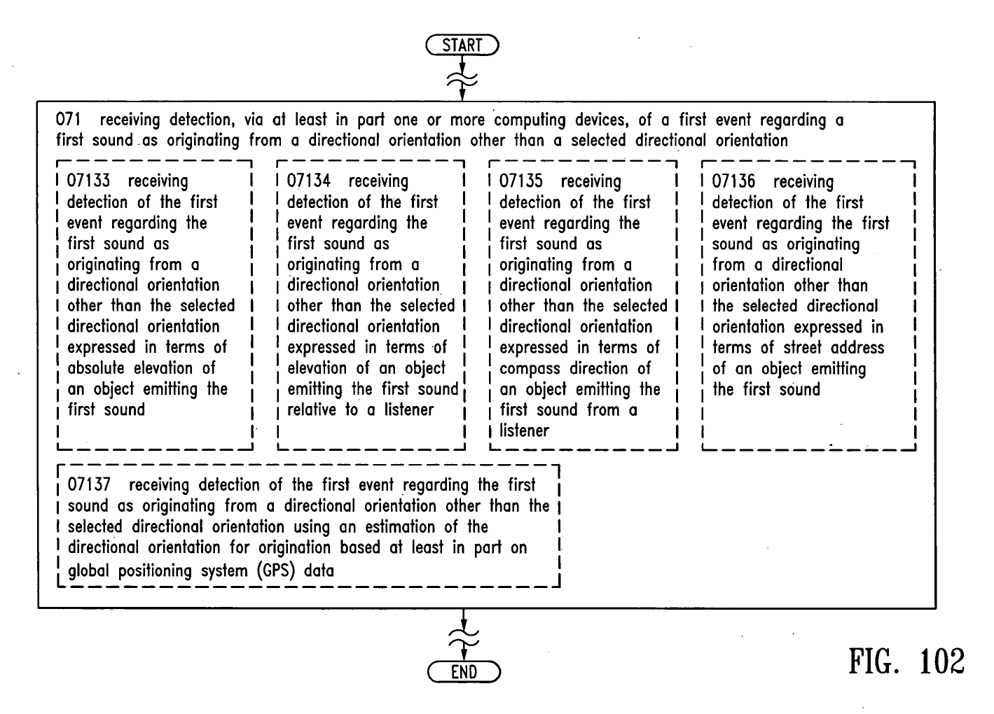

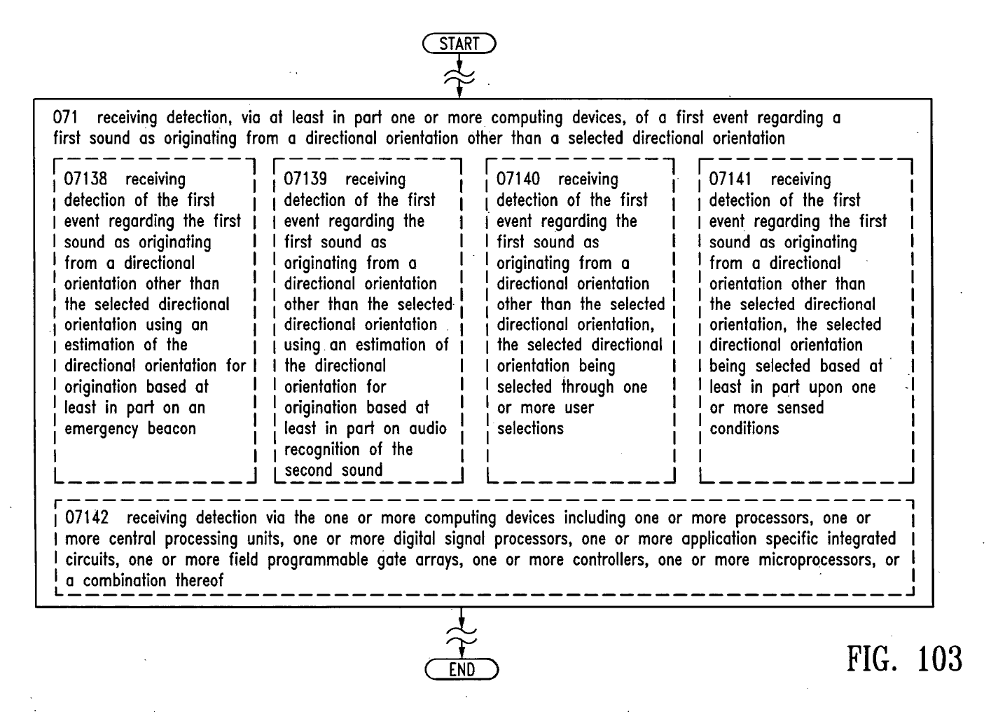

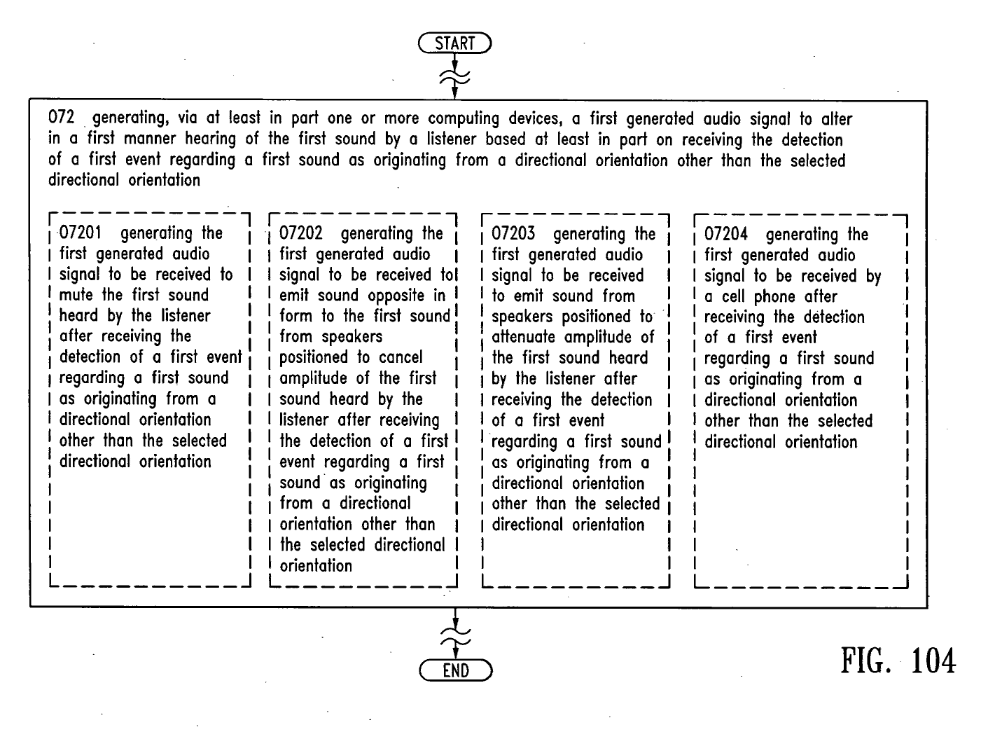

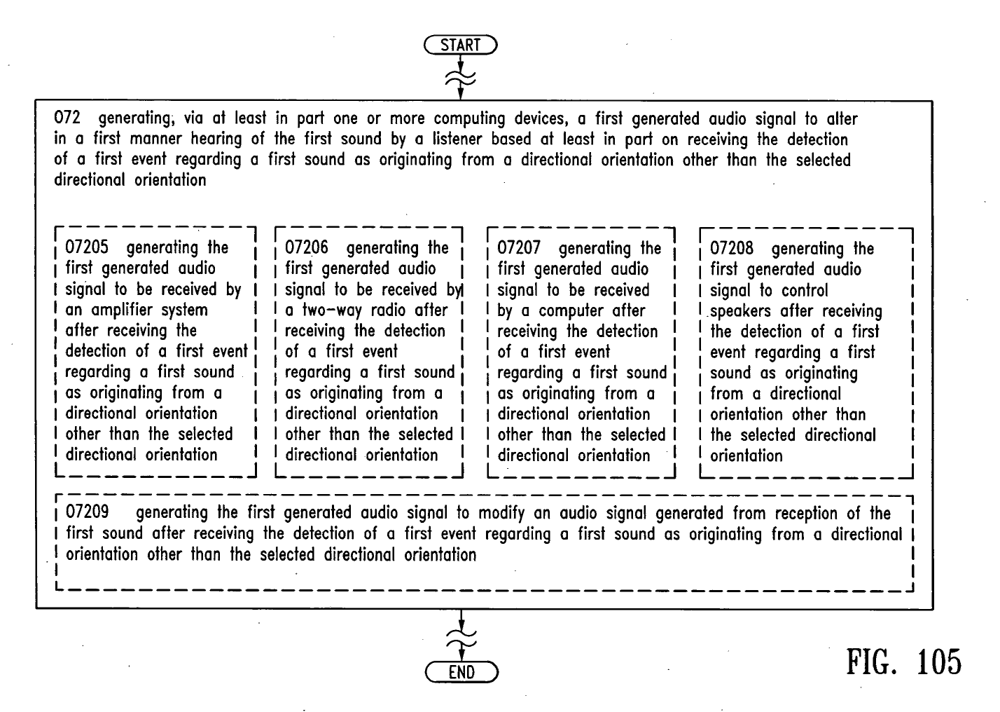

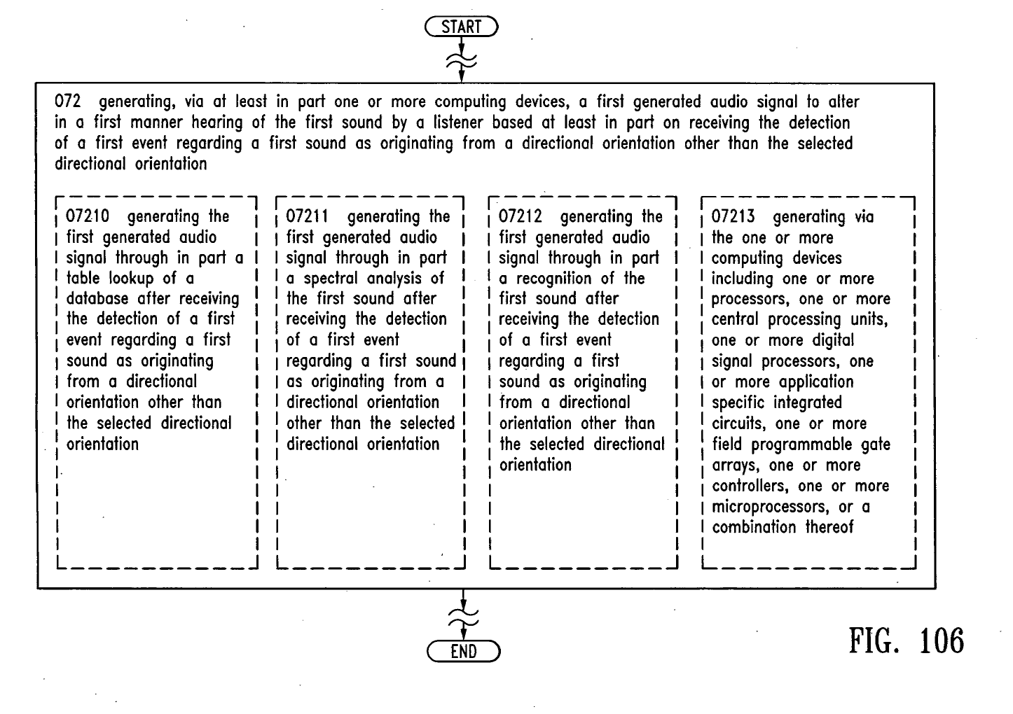

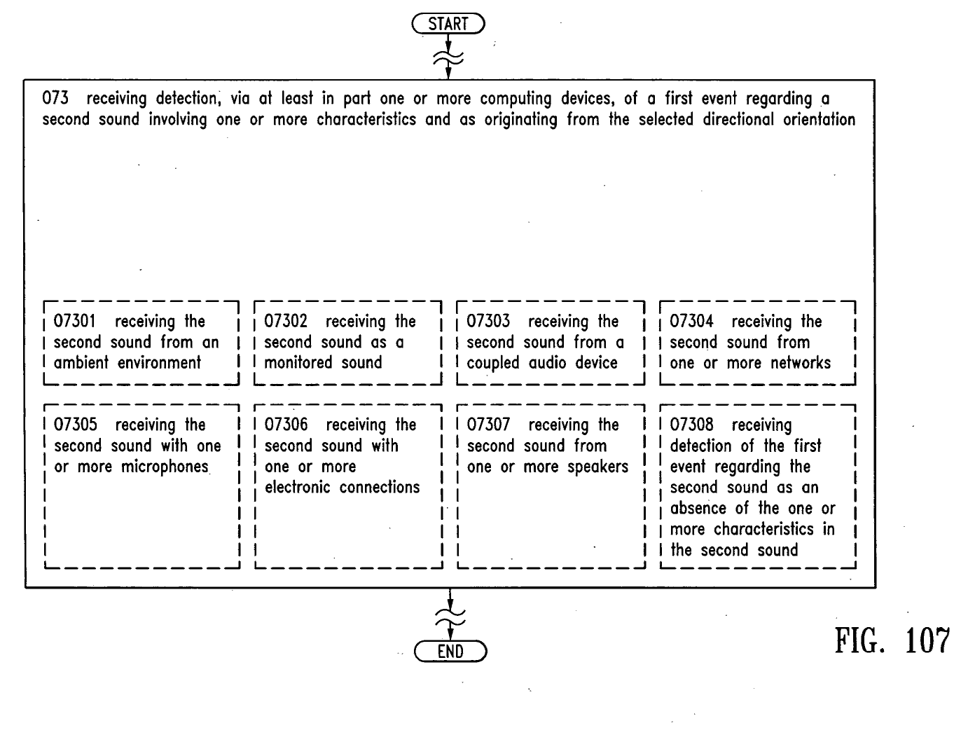

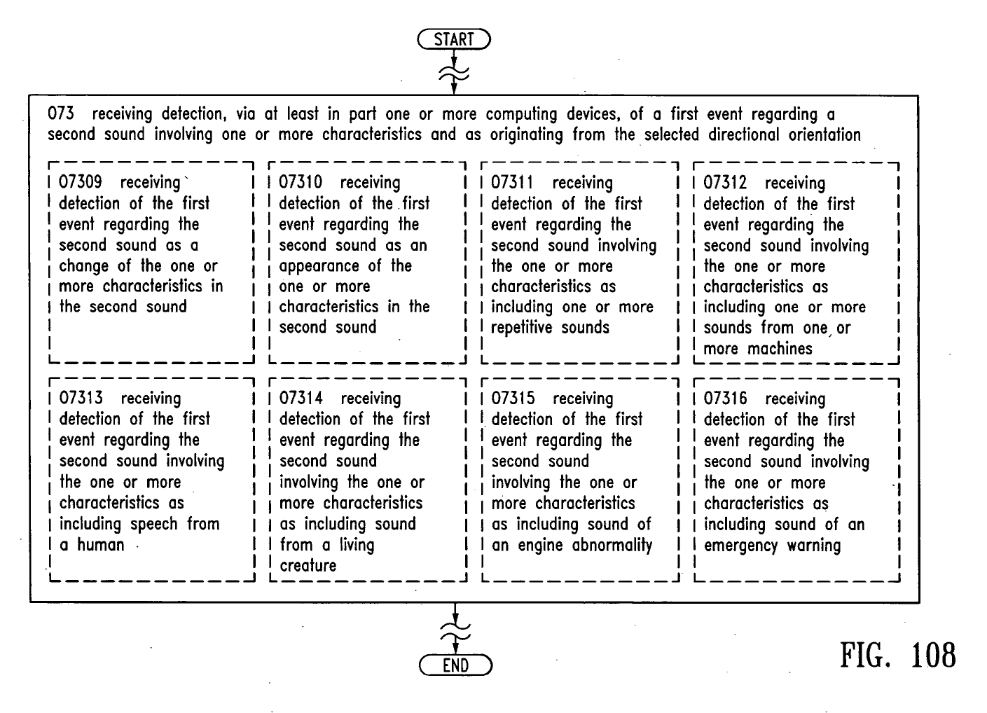

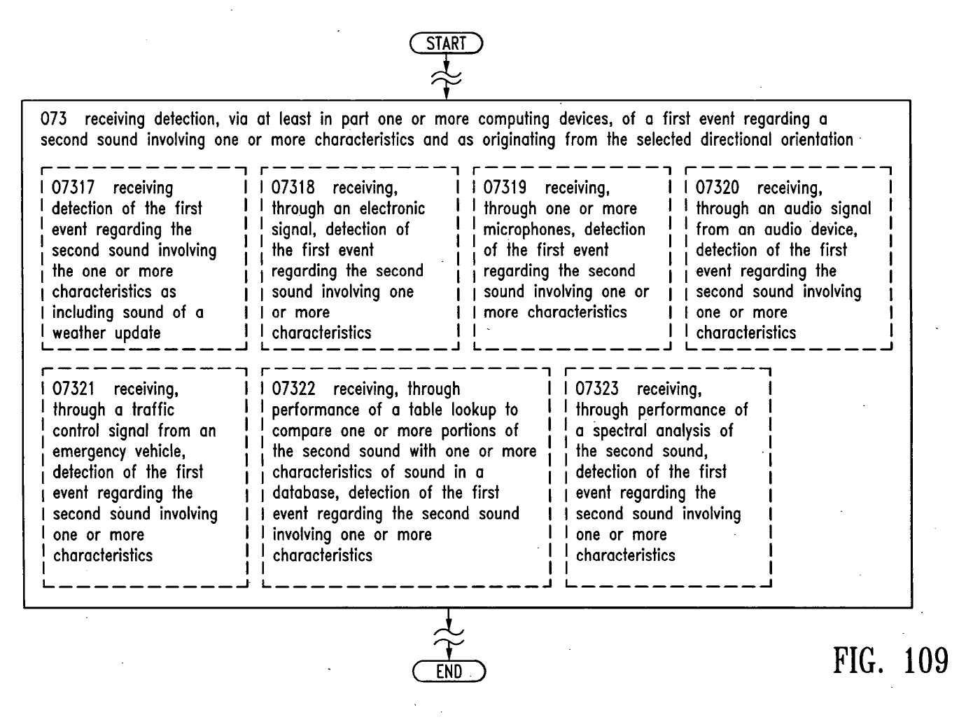

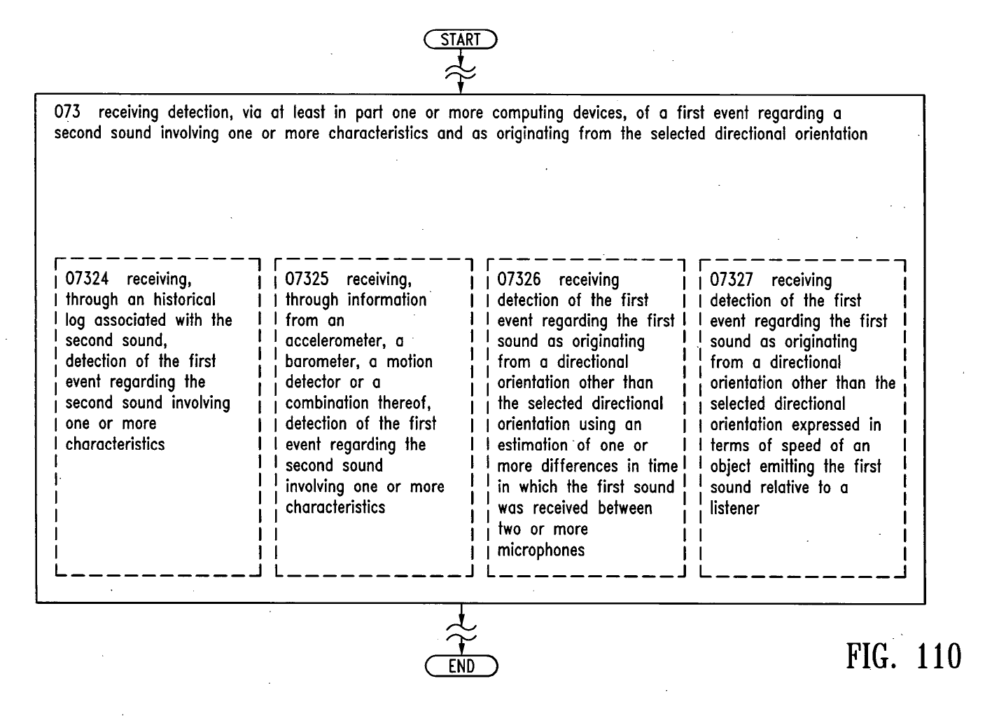

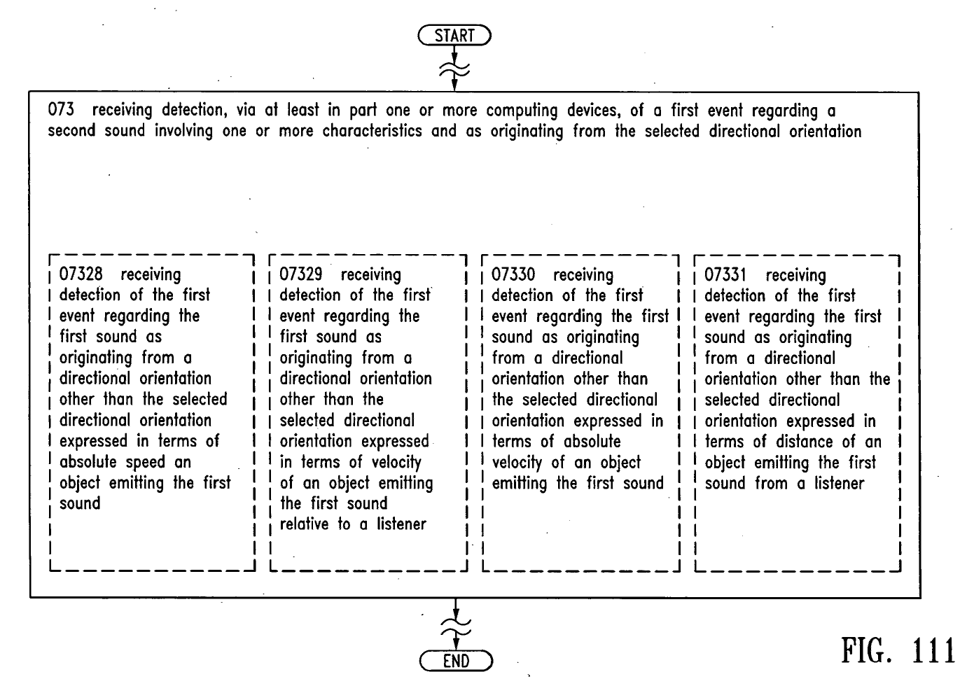

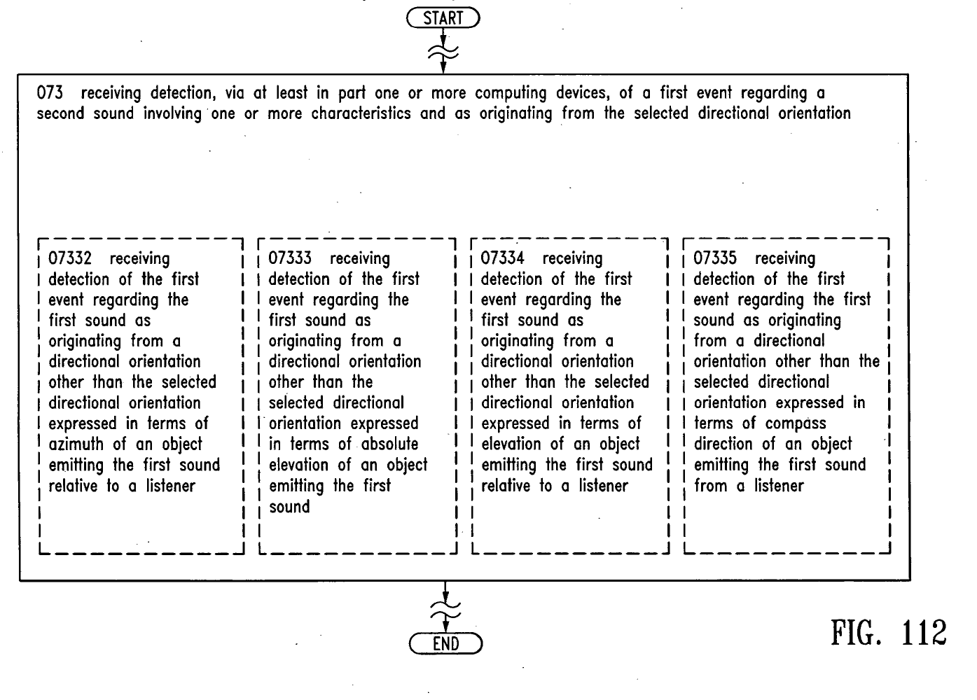

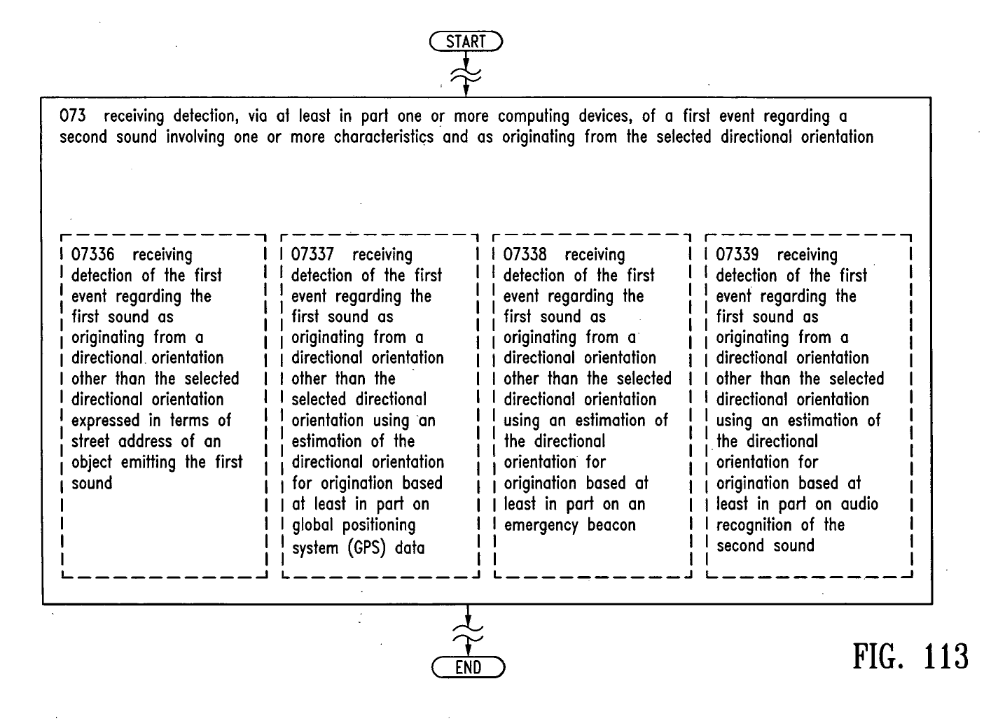

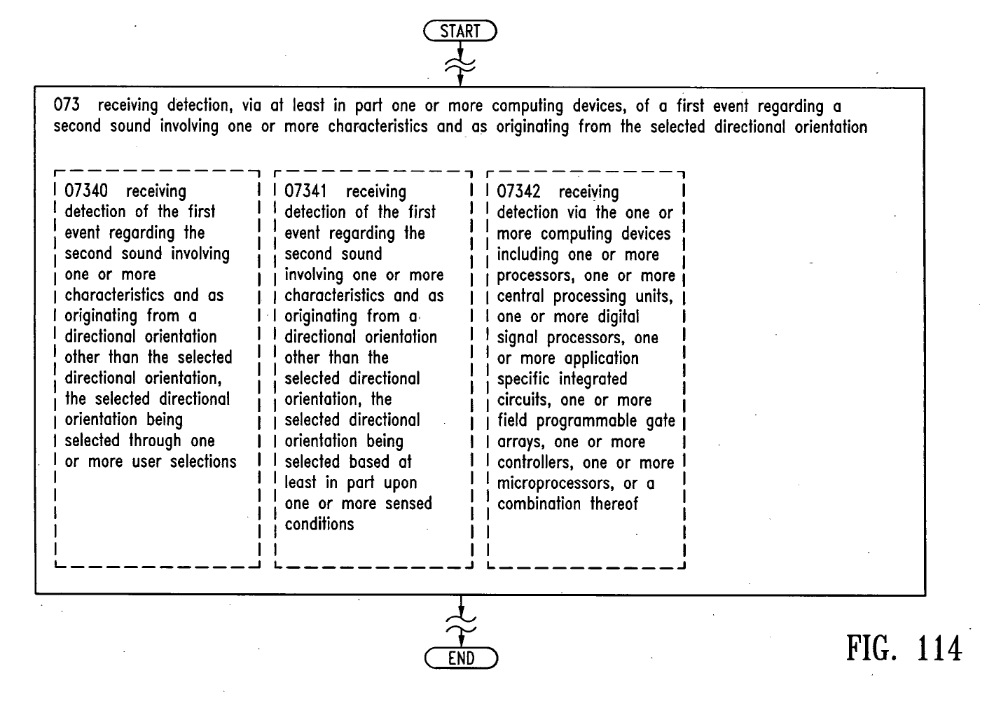

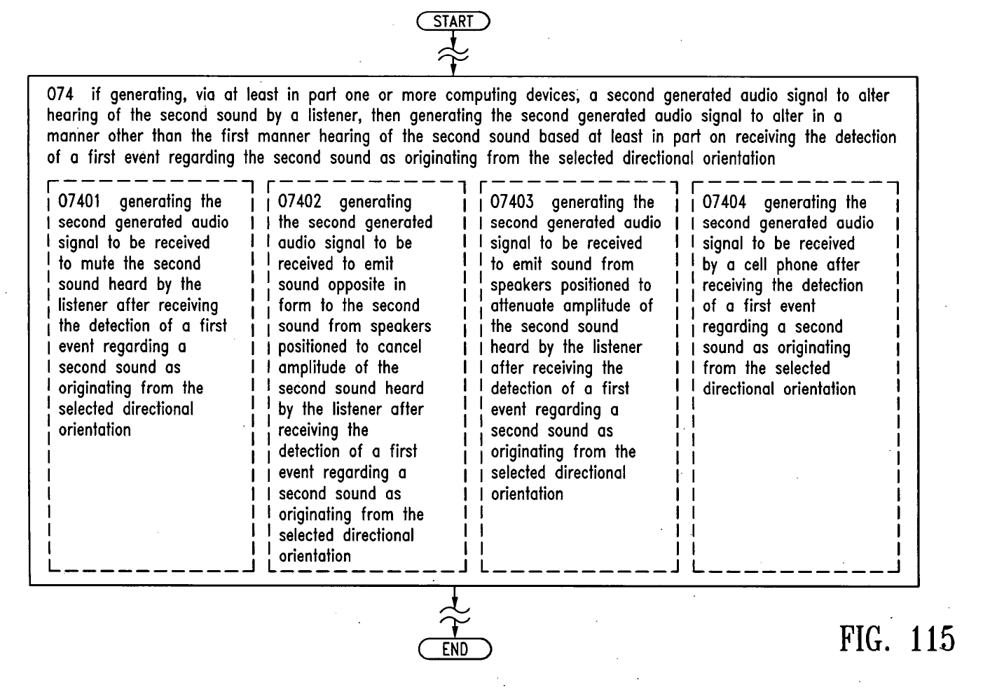

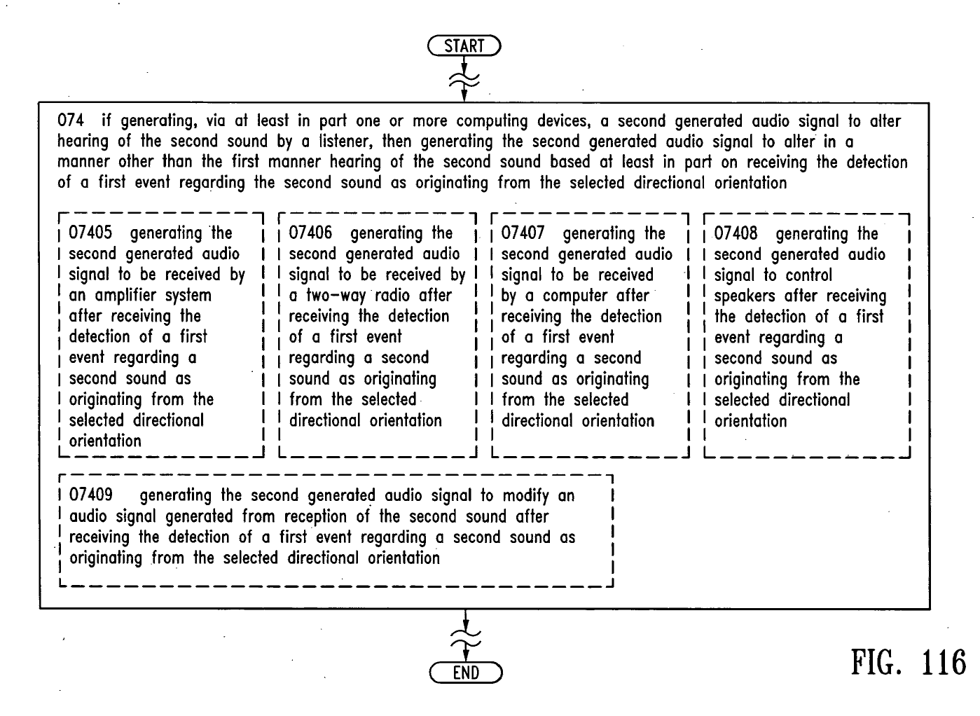

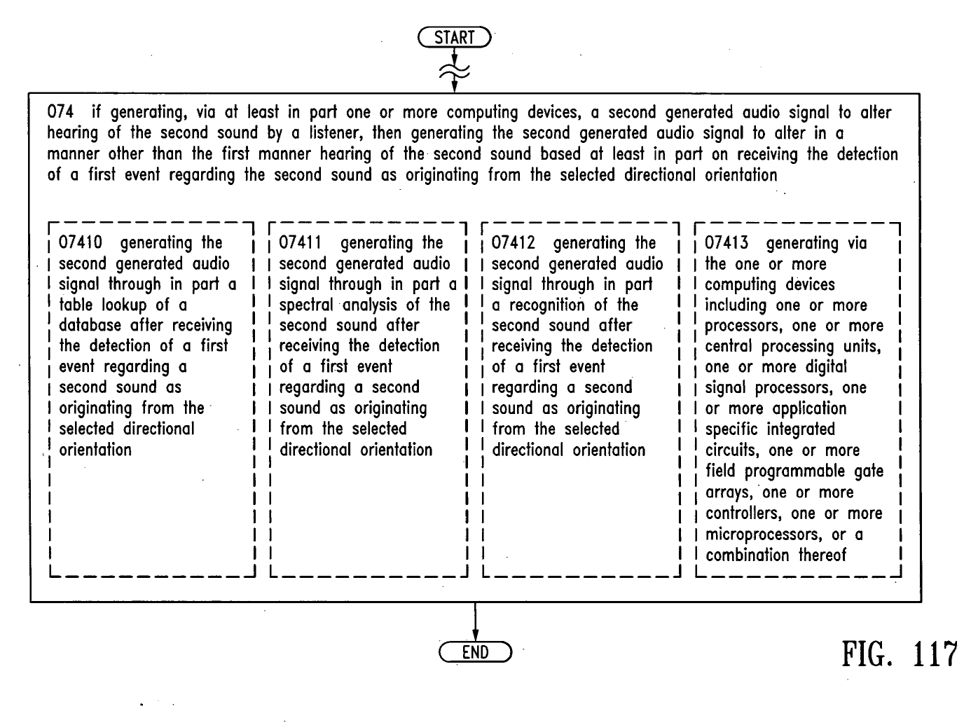

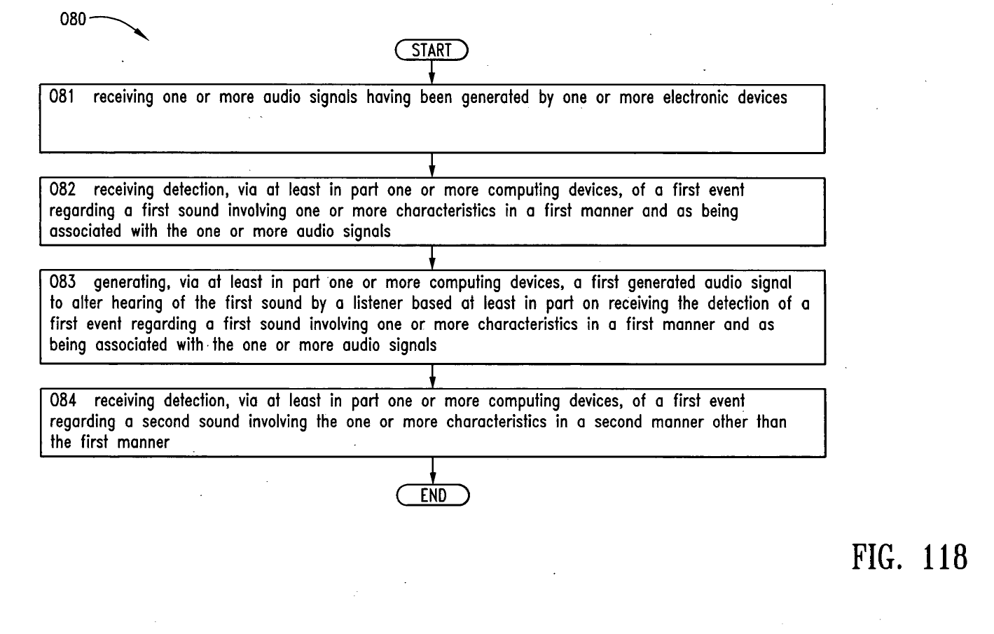

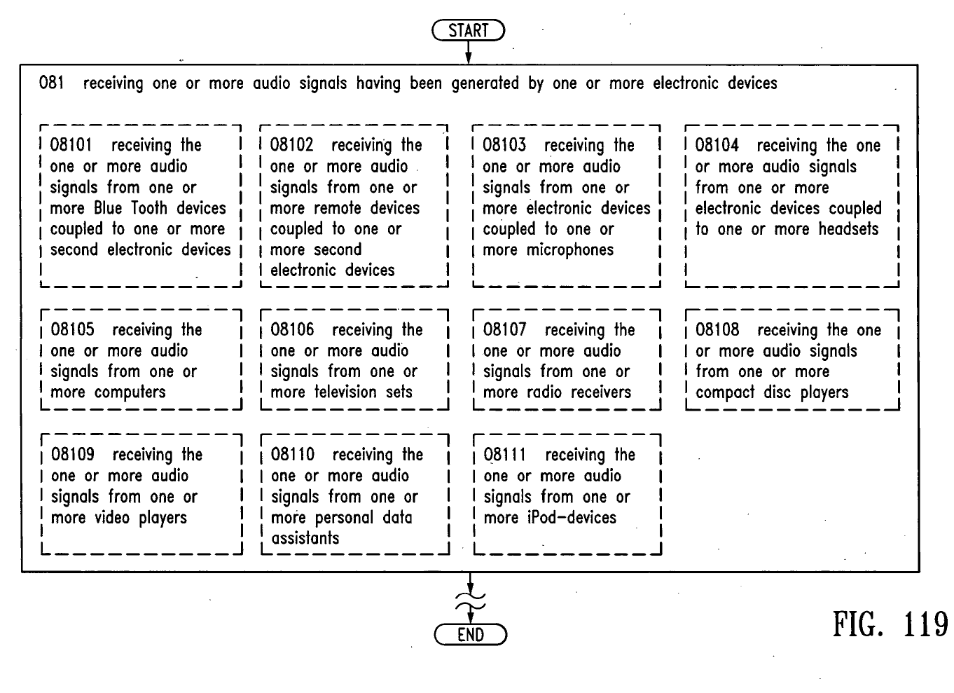

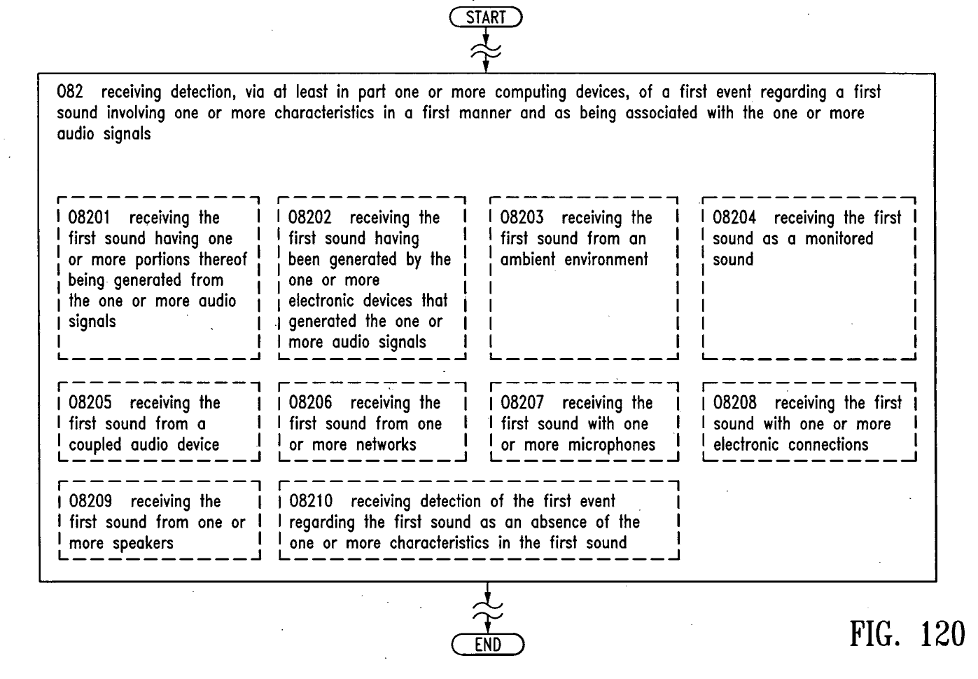

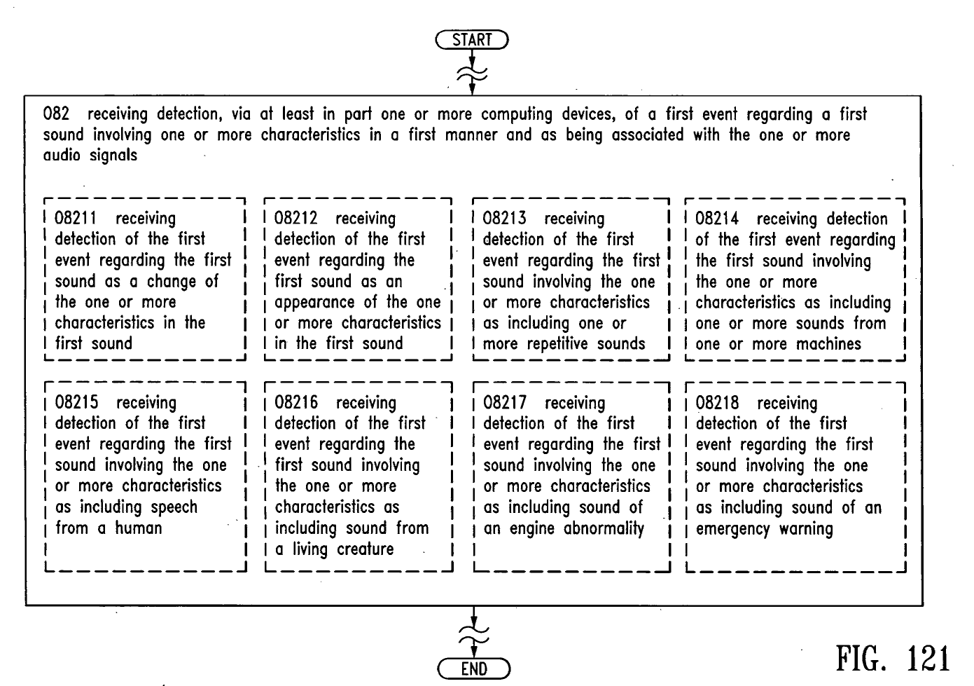

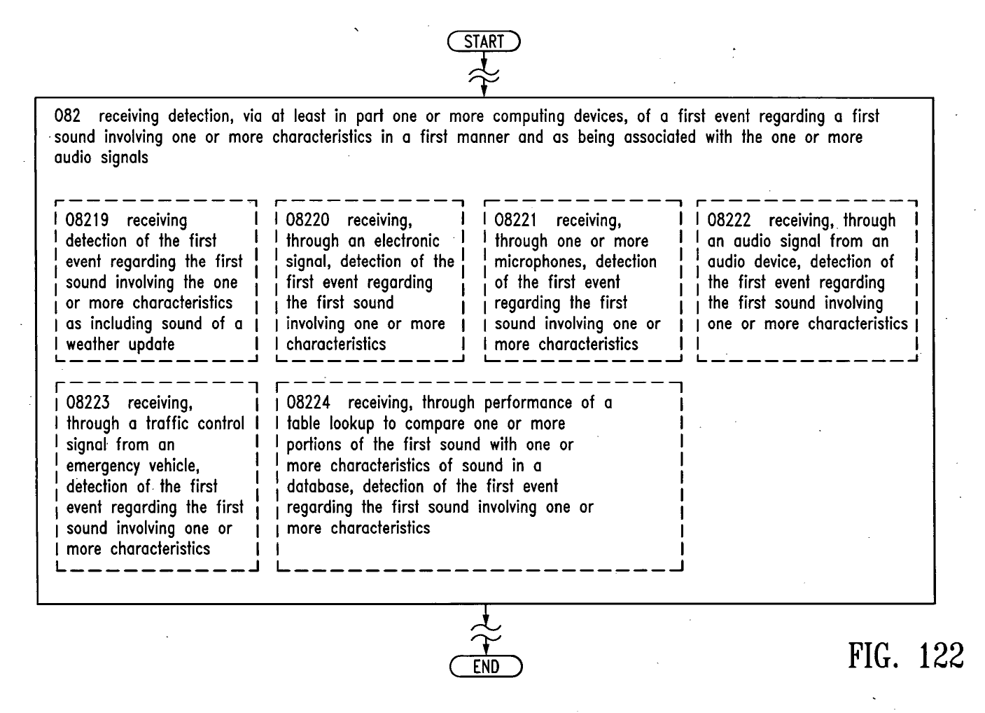

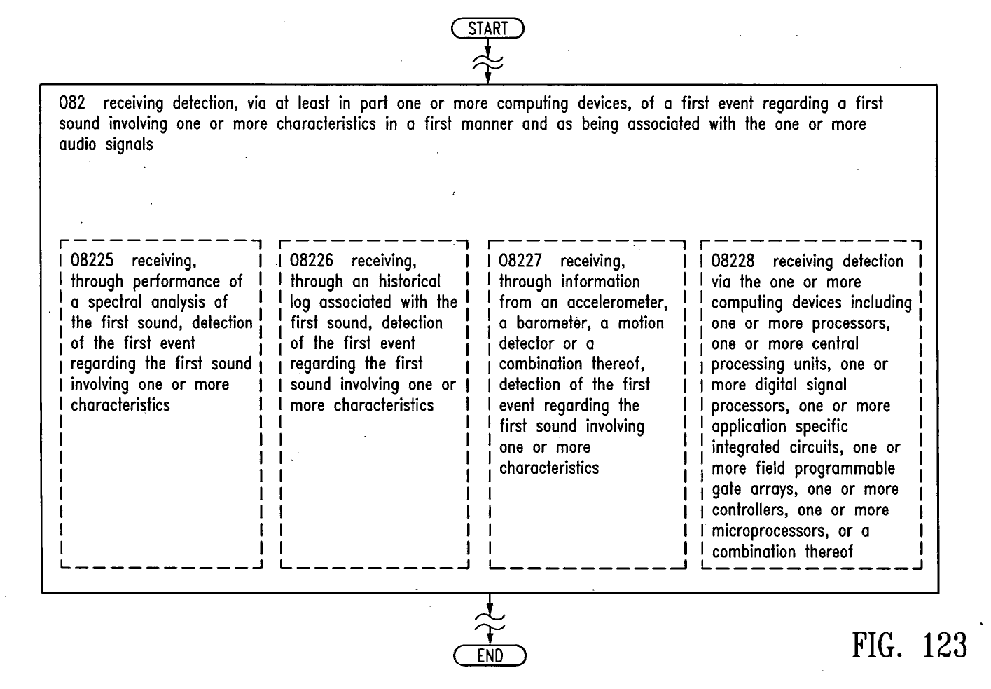

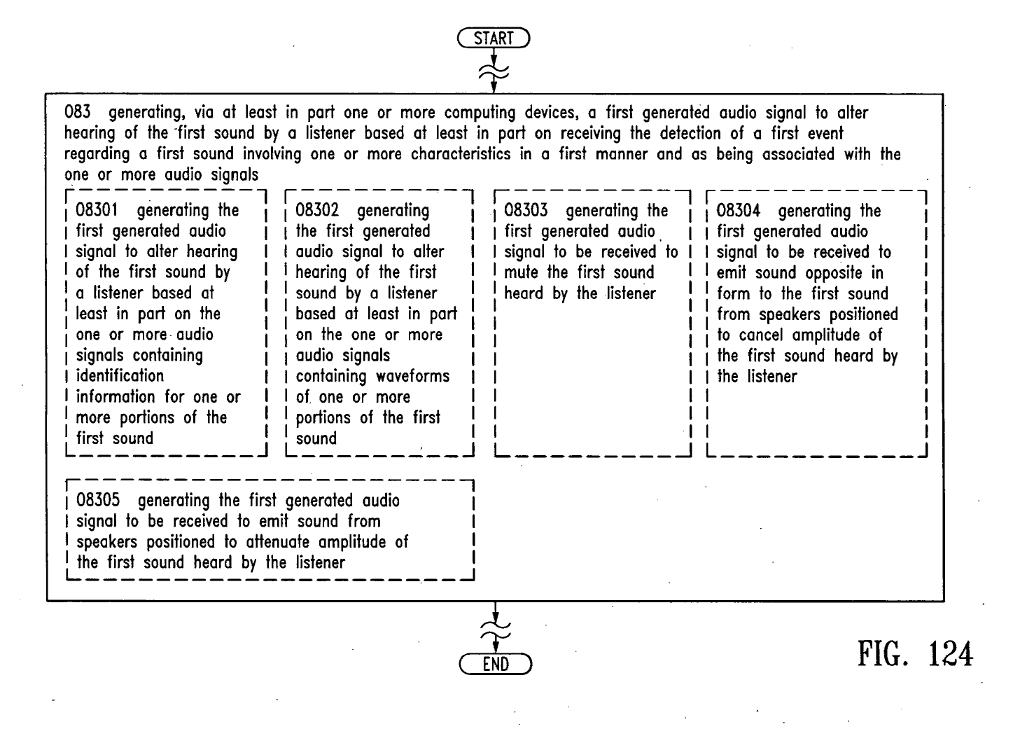

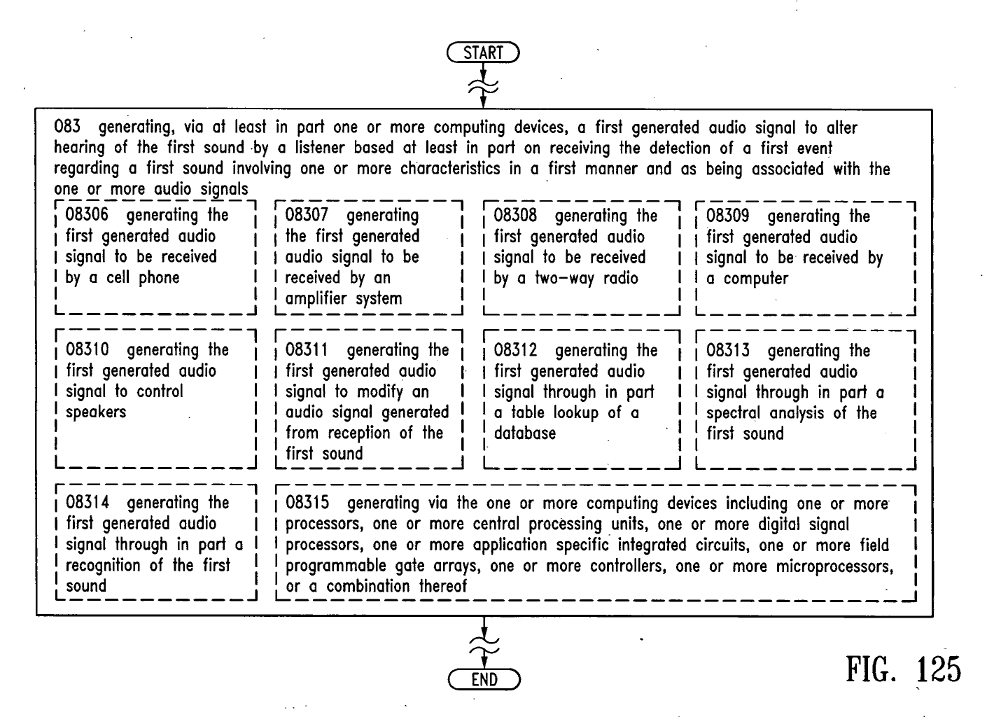

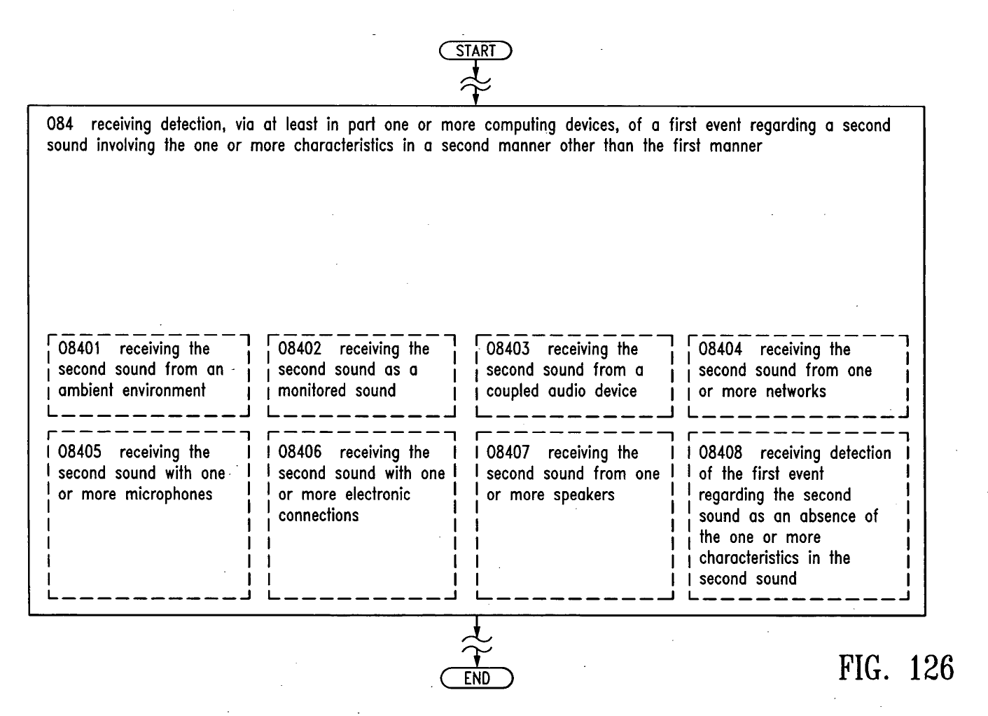

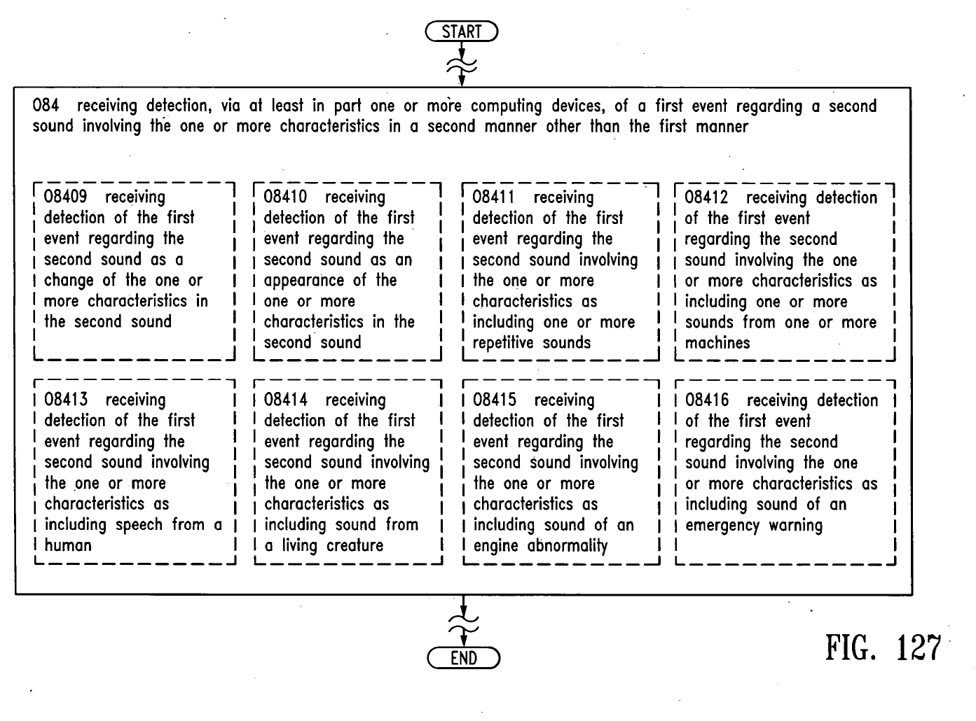

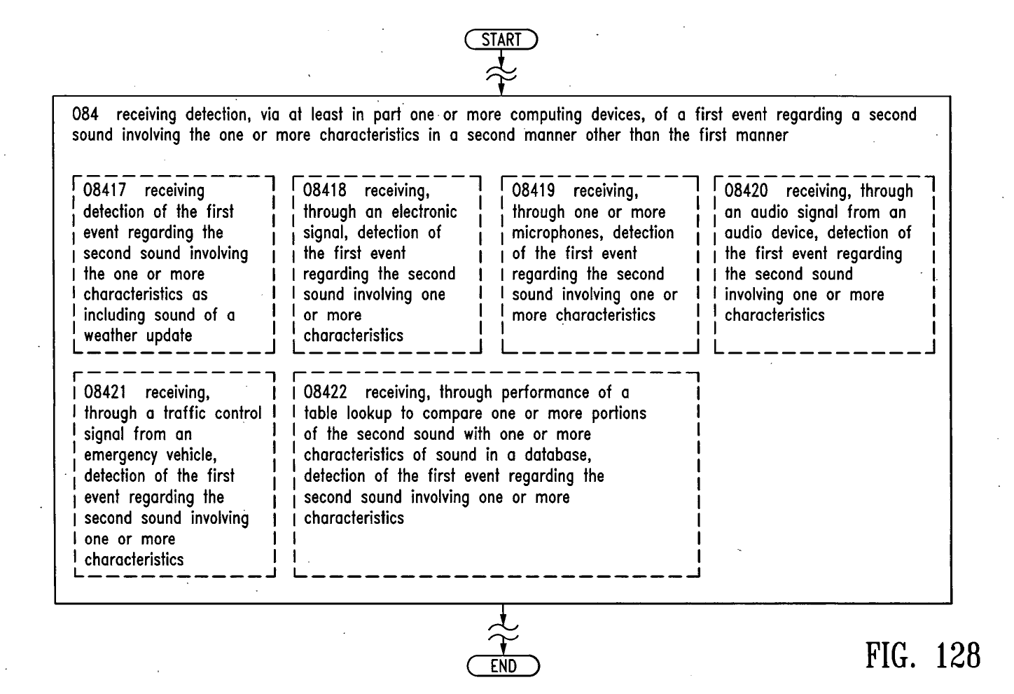

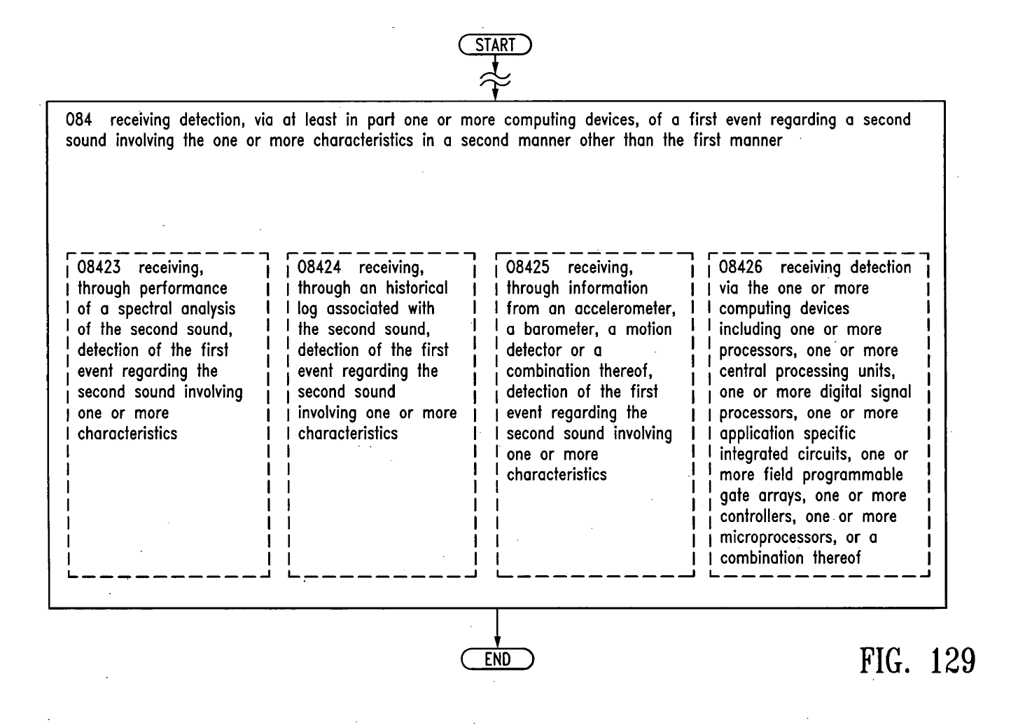

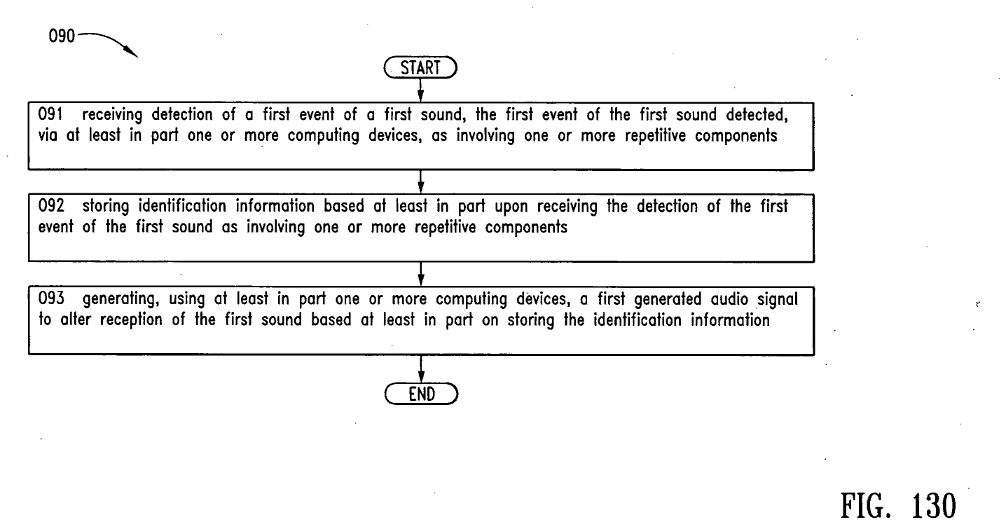

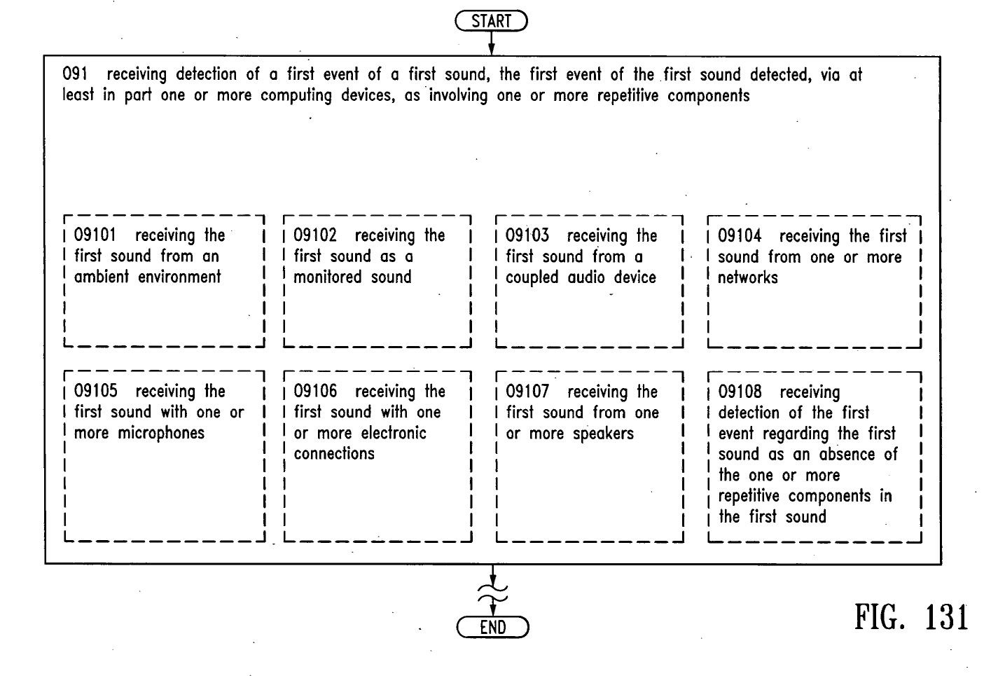

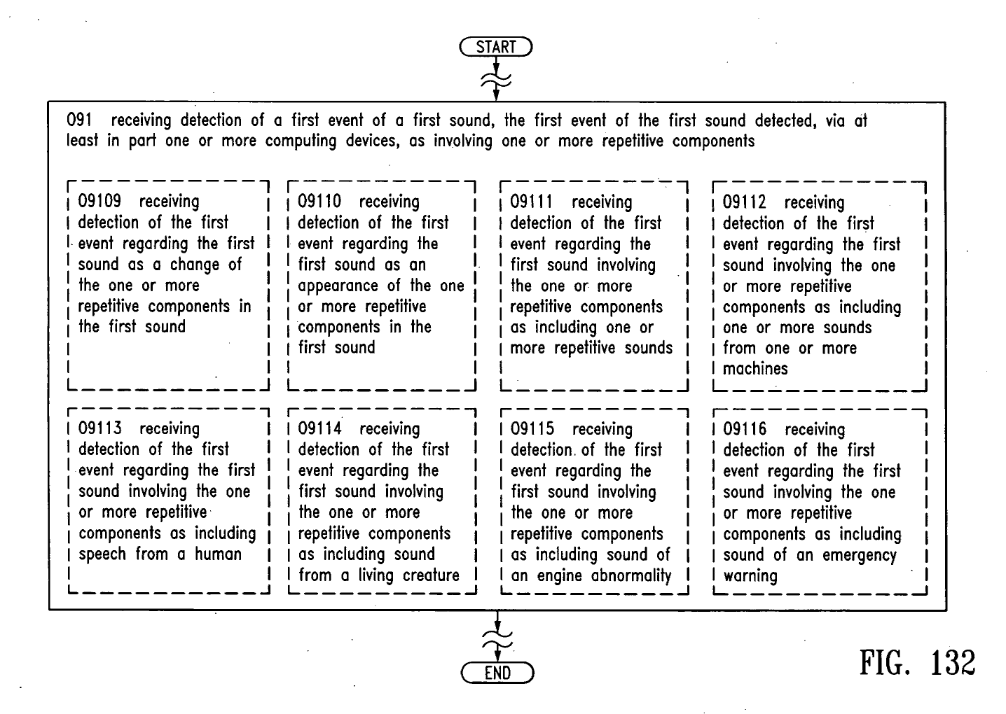

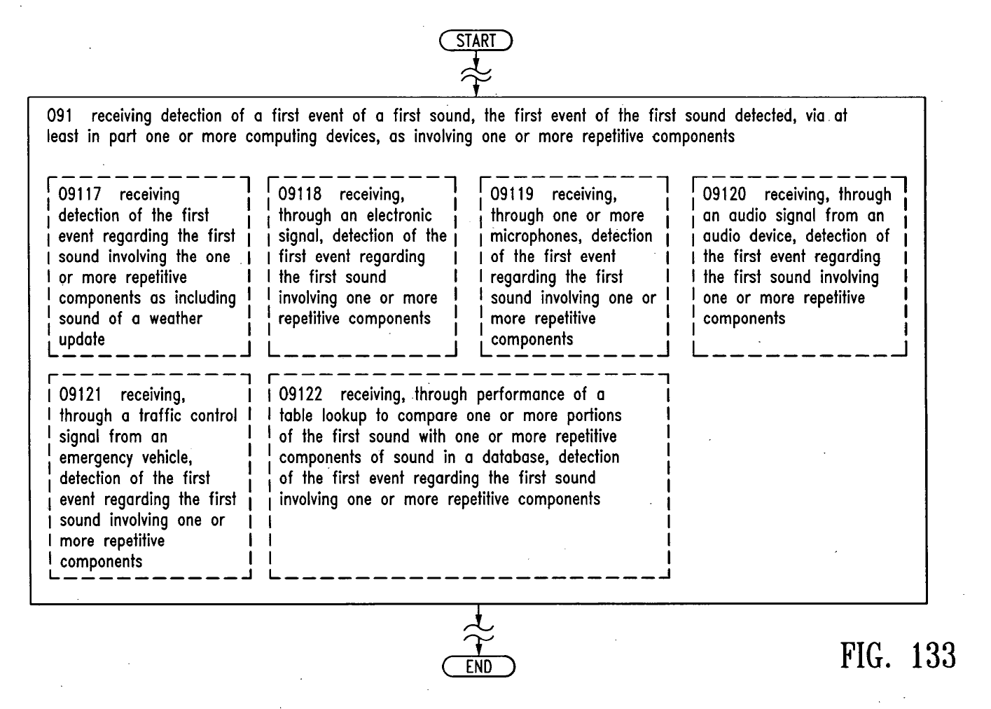

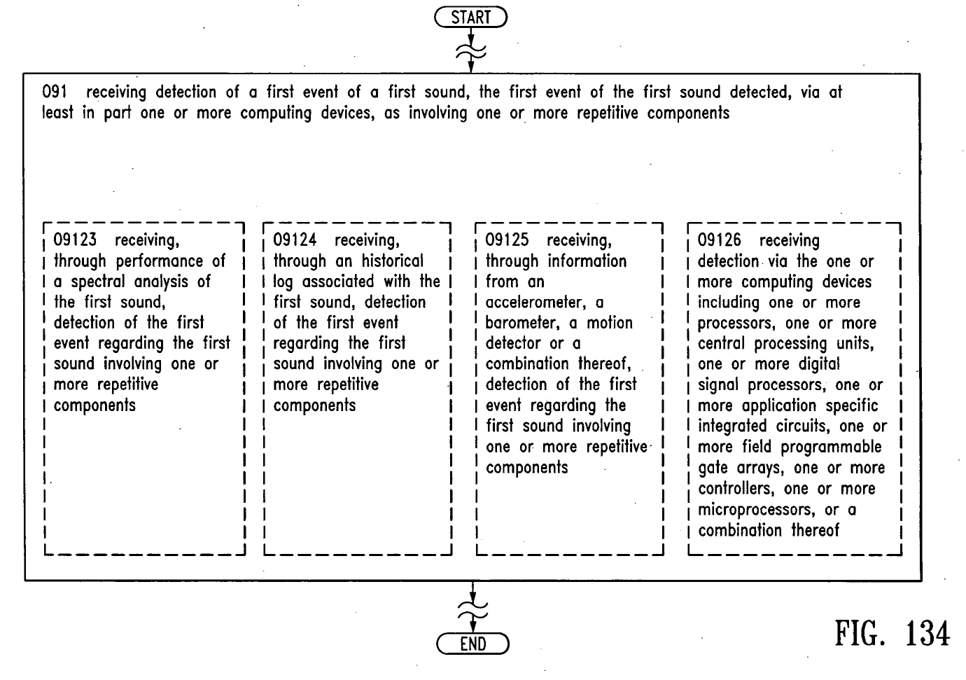

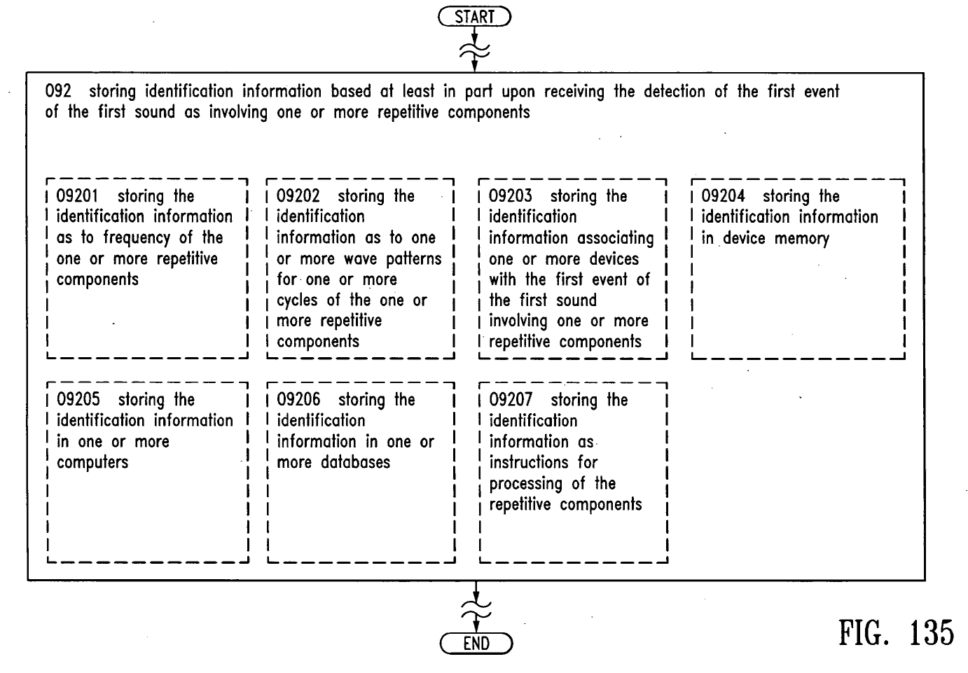

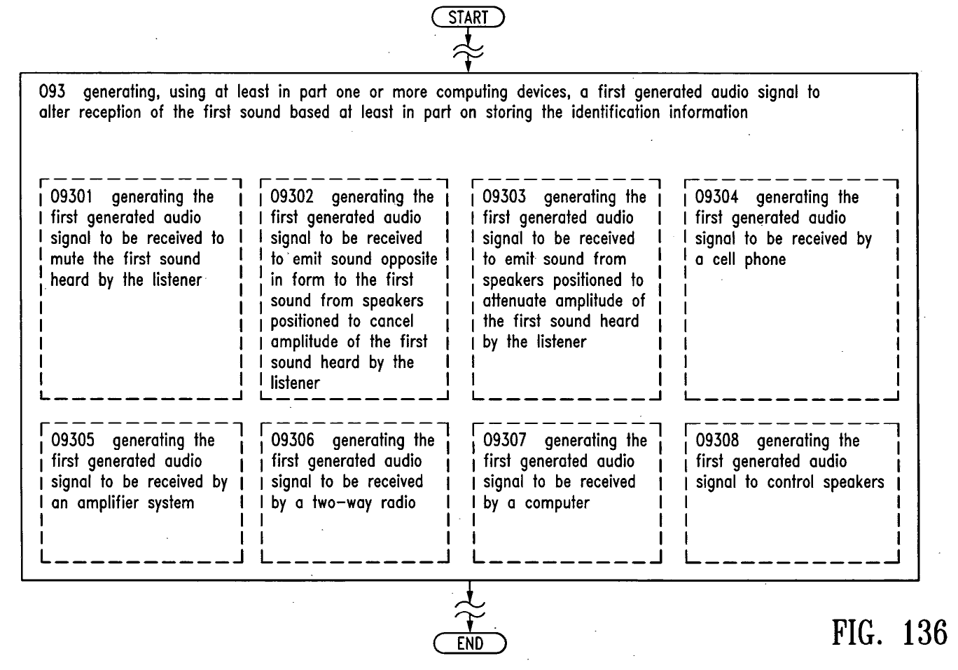

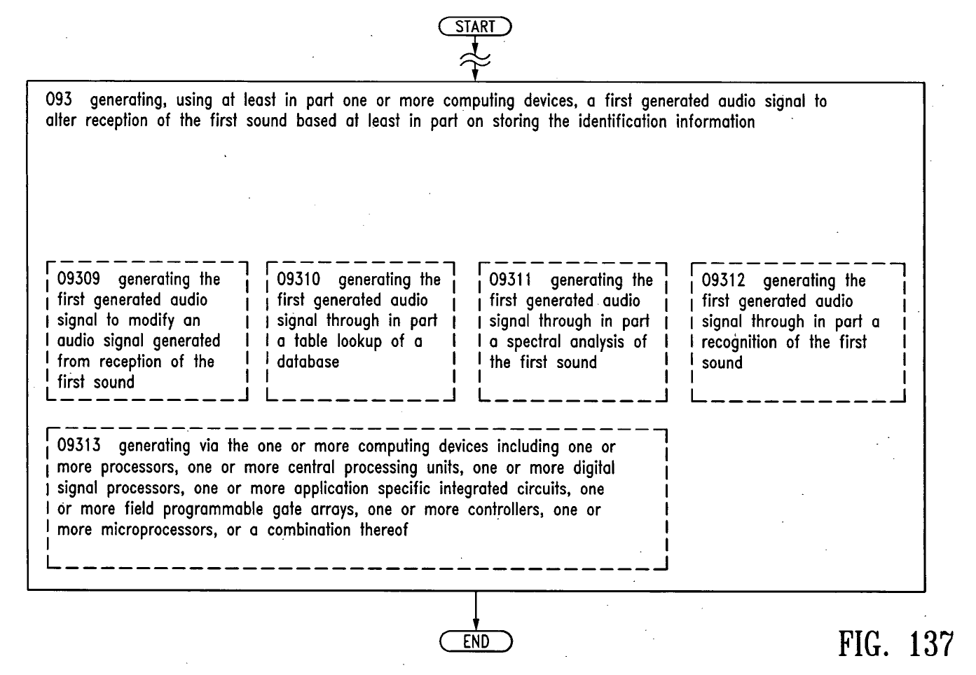

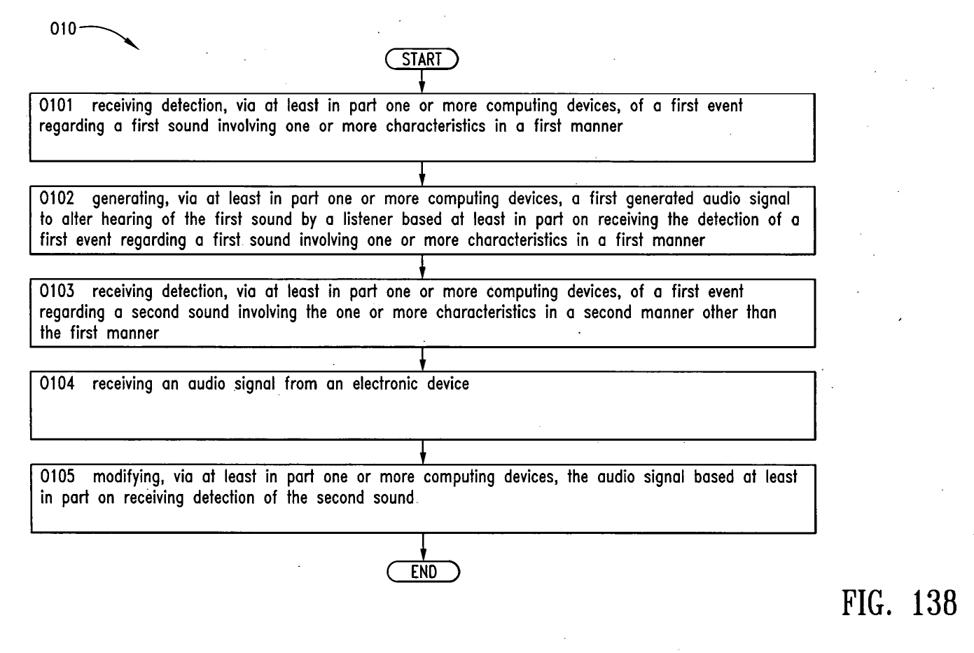

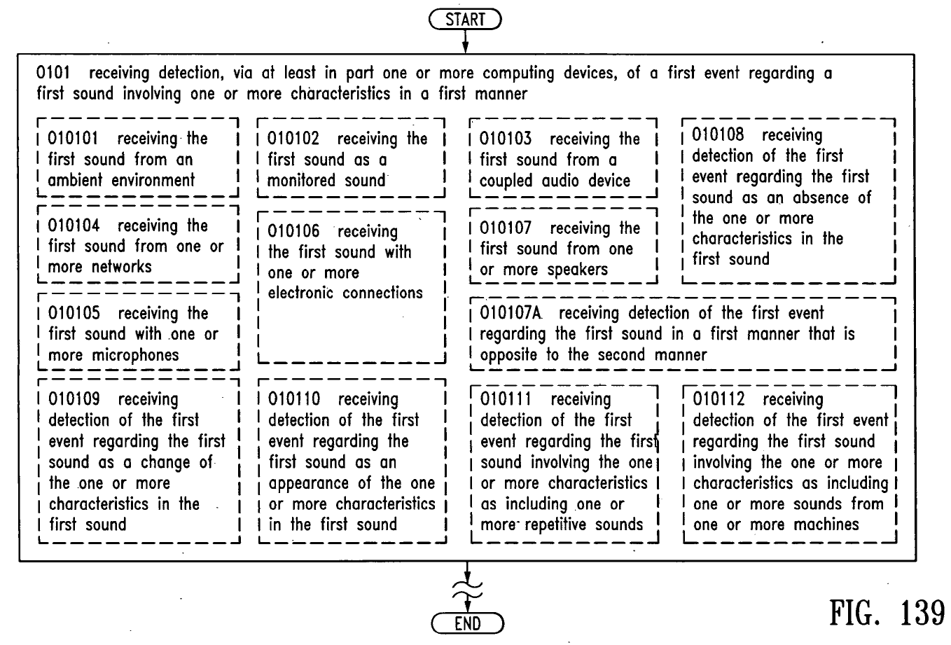

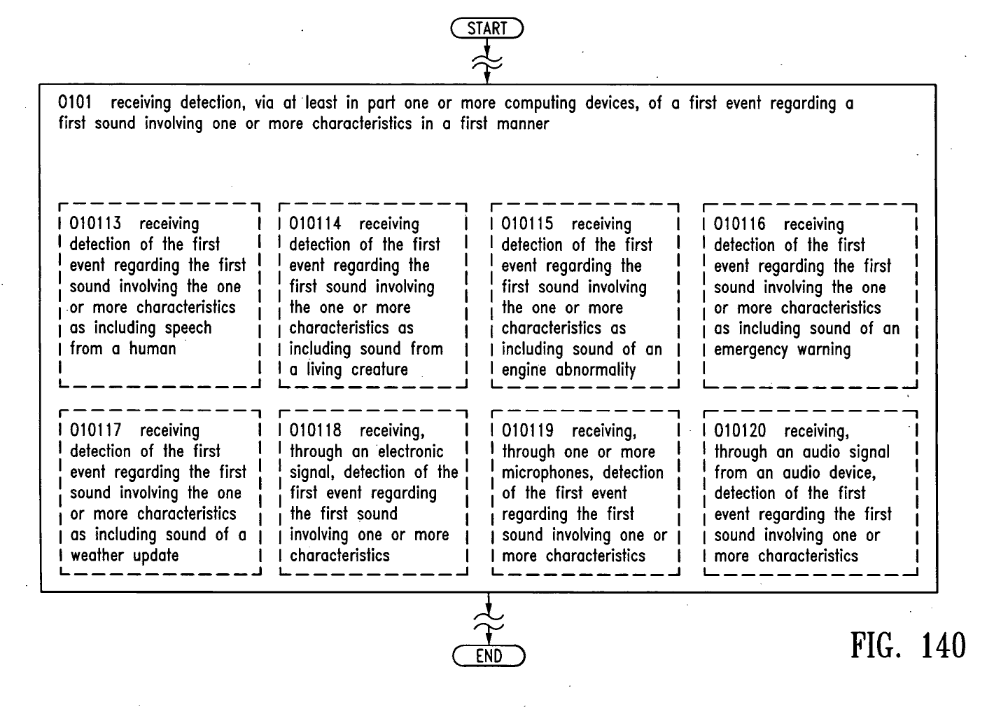

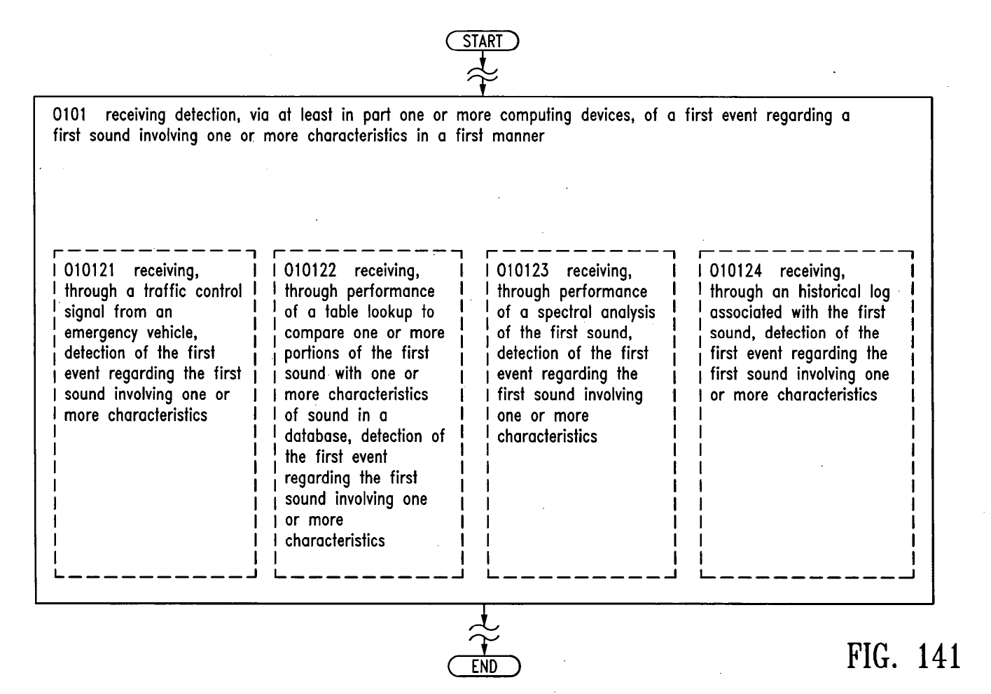

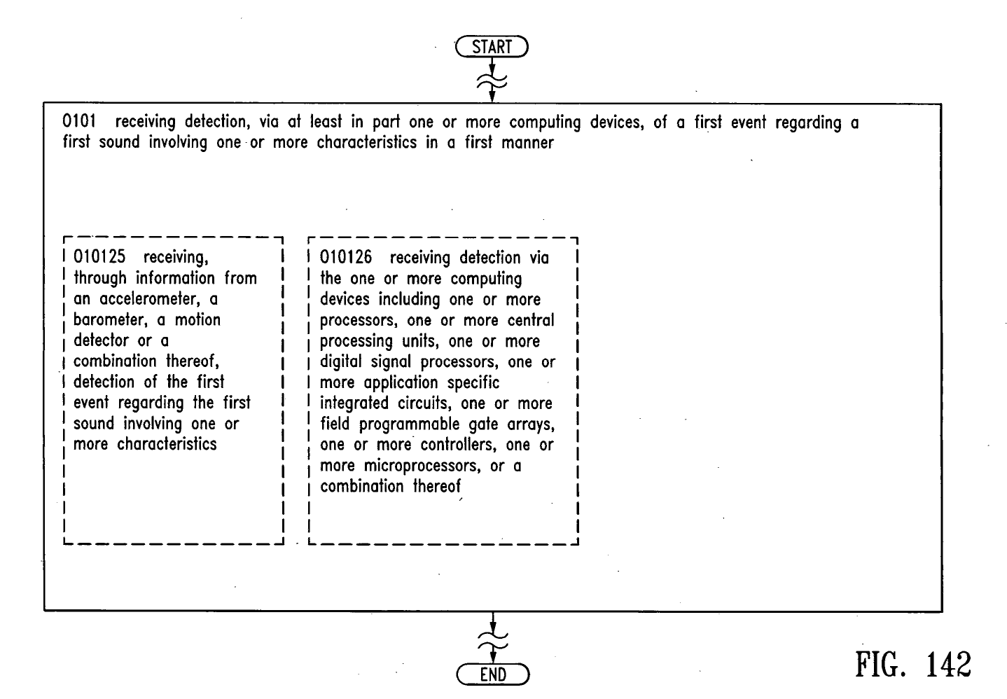

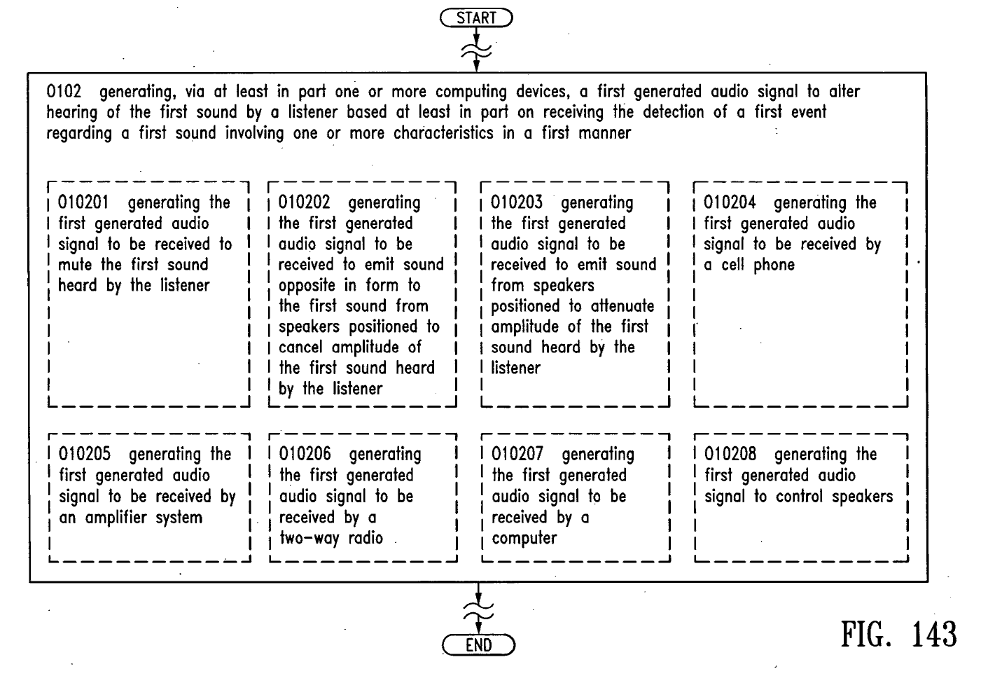

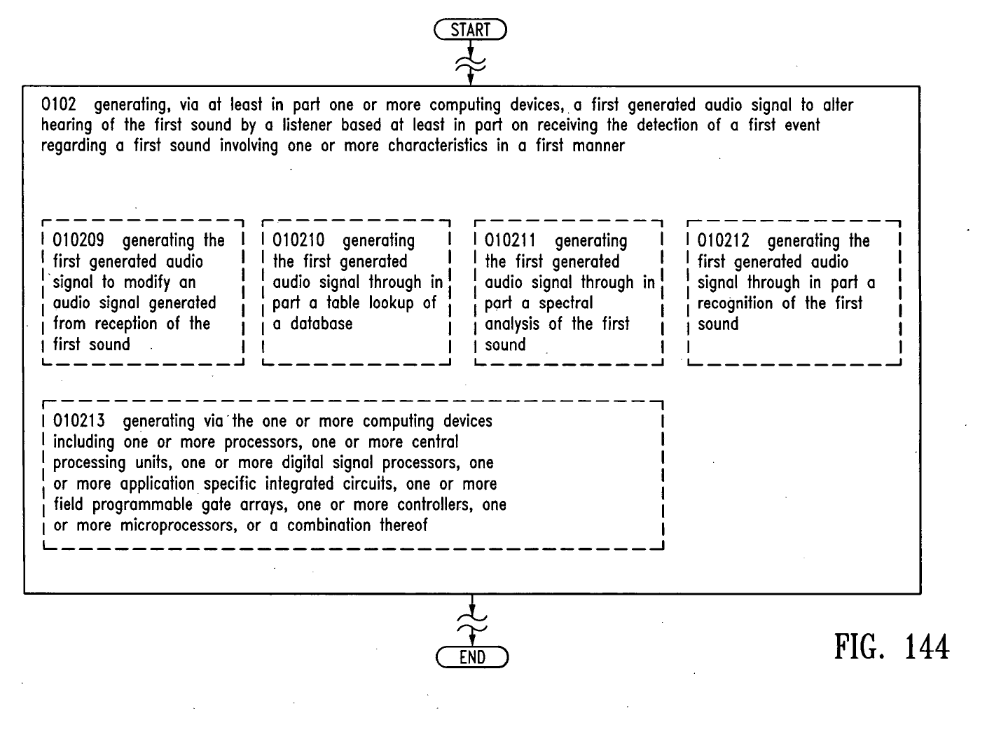

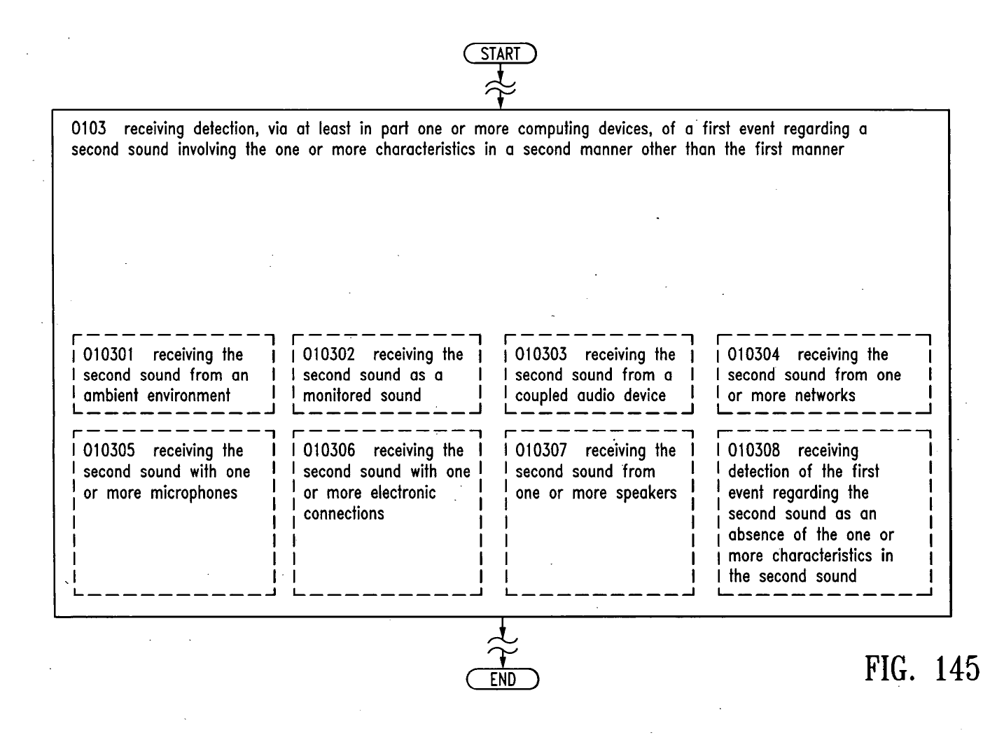

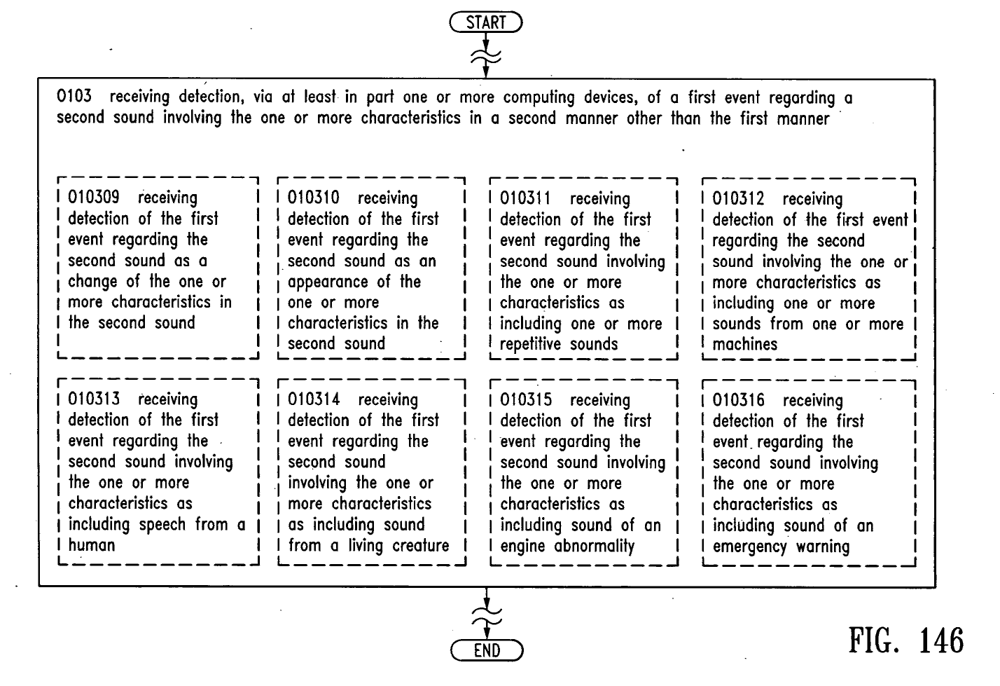

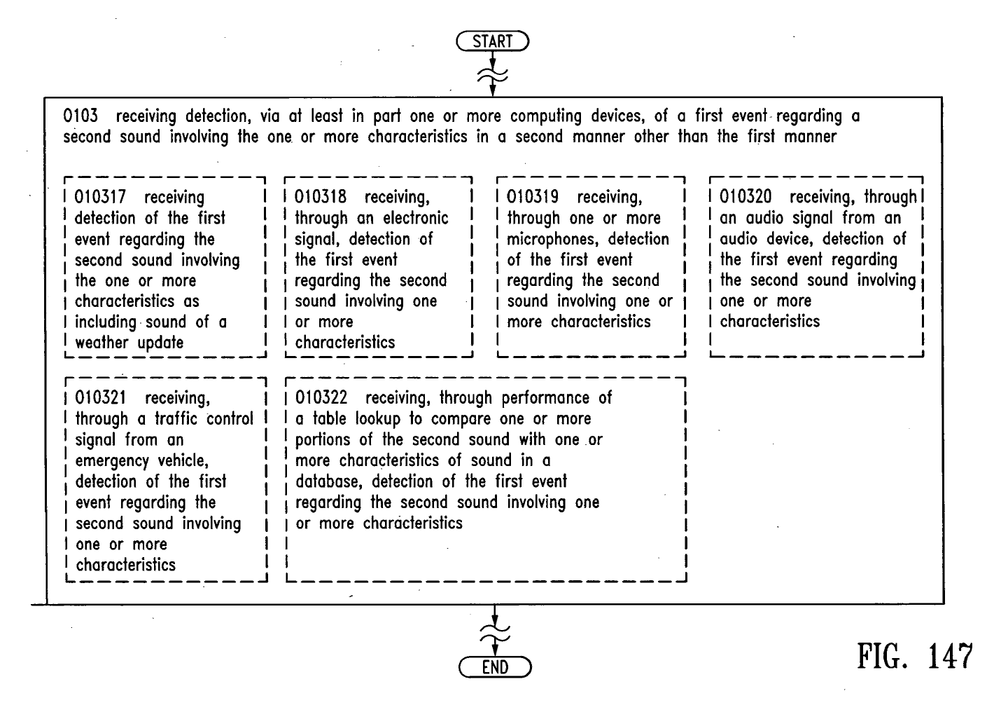

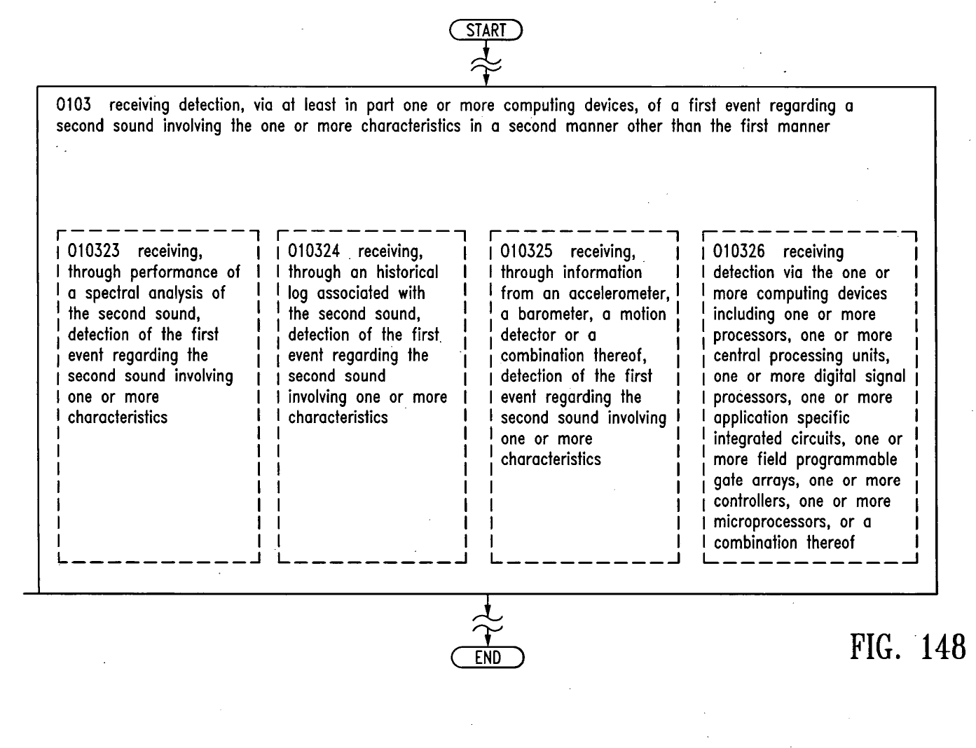

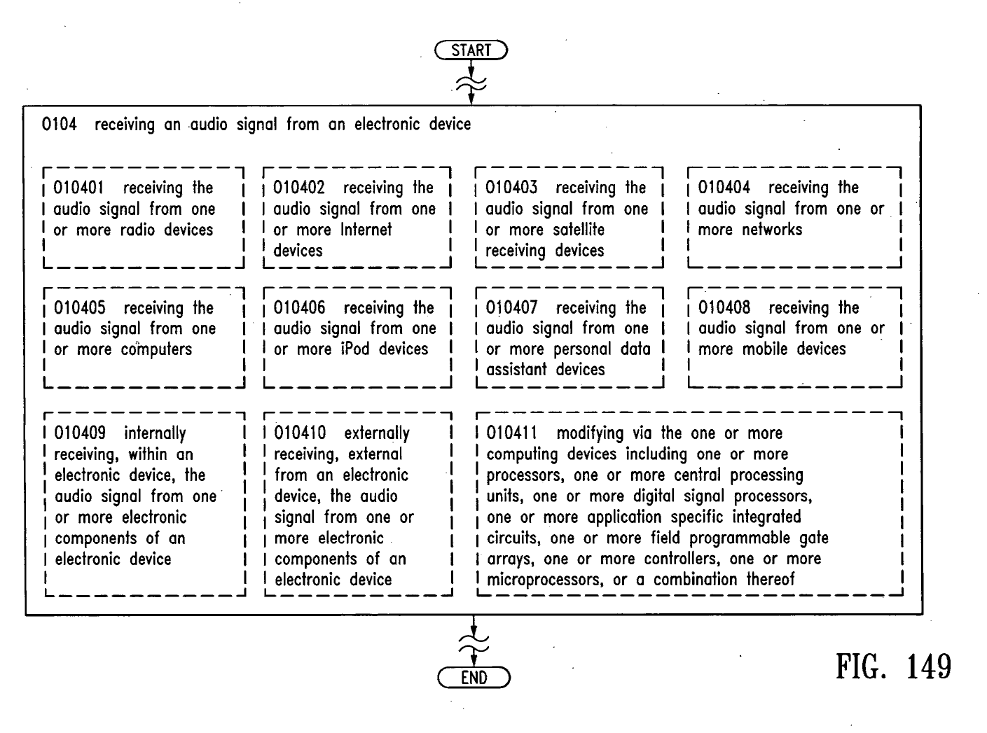

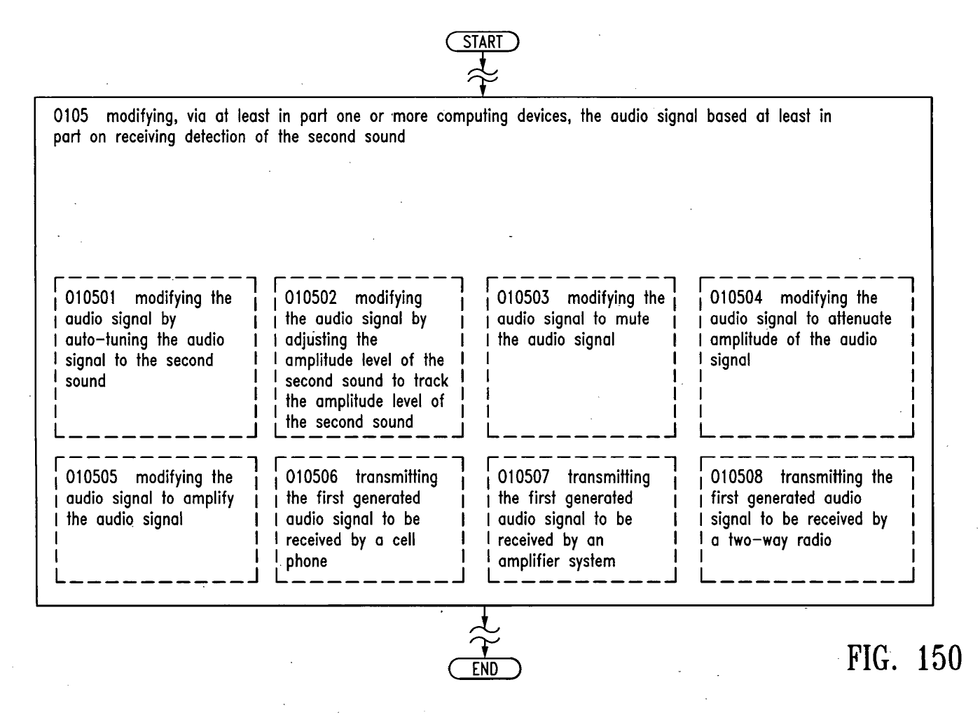

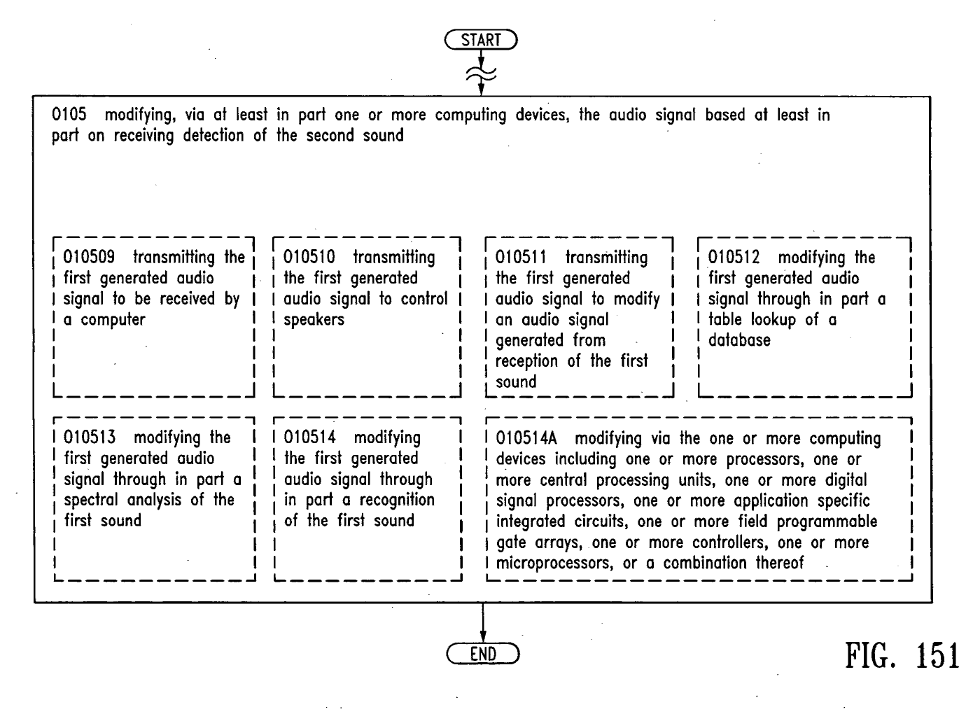

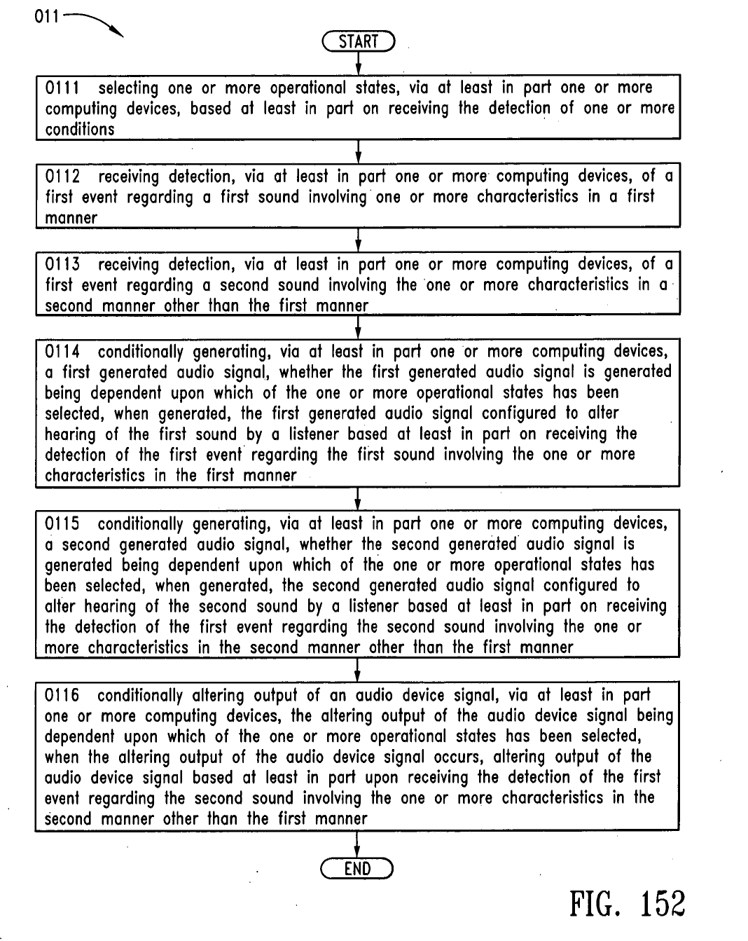

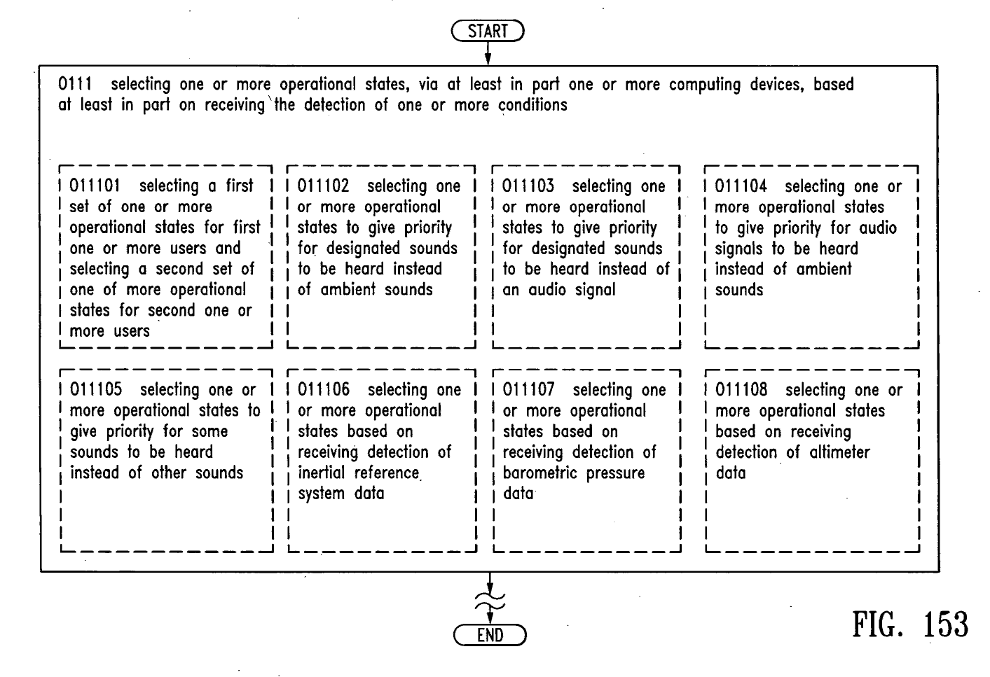

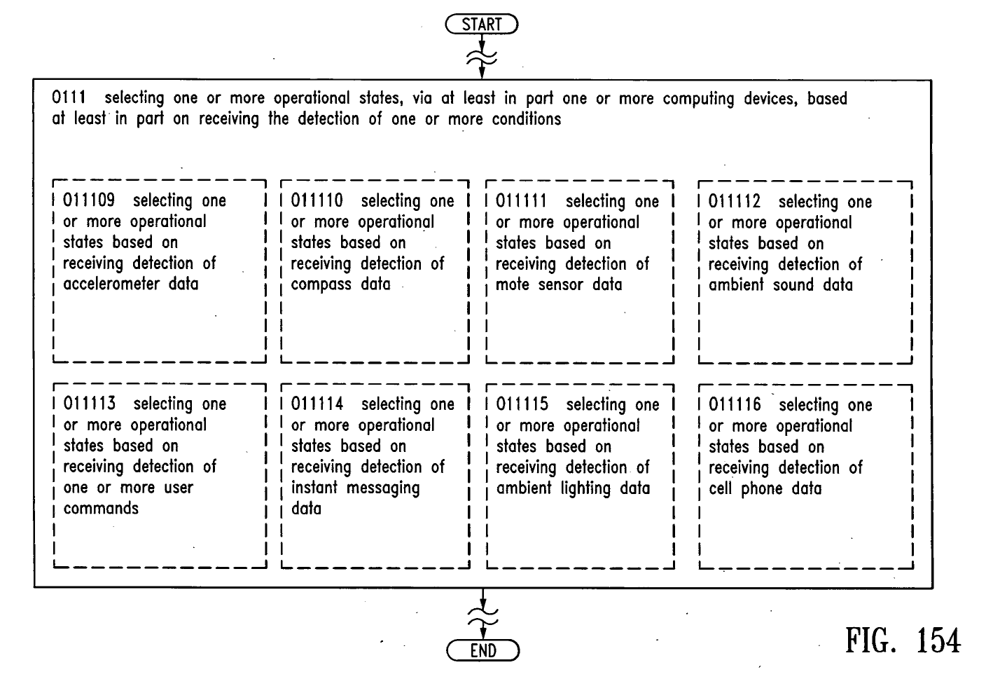

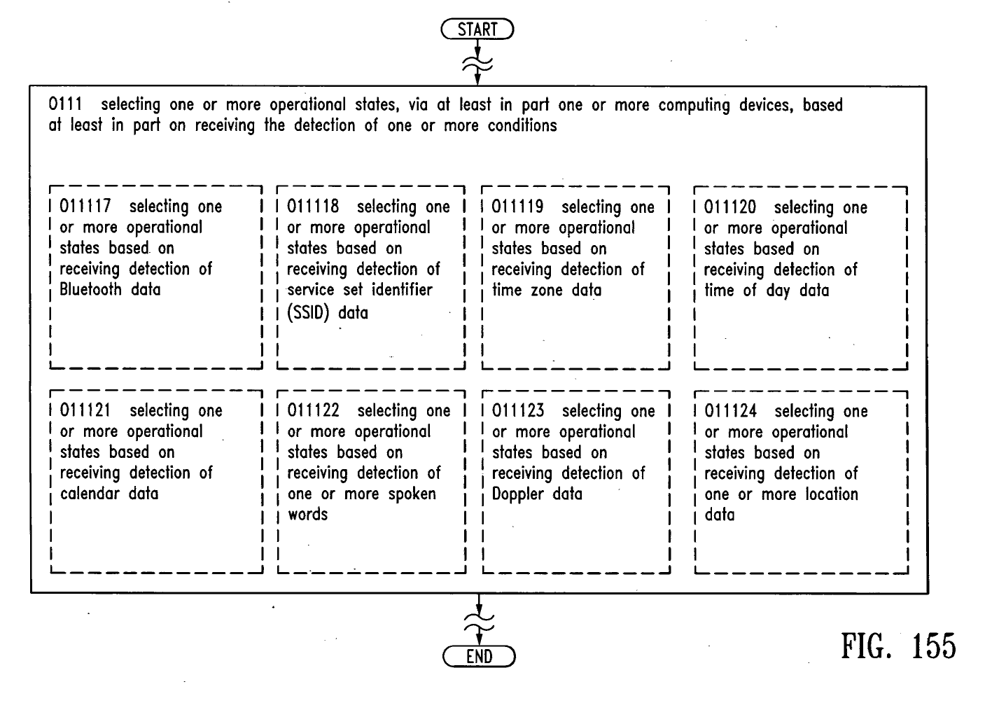

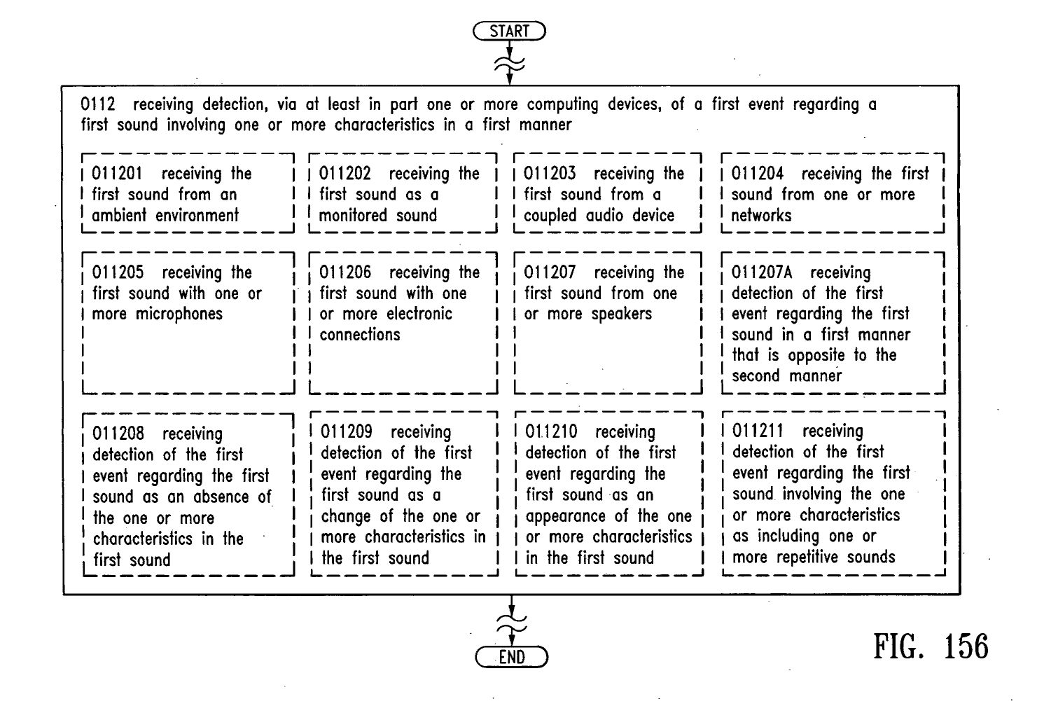

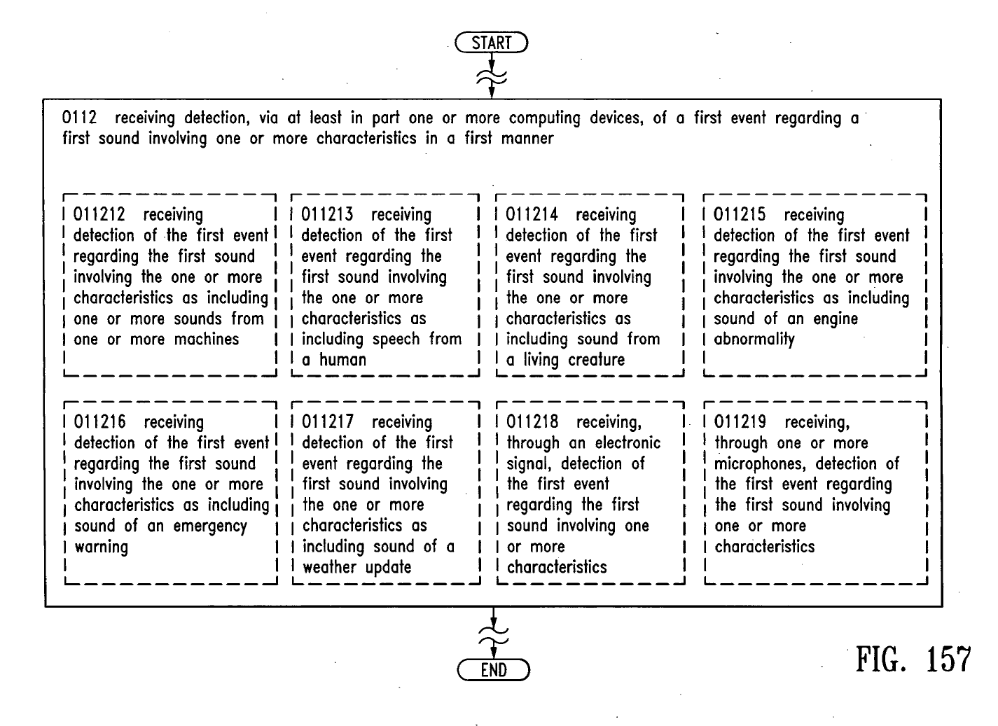

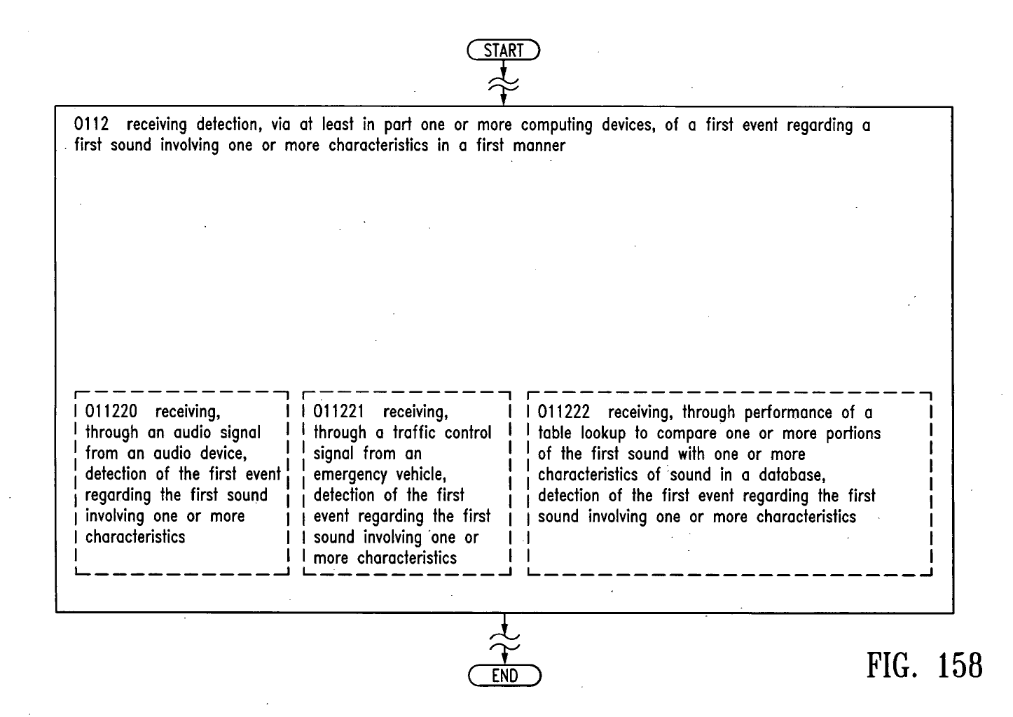

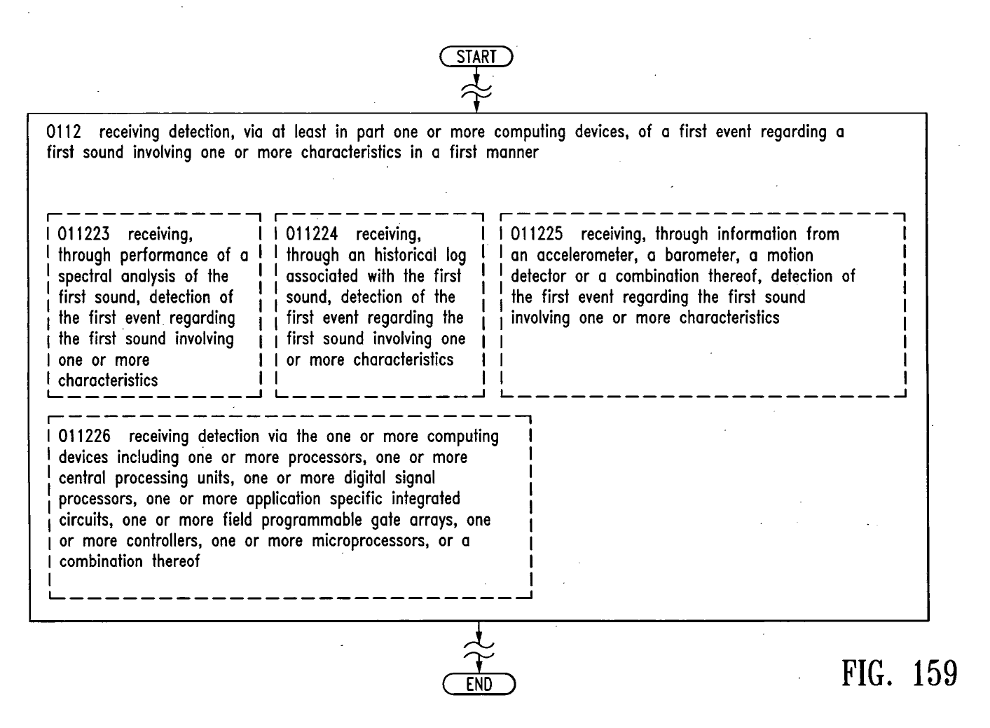

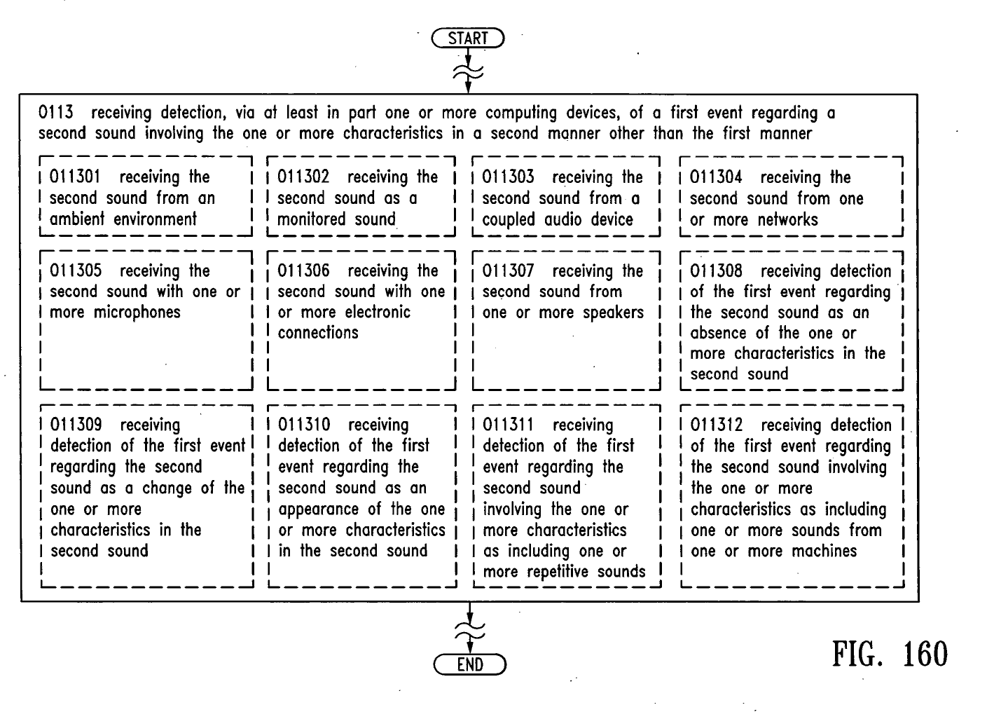

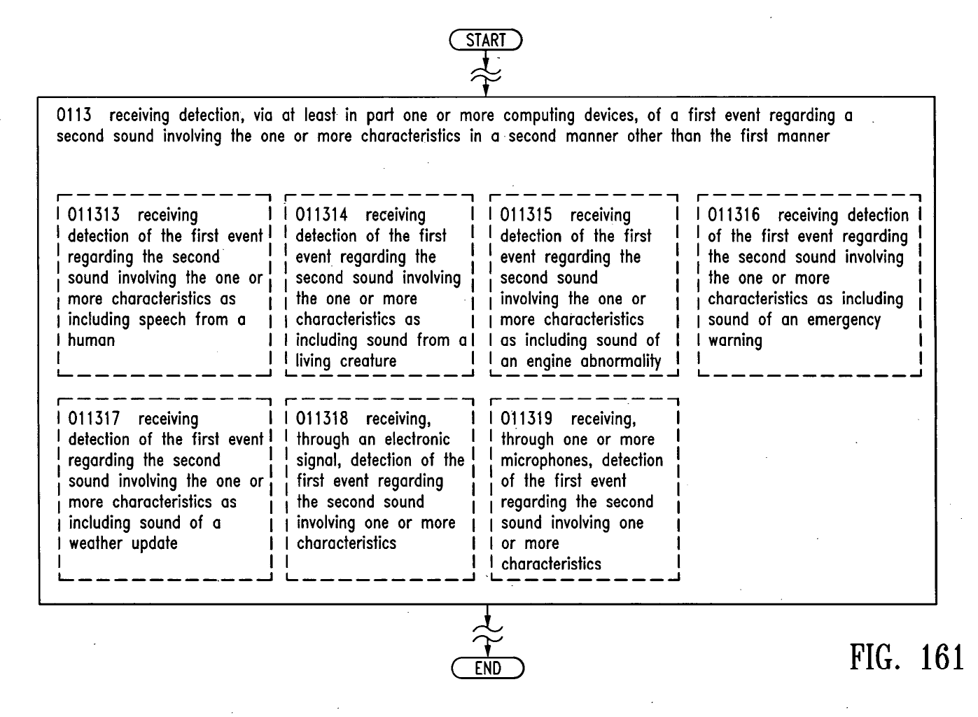

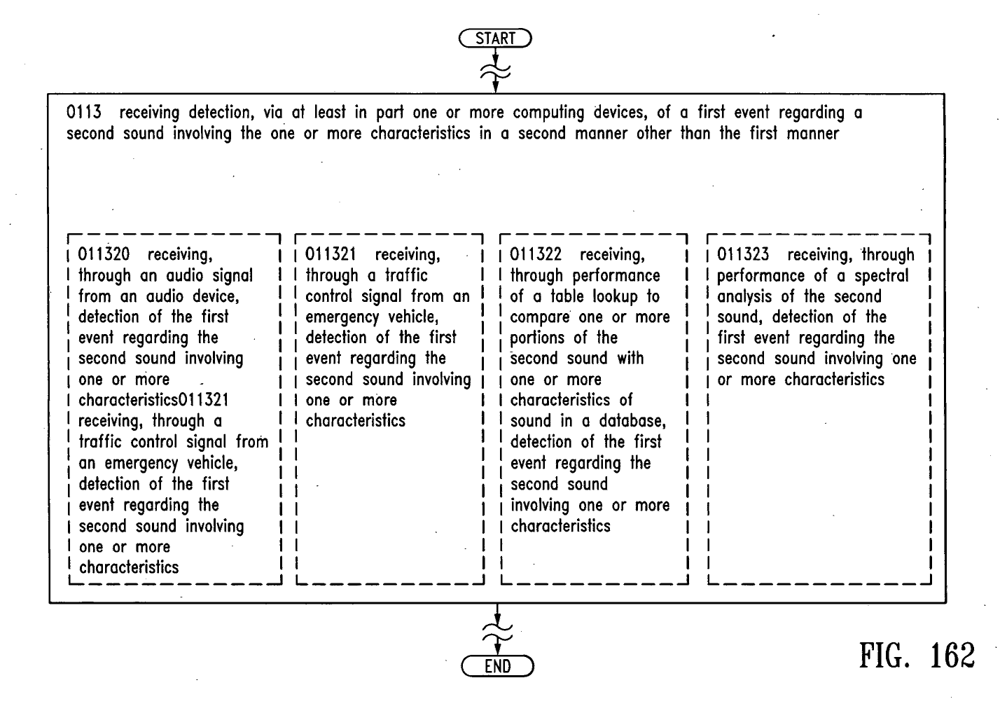

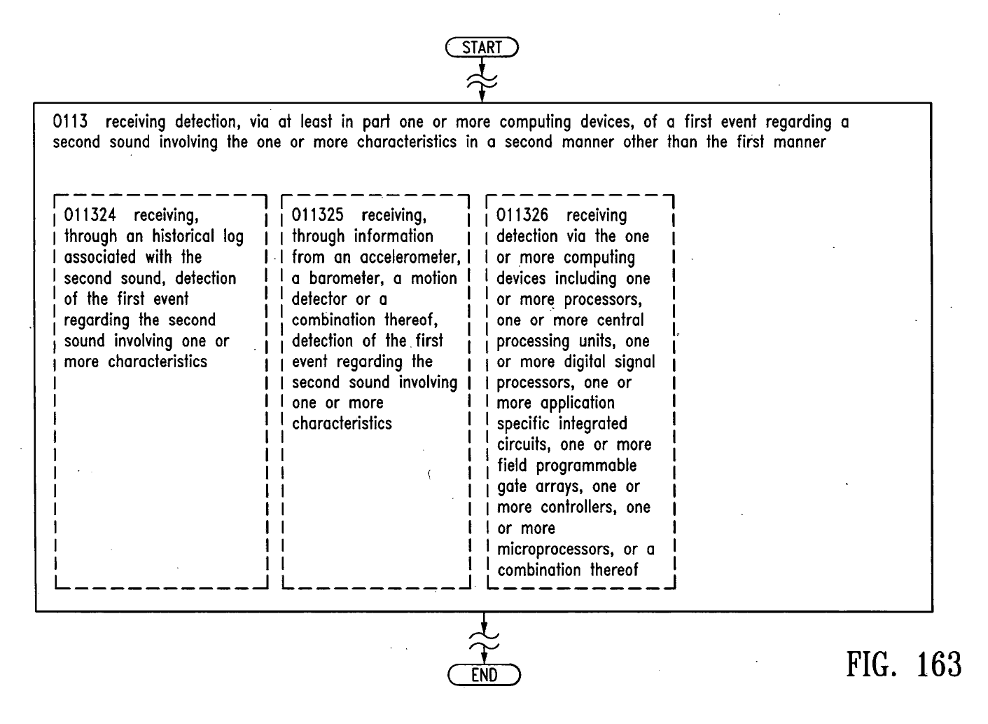

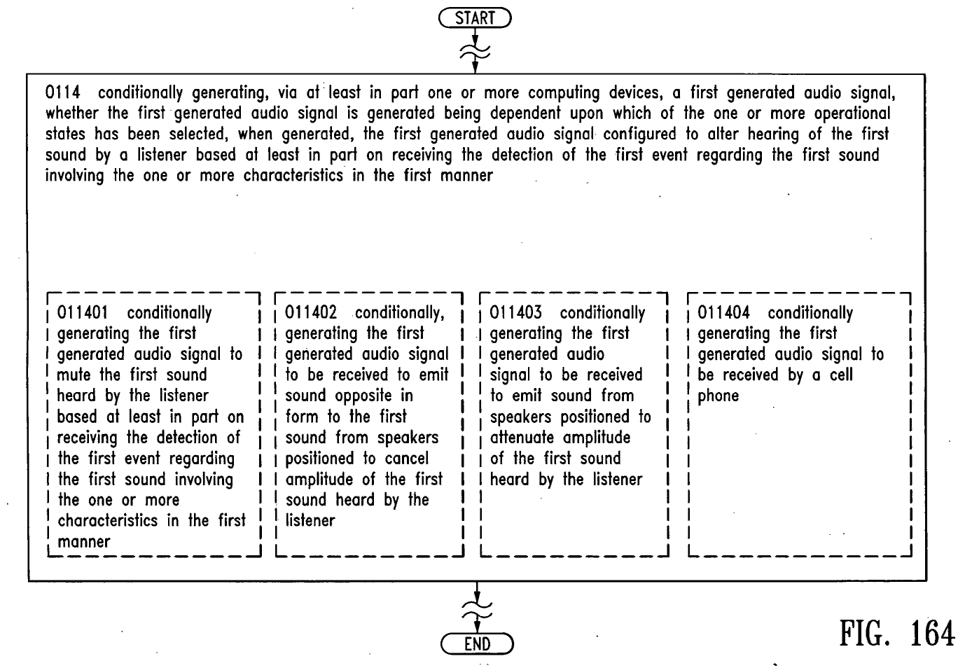

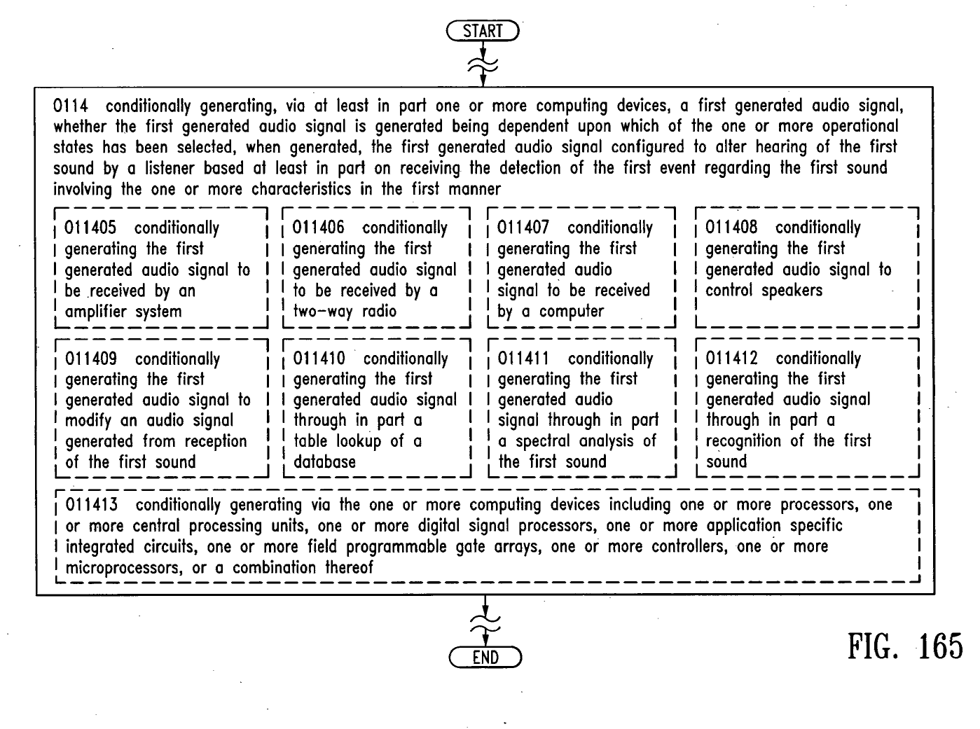

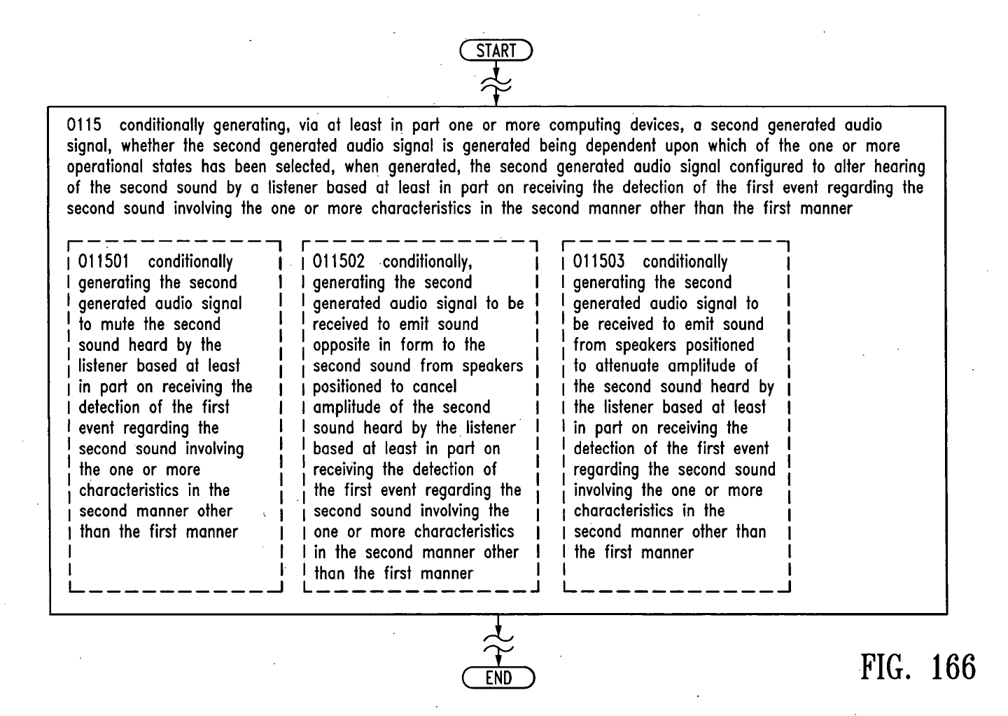

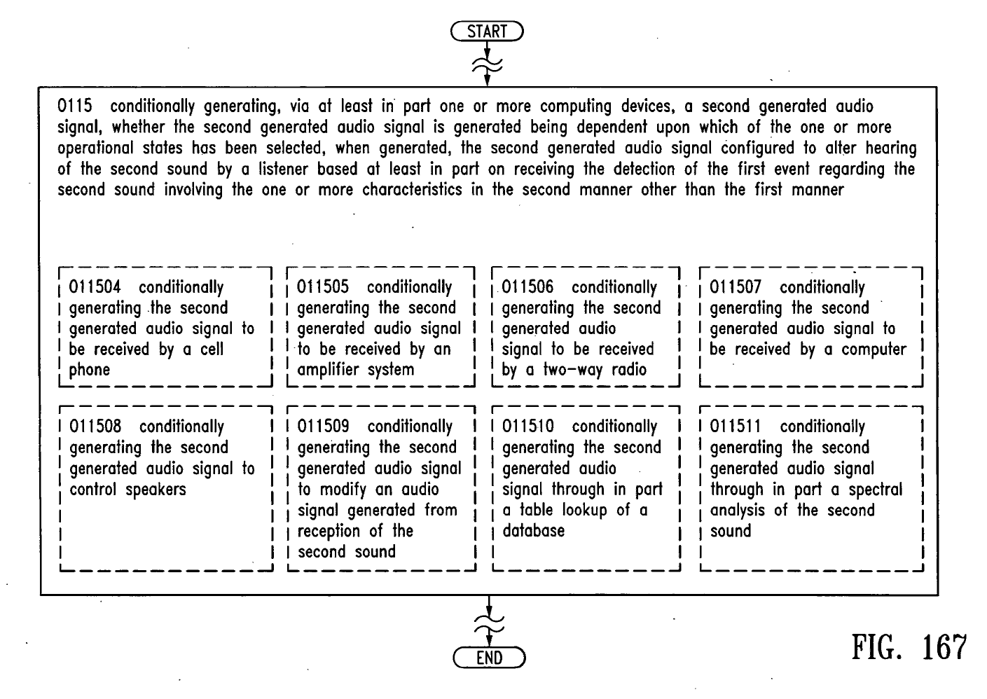

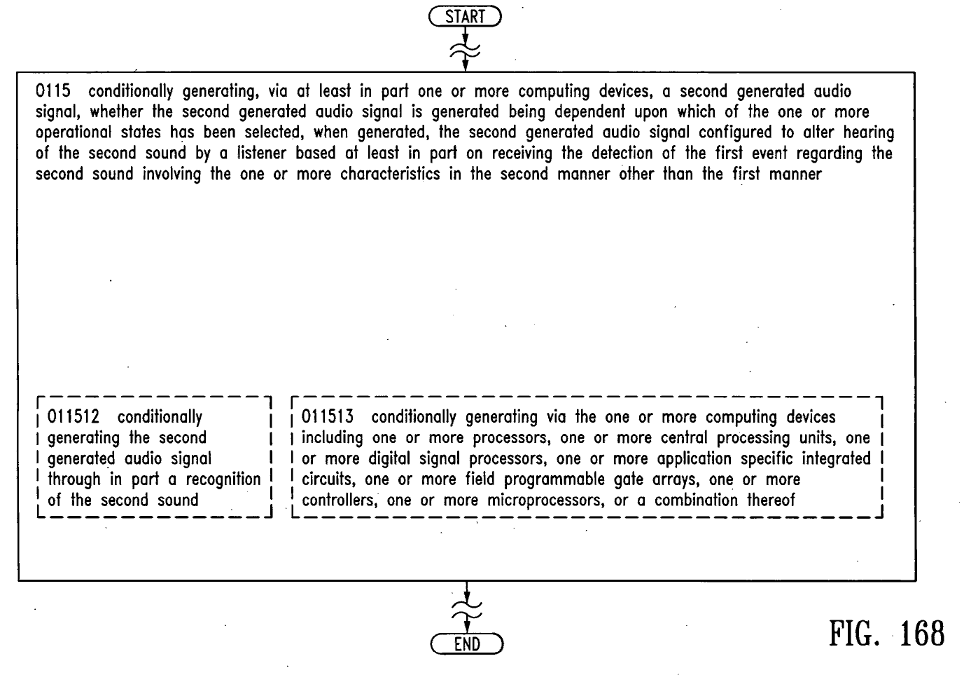

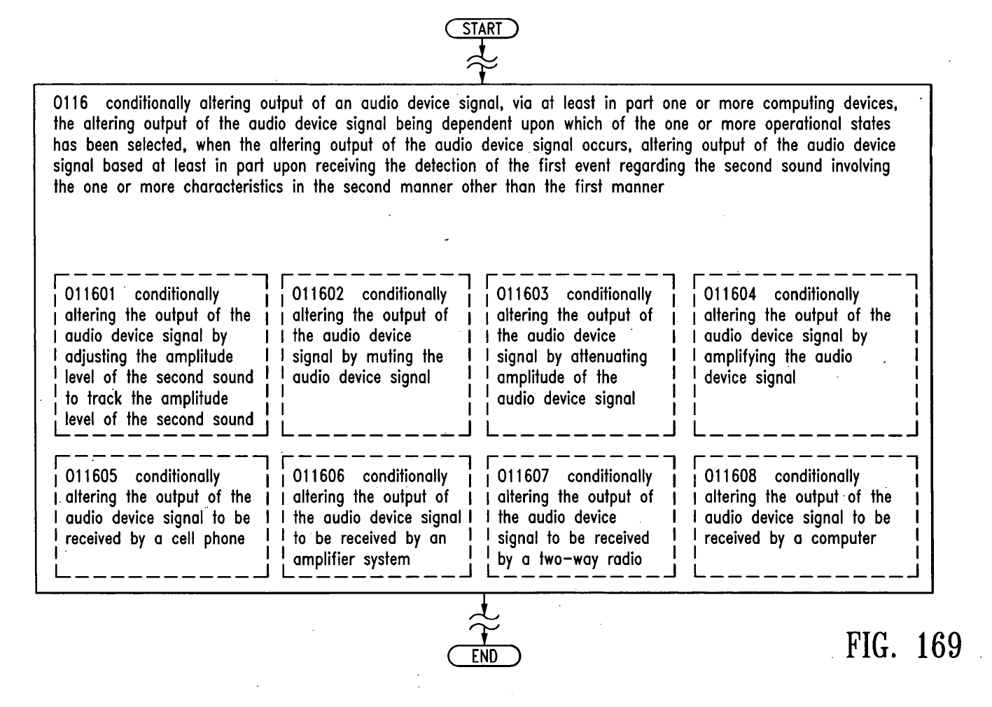

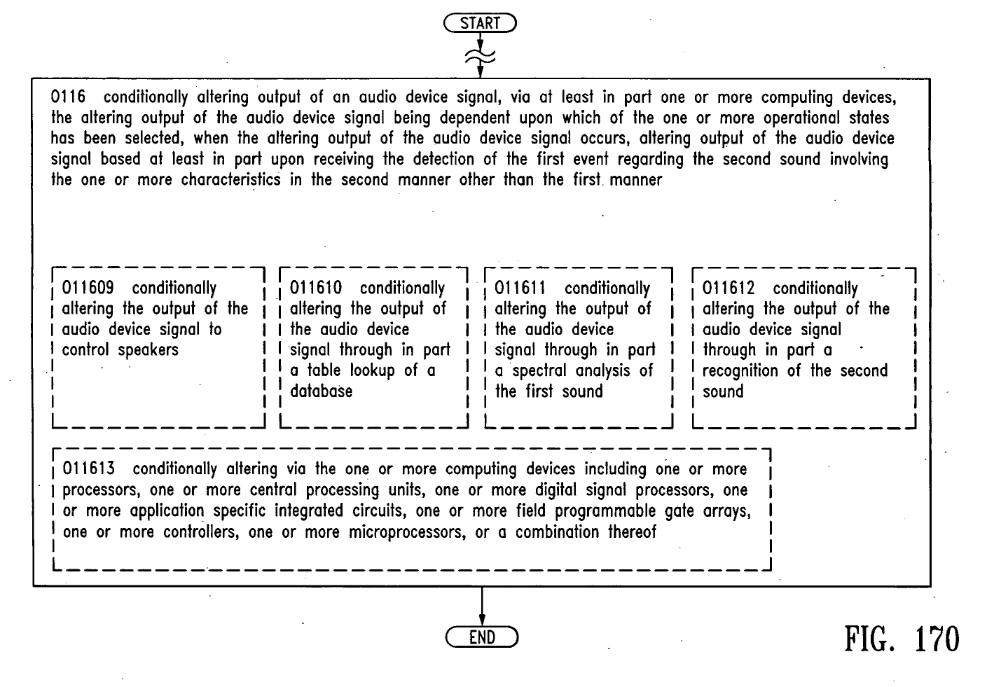

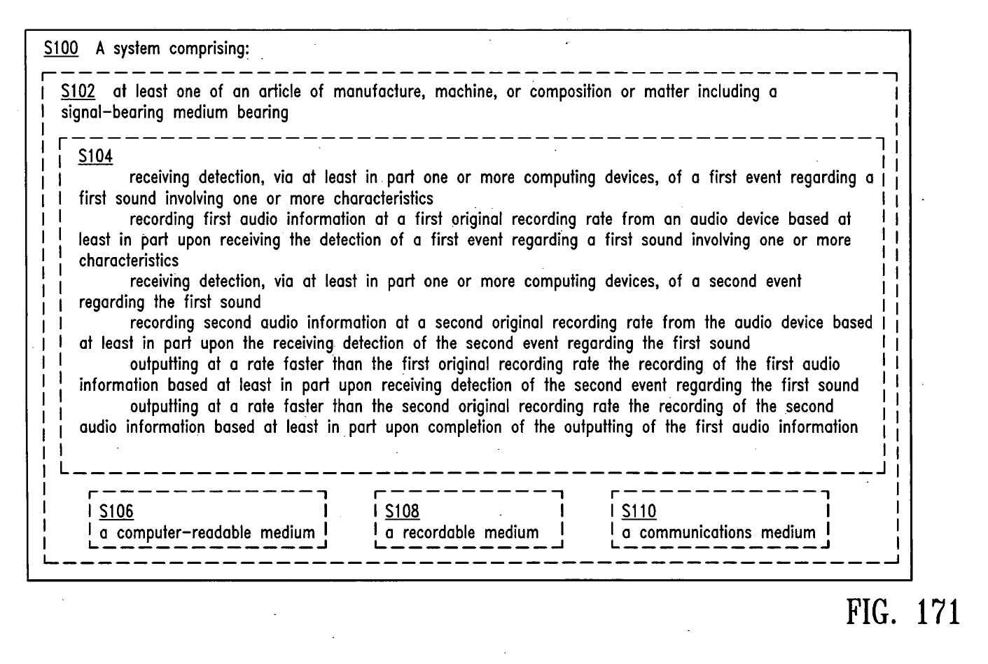

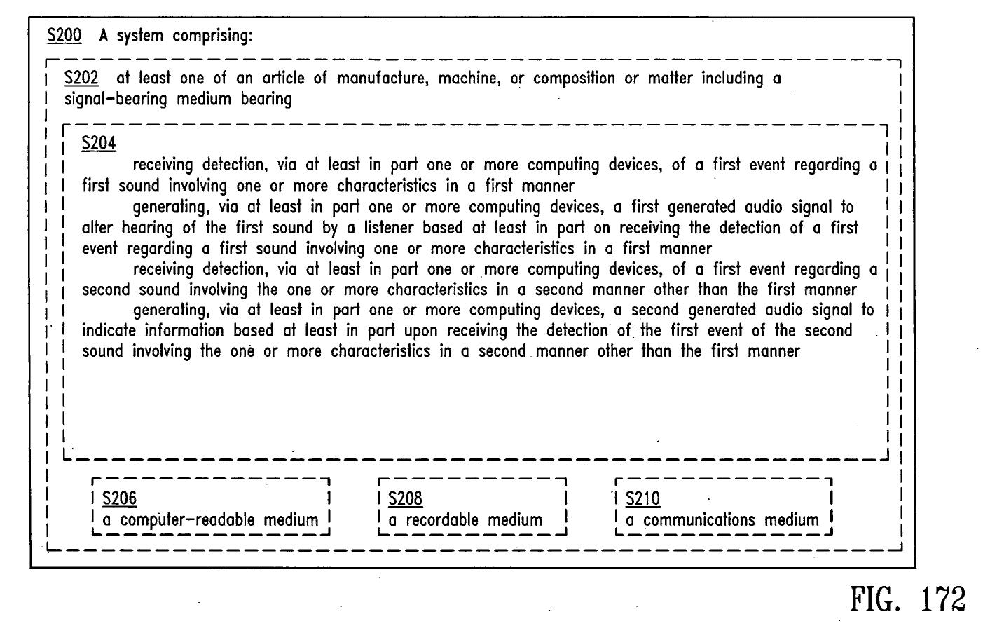

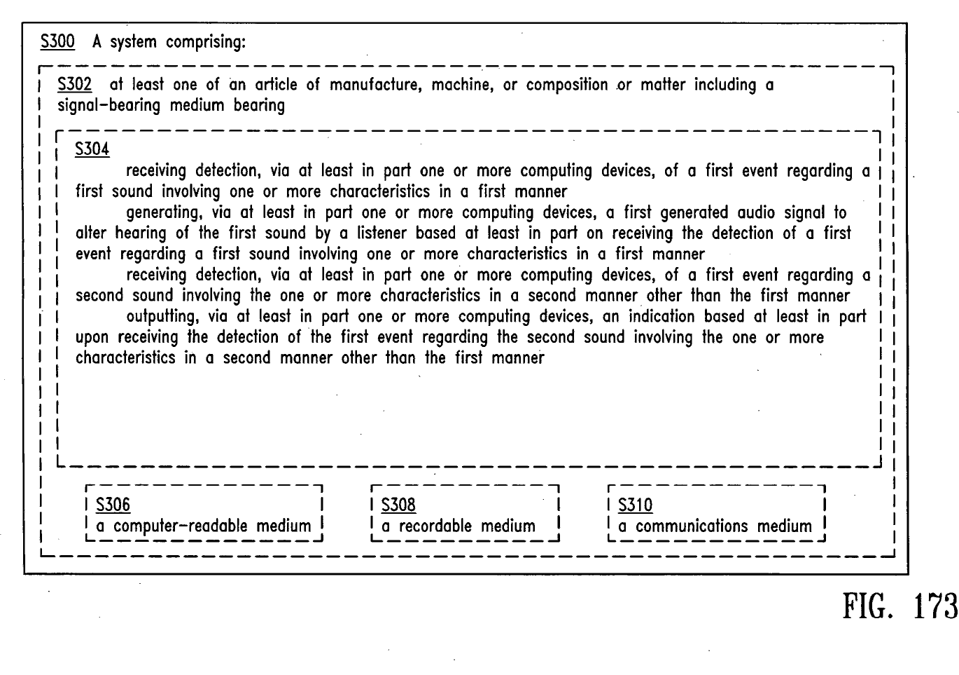

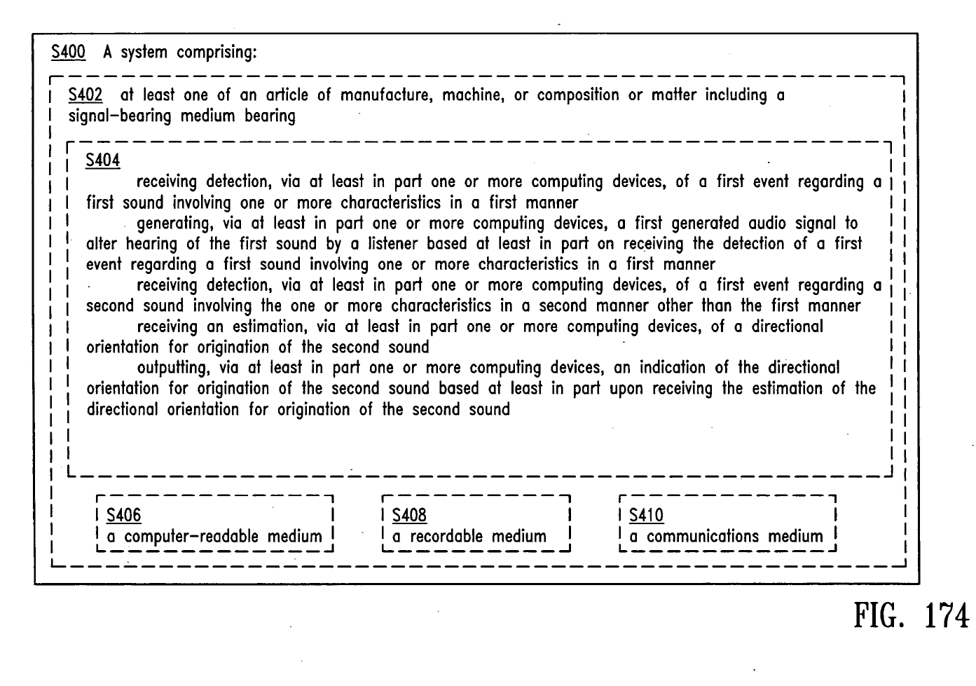

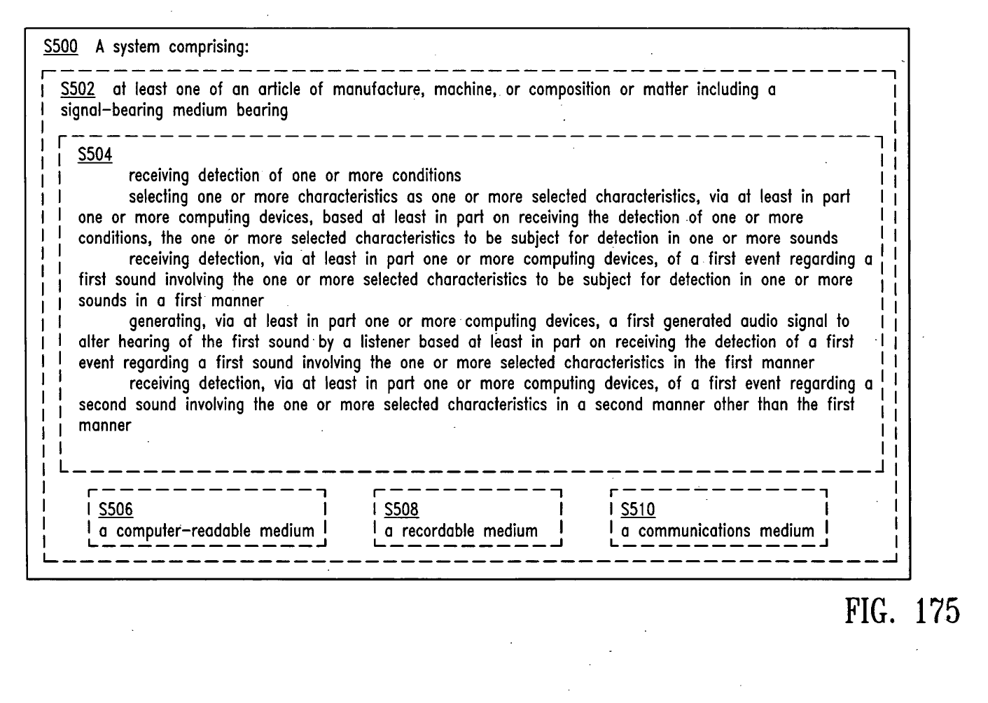

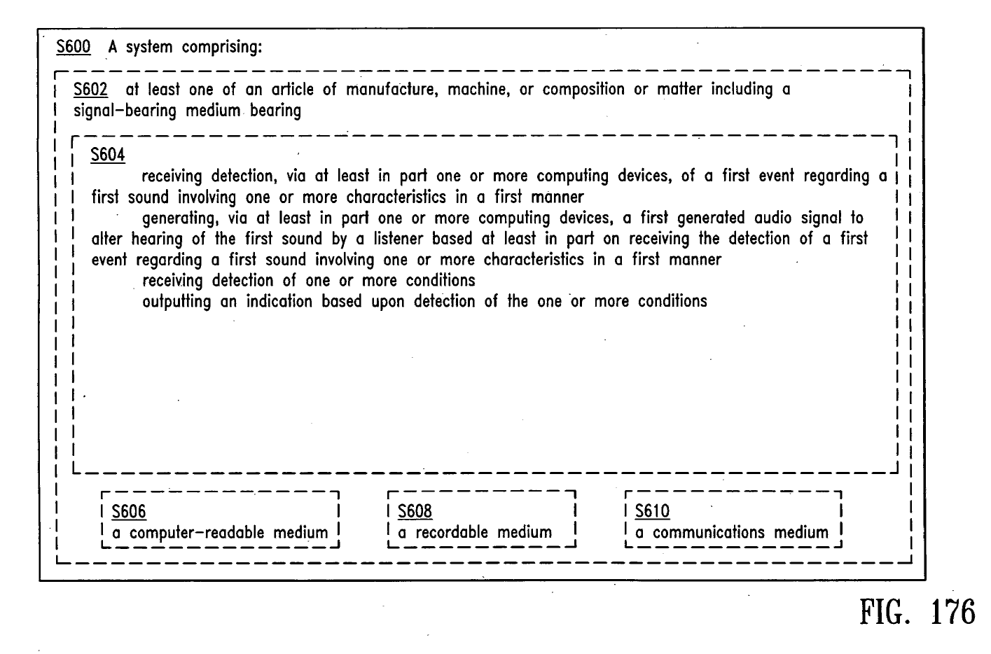

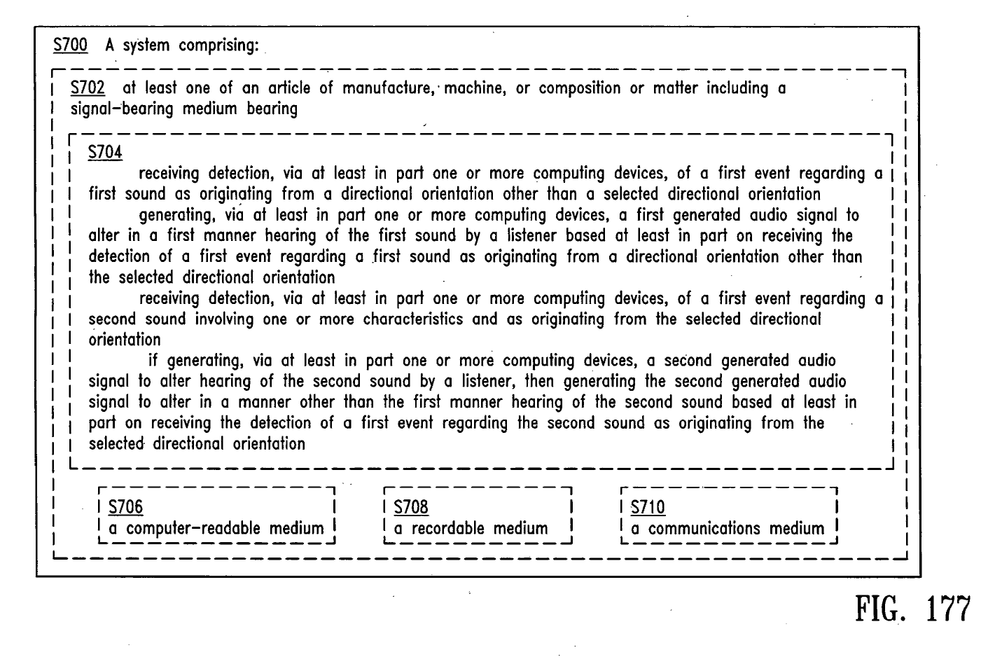

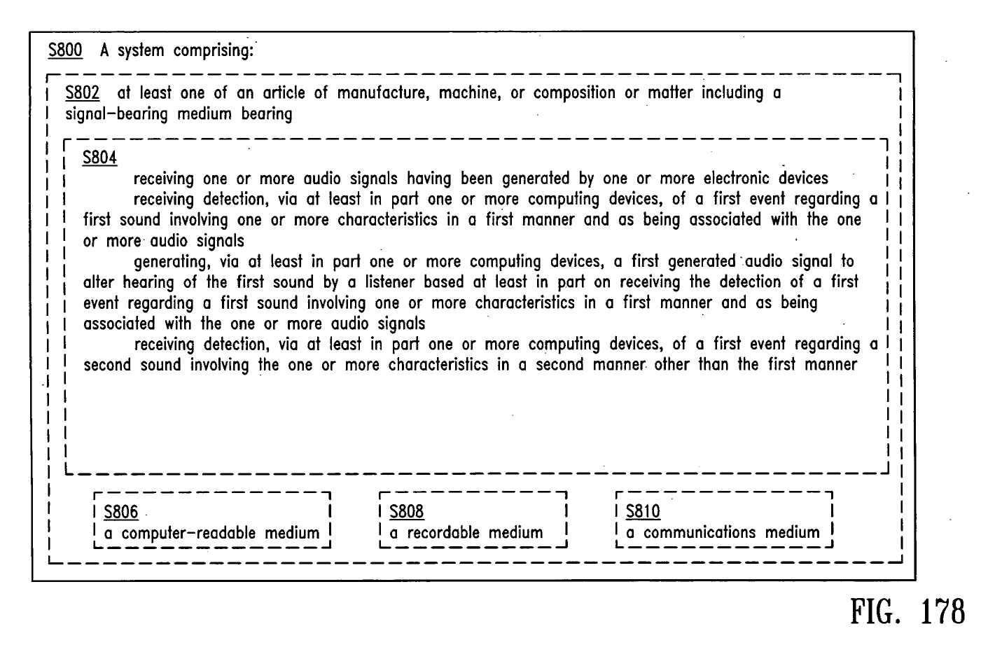

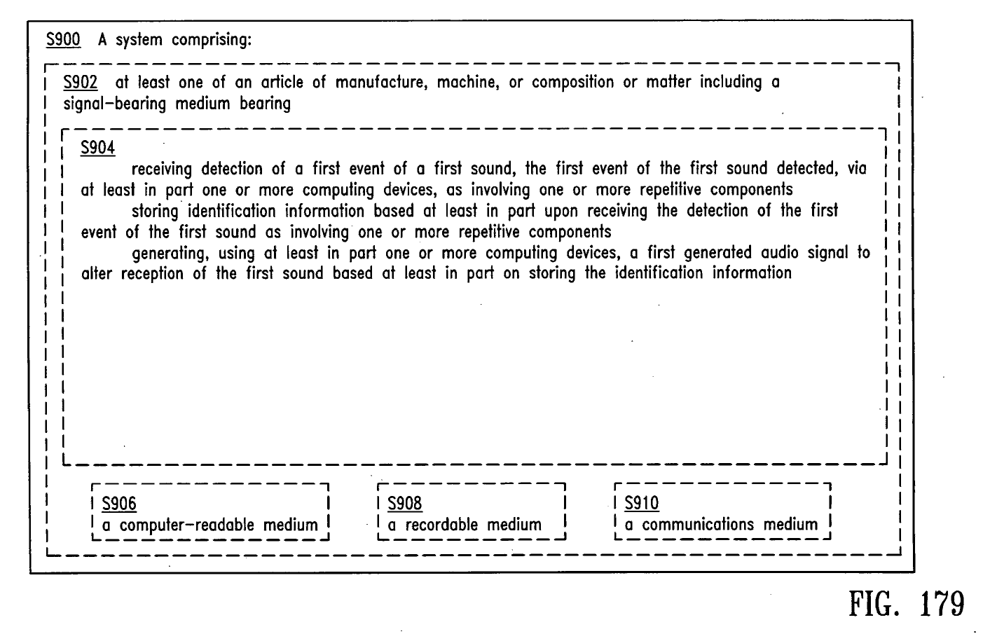

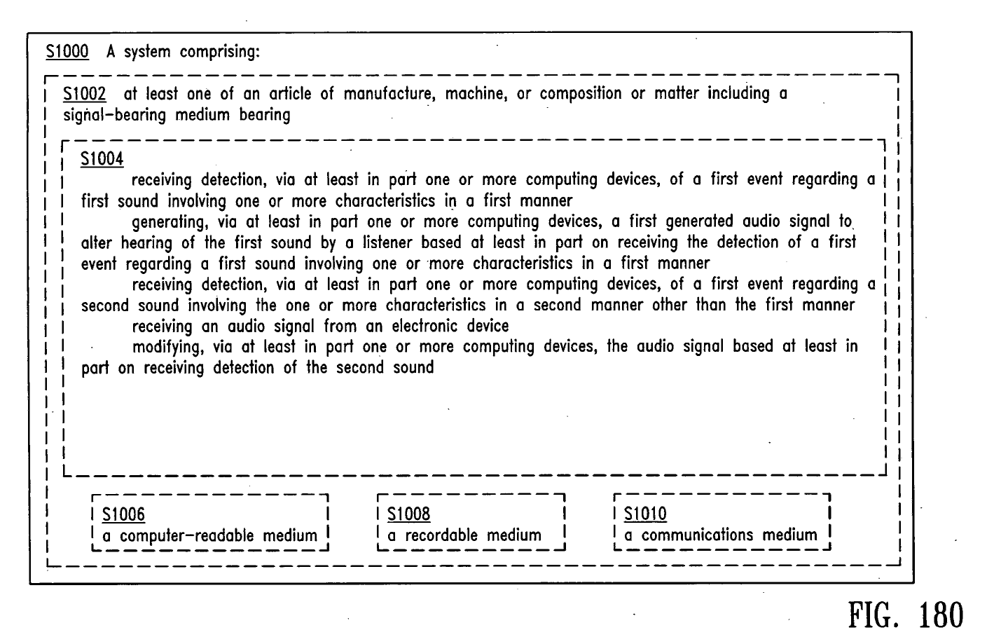

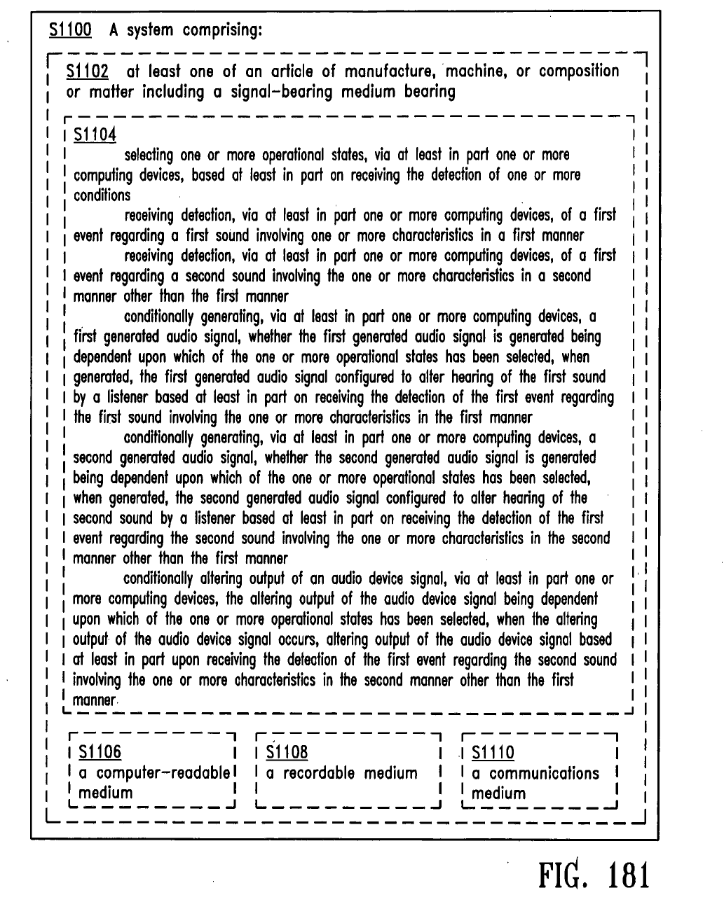

Certain embodiments of a high-level flowchart of a audio/sound technique 2200 is described with respect to FIG. 11 (including FIGS. 11a to 11c) and can include, but is not limited to, operations 2202 and 2204, and optional operations 2220, 2222, 2224, 2226, 2228, 2230, 2232, 2236, 2238, and/or 2240. Certain embodiments of operations 2004 can include, but is not limited to, optional operation 2210, 2212, 2214, 2216, and/or 2218. The high-level flowchart of FIG. 11 (including FIGS. 11a to 11c) should be considered in combination with the embodiments of the audio/sound device 100, as described with respect to FIG. 1.

Certain embodiments of operation 2202 can include, but is not limited to, providing an at least one audio source to at least one user. For example, the at least one audio source 150 can be provided within certain embodiments of the audio/sound device 100, as described with respect to FIGS. 1 and 2. Certain embodiments of the audio/sound device 100 are described in this disclosure with respect to FIGS. 3 to 7. Certain embodiments of the audio/sound device can be configured to utilize hardware, firmware, and/or software versions of the audio/sound controller 97 as described in this disclosure. Certain embodiments of operation 2204 can include, but is not limited to, selectively modifying an at least one first sound source to be provided to the at least one user, wherein the at least one first sound source is combined with an at least one second sound source, and wherein the selectively modifying is performed relative to the at least one second sound source based at least in part on at least some specific information of the at least one first sound source. For example, certain embodiments of the at least one first sound source 152 can be modified relative to the at least one audio source 150. Certain embodiments of the modification can include, but are not limited to, amplification, maintaining, filtering, clarification, etc. Certain embodiments of the selectively modifying an at least one first sound source to be provided to the at least one user, wherein the at least one first sound source is combined with an at least one second sound source, and wherein the selectively modifying is performed relative to the at least one second sound source based at least in part on at least some specific information of the at least one first sound source of operation 2204 can include operation 2210, that can include but are not limited to, selectively reducing the at least one second sound source relative to the at least one first sound source. For example, wherein the selective modification of the at least one first sound source relative to the at least one second sound source can include, but is not limited to, reducing such as by diminishing the volume of the at least one second sound source 154 relative to the at least one first sound source 152 as described with respect to FIG. 1. Certain embodiments of operation 2204 can include operation 2212, that can include but are not limited to, selectively stopping the at least one second sound source relative to the at least one first sound source. For example, wherein the selective modification of the at least one first sound source relative to the at least one second sound source can include, but is not limited to, stopping the at least one second sound source as described with respect to FIG. 1. Certain embodiments of operation 2204 can include operation 2214, that can include but are not limited to, selectively filtering the at least one second sound source relative to the at least one first sound source. For example, wherein the selective modification of the at least one first sound source 152 relative to the at least one second sound source 154 can include, but is not limited to, selectively filtering the at least one second sound source relative to the at least one first sound source. Certain embodiments of operation 2204 can include operation 2216, that can include but are not limited to, selectively maintaining the at least one first sound source as the at least one second sound source is diminished or stopped. For example, the selective modification of the at least one first sound source relative to the at least one second sound source can include, but is not limited to, selectively maintaining the volume or other characteristics of the at least one sound source as the volume or other characteristics of the at least one second sound source is reduced or diminished as described with respect to FIG. 1.

Certain embodiments of operation 2220 can include, but are not limited to, further comprising reducing a volume of the at least one audio source at least partially in response to at least some outside classes of sound. For example, reducing the volume of the at least one audio source 150 such as is typically produced by certain embodiments of the audio/sound device 100 as described with respect to FIG. 1 in this disclosure, such as to allow the user to more easily discern the at least one first sound source 152 which may be a different class of sound or audio (originating outside of the audio/sound device) as compared with the at least one audio source 150. Certain embodiments of operation 2222 can include, but are not limited to, wherein the at least one first sound source at least partially includes a noise. For example, the at least one first sound source can include a noise such as a siren, alert, alarm, etc. that may be desired to be used to the user of the audio/sound device 100, or such as may be designed into the audio/sound device by its designers, producer, operator, etc. Certain embodiments of operation 2224 can include, but are not limited to, wherein the at least one first sound source at least partially includes a recorded or synthesized audio. For example, certain embodiments of the at least one first sound source 152 may be in the form of synthesized or recorded audio. Certain embodiments of operation 2226 can include, but are not limited to, wherein the at least one first sound source at least partially includes a voice. For example, certain embodiments of the at least one first sound source 152 may include a voice, such as one which the user wishes to hear. Alternatively, the at least one first sound source can include a voice of a speaker or performer that should be amplified or maintained to the user by certain embodiments of the audio/sound device. Certain embodiments of operation 2228 can include, but are not limited to, wherein the at least one second sound source at least partially includes an ambient sound. For example, certain embodiments of the at least one second sound source can include ambient sound, noises, voices, which the user may desire to be diminished relative to the at least one first sound source. Certain embodiments of operation 2230 can include, but are not limited to, wherein the at least one second sound source at least partially includes a recorded or synthesized audio. For example, certain embodiments of the at least one second sound source 154 at least partially includes a recorded or synthesized audio, such as which may be desired to be relatively diminished relative to the at least one first sound source 152. Certain embodiments of operation 2232 can include, but are not limited to, wherein the at least one second sound source at least partially includes a voice. For example, certain embodiments of the at least one second sound source 154 as described with respect to FIG. 1 can include one or more voices that can be relatively diminished compared to other voices, noises, information, etc. that can be characterized as the at least one first sound source. Certain embodiments of operation 2234 can include, but are not limited to, wherein the at least one audio source is presented over a headphone. For example, certain embodiments of the at least one audio source 150 can be presented over certain personal embodiments of the audio/sound device 100 that can be configured as a headphone. Certain embodiments of operation 2236 can include, but are not limited to, wherein the at least one audio source is presented over a speaker system. For example, certain embodiments of the at least one audio source 150 can be presented over certain group-based embodiments of the audio/sound device 100 that can be configured as a speaker system. Certain embodiments of operation 2238 can include, but are not limited to, wherein the at least one audio source is presented over a music system. For example, certain embodiments of the at least one audio source 150 can be presented over certain embodiments of the audio/sound device 100 that can be configured as a music system, such as an IPOD, an MP3 player, a surround-sound system, or a concert system. Certain embodiments of operation 2240 can include, but are not limited to, wherein the at least some specific information includes at least some specific frequency information, specific spectral content information, or specific recognition-based information. For example, there may be a variety of classifications of the at least some specific information for certain embodiments of the audio/sound device as described with respect to FIG. 1 that can include, but are not limited to, at least some specific frequency information, specific spectral content information, or specific recognition-based information.

In one or more various aspects, related systems include but are not limited to circuitry and/or programming for effecting the herein-referenced method aspects; the circuitry and/or programming can be virtually any combination of hardware, software, electro-mechanical system, and/or firmware configurable to effect the herein-referenced method aspects depending upon the design choices of the system designer.

An operational flow O10 as shown represents exemplary operations. Some of the figures may have various examples of operational flows. It should be understood that the operational flows may be executed in a number of environments and contexts, including versions and modified versions of the figures and other versions as well. Furthermore, although the various operational flows are presented in the sequence(s) illustrated, it should be understood that the various operations may be performed in other orders than those which are illustrated, or may be performed concurrently.

In figures that follow, various operations may be depicted in a box-within-a-box manner. Such depictions may indicate that an operation in an internal box may comprise an optional exemplary implementation of the operational step illustrated in one or more external boxes. However, it should be understood that internal box operations may be viewed as independent operations separate from any associated external boxes and may be performed in any sequence with respect to all other illustrated operations, or may be performed concurrently.

The operational flow O10, directed by the exemplary processing module M10, can move to operation O11, where receiving detection, via at least in part one or more computing devices, of a first event regarding a first sound involving one or more characteristics may be executed. An exemplary implementation may include the receiving module M11 configured to direct the operation. For instance, the compute/control 210 of the audio/sound device 200 can be receiving detection, such as receiving a communication signal, such as a wireless signal, carrying information indicating a detection of a particular sound had occurred, via the wireless component 222b, such as from a sensing device, such as an external microphone externally remote from the audio/sound device 200, or can be receiving internally from one of the input/sensing components 240, such as the acoustic sensing component 242i, such as a microphone, via at least in part one or more computing devices, such as the compute/control 210, of a first event, such as a start of a sound emission, regarding a first sound, such as a sound of a siren, involving one or more characteristics, such as frequency range of the sound.

The operational flow O10 can move to operation O12, where recording first audio information at a first original recording rate from an audio device based at least in part upon receiving the detection of a first event regarding a first sound involving one or more characteristics may be executed. An exemplary implementation may include the recording module M12 configured to direct the operation. For instance, the compute/control 210 of the audio/sound device 200 can be recording, such as recording to the storage 214, first audio information, such as a first portion of a news cast, at a first original recording rate, such as the rate that the news announcer normally speaks, from an audio device, such as being received through the communication component 220 in a peer-to-peer fashion, such as through the peer-to-peer component 222d, from an external, audio device, such as iPod that is wired to the audio/sound device 200, based at least in part upon receiving the detection of a first event, such as the start of emission discussed above, regarding a first sound, such as that of the siren discussed above, involving one or more characteristics, such as that of frequency range of the sound discussed above.

The operational flow O10 can move to operation O13, where receiving detection, via at least in part one or more computing devices, of a second event regarding the first sound may be executed. An exemplary implementation may include the receiving module M13 configured to direct the operation. For instance, the compute/control 210 of the audio/sound device 200 can be receiving detection, such as receiving a communication signal, such as a wireless signal, carrying information indicating a detection of a particular sound had ceased to occur, via the wireless component 222b, such as from a sensing device, such as an external microphone externally remote from the audio/sound device 200, or can be receiving internally from one of the input/sensing components 240, such as the acoustic sensing component 242i, such as a microphone, via at least in part one or more computing devices, such as the compute/control 210, of a second event, such as a cessation of the sound emission, regarding a first sound, such as a sound of a siren, involving one or more characteristics, such as frequency range of the sound.

The operational flow O10 can move to operation O14, where recording second audio information at a second original recording rate from the audio device based at least in part upon the receiving detection of the second event regarding the first sound may be executed. An exemplary implementation may include the recording module M14 configured to direct the operation. For instance, the compute/control 210 of the audio/sound device 200 can be recording, such as recording to the storage 214, second audio information, such as a second portion of a news cast, at a second original recording rate, such as the rate that the news announcer normally speaks, from the audio device, such as being received through the communication component 220 in a peer-to-peer fashion, such as through the peer-to-peer component 222d, from an external audio device, such as iPod that is wired to the audio/sound device 200, based at least in part upon receiving the detection of the second event, such as the cessation of emission discussed above, regarding the first sound, such as that of the siren discussed above.

The operational flow O10 can move to operation O15, where outputting at a rate faster than the first original recording rate the recording of the first audio information based at least in part upon receiving detection of the second event regarding the first sound may be executed. An exemplary implementation may include the outputting module M15 configured to direct the operation. For instance, the compute/control 210 of the audio/sound device 200 can be outputting, such as through the audio out 230a, such as through headphones, at a rate faster than the first original recording rate the recording of the first audio information based at least in part upon receiving detection of the second event regarding the first sound.

The operational flow O10 can move to operation O16, where outputting at a rate faster than the second original recording rate the recording of the second audio information based at least in part upon completion of the outputting of the first audio information may be executed. An exemplary implementation may include the outputting module M16 configured to direct the operation. For instance, the compute/control 210 of the audio/sound device 200 can be outputting, such as through the audio out 230a, such as through headphones, at a rate faster than the second original recording rate the recording of the second audio information based at least in part upon receiving detection of the second event regarding the first sound.

Illustrations of various implementations of the exemplary operations O11, O12, O13, O14, O15, and O16 are found in the figures.

For instance, in some implementations, the exemplary operation O11 may include the operation of O1101 for receiving the first sound from an ambient environment. An exemplary implementation may include the receiving module M1101 configured to direct the operation.

For instance, in some implementations, the exemplary operation O11 may include the operation of O1102 for receiving the first sound as a monitored sound. An exemplary implementation may include the receiving module M1102 configured to direct the operation.

For instance, in some implementations, the exemplary operation O11 may include the operation of O1103 for receiving the first sound from a coupled audio device. An exemplary implementation may include the receiving module M1103 configured to direct the operation.

For instance, in some implementations, the exemplary operation O11 may include the operation of O1104 for receiving the first sound from one or more speakers. An exemplary implementation may include the receiving module M1104 configured to direct the operation.

For instance, in some implementations, the exemplary operation O11 may include the operation of O1105 for receiving the first sound with one or more microphones. An exemplary implementation may include the receiving module M1105 configured to direct the operation.

For instance, in some implementations, the exemplary operation O11 may include the operation of O1106 for receiving the first sound with one or more electronic connections. An exemplary implementation may include the receiving module M1106 configured to direct the operation.

For instance, in some implementations, the exemplary operation O11 may include the operation of O1107 for receiving detection of the first event regarding the first sound as an absence of the one or more characteristics in the first sound. An exemplary implementation may include the receiving module M1107 configured to direct the operation.

For instance, in some implementations, the exemplary operation O11 may include the operation of O1108 for receiving detection of the first event regarding the first sound as a change of the one or more characteristics in the first sound. An exemplary implementation may include the receiving module M1108 configured to direct the operation.

For instance, in some implementations, the exemplary operation O11 may include the operation of O1109 for receiving detection of the first event regarding the first sound as an appearance of the one or more characteristics in the first sound. An exemplary implementation may include the receiving module M1109 configured to direct the operation.

For instance, in some implementations, the exemplary operation O11 may include the operation of O1110 for receiving detection of the first event regarding the first sound involving the one or more characteristics as including one or more repetitive sounds. An exemplary implementation may include the receiving module M1110 configured to direct the operation.

For instance, in some implementations, the exemplary operation O11 may include the operation of O1111 for receiving detection of the first event regarding the first sound involving the one or more characteristics as including one or more sounds from one or more machines. An exemplary implementation may include the receiving module M1111 configured to direct the operation.

For instance, in some implementations, the exemplary operation O11 may include the operation of O1112 for receiving detection of the first event regarding the first sound involving the one or more characteristics as including speech from a human. An exemplary implementation may include the receiving module M1112 configured to direct the operation.

For instance, in some implementations, the exemplary operation O11 may include the operation of O1113 for receiving detection of the first event regarding the first sound involving the one or more characteristics as including sound from a living creature. An exemplary implementation may include the receiving module M1113 configured to direct the operation.

For instance, in some implementations, the exemplary operation O11 may include the operation of O1114 for receiving detection of the first event regarding the first sound involving the one or more characteristics as including sound of an engine abnormality. An exemplary implementation may include the receiving module M1114 configured to direct the operation.

For instance, in some implementations, the exemplary operation O11 may include the operation of O1115 for receiving detection of the first event regarding the first sound involving the one or more characteristics as including sound of an emergency warning. An exemplary implementation may include the receiving module M1115 configured to direct the operation.

For instance, in some implementations, the exemplary operation O11 may include the operation of O1116 for receiving detection of the first event regarding the first sound involving the one or more characteristics as including sound of a weather update. An exemplary implementation may include the receiving module M1116 configured to direct the operation.

For instance, in some implementations, the exemplary operation O11 may include the operation of O1117 for receiving, through an electronic signal, detection of the first event regarding the first sound involving one or more characteristics. An exemplary implementation may include the receiving module M1117 configured to direct the operation.

For instance, in some implementations, the exemplary operation O11 may include the operation of O1118 for receiving, through one or more microphones, detection of the first event regarding the first sound involving one or more characteristics. An exemplary implementation may include the receiving module M1118 configured to direct the operation.

For instance, in some implementations, the exemplary operation O11 may include the operation of O1119 for receiving, through an audio signal from an audio device, detection of the first event regarding the first sound involving one or more characteristics. An exemplary implementation may include the receiving module M1119 configured to direct the operation.

For instance, in some implementations, the exemplary operation O11 may include the operation of O1120 for receiving, through a traffic control signal from an emergency vehicle, detection of the first event regarding the first sound involving one or more characteristics. An exemplary implementation may include the receiving module M1120 configured to direct the operation.

For instance, in some implementations, the exemplary operation O11 may include the operation of O1121 for receiving, through performance of a table lookup to compare one or more portions of the first sound with one or more characteristics of sound in a database, detection of the first event regarding the first sound involving one or more characteristics. An exemplary implementation may include the receiving module M1121 configured to direct the operation.

For instance, in some implementations, the exemplary operation O11 may include the operation of O1122 for receiving, through performance of a spectral analysis of the first sound, detection of the first event regarding the first sound involving one or more characteristics. An exemplary implementation may include the receiving module M1122 configured to direct the operation.

For instance, in some implementations, the exemplary operation O11 may include the operation of O1123 for receiving, through an historical log associated with the first sound, detection of the first event regarding the first sound involving one or more characteristics. An exemplary implementation may include the receiving module M1123 configured to direct the operation.

For instance, in some implementations, the exemplary operation O11 may include the operation of O1124 for receiving, through information from an accelerometer, a barometer, a motion detector or a combination thereof, detection of the first event regarding the first sound involving one or more characteristics. An exemplary implementation may include the receiving module M1124 configured to direct the operation.

For instance, in some implementations, the exemplary operation O11 may include the operation of O1125 for receiving detection via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the receiving module M1125 configured to direct the operation.

For instance, in some implementations, the exemplary operation O12 may include the operation of O1201 for recording the first audio information from a radio broadcast being received by the audio device. An exemplary implementation may include the record module M1201 configured to direct the operation.

For instance, in some implementations, the exemplary operation O12 may include the operation of O1202 for recording the first audio information from a podcast being received by the audio device. An exemplary implementation may include the record module M1202 configured to direct the operation.

For instance, in some implementations, the exemplary operation O12 may include the operation of O1203 for recording the first audio information from a cell phone communication being communicated through the audio device. An exemplary implementation may include the record module M1203 configured to direct the operation.

For instance, in some implementations, the exemplary operation O12 may include the operation of O1204 for recording the first audio information at the first original recording rate as a real time recording rate. An exemplary implementation may include the record module M1204 configured to direct the operation.

For instance, in some implementations, the exemplary operation O12 may include the operation of O1205 for recording the first audio information as a musical performance. An exemplary implementation may include the record module M1205 configured to direct the operation.

For instance, in some implementations, the exemplary operation O12 may include the operation of O1206 for recording the first audio information as human speech. An exemplary implementation may include the record module M1206 configured to direct the operation.

For instance, in some implementations, the exemplary operation O12 may include the operation of O1207 for recording the first audio information as computer generated audio information. An exemplary implementation may include the record module M1207 configured to direct the operation.

For instance, in some implementations, the exemplary operation O12 may include the operation of O1208 for recording the first audio information to an electronic memory. An exemplary implementation may include the record module M1208 configured to direct the operation.

For instance, in some implementations, the exemplary operation O12 may include the operation of O1209 for recording the first audio information to a database. An exemplary implementation may include the record module M1209 configured to direct the operation.

For instance, in some implementations, the exemplary operation O12 may include the operation of O1210 for recording the first audio information from the audio device being located in a vehicle. An exemplary implementation may include the record module M1210 configured to direct the operation.

For instance, in some implementations, the exemplary operation O13 may include the operation of O1301 for receiving the first sound from an ambient environment. An exemplary implementation may include the receiving module M1301 configured to direct the operation.

For instance, in some implementations, the exemplary operation O13 may include the operation of O1302 for receiving the first sound as a monitored sound. An exemplary implementation may include the receiving module M1302 configured to direct the operation.

For instance, in some implementations, the exemplary operation O13 may include the operation of O1303 for receiving the first sound from a coupled audio device. An exemplary implementation may include the receiving module M1303 configured to direct the operation.

For instance, in some implementations, the exemplary operation O13 may include the operation of O1304 for receiving the first sound from one or more speakers. An exemplary implementation may include the receiving module M1304 configured to direct the operation.

For instance, in some implementations, the exemplary operation O13 may include the operation of O1305 for receiving the first sound with one or more microphones. An exemplary implementation may include the receiving module M1305 configured to direct the operation.

For instance, in some implementations, the exemplary operation O13 may include the operation of O1306 for receiving the first sound with one or more electronic connections. An exemplary implementation may include the receiving module M1306 configured to direct the operation.

For instance, in some implementations, the exemplary operation O13 may include the operation of O1307 for receiving the first sound from one or more speakers. An exemplary implementation may include the receiving module M1307 configured to direct the operation.

For instance, in some implementations, the exemplary operation O13 may include the operation of O1308 for receiving detection of the second event regarding the first sound as an absence of the one or more characteristics in the first sound. An exemplary implementation may include the receiving module M1308 configured to direct the operation.

For instance, in some implementations, the exemplary operation O13 may include the operation of O1309 for receiving detection of the second event regarding the first sound as a change of the one or more characteristics in the first sound. An exemplary implementation may include the receiving module M1309 configured to direct the operation.

For instance, in some implementations, the exemplary operation O13 may include the operation of O1310 for receiving detection of the second event regarding the first sound as an appearance of the one or more characteristics in the first sound. An exemplary implementation may include the receiving module M1310 configured to direct the operation.

For instance, in some implementations, the exemplary operation O13 may include the operation of O1311 for receiving detection of the second event regarding the first sound involving the one or more characteristics as including one or more repetitive sounds. An exemplary implementation may include the receiving module M1311 configured to direct the operation.

For instance, in some implementations, the exemplary operation O13 may include the operation of O1312 for receiving detection of the second event regarding the first sound involving the one or more characteristics as including one or more sounds from one or more machines. An exemplary implementation may include the receiving module M1312 configured to direct the operation.

For instance, in some implementations, the exemplary operation O13 may include the operation of O1313 for receiving detection of the second event regarding the first sound involving the one or more characteristics as including speech from a human. An exemplary implementation may include the receiving module M1313 configured to direct the operation.

For instance, in some implementations, the exemplary operation O13 may include the operation of O1314 for receiving detection of the second event regarding the first sound involving the one or more characteristics as including sound from a living creature. An exemplary implementation may include the receiving module M1314 configured to direct the operation.

For instance, in some implementations, the exemplary operation O13 may include the operation of O1315 for receiving detection of the second event regarding the first sound involving the one or more characteristics as including sound of an engine abnormality. An exemplary implementation may include the receiving module M1315 configured to direct the operation.

For instance, in some implementations, the exemplary operation O13 may include the operation of O1316 for receiving detection of the second event regarding the first sound involving the one or more characteristics as including sound of an emergency warning. An exemplary implementation may include the receiving module M1316 configured to direct the operation.

For instance, in some implementations, the exemplary operation O13 may include the operation of O1317 for receiving detection of the second event regarding the first sound involving the one or more characteristics as including sound of a weather update. An exemplary implementation may include the receiving module M1317 configured to direct the operation.

For instance, in some implementations, the exemplary operation O13 may include the operation of O1318 for receiving, through an electronic signal, detection of the second event regarding the first sound involving one or more characteristics. An exemplary implementation may include the receiving module M1318 configured to direct the operation.

For instance, in some implementations, the exemplary operation O13 may include the operation of O1319 for receiving, through one or more microphones, detection of the second event regarding the first sound involving one or more characteristics. An exemplary implementation may include the receiving module M1319 configured to direct the operation.

For instance, in some implementations, the exemplary operation O13 may include the operation of O1320 for receiving, through an audio signal from an audio device, detection of the second event regarding the first sound involving one or more characteristics. An exemplary implementation may include the receiving module M1320 configured to direct the operation.

For instance, in some implementations, the exemplary operation O13 may include the operation of O1321 for receiving, through a traffic control signal from an emergency vehicle, detection of the second event regarding the first sound involving one or more characteristics. An exemplary implementation may include the receiving module M1321 configured to direct the operation.

For instance, in some implementations, the exemplary operation O13 may include the operation of O1322 for receiving, through performance of a table lookup to compare one or more portions of the first sound with one or more characteristics of sound in a database, detection of the second event regarding the first sound involving one or more characteristics. An exemplary implementation may include the receiving module M1322 configured to direct the operation.

For instance, in some implementations, the exemplary operation O13 may include the operation of O1323 for receiving, through performance of a spectral analysis of the first sound, detection of the second event regarding the first sound involving one or more characteristics. An exemplary implementation may include the receiving module M1323 configured to direct the operation.

For instance, in some implementations, the exemplary operation O13 may include the operation of O1324 for receiving, through an historical log associated with the first sound, detection of the second event regarding the first sound involving one or more characteristics. An exemplary implementation may include the receiving module M1324 configured to direct the operation.

For instance, in some implementations, the exemplary operation O13 may include the operation of O1325 for receiving, through information from an accelerometer, a barometer, a motion detector or a combination thereof, detection of the second event regarding the first sound involving one or more characteristics. An exemplary implementation may include the receiving module M1325 configured to direct the operation.

For instance, in some implementations, the exemplary operation O13 may include the operation of O1326 for receiving detection via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the receiving module M1326 configured to direct the operation.

For instance, in some implementations, the exemplary operation O14 may include the operation of O1401 for recording the second audio information from a radio broadcast being received by the audio device. An exemplary implementation may include the recording module M1401 configured to direct the operation.

For instance, in some implementations, the exemplary operation O14 may include the operation of O1402 for recording the second audio information from a podcast being received by the audio device. An exemplary implementation may include the recording module M1402 configured to direct the operation.

For instance, in some implementations, the exemplary operation O14 may include the operation of O1403 for recording the second audio information from a cell phone communication being communicated through the audio device. An exemplary implementation may include the recording module M1403 configured to direct the operation.

For instance, in some implementations, the exemplary operation O14 may include the operation of O1404 for recording the second audio information at the first original recording rate as a real time recording rate. An exemplary implementation may include the recording module M1404 configured to direct the operation.

For instance, in some implementations, the exemplary operation O14 may include the operation of O1405 for recording the second audio information as a musical performance. An exemplary implementation may include the recording module M1405 configured to direct the operation.

For instance, in some implementations, the exemplary operation O14 may include the operation of O1406 for recording the second audio information as human speech. An exemplary implementation may include the recording module M1406 configured to direct the operation.

For instance, in some implementations, the exemplary operation O14 may include the operation of O1407 for recording the second audio information as computer generated audio information. An exemplary implementation may include the recording module M1407 configured to direct the operation.

For instance, in some implementations, the exemplary operation O14 may include the operation of O1408 recording the second audio information to an electronic memory. An exemplary implementation may include the recording module M1408 configured to direct the operation.

For instance, in some implementations, the exemplary operation O14 may include the operation of O1409 for recording the second audio information to a database. An exemplary implementation may include the recording module M1409 configured to direct the operation.

For instance, in some implementations, the exemplary operation O14 may include the operation of O1410 for recording the second audio information from the audio device being located in a vehicle. An exemplary implementation may include the recording module M1410 configured to direct the operation.

For instance, in some implementations, the exemplary operation O15 may include the operation of O1501 for outputting at the rate faster than the first original recording rate at least in part to synchronize to a real time broadcast of audio information from the audio device. An exemplary implementation may include the outputting module M1501 configured to direct the operation.

For instance, in some implementations, the exemplary operation O15 may include the operation of O1502 for outputting at a rate based at least in part upon total time duration of the recording of the first audio information. An exemplary implementation may include the outputting module M1502 configured to direct the operation.

For instance, in some implementations, the exemplary operation O15 may include the operation of O1503 for outputting using pitch compensation to adjust pitch of the first audio information being played at the rate faster than the first original recording rate. An exemplary implementation may include the outputting module M1503 configured to direct the operation.

For instance, in some implementations, the exemplary operation O15 may include the operation of O1504 for outputting using variable speed control selectable by a listener of the first audio information being played at a rate faster than the first original recording rate. An exemplary implementation may include the outputting module M1504 configured to direct the operation.

For instance, in some implementations, the exemplary operation O15 may include the operation of O1505 for outputting using one or more speakers located inside of an automobile. An exemplary implementation may include the outputting module M1505 configured to direct the operation.

For instance, in some implementations, the exemplary operation O15 may include the operation of O1506 for outputting using one or more speakers integrated into one or more headphones. An exemplary implementation may include the outputting module M1506 configured to direct the operation.

For instance, in some implementations, the exemplary operation O15 may include the operation of O1507 for outputting using one or more speakers integrated into one or more earbuds. An exemplary implementation may include the outputting module M1507 configured to direct the operation.

For instance, in some implementations, the exemplary operation O15 may include the operation of O1508 for outputting using one or more speakers in a performance hall. An exemplary implementation may include the outputting module M1508 configured to direct the operation.

For instance, in some implementations, the exemplary operation O15 may include the operation of O1509 for outputting using one or more speakers integrated with an entertainment center. An exemplary implementation may include the outputting module M1509 configured to direct the operation.

For instance, in some implementations, the exemplary operation O15 may include the operation of O1510 for outputting using one or more speakers integrated into a vehicle. An exemplary implementation may include the outputting module M1510 configured to direct the operation.

For instance, in some implementations, the exemplary operation O16 may include the operation of O1601 for outputting at the rate faster than the second original recording rate to at least in part to synchronize to a real time broadcast of audio information from the audio device. An exemplary implementation may include the outputting module M1601 configured to direct the operation.

For instance, in some implementations, the exemplary operation O16 may include the operation of O1602 for outputting at a rate based at least in part upon total time duration of the recording of the first audio information. An exemplary implementation may include the outputting module M1602 configured to direct the operation.

For instance, in some implementations, the exemplary operation O16 may include the operation of O1603 for outputting using pitch compensation to adjust pitch of the first audio information being played at the rate faster than the first original recording rate. An exemplary implementation may include the outputting module M1603 configured to direct the operation.

For instance, in some implementations, the exemplary operation O16 may include the operation of O1604 for outputting using variable speed control selectable by a listener of the first audio information being played at a rate faster than the first original recording rate. An exemplary implementation may include the outputting module M1604 configured to direct the operation.

For instance, in some implementations, the exemplary operation O16 may include the operation of O1605 for outputting using one or more speakers located inside of an automobile. An exemplary implementation may include the outputting module M1605 configured to direct the operation.

For instance, in some implementations, the exemplary operation O16 may include the operation of O1606 for outputting using one or more speakers integrated into one or more headphones. An exemplary implementation may include the outputting module M1606 configured to direct the operation.

For instance, in some implementations, the exemplary operation O16 may include the operation of O1607 for outputting using one or more speakers integrated into one or more earbuds. An exemplary implementation may include the outputting module M1607 configured to direct the operation.

For instance, in some implementations, the exemplary operation O16 may include the operation of O1608 for outputting using one or more speakers in a performance hall. An exemplary implementation may include the outputting module M1608 configured to direct the operation.

For instance, in some implementations, the exemplary operation O16 may include the operation of O1609 for outputting using one or more speakers integrated with an entertainment center. An exemplary implementation may include the outputting module M1609 configured to direct the operation.

An operational flow O20 as shown represents exemplary operations. Some of the figures may have various examples of operational flows. It should be understood that the operational flows may be executed in a number of environments and contexts, including versions and modified versions of the figures and other versions as well. Furthermore, although the various operational flows are presented in the sequence(s) illustrated, it should be understood that the various operations may be performed in other orders than those which are illustrated, or may be performed concurrently.

In figures that follow, various operations may be depicted in a box-within-a-box manner. Such depictions may indicate that an operation in an internal box may comprise an optional exemplary implementation of the operational step illustrated in one or more external boxes. However, it should be understood that internal box operations may be viewed as independent operations separate from any associated external boxes and may be performed in any sequence with respect to all other illustrated operations, or may be performed concurrently.

The operational flow O20 can move to operation O21 where receiving detection, via at least in part one or more computing devices, of a first event regarding a first sound involving one or more characteristics in a first manner may be executed. An exemplary implementation may include the receiving module M21 configured to direct the operation. For instance, the compute/control 210 of the audio/sound device 200 can receive detection through the acoustic component 242i of the input/sensing 240 that a first event of an appearance of background sound such as machine noise as a first sound involving such characteristics as pitch characteristics in a first manner such as lacking the pitch characteristics.

The operational flow O20 can move to operation O22 where generating, via at least in part one or more computing devices, a first generated audio signal to alter hearing of the first sound by a listener based at least in part on receiving the detection of a first event regarding a first sound involving one or more characteristics in a first manner may be executed. An exemplary implementation may include the generating module M22 configured to direct the operation. For instance, the compute/control 210 of the audio/sound device 200 can generate a first generated audio signal such as an anti-noise signal to cancel out the hearing of the first sound such as the machine noise based upon the detection of the machine noise as lacking the pitch characteristics.

The operational flow O20 can move to operation O23 where receiving detection, via at least in part one or more computing devices, of a first event regarding a second sound involving the one or more characteristics in a second manner other than the first manner may be executed. An exemplary implementation may include the receiving module M23 configured to direct the operation. For instance, the compute/control 210 of the audio/sound device 200 can receive detection through the acoustic component 242i of the input/sensing 240 that a first event of an appearance of desired sound as the second sound such as particular person speaking involving one or more characteristics such as certain pitch characteristics in a second manner other than the first manner such as having the certain pitch characteristics.

The operational flow O20 can move to operation O24 where generating, via at least in part one or more computing devices, a second generated audio signal to indicate information based at least in part upon receiving the detection of the first event of the second sound involving the one or more characteristics in a second manner other than the first manner may be executed. An exemplary implementation may include the generating module M24 configured to direct the operation. For instance, the compute/control 210 of the audio/sound device 200 can generate through the audio out component 230a an audio indication such as that of a person's name that the particular individual is speaking based upon receiving the detection of the first event of the appearance of the second sound as a particular person speaking having certain pitch characteristics.

Illustrations of various implementations of the exemplary operations O21, O22, O23, and O24 are found in the figures.

For instance, in some implementations, the exemplary operation O21 may include the operation of O2101 for receiving the first sound from an ambient environment. An exemplary implementation may include the receiving module M2101 configured to direct the operation.

For instance, in some implementations, the exemplary operation O21 may include the operation of O2102 for receiving the first sound as a monitored sound. An exemplary implementation may include the receiving module M2102 configured to direct the operation.

For instance, in some implementations, the exemplary operation O21 may include the operation of O2103 for receiving the first sound from a coupled audio device. An exemplary implementation may include the receiving module M2103 configured to direct the operation.

For instance, in some implementations, the exemplary operation O21 may include the operation of O2104 for receiving the first sound from one or more speakers. An exemplary implementation may include the receiving module M2104 configured to direct the operation.

For instance, in some implementations, the exemplary operation O21 may include the operation of O2105 for receiving the first sound with one or more microphones. An exemplary implementation may include the receiving module M2105 configured to direct the operation.

For instance, in some implementations, the exemplary operation O21 may include the operation of O2106 for receiving the first sound with one or more electronic connections. An exemplary implementation may include the receiving module M2106 configured to direct the operation.

For instance, in some implementations, the exemplary operation O21 may include the operation of O2107 for receiving the first sound from one or more speakers. An exemplary implementation may include the receiving module M2107 configured to direct the operation.

For instance, in some implementations, the exemplary operation O21 may include the operation of O2107A for receiving detection of the first event regarding the first sound in a first manner that is opposite to the second manner. An exemplary implementation may include the receiving module M2107A configured to direct the operation.

For instance, in some implementations, the exemplary operation O21 may include the operation of O2108 for receiving detection of the first event regarding the first sound as an absence of the one or more characteristics in the first sound. An exemplary implementation may include the receiving module M2108 configured to direct the operation.

For instance, in some implementations, the exemplary operation O21 may include the operation of O2109 for receiving detection of the first event regarding the first sound as a change of the one or more characteristics in the first sound. An exemplary implementation may include the receiving module M2109 configured to direct the operation.

For instance, in some implementations, the exemplary operation O21 may include the operation of O2110 for receiving detection of the first event regarding the first sound as an appearance of the one or more characteristics in the first sound. An exemplary implementation may include the receiving module M2110 configured to direct the operation.

For instance, in some implementations, the exemplary operation O21 may include the operation of O2111 for receiving detection of the first event regarding the first sound involving the one or more characteristics as including one or more repetitive sounds. An exemplary implementation may include the receiving module M2111 configured to direct the operation.

For instance, in some implementations, the exemplary operation O21 may include the operation of O2112 for receiving detection of the first event regarding the first sound involving the one or more characteristics as including one or more sounds from one or more machines. An exemplary implementation may include the receiving module M2112 configured to direct the operation.

For instance, in some implementations, the exemplary operation O21 may include the operation of O2113 for receiving detection of the first event regarding the first sound involving the one or more characteristics as including speech from a human. An exemplary implementation may include the receiving module M2113 configured to direct the operation.

For instance, in some implementations, the exemplary operation O21 may include the operation of O2114 for receiving detection of the first event regarding the first sound involving the one or more characteristics as including sound from a living creature. An exemplary implementation may include the receiving module M2114 configured to direct the operation.

For instance, in some implementations, the exemplary operation O21 may include the operation of O2115 for receiving detection of the first event regarding the first sound involving the one or more characteristics as including sound of an engine abnormality. An exemplary implementation may include the receiving module M2115 configured to direct the operation.

For instance, in some implementations, the exemplary operation O21 may include the operation of O2116 for receiving detection of the first event regarding the first sound involving the one or more characteristics as including sound of an emergency warning. An exemplary implementation may include the receiving module M2116 configured to direct the operation.

For instance, in some implementations, the exemplary operation O21 may include the operation of O2117 for receiving detection of the first event regarding the first sound involving the one or more characteristics as including sound of a weather update. An exemplary implementation may include the receiving module M2117 configured to direct the operation.

For instance, in some implementations, the exemplary operation O21 may include the operation of O2118 for receiving, through an electronic signal, detection of the first event regarding the first sound involving one or more characteristics. An exemplary implementation may include the receiving module M2118 configured to direct the operation.

For instance, in some implementations, the exemplary operation O21 may include the operation of O2119 for receiving, through one or more microphones, detection of the first event regarding the first sound involving one or more characteristics. An exemplary implementation may include the receiving module M2119 configured to direct the operation.

For instance, in some implementations, the exemplary operation O21 may include the operation of O2120 for receiving, through an audio signal from an audio device, detection of the first event regarding the first sound involving one or more characteristics. An exemplary implementation may include the receiving module M2120 configured to direct the operation.

For instance, in some implementations, the exemplary operation O21 may include the operation of O2121 for receiving, through a traffic control signal from an emergency vehicle, detection of the first event regarding the first sound involving one or more characteristics. An exemplary implementation may include the receiving module M2121 configured to direct the operation.

For instance, in some implementations, the exemplary operation O21 may include the operation of O2122 for receiving, through performance of a table lookup to compare one or more portions of the first sound with one or more characteristics of sound in a database, detection of the first event regarding the first sound involving one or more characteristics. An exemplary implementation may include the receiving module M2122 configured to direct the operation.

For instance, in some implementations, the exemplary operation O21 may include the operation of O2123 for receiving, through performance of a spectral analysis of the first sound, detection of the first event regarding the first sound involving one or more characteristics. An exemplary implementation may include the receiving module M2123 configured to direct the operation.

For instance, in some implementations, the exemplary operation O21 may include the operation of O2124 for receiving, through an historical log associated with the first sound, detection of the first event regarding the first sound involving one or more characteristics. An exemplary implementation may include the receiving module M2124 configured to direct the operation.

For instance, in some implementations, the exemplary operation O21 may include the operation of O2125 for receiving, through information from an accelerometer, a barometer, a motion detector or a combination thereof, detection of the first event regarding the first sound involving one or more characteristics. An exemplary implementation may include the receiving module M2125 configured to direct the operation.

For instance, in some implementations, the exemplary operation O21 may include the operation of O2126 for receiving detection via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the receiving module M2126 configured to direct the operation.

For instance, in some implementations, the exemplary operation O22 may include the operation of O2201 for generating the first generated audio signal to be received to mute the first sound heard by the listener. An exemplary implementation may include the generating module M2201 configured to direct the operation.

For instance, in some implementations, the exemplary operation O22 may include the operation of O2202 for generating the first generated audio signal to be received to emit sound opposite in form to the first sound from speakers positioned to cancel amplitude of the first sound heard by the listener. An exemplary implementation may include the generating module M2202 configured to direct the operation.

For instance, in some implementations, the exemplary operation O22 may include the operation of O2203 for generating the first generated audio signal to be received to emit sound from speakers positioned to attenuate amplitude of the first sound heard by the listener. An exemplary implementation may include the generating module M2203 configured to direct the operation.

For instance, in some implementations, the exemplary operation O22 may include the operation of O2204 for generating the first generated audio signal to be received by a cell phone. An exemplary implementation may include the generating module M2204 configured to direct the operation.

For instance, in some implementations, the exemplary operation O22 may include the operation of O2205 for generating the first generated audio signal to be received by an amplifier system. An exemplary implementation may include the generating module M2205 configured to direct the operation.

For instance, in some implementations, the exemplary operation O22 may include the operation of O2206 for generating the first generated audio signal to be received by a two-way radio. An exemplary implementation may include the generating module M2206 configured to direct the operation.

For instance, in some implementations, the exemplary operation O22 may include the operation of O2207 for generating the first generated audio signal to be received by a computer. An exemplary implementation may include the generating module M2207 configured to direct the operation.

For instance, in some implementations, the exemplary operation O22 may include the operation of O2208 for generating the first generated audio signal to control speakers. An exemplary implementation may include the generating module M2208 configured to direct the operation.

For instance, in some implementations, the exemplary operation O22 may include the operation of O2209 for generating the first generated audio signal to modify an audio signal generated from reception of the first sound. An exemplary implementation may include the generating module M2209 configured to direct the operation.

For instance, in some implementations, the exemplary operation O22 may include the operation of O2210 for generating the first generated audio signal through in part a table lookup of a database. An exemplary implementation may include the generating module M2210 configured to direct the operation.

For instance, in some implementations, the exemplary operation O22 may include the operation of O2211 for generating the first generated audio signal through in part a spectral analysis of the first sound. An exemplary implementation may include the generating module M2211 configured to direct the operation.

For instance, in some implementations, the exemplary operation O22 may include the operation of O2212 for generating the first generated audio signal through in part a recognition of the first sound. An exemplary implementation may include the generating module M2212 configured to direct the operation.

For instance, in some implementations, the exemplary operation O22 may include the operation of O2213 for generating via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the generating module M2213 configured to direct the operation.

For instance, in some implementations, the exemplary operation O23 may include the operation of O2301 for receiving the second sound from an ambient environment. An exemplary implementation may include the receiving module M2301 configured to direct the operation.

For instance, in some implementations, the exemplary operation O23 may include the operation of O2302 for receiving the second sound as a monitored sound. An exemplary implementation may include the receiving module M2302 configured to direct the operation.

For instance, in some implementations, the exemplary operation O23 may include the operation of O2303 for receiving the second sound from a coupled audio device. An exemplary implementation may include the receiving module M2303 configured to direct the operation.

For instance, in some implementations, the exemplary operation O23 may include the operation of O2304 for receiving the second sound from one or more speakers. An exemplary implementation may include the receiving module M2304 configured to direct the operation.

For instance, in some implementations, the exemplary operation O23 may include the operation of O2305 for receiving the second sound with one or more microphones. An exemplary implementation may include the receiving module M2305 configured to direct the operation.

For instance, in some implementations, the exemplary operation O23 may include the operation of O2306 for receiving the second sound with one or more electronic connections. An exemplary implementation may include the receiving module M2306 configured to direct the operation.

For instance, in some implementations, the exemplary operation O23 may include the operation of O2307 for receiving the second sound from one or more speakers. An exemplary implementation may include the receiving module M2307 configured to direct the operation.

For instance, in some implementations, the exemplary operation O23 may include the operation of O2308 for receiving detection of the first event regarding the second sound as an absence of the one or more characteristics in the second sound. An exemplary implementation may include the receiving module M2308 configured to direct the operation.

For instance, in some implementations, the exemplary operation O23 may include the operation of O2309 for receiving detection of the first event regarding the second sound as a change of the one or more characteristics in the second sound. An exemplary implementation may include the receiving module M2309 configured to direct the operation.

For instance, in some implementations, the exemplary operation O23 may include the operation of O2310 for receiving detection of the first event regarding the second sound as an appearance of the one or more characteristics in the second sound. An exemplary implementation may include the receiving module M2310 configured to direct the operation.

For instance, in some implementations, the exemplary operation O23 may include the operation of O2311 for receiving detection of the first event regarding the second sound involving the one or more characteristics as including one or more repetitive sounds. An exemplary implementation may include the receiving module M2311 configured to direct the operation.

For instance, in some implementations, the exemplary operation O23 may include the operation of O2312 for receiving detection of the first event regarding the second sound involving the one or more characteristics as including one or more sounds from one or more machines. An exemplary implementation may include the receiving module M2312 configured to direct the operation.

For instance, in some implementations, the exemplary operation O23 may include the operation of O2313 for receiving detection of the first event regarding the second sound involving the one or more characteristics as including speech from a human. An exemplary implementation may include the receiving module M2313 configured to direct the operation.

For instance, in some implementations, the exemplary operation O23 may include the operation of O2314 for receiving detection of the first event regarding the second sound involving the one or more characteristics as including sound from a living creature. An exemplary implementation may include the receiving module M2314 configured to direct the operation.

For instance, in some implementations, the exemplary operation O23 may include the operation of O2315 for receiving detection of the first event regarding the second sound involving the one or more characteristics as including sound of an engine abnormality. An exemplary implementation may include the receiving module M2315 configured to direct the operation.

For instance, in some implementations, the exemplary operation O23 may include the operation of O2316 for receiving detection of the first event regarding the second sound involving the one or more characteristics as including sound of an emergency warning. An exemplary implementation may include the receiving module M2316 configured to direct the operation.

For instance, in some implementations, the exemplary operation O23 may include the operation of O2317 for receiving detection of the first event regarding the second sound involving the one or more characteristics as including sound of a weather update. An exemplary implementation may include the receiving module M2317 configured to direct the operation.

For instance, in some implementations, the exemplary operation O23 may include the operation of O2318 for receiving, through an electronic signal, detection of the first event regarding the second sound involving one or more characteristics. An exemplary implementation may include the receiving module M2318 configured to direct the operation.

For instance, in some implementations, the exemplary operation O23 may include the operation of O2319 for receiving, through one or more microphones, detection of the first event regarding the second sound involving one or more characteristics. An exemplary implementation may include the receiving module M2319 configured to direct the operation.

For instance, in some implementations, the exemplary operation O23 may include the operation of O2320 for receiving, through an audio signal from an audio device, detection of the first event regarding the second sound involving one or more characteristics. An exemplary implementation may include the receiving module M2320 configured to direct the operation.

For instance, in some implementations, the exemplary operation O23 may include the operation of O2321 for receiving, through a traffic control signal from an emergency vehicle, detection of the first event regarding the second sound involving one or more characteristics. An exemplary implementation may include the receiving module M2321 configured to direct the operation.

For instance, in some implementations, the exemplary operation O23 may include the operation of O2322 for receiving, through performance of a table lookup to compare one or more portions of the second sound with one or more characteristics of sound in a database, detection of the first event regarding the second sound involving one or more characteristics. An exemplary implementation may include the receiving module M2322 configured to direct the operation.

For instance, in some implementations, the exemplary operation O23 may include the operation of O2323 for receiving, through performance of a spectral analysis of the second sound, detection of the first event regarding the second sound involving one or more characteristics. An exemplary implementation may include the receiving module M2323 configured to direct the operation.

For instance, in some implementations, the exemplary operation O23 may include the operation of O2324 for receiving, through an historical log associated with the second sound, detection of the first event regarding the second sound involving one or more characteristics. An exemplary implementation may include the receiving module M2324 configured to direct the operation.

For instance, in some implementations, the exemplary operation O23 may include the operation of O2325 for receiving, through information from an accelerometer, a barometer, a motion detector or a combination thereof, detection of the first event regarding the second sound involving one or more characteristics. An exemplary implementation may include the receiving module M2325 configured to direct the operation.

For instance, in some implementations, the exemplary operation O23 may include the operation of O2326 for receiving detection via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the receiving module M2326 configured to direct the operation.

For instance, in some implementations, the exemplary operation O24 may include the operation of O2401 for generating the second generated audio signal as an indication of an appearance of the one or more characteristics in the second sound. An exemplary implementation may include the generating module M2401 configured to direct the operation.

For instance, in some implementations, the exemplary operation O24 may include the operation of O2402 for generating the second generated audio signal as an indication of an absence of the one or more characteristics in the second sound. An exemplary implementation may include the generating module M2402 configured to direct the operation.

For instance, in some implementations, the exemplary operation O24 may include the operation of O2403 for generating the second generated audio signal as an indication of a change of the one or more characteristics in the second sound. An exemplary implementation may include the generating module M2403 configured to direct the operation.

For instance, in some implementations, the exemplary operation O24 may include the operation of O2404 for generating the second generated audio signal as an indication of the existence of the one or more characteristics of the second sound. An exemplary implementation may include the generating module M2404 configured to direct the operation.

For instance, in some implementations, the exemplary operation O24 may include the operation of O2405 for generating the second generated audio signal to be received by a cell phone. An exemplary implementation may include the generating module M2405 configured to direct the operation.

For instance, in some implementations, the exemplary operation O24 may include the operation of O2406 for generating the second generated audio signal to be received by an amplifier system. An exemplary implementation may include the generating module M2406 configured to direct the operation.

For instance, in some implementations, the exemplary operation O24 may include the operation of O2407 for generating the second generated audio signal to be received by a two-way radio. An exemplary implementation may include the generating module M2407 configured to direct the operation.

For instance, in some implementations, the exemplary operation O24 may include the operation of O2408 for generating the second generated audio signal to be received by a computer. An exemplary implementation may include the generating module M2408 configured to direct the operation.

For instance, in some implementations, the exemplary operation O24 may include the operation of O2409 for generating the second generated audio signal to control speakers. An exemplary implementation may include the generating module M2409 configured to direct the operation.

For instance, in some implementations, the exemplary operation O24 may include the operation of O2410 for generating the second generated audio signal through in part a table lookup of a database. An exemplary implementation may include the generating module M2410 configured to direct the operation.

For instance, in some implementations, the exemplary operation O24 may include the operation of O2411 for generating the second generated audio signal through in part a spectral analysis of the second sound. An exemplary implementation may include the generating module M2411 configured to direct the operation.

For instance, in some implementations, the exemplary operation O24 may include the operation of O2412 for generating the second generated audio signal through in part a recognition of the second sound. An exemplary implementation may include the generating module M2412 configured to direct the operation.

For instance, in some implementations, the exemplary operation O24 may include the operation of O2413 for generating via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the generating module M2413 configured to direct the operation.

An operational flow O30 as shown represents exemplary operations. Some of the figures may have various examples of operational flows. It should be understood that the operational flows may be executed in a number of environments and contexts, including versions and modified versions of the Figures and other versions as well. Furthermore, although the various operational flows are presented in the sequence(s) illustrated, it should be understood that the various operations may be performed in other orders than those which are illustrated, or may be performed concurrently.

In figures that follow, various operations may be depicted in a box-within-a-box manner. Such depictions may indicate that an operation in an internal box may comprise an optional exemplary implementation of the operational step illustrated in one or more external boxes. However, it should be understood that internal box operations may be viewed as independent operations separate from any associated external boxes and may be performed in any sequence with respect to all other illustrated operations, or may be performed concurrently.

The operational flow O30 can move to operation O31 where receiving detection, via at least in part one or more computing devices, of a first event regarding a first sound involving one or more characteristics in a first manner may be executed. An exemplary implementation may include the receiving module M31 configured to direct the operation. For instance, the compute/control 210 of the audio/sound device 200 can receive detection through the acoustic component 242i of the input/sensing 240 that a first event of an appearance of background sound such as wind noise as a first sound is occurring involving such characteristics as an audio pattern of a desired sound in a first manner such as lacking the audio pattern of the desired sound.

The operational flow O30 can move to operation O32 where generating, via at least in part one or more computing devices, a first generated audio signal to alter hearing of the first sound by a listener based at least in part on receiving the detection of a first event regarding a first sound involving one or more characteristics in a first manner may be executed. An exemplary implementation may include the generating module M32 configured to direct the operation. For instance, the compute/control 210 of the audio/sound device 200 can generate a first generated audio signal such as an anti-noise signal to cancel out the hearing of the first sound such as the wind noise based upon the detection of the wind noise lacking the audio pattern of the desired sound.

The operational flow O30 can move to operation O33 where receiving detection, via at least in part one or more computing devices, of a first event regarding a second sound involving the one or more characteristics in a second manner other than the first manner may be executed. An exemplary implementation may include the receiving module M33 configured to direct the operation. For instance, the compute/control 210 of the audio/sound device 200 can receive detection through the acoustic component 242i of the input/sensing 240 that a first event of a disappearance of a desired sound as the second sound such as a sound from a particular machine involving the audio pattern of the desired sound in a second manner has having the audio pattern of the desired sound.

The operational flow O30 can move to operation O34 where outputting, via at least in part one or more computing devices, an indication based at least in part upon receiving the detection of the first event regarding the second sound involving the one or more characteristics in a second manner other than the first manner may be executed. An exemplary implementation may include the outputting module M34 configured to direct the operation. For instance, the compute/control 210 of the audio/sound device 200 can generate through the text out component 230a a textual indication that the particular machine has ceased functioning based upon receiving the detection of the first event of the disappearance of a desired sound as the second sound such as a sound from a particular machine having the audio pattern of the desired sound.

Illustrations of various implementations of the exemplary operations O31, O32, O33, and O34 are found in the figures.

For instance, in some implementations, the exemplary operation O31 may include the operation of O3101 for receiving the first sound from an ambient environment. An exemplary implementation may include the receiving module M3101 configured to direct the operation.

For instance, in some implementations, the exemplary operation O31 may include the operation of O3102 for receiving the first sound as a monitored sound. An exemplary implementation may include the receiving module M3102 configured to direct the operation.

For instance, in some implementations, the exemplary operation O31 may include the operation of O3103 for receiving the first sound from a coupled audio device. An exemplary implementation may include the receiving module M3103 configured to direct the operation.

For instance, in some implementations, the exemplary operation O31 may include the operation of O3104 for receiving the first sound from one or more speakers. An exemplary implementation may include the receiving module M3104 configured to direct the operation.

For instance, in some implementations, the exemplary operation O31 may include the operation of O3105 for receiving the first sound with one or more microphones. An exemplary implementation may include the receiving module M3105 configured to direct the operation.

For instance, in some implementations, the exemplary operation O31 may include the operation of O3106 for receiving the first sound with one or more electronic connections. An exemplary implementation may include the receiving module M3106 configured to direct the operation.

For instance, in some implementations, the exemplary operation O31 may include the operation of O3107 for receiving the first sound from one or more speakers. An exemplary implementation may include the receiving module M3107 configured to direct the operation.

For instance, in some implementations, the exemplary operation O21 may include the operation of O3107A for receiving detection of the first event regarding the first sound in a first manner that is opposite to the second manner. An exemplary implementation may include the receiving module M3107A configured to direct the operation.

For instance, in some implementations, the exemplary operation O31 may include the operation of O3108 for receiving detection of the first event regarding the first sound as an absence of the one or more characteristics in the first sound. An exemplary implementation may include the receiving module M3108 configured to direct the operation.

For instance, in some implementations, the exemplary operation O31 may include the operation of O3109 for receiving detection of the first event regarding the first sound as a change of the one or more characteristics in the first sound. An exemplary implementation may include the receiving module M3109 configured to direct the operation.

For instance, in some implementations, the exemplary operation O31 may include the operation of O3110 for receiving detection of the first event regarding the first sound as an appearance of the one or more characteristics in the first sound. An exemplary implementation may include the receiving module M3110 configured to direct the operation.

For instance, in some implementations, the exemplary operation O31 may include the operation of O3111 for receiving detection of the first event regarding the first sound involving the one or more characteristics as including one or more repetitive sounds. An exemplary implementation may include the receiving module M3111 configured to direct the operation.

For instance, in some implementations, the exemplary operation O31 may include the operation of O3112 for receiving detection of the first event regarding the first sound involving the one or more characteristics as including one or more sounds from one or more machines. An exemplary implementation may include the receiving module M3112 configured to direct the operation.

For instance, in some implementations, the exemplary operation O31 may include the operation of O3113 for receiving detection of the first event regarding the first sound involving the one or more characteristics as including speech from a human. An exemplary implementation may include the receiving module M3113 configured to direct the operation.

For instance, in some implementations, the exemplary operation O31 may include the operation of O3114 for receiving detection of the first event regarding the first sound involving the one or more characteristics as including sound from a living creature. An exemplary implementation may include the receiving module M3114 configured to direct the operation.

For instance, in some implementations, the exemplary operation O31 may include the operation of O3115 for receiving detection of the first event regarding the first sound involving the one or more characteristics as including sound of an engine abnormality. An exemplary implementation may include the receiving module M3115 configured to direct the operation.

For instance, in some implementations, the exemplary operation O31 may include the operation of O3116 for receiving detection of the first event regarding the first sound involving the one or more characteristics as including sound of an emergency warning. An exemplary implementation may include the receiving module M3116 configured to direct the operation.

For instance, in some implementations, the exemplary operation O31 may include the operation of O3117 for receiving detection of the first event regarding the first sound involving the one or more characteristics as including sound of a weather update. An exemplary implementation may include the receiving module M3117 configured to direct the operation.

For instance, in some implementations, the exemplary operation O31 may include the operation of O3118 for receiving, through an electronic signal, detection of the first event regarding the first sound involving one or more characteristics. An exemplary implementation may include the receiving module M3118 configured to direct the operation.

For instance, in some implementations, the exemplary operation O31 may include the operation of O3119 for receiving, through one or more microphones, detection of the first event regarding the first sound involving one or more characteristics. An exemplary implementation may include the receiving module M3119 configured to direct the operation.

For instance, in some implementations, the exemplary operation O31 may include the operation of O3120 for receiving, through an audio signal from an audio device, detection of the first event regarding the first sound involving one or more characteristics. An exemplary implementation may include the receiving module M3120 configured to direct the operation.

For instance, in some implementations, the exemplary operation O31 may include the operation of O3121 for receiving, through a traffic control signal from an emergency vehicle, detection of the first event regarding the first sound involving one or more characteristics. An exemplary implementation may include the receiving module M3121 configured to direct the operation.

For instance, in some implementations, the exemplary operation O31 may include the operation of O3122 for receiving, through performance of a table lookup to compare one or more portions of the first sound with one or more characteristics of sound in a database, detection of the first event regarding the first sound involving one or more characteristics. An exemplary implementation may include the receiving module M3122 configured to direct the operation.

For instance, in some implementations, the exemplary operation O31 may include the operation of O3123 for receiving, through performance of a spectral analysis of the first sound, detection of the first event regarding the first sound involving one or more characteristics. An exemplary implementation may include the receiving module M3123 configured to direct the operation.

For instance, in some implementations, the exemplary operation O31 may include the operation of O3124 for receiving, through an historical log associated with the first sound, detection of the first event regarding the first sound involving one or more characteristics. An exemplary implementation may include the receiving module M3124 configured to direct the operation.

For instance, in some implementations, the exemplary operation O31 may include the operation of O3125 for receiving, through information from an accelerometer, a barometer, a motion detector or a combination thereof, detection of the first event regarding the first sound involving one or more characteristics. An exemplary implementation may include the receiving module M3125 configured to direct the operation.

For instance, in some implementations, the exemplary operation O31 may include the operation of O3126 for receiving detection via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the receiving module M3126 configured to direct the operation.

For instance, in some implementations, the exemplary operation O32 may include the operation of O3201 for generating the first generated audio signal to be received to mute the first sound heard by the listener. An exemplary implementation may include the generating module M3201 configured to direct the operation.

For instance, in some implementations, the exemplary operation O32 may include the operation of O3202 for generating the first generated audio signal to be received to emit sound opposite in form to the first sound from speakers positioned to cancel amplitude of the first sound heard by the listener. An exemplary implementation may include the generating module M3202 configured to direct the operation.

For instance, in some implementations, the exemplary operation O32 may include the operation of O3203 for generating the first generated audio signal to be received to emit sound from speakers positioned to attenuate amplitude of the first sound heard by the listener. An exemplary implementation may include the generating module M3203 configured to direct the operation.

For instance, in some implementations, the exemplary operation O32 may include the operation of O3204 for generating the first generated audio signal to be received by a cell phone. An exemplary implementation may include the generating module M3204 configured to direct the operation.

For instance, in some implementations, the exemplary operation O32 may include the operation of O3205 for generating the first generated audio signal to be received by an amplifier system. An exemplary implementation may include the generating module M3205 configured to direct the operation.

For instance, in some implementations, the exemplary operation O32 may include the operation of O3206 for generating the first generated audio signal to be received by a two-way radio. An exemplary implementation may include the generating module M3206 configured to direct the operation.

For instance, in some implementations, the exemplary operation O32 may include the operation of O3207 for generating the first generated audio signal to be received by a computer. An exemplary implementation may include the generating module M3207 configured to direct the operation.

For instance, in some implementations, the exemplary operation O32 may include the operation of O3208 for generating the first generated audio signal to control speakers. An exemplary implementation may include the generating module M3208 configured to direct the operation.

For instance, in some implementations, the exemplary operation O32 may include the operation of O3209 for generating the first generated audio signal to modify an audio signal generated from reception of the first sound. An exemplary implementation may include the generating module M3209 configured to direct the operation.

For instance, in some implementations, the exemplary operation O32 may include the operation of O3210 for generating the first generated audio signal through in part a table lookup of a database. An exemplary implementation may include the generating module M3210 configured to direct the operation.

For instance, in some implementations, the exemplary operation O32 may include the operation of O3211 for generating the first generated audio signal through in part a spectral analysis of the first sound. An exemplary implementation may include the generating module M3211 configured to direct the operation.

For instance, in some implementations, the exemplary operation O32 may include the operation of O3212 for generating the first generated audio signal through in part a recognition of the first sound. An exemplary implementation may include the generating module M3212 configured to direct the operation.

For instance, in some implementations, the exemplary operation O32 may include the operation of O3213 for generating via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the generating module M3213 configured to direct the operation.

For instance, in some implementations, the exemplary operation O33 may include the operation of O3301 for receiving the second sound from an ambient environment. An exemplary implementation may include the receiving module M3301 configured to direct the operation.

For instance, in some implementations, the exemplary operation O33 may include the operation of O3302 for receiving the second sound as a monitored sound. An exemplary implementation may include the receiving module M3302 configured to direct the operation.

For instance, in some implementations, the exemplary operation O33 may include the operation of O3303 for receiving the second sound from a coupled audio device. An exemplary implementation may include the receiving module M3303 configured to direct the operation.

For instance, in some implementations, the exemplary operation O33 may include the operation of O3304 for receiving the second sound from one or more speakers. An exemplary implementation may include the receiving module M3304 configured to direct the operation.

For instance, in some implementations, the exemplary operation O33 may include the operation of O3305 for receiving the second sound with one or more microphones. An exemplary implementation may include the receiving module M3305 configured to direct the operation.

For instance, in some implementations, the exemplary operation O33 may include the operation of O3306 for receiving the second sound with one or more electronic connections. An exemplary implementation may include the receiving module M3306 configured to direct the operation.

For instance, in some implementations, the exemplary operation O33 may include the operation of O3307 for receiving the second sound from one or more speakers. An exemplary implementation may include the receiving module M3307 configured to direct the operation.

For instance, in some implementations, the exemplary operation O33 may include the operation of O3308 for receiving detection of the first event regarding the second sound as an absence of the one or more characteristics in the second sound. An exemplary implementation may include the receiving module M3308 configured to direct the operation.

For instance, in some implementations, the exemplary operation O33 may include the operation of O3309 for receiving detection of the first event regarding the second sound as a change of the one or more characteristics in the second sound. An exemplary implementation may include the receiving module M3309 configured to direct the operation.

For instance, in some implementations, the exemplary operation O33 may include the operation of O3310 for receiving detection of the first event regarding the second sound as an appearance of the one or more characteristics in the second sound. An exemplary implementation may include the receiving module M3310 configured to direct the operation.

For instance, in some implementations, the exemplary operation O33 may include the operation of O3311 for receiving detection of the first event regarding the second sound involving the one or more characteristics as including one or more repetitive sounds. An exemplary implementation may include the receiving module M3311 configured to direct the operation.

For instance, in some implementations, the exemplary operation O33 may include the operation of O3312 for receiving detection of the first event regarding the second sound involving the one or more characteristics as including one or more sounds from one or more machines. An exemplary implementation may include the receiving module M3312 configured to direct the operation.

For instance, in some implementations, the exemplary operation O33 may include the operation of O3313 for receiving detection of the first event regarding the second sound involving the one or more characteristics as including speech from a human. An exemplary implementation may include the receiving module M3313 configured to direct the operation.

For instance, in some implementations, the exemplary operation O33 may include the operation of O3314 for receiving detection of the first event regarding the second sound involving the one or more characteristics as including sound from a living creature. An exemplary implementation may include the receiving module M3314 configured to direct the operation.

For instance, in some implementations, the exemplary operation O33 may include the operation of O3315 for receiving detection of the first event regarding the second sound involving the one or more characteristics as including sound of an engine abnormality. An exemplary implementation may include the receiving module M3315 configured to direct the operation.

For instance, in some implementations, the exemplary operation O33 may include the operation of O3316 for receiving detection of the first event regarding the second sound involving the one or more characteristics as including sound of an emergency warning. An exemplary implementation may include the receiving module M3316 configured to direct the operation.

For instance, in some implementations, the exemplary operation O33 may include the operation of O3317 for receiving detection of the first event regarding the second sound involving the one or more characteristics as including sound of a weather update. An exemplary implementation may include the receiving module M3317 configured to direct the operation.

For instance, in some implementations, the exemplary operation O33 may include the operation of O3318 for receiving, through an electronic signal, detection of the first event regarding the second sound involving one or more characteristics. An exemplary implementation may include the receiving module M3318 configured to direct the operation.

For instance, in some implementations, the exemplary operation O33 may include the operation of O3319 for receiving, through one or more microphones, detection of the first event regarding the second sound involving one or more characteristics. An exemplary implementation may include the receiving module M3319 configured to direct the operation.

For instance, in some implementations, the exemplary operation O33 may include the operation of O3320 for receiving, through an audio signal from an audio device, detection of the first event regarding the second sound involving one or more characteristics. An exemplary implementation may include the receiving module M3320 configured to direct the operation.

For instance, in some implementations, the exemplary operation O33 may include the operation of O3321 for receiving, through a traffic control signal from an emergency vehicle, detection of the first event regarding the second sound involving one or more characteristics. An exemplary implementation may include the receiving module M3321 configured to direct the operation.

For instance, in some implementations, the exemplary operation O33 may include the operation of O3322 for receiving, through performance of a table lookup to compare one or more portions of the second sound with one or more characteristics of sound in a database, detection of the first event regarding the second sound involving one or more characteristics. An exemplary implementation may include the receiving module M3322 configured to direct the operation.

For instance, in some implementations, the exemplary operation O33 may include the operation of O3323 for receiving, through performance of a spectral analysis of the second sound, detection of the first event regarding the second sound involving one or more characteristics. An exemplary implementation may include the receiving module M3323 configured to direct the operation.

For instance, in some implementations, the exemplary operation O33 may include the operation of O3324 for receiving, through an historical log associated with the second sound, detection of the first event regarding the second sound involving one or more characteristics. An exemplary implementation may include the receiving module M3324 configured to direct the operation.

For instance, in some implementations, the exemplary operation O33 may include the operation of O3325 for receiving, through information from an accelerometer, a barometer, a motion detector or a combination thereof, detection of the first event regarding the second sound involving one or more characteristics. An exemplary implementation may include the receiving module M3325 configured to direct the operation.

For instance, in some implementations, the exemplary operation O33 may include the operation of O3326 for receiving detection via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the receiving module M3326 configured to direct the operation.

For instance, in some implementations, the exemplary operation O34 may include the operation of O3401 for outputting the indication to notify of an appearance of the one or more characteristics in the second sound. An exemplary implementation may include the outputting module M3401 configured to direct the operation.

For instance, in some implementations, the exemplary operation O34 may include the operation of O3402 for outputting the indication to notify of an absence of the one or more characteristics in the second sound. An exemplary implementation may include the outputting module M3402 configured to direct the operation.

For instance, in some implementations, the exemplary operation O34 may include the operation of O3403 for outputting the indication to notify of a change of the one or more characteristics in the second sound. An exemplary implementation may include the outputting module M3403 configured to direct the operation.

For instance, in some implementations, the exemplary operation O34 may include the operation of O3404 for outputting the indication to notify of the existence of the one or more characteristics of the second sound. An exemplary implementation may include the outputting module M3404 configured to direct the operation.

For instance, in some implementations, the exemplary operation O34 may include the operation of O3405 for outputting the indication to be received by a cell phone. An exemplary implementation may include the outputting module M3405 configured to direct the operation.

For instance, in some implementations, the exemplary operation O34 may include the operation of O3406 for outputting the indication to be received by an amplifier system. An exemplary implementation may include the outputting module M3406 configured to direct the operation.

For instance, in some implementations, the exemplary operation O34 may include the operation of O3407 for outputting the indication to be received by a two-way radio. An exemplary implementation may include the outputting module M3407 configured to direct the operation.

For instance, in some implementations, the exemplary operation O34 may include the operation of O3408 for outputting the indication to be received by a computer. An exemplary implementation may include the outputting module M3408 configured to direct the operation.

For instance, in some implementations, the exemplary operation O34 may include the operation of O3409 for outputting the indication to control speakers. An exemplary implementation may include the outputting module M3409 configured to direct the operation.

For instance, in some implementations, the exemplary operation O34 may include the operation of O3410 for outputting the indication through in part a table lookup of a database. An exemplary implementation may include the outputting module M3410 configured to direct the operation.

For instance, in some implementations, the exemplary operation O34 may include the operation of O3411 for outputting the indication through in part a spectral analysis of the second sound. An exemplary implementation may include the outputting module M3411 configured to direct the operation.

For instance, in some implementations, the exemplary operation O34 may include the operation of O3412 for outputting the indication through in part a recognition of the second sound. An exemplary implementation may include the outputting module M3412 configured to direct the operation.

For instance, in some implementations, the exemplary operation O34 may include the operation of O3413 for outputting the indication on a visual display. An exemplary implementation may include the outputting module M3413 configured to direct the operation.

For instance, in some implementations, the exemplary operation O34 may include the operation of O3414 for outputting the indication as a textual display. An exemplary implementation may include the outputting module M3414 configured to direct the operation.

For instance, in some implementations, the exemplary operation O34 may include the operation of O3415 for outputting the indication in audio form. An exemplary implementation may include the outputting module M3415 configured to direct the operation.

For instance, in some implementations, the exemplary operation O34 may include the operation of O3416 for outputting the indication as synthesized speech. An exemplary implementation may include the outputting module M3416 configured to direct the operation.

For instance, in some implementations, the exemplary operation O34 may include the operation of O3417 for outputting the indication as an electromechanical vibration. An exemplary implementation may include the outputting module M3417 configured to direct the operation.

For instance, in some implementations, the exemplary operation O34 may include the operation of O3418 for outputting the indication though an interface incorporated into a steering wheel of a vehicle. An exemplary implementation may include the outputting module M3418 configured to direct the operation.

For instance, in some implementations, the exemplary operation O34 may include the operation of O3419 for outputting the indication as a projection. An exemplary implementation may include the outputting module M3419 configured to direct the operation.

For instance, in some implementations, the exemplary operation O34 may include the operation of O3420 for outputting the indication as a heads-up display. An exemplary implementation may include the outputting module M34020 configured to direct the operation.

For instance, in some implementations, the exemplary operation O34 may include the operation of O3421 for outputting the indication on a portion of a windshield. An exemplary implementation may include the outputting module M3421 configured to direct the operation.

For instance, in some implementations, the exemplary operation O34 may include the operation of O3422 for outputting the indication on a portion of a vehicle. An exemplary implementation may include the outputting module M3422 configured to direct the operation.

For instance, in some implementations, the exemplary operation O34 may include the operation of O3423 for outputting the indication through ear-buds. An exemplary implementation may include the outputting module M3423 configured to direct the operation.

For instance, in some implementations, the exemplary operation O34 may include the operation of O3424 for outputting the indication through a radio system. An exemplary implementation may include the outputting module M3424 configured to direct the operation.

For instance, in some implementations, the exemplary operation O34 may include the operation of O3425 for outputting the indication through a personal data assistant. An exemplary implementation may include the outputting module M3425 configured to direct the operation.

For instance, in some implementations, the exemplary operation O34 may include the operation of O3426 for outputting the indication through an iPod-like device. An exemplary implementation may include the outputting module M3426 configured to direct the operation.

For instance, in some implementations, the exemplary operation O34 may include the operation of O3427 for outputting the indication through a computer. An exemplary implementation may include the outputting module M3427 configured to direct the operation.

For instance, in some implementations, the exemplary operation O34 may include the operation of O3428 for outputting the indication through headphones. An exemplary implementation may include the outputting module M3428 configured to direct the operation.

For instance, in some implementations, the exemplary operation O34 may include the operation of O3429 for outputting the indication through loudspeakers. An exemplary implementation may include the outputting module M3429 configured to direct the operation.

For instance, in some implementations, the exemplary operation O34 may include the operation of O3430 for outputting the indication through a graphics display. An exemplary implementation may include the outputting module M3430 configured to direct the operation.

For instance, in some implementations, the exemplary operation O34 may include the operation of O3431 for outputting via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the outputting module M3431 configured to direct the operation.

An operational flow O40 as shown represents exemplary operations. Some of the figures may have various examples of operational flows. It should be understood that the operational flows may be executed in a number of environments and contexts, including versions and modified versions of the figures and other versions as well. Furthermore, although the various operational flows are presented in the sequence(s) illustrated, it should be understood that the various operations may be performed in other orders than those which are illustrated, or may be performed concurrently.

In figures that follow, various operations may be depicted in a box-within-a-box manner. Such depictions may indicate that an operation in an internal box may comprise an optional exemplary implementation of the operational step illustrated in one or more external boxes. However, it should be understood that internal box operations may be viewed as independent operations separate from any associated external boxes and may be performed in any sequence with respect to all other illustrated operations, or may be performed concurrently.

The operational flow O40 can move to operation O41 where receiving detection, via at least in part one or more computing devices, of a first event regarding a first sound involving one or more characteristics in a first manner may be executed. An exemplary implementation may include the receiving module M41 configured to direct the operation. For instance, the compute/control 210 of the audio/sound device 200 can receive detection through the acoustic component 242i of the input/sensing 240 that a first event of an appearance of background sound such as traffic noise as a first sound is occurring involving such characteristics as involving an audio pattern of a desired sound in a first manner as lacking the audio pattern of the desired sound.

The operational flow O40 can move to operation O42 where generating, via at least in part one or more computing devices, a first generated audio signal to alter hearing of the first sound by a listener based at least in part on receiving the detection of a first event regarding a first sound involving one or more characteristics in a first manner may be executed. An exemplary implementation may include the generating module M42 configured to direct the operation. An exemplary implementation may include the generating module M32 configured to direct the operation. For instance, the compute/control 210 of the audio/sound device 200 can generate a first generated audio signal such as an anti-noise signal to cancel out the hearing of the first sound such as the traffic noise based upon the detection of the traffic noise as lacking the audio pattern of the desired sound.

The operational flow O40 can move to operation O43 where receiving detection, via at least in part one or more computing devices, of a first event regarding a second sound involving the one or more characteristics in a second manner other than the first manner may be executed. An exemplary implementation may include the receiving module M43 configured to direct the operation. For instance, the compute/control 210 of the audio/sound device 200 can receive detection through the acoustic component 242i of the input/sensing 240 that a first event of an appearance of desired sound as the second sound such as a siren of an emergency vehicle having one or more characteristics involving the audio pattern of the desired sound in a second manner as including the audio pattern of the desired sound.

The operational flow O40 can move to operation O44 where receiving an estimation, via at least in part one or more computing devices, of a directional orientation for origination of the second sound may be executed. An exemplary implementation may include the receiving module M44 configured to direct the operation. For instance, the compute/control 210 of the audio/sound device 200 can receive an estimation through the triangulation component 242t of the input/sensing 240 of a directional orientation for origination of the second sound such as the second sound is originating from a southwest direction or rearward of a vehicle housing the audio/sound device 200.

The operational flow O40 can move to operation O45 where outputting, via at least in part one or more computing devices, an indication of the directional orientation for origination of the second sound based at least in part upon receiving the estimation of the directional orientation for origination of the second sound may be executed. An exemplary implementation may include the outputting module M45 configured to direct the operation. For instance, the compute/control 210 of the audio/sound device 200 can generate through the projector out component 230l a symbolic indication that an emergency vehicle is approaching from a rearward orientation based upon receiving the estimation of a directional orientation for origination of the second sound as a siren of an emergency vehicle such the second sound originating rearward of a vehicle housing the audio/sound device 200.

For instance, in some implementations, the exemplary operation O41 may include the operation of O4101 for receiving the first sound from an ambient environment. An exemplary implementation may include the receiving module M4101 configured to direct the operation.

For instance, in some implementations, the exemplary operation O41 may include the operation of O4102 for receiving the first sound as a monitored sound. An exemplary implementation may include the receiving module M4102 configured to direct the operation.

For instance, in some implementations, the exemplary operation O41 may include the operation of O4103 for receiving the first sound from a coupled audio device. An exemplary implementation may include the receiving module M4103 configured to direct the operation.

For instance, in some implementations, the exemplary operation O41 may include the operation of O4104 for receiving the first sound from one or more speakers. An exemplary implementation may include the receiving module M4104 configured to direct the operation.

For instance, in some implementations, the exemplary operation O41 may include the operation of O4105 for receiving the first sound with one or more microphones. An exemplary implementation may include the receiving module M4105 configured to direct the operation.

For instance, in some implementations, the exemplary operation O41 may include the operation of O4106 for receiving the first sound with one or more electronic connections. An exemplary implementation may include the receiving module M4106 configured to direct the operation.

For instance, in some implementations, the exemplary operation O41 may include the operation of O4107 for receiving the first sound from one or more speakers. An exemplary implementation may include the receiving module M4107 configured to direct the operation.

For instance, in some implementations, the exemplary operation O21 may include the operation of O4107A for receiving detection of the first event regarding the first sound in a first manner that is opposite to the second manner. An exemplary implementation may include the receiving module M4107A configured to direct the operation.

For instance, in some implementations, the exemplary operation O41 may include the operation of O4108 for receiving detection of the first event regarding the first sound as an absence of the one or more characteristics in the first sound. An exemplary implementation may include the receiving module M4108 configured to direct the operation.

For instance, in some implementations, the exemplary operation O41 may include the operation of O4109 for receiving detection of the first event regarding the first sound as a change of the one or more characteristics in the first sound. An exemplary implementation may include the receiving module M4109 configured to direct the operation.

For instance, in some implementations, the exemplary operation O41 may include the operation of O4110 for receiving detection of the first event regarding the first sound as an appearance of the one or more characteristics in the first sound. An exemplary implementation may include the receiving module M4110 configured to direct the operation.

For instance, in some implementations, the exemplary operation O41 may include the operation of O4111 for receiving detection of the first event regarding the first sound involving the one or more characteristics as including one or more repetitive sounds. An exemplary implementation may include the receiving module M4111 configured to direct the operation.

For instance, in some implementations, the exemplary operation O41 may include the operation of O4112 for receiving detection of the first event regarding the first sound involving the one or more characteristics as including one or more sounds from one or more machines. An exemplary implementation may include the receiving module M4112 configured to direct the operation.

For instance, in some implementations, the exemplary operation O41 may include the operation of O4113 for receiving detection of the first event regarding the first sound involving the one or more characteristics as including speech from a human. An exemplary implementation may include the receiving module M4113 configured to direct the operation.

For instance, in some implementations, the exemplary operation O41 may include the operation of O4114 for receiving detection of the first event regarding the first sound involving the one or more characteristics as including sound from a living creature. An exemplary implementation may include the receiving module M4114 configured to direct the operation.

For instance, in some implementations, the exemplary operation O41 may include the operation of O4115 for receiving detection of the first event regarding the first sound involving the one or more characteristics as including sound of an engine abnormality. An exemplary implementation may include the receiving module M4115 configured to direct the operation.

For instance, in some implementations, the exemplary operation O41 may include the operation of O4116 for receiving detection of the first event regarding the first sound involving the one or more characteristics as including sound of an emergency warning. An exemplary implementation may include the receiving module M4116 configured to direct the operation.

For instance, in some implementations, the exemplary operation O41 may include the operation of O4117 for receiving detection of the first event regarding the first sound involving the one or more characteristics as including sound of a weather update. An exemplary implementation may include the receiving module M4117 configured to direct the operation.

For instance, in some implementations, the exemplary operation O41 may include the operation of O4118 for receiving, through an electronic signal, detection of the first event regarding the first sound involving one or more characteristics. An exemplary implementation may include the receiving module M4118 configured to direct the operation.

For instance, in some implementations, the exemplary operation O41 may include the operation of O4119 for receiving, through one or more microphones, detection of the first event regarding the first sound involving one or more characteristics. An exemplary implementation may include the receiving module M4119 configured to direct the operation.

For instance, in some implementations, the exemplary operation O41 may include the operation of O4120 for receiving, through an audio signal from an audio device, detection of the first event regarding the first sound involving one or more characteristics. An exemplary implementation may include the receiving module M4120 configured to direct the operation.

For instance, in some implementations, the exemplary operation O41 may include the operation of O4121 for receiving, through a traffic control signal from an emergency vehicle, detection of the first event regarding the first sound involving one or more characteristics. An exemplary implementation may include the receiving module M4121 configured to direct the operation.

For instance, in some implementations, the exemplary operation O41 may include the operation of O4122 for receiving, through performance of a table lookup to compare one or more portions of the first sound with one or more characteristics of sound in a database, detection of the first event regarding the first sound involving one or more characteristics. An exemplary implementation may include the receiving module M4122 configured to direct the operation.

For instance, in some implementations, the exemplary operation O41 may include the operation of O4123 for receiving, through performance of a spectral analysis of the first sound, detection of the first event regarding the first sound involving one or more characteristics. An exemplary implementation may include the receiving module M4123 configured to direct the operation.

For instance, in some implementations, the exemplary operation O41 may include the operation of O4124 for receiving, through an historical log associated with the first sound, detection of the first event regarding the first sound involving one or more characteristics. An exemplary implementation may include the receiving module M4124 configured to direct the operation.

For instance, in some implementations, the exemplary operation O41 may include the operation of O4125 for receiving, through information from an accelerometer, a barometer, a motion detector or a combination thereof, detection of the first event regarding the first sound involving one or more characteristics. An exemplary implementation may include the receiving module M4125 configured to direct the operation.

For instance, in some implementations, the exemplary operation O41 may include the operation of O4126 for receiving detection via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the receiving module M4126 configured to direct the operation.

For instance, in some implementations, the exemplary operation O42 may include the operation of O4201 for generating the first generated audio signal to be received to mute the first sound heard by the listener. An exemplary implementation may include the generating module M4201 configured to direct the operation.

For instance, in some implementations, the exemplary operation O42 may include the operation of O4202 for generating the first generated audio signal to be received to emit sound opposite in form to the first sound from speakers positioned to cancel amplitude of the first sound heard by the listener. An exemplary implementation may include the generating module M4202 configured to direct the operation.

For instance, in some implementations, the exemplary operation O42 may include the operation of O4203 for generating the first generated audio signal to be received to emit sound from speakers positioned to attenuate amplitude of the first sound heard by the listener. An exemplary implementation may include the generating module M4203 configured to direct the operation.

For instance, in some implementations, the exemplary operation O42 may include the operation of O4204 for generating the first generated audio signal to be received by a cell phone. An exemplary implementation may include the generating module M4204 configured to direct the operation.

For instance, in some implementations, the exemplary operation O42 may include the operation of O4205 for generating the first generated audio signal to be received by an amplifier system. An exemplary implementation may include the generating module M4205 configured to direct the operation.

For instance, in some implementations, the exemplary operation O42 may include the operation of O4206 for generating the first generated audio signal to be received by a two-way radio. An exemplary implementation may include the generating module M4206 configured to direct the operation.

For instance, in some implementations, the exemplary operation O42 may include the operation of O4207 for generating the first generated audio signal to be received by a computer. An exemplary implementation may include the generating module M4207 configured to direct the operation.

For instance, in some implementations, the exemplary operation O42 may include the operation of O4208 for generating the first generated audio signal to control speakers. An exemplary implementation may include the generating module M4208 configured to direct the operation.

For instance, in some implementations, the exemplary operation O42 may include the operation of O4209 for generating the first generated audio signal to modify an audio signal generated from reception of the first sound. An exemplary implementation may include the generating module M4209 configured to direct the operation.

For instance, in some implementations, the exemplary operation O42 may include the operation of O4210 for generating the first generated audio signal through in part a table lookup of a database. An exemplary implementation may include the generating module M4210 configured to direct the operation.

For instance, in some implementations, the exemplary operation O42 may include the operation of O4211 for generating the first generated audio signal through in part a spectral analysis of the first sound. An exemplary implementation may include the generating module M4211 configured to direct the operation.

For instance, in some implementations, the exemplary operation O42 may include the operation of O4212 for generating the first generated audio signal through in part a recognition of the first sound. An exemplary implementation may include the generating module M4212 configured to direct the operation.

For instance, in some implementations, the exemplary operation O42 may include the operation of O4213 for generating via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the generating module M4213 configured to direct the operation.

For instance, in some implementations, the exemplary operation O43 may include the operation of O4301 for receiving the second sound from an ambient environment. An exemplary implementation may include the receiving module M4301 configured to direct the operation.

For instance, in some implementations, the exemplary operation O43 may include the operation of O4302 for receiving the second sound as a monitored sound. An exemplary implementation may include the receiving module M4302 configured to direct the operation.

For instance, in some implementations, the exemplary operation O43 may include the operation of O4303 for receiving the second sound from a coupled audio device. An exemplary implementation may include the receiving module M4303 configured to direct the operation.

For instance, in some implementations, the exemplary operation O43 may include the operation of O4304 for receiving the second sound from one or more speakers. An exemplary implementation may include the receiving module M4304 configured to direct the operation.

For instance, in some implementations, the exemplary operation O43 may include the operation of O4305 for receiving the second sound with one or more microphones. An exemplary implementation may include the receiving module M4305 configured to direct the operation.

For instance, in some implementations, the exemplary operation O43 may include the operation of O4306 for receiving the second sound with one or more electronic connections. An exemplary implementation may include the receiving module M4306 configured to direct the operation.

For instance, in some implementations, the exemplary operation O43 may include the operation of O4307 for receiving the second sound from one or more speakers. An exemplary implementation may include the receiving module M4307 configured to direct the operation.

For instance, in some implementations, the exemplary operation O43 may include the operation of O4308 for receiving detection of the first event regarding the second sound as an absence of the one or more characteristics in the second sound. An exemplary implementation may include the receiving module M4308 configured to direct the operation.

For instance, in some implementations, the exemplary operation O43 may include the operation of O4309 for receiving detection of the first event regarding the second sound as a change of the one or more characteristics in the second sound. An exemplary implementation may include the receiving module M4309 configured to direct the operation.

For instance, in some implementations, the exemplary operation O43 may include the operation of O4310 for receiving detection of the first event regarding the second sound as an appearance of the one or more characteristics in the second sound. An exemplary implementation may include the receiving module M4310 configured to direct the operation.

For instance, in some implementations, the exemplary operation O43 may include the operation of O4311 for receiving detection of the first event regarding the second sound involving the one or more characteristics as including one or more repetitive sounds. An exemplary implementation may include the receiving module M4311 configured to direct the operation.

For instance, in some implementations, the exemplary operation O43 may include the operation of O4312 for receiving detection of the first event regarding the second sound involving the one or more characteristics as including one or more sounds from one or more machines. An exemplary implementation may include the receiving module M4312 configured to direct the operation.

For instance, in some implementations, the exemplary operation O43 may include the operation of O4313 for receiving detection of the first event regarding the second sound involving the one or more characteristics as including speech from a human. An exemplary implementation may include the receiving module M4313 configured to direct the operation.

For instance, in some implementations, the exemplary operation O43 may include the operation of O4314 for receiving detection of the first event regarding the second sound involving the one or more characteristics as including sound from a living creature. An exemplary implementation may include the receiving module M4314 configured to direct the operation.

For instance, in some implementations, the exemplary operation O43 may include the operation of O4315 for receiving detection of the first event regarding the second sound involving the one or more characteristics as including sound of an engine abnormality. An exemplary implementation may include the receiving module M4315 configured to direct the operation.

For instance, in some implementations, the exemplary operation O43 may include the operation of O4316 for receiving detection of the first event regarding the second sound involving the one or more characteristics as including sound of an emergency warning. An exemplary implementation may include the receiving module M4316 configured to direct the operation.

For instance, in some implementations, the exemplary operation O43 may include the operation of O4317 for receiving detection of the first event regarding the second sound involving the one or more characteristics as including sound of a weather update. An exemplary implementation may include the receiving module M4317 configured to direct the operation.

For instance, in some implementations, the exemplary operation O43 may include the operation of O4318 for receiving, through an electronic signal, detection of the first event regarding the second sound involving one or more characteristics. An exemplary implementation may include the receiving module M4318 configured to direct the operation.

For instance, in some implementations, the exemplary operation O43 may include the operation of O4319 for receiving, through one or more microphones, detection of the first event regarding the second sound involving one or more characteristics. An exemplary implementation may include the receiving module M4319 configured to direct the operation.

For instance, in some implementations, the exemplary operation O43 may include the operation of O4320 for receiving, through an audio signal from an audio device, detection of the first event regarding the second sound involving one or more characteristics. An exemplary implementation may include the receiving module M4320 configured to direct the operation.

For instance, in some implementations, the exemplary operation O43 may include the operation of O4321 for receiving, through a traffic control signal from an emergency vehicle, detection of the first event regarding the second sound involving one or more characteristics. An exemplary implementation may include the receiving module M4321 configured to direct the operation.

For instance, in some implementations, the exemplary operation O43 may include the operation of O4322 for receiving, through performance of a table lookup to compare one or more portions of the second sound with one or more characteristics of sound in a database, detection of the first event regarding the second sound involving one or more characteristics. An exemplary implementation may include the receiving module M4322 configured to direct the operation.

For instance, in some implementations, the exemplary operation O43 may include the operation of O4323 for receiving, through performance of a spectral analysis of the second sound, detection of the first event regarding the second sound involving one or more characteristics. An exemplary implementation may include the receiving module M4323 configured to direct the operation.

For instance, in some implementations, the exemplary operation O43 may include the operation of O4324 for receiving, through an historical log associated with the second sound, detection of the first event regarding the second sound involving one or more characteristics. An exemplary implementation may include the receiving module M4324 configured to direct the operation.

For instance, in some implementations, the exemplary operation O43 may include the operation of O4325 for receiving, through information from an accelerometer, a barometer, a motion detector or a combination thereof, detection of the first event regarding the second sound involving one or more characteristics. An exemplary implementation may include the receiving module M4325 configured to direct the operation.

For instance, in some implementations, the exemplary operation O43 may include the operation of O4326 for receiving detection via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the receiving module M4326 configured to direct the operation.

For instance, in some implementations, the exemplary operation O44 may include the operation of O4401 for basing the estimation of the directional orientation for origination at least in part on one or more differences in time in which the second sound was received between two or more microphones. An exemplary implementation may include the basing module M4401 configured to direct the operation.

For instance, in some implementations, the exemplary operation O44 may include the operation of O4402 for expressing the estimation of the directional orientation for origination in terms of a speed of an object emitting the second sound relative to a listener. An exemplary implementation may include the expressing module M4402 configured to direct the operation.

For instance, in some implementations, the exemplary operation O44 may include the operation of O4403 for expressing the estimation of the directional orientation for origination in terms of an absolute speed an object emitting the second sound. An exemplary implementation may include the expressing module M4403 configured to direct the operation.

For instance, in some implementations, the exemplary operation O44 may include the operation of O4404 for expressing the estimation of the directional orientation for origination in terms of a velocity of an object emitting the second sound relative to a listener. An exemplary implementation may include the expressing module M4404 configured to direct the operation.

For instance, in some implementations, the exemplary operation O44 may include the operation of O4405 for expressing the estimation of the directional orientation for origination in terms of an absolute velocity of an object emitting the second sound. An exemplary implementation may include the expressing module M4405 configured to direct the operation.

For instance, in some implementations, the exemplary operation O44 may include the operation of O4406 for expressing the estimation of the directional orientation for origination in terms of a distance of an object emitting the second sound from a listener. An exemplary implementation may include the expressing module M4406 configured to direct the operation.

For instance, in some implementations, the exemplary operation O44 may include the operation of O4407 for expressing the estimation of the directional orientation for origination in terms of an azimuth of an object emitting the second sound relative to a listener. An exemplary implementation may include the expressing module M4407 configured to direct the operation.

For instance, in some implementations, the exemplary operation O44 may include the operation of O4408 for expressing the estimation of the directional orientation for origination in terms of an absolute elevation of an object emitting the second sound. An exemplary implementation may include the expressing module M4408 configured to direct the operation.

For instance, in some implementations, the exemplary operation O44 may include the operation of O4409 for expressing the estimation of the directional orientation for origination in terms of an elevation of an object emitting the second sound relative to a listener. An exemplary implementation may include the expressing module M4409 configured to direct the operation.

For instance, in some implementations, the exemplary operation O44 may include the operation of O4410 for expressing the estimation of the directional orientation for origination in terms of a compass direction of an object emitting the second sound from a listener. An exemplary implementation may include the expressing module M4410 configured to direct the operation.

For instance, in some implementations, the exemplary operation O44 may include the operation of O4411 for expressing the estimation of the directional orientation for origination in terms of a street address of an object emitting the second sound. An exemplary implementation may include the expressing module M4411 configured to direct the operation.

For instance, in some implementations, the exemplary operation O44 may include the operation of O4412 for basing the estimation of the directional orientation for origination at least in part on global positioning system (GPS) data. An exemplary implementation may include the basing module M4412 configured to direct the operation.

For instance, in some implementations, the exemplary operation O44 may include the operation of O4413 for basing the estimation of the directional orientation for origination at least in part on an emergency beacon. An exemplary implementation may include the basing module M4413 configured to direct the operation.

For instance, in some implementations, the exemplary operation O44 may include the operation of O4414 for basing the estimation of the directional orientation for origination at least in part on audio recognition of the second sound. An exemplary implementation may include the basing module M4414 configured to direct the operation.

For instance, in some implementations, the exemplary operation O44 may include the operation of O4415 receiving the estimation via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the receiving module M4415 configured to direct the operation.

O45 for outputting, via at least in part one or more computing devices, an indication of the directional orientation for origination of the second sound based at least in part upon receiving the estimation of the directional orientation for origination of the second sound

For instance, in some implementations, the exemplary operation O45 may include the operation of O4501 for outputting the indication of the directional orientation for origination of the second sound including indication of an appearance of the one or more characteristics in the second sound. An exemplary implementation may include the outputting module M4501 configured to direct the operation.

For instance, in some implementations, the exemplary operation O45 may include the operation of O4502 for outputting the indication of the directional orientation for origination of the second sound including indication of an absence of the one or more characteristics in the second sound. An exemplary implementation may include the outputting module M4502 configured to direct the operation.

For instance, in some implementations, the exemplary operation O45 may include the operation of O4503 for outputting the indication of the directional orientation for origination of the second sound including indication of a change of the one or more characteristics in the second sound. An exemplary implementation may include the outputting module M4503 configured to direct the operation.

For instance, in some implementations, the exemplary operation O45 may include the operation of O4504 for outputting the indication of the directional orientation for origination of the second sound including indication of the existence of the one or more characteristics of the second sound. An exemplary implementation may include the outputting module M4504 configured to direct the operation.

For instance, in some implementations, the exemplary operation O45 may include the operation of O4505 for outputting the indication of the directional orientation for origination of the second sound to be received by a cell phone. An exemplary implementation may include the outputting module M4505 configured to direct the operation.

For instance, in some implementations, the exemplary operation O45 may include the operation of O4506 for outputting the indication of the directional orientation for origination of the second sound to be received by an amplifier system. An exemplary implementation may include the outputting module M4506 configured to direct the operation.

For instance, in some implementations, the exemplary operation O45 may include the operation of O4507 for outputting the indication of the directional orientation for origination of the second sound to be received by a two-way radio. An exemplary implementation may include the outputting module M4507 configured to direct the operation.

For instance, in some implementations, the exemplary operation O45 may include the operation of O4508 for outputting the indication of the directional orientation for origination of the second sound to be received by a computer. An exemplary implementation may include the outputting module M4508 configured to direct the operation.

For instance, in some implementations, the exemplary operation O45 may include the operation of O4509 for outputting the indication of the directional orientation for origination of the second sound to control speakers. An exemplary implementation may include the outputting module M4509 configured to direct the operation.

For instance, in some implementations, the exemplary operation O45 may include the operation of O4510 for outputting the indication of the directional orientation for origination of the second sound through in part a table lookup of a database. An exemplary implementation may include the outputting module M4510 configured to direct the operation.

For instance, in some implementations, the exemplary operation O45 may include the operation of O4511 for outputting the indication of the directional orientation for origination of the second sound through in part a spectral analysis of the second sound. An exemplary implementation may include the outputting module M4511 configured to direct the operation.

For instance, in some implementations, the exemplary operation O45 may include the operation of O4512 for outputting the indication of the directional orientation for origination of the second sound through in part a recognition of the second sound. An exemplary implementation may include the outputting module M4512 configured to direct the operation.

For instance, in some implementations, the exemplary operation O45 may include the operation of O4513 for outputting the indication of the directional orientation for origination of the second sound on a visual display. An exemplary implementation may include the outputting module M4513 configured to direct the operation.

For instance, in some implementations, the exemplary operation O45 may include the operation of O4514 for outputting the indication of the directional orientation for origination of the second sound as a textual display. An exemplary implementation may include the outputting module M4514 configured to direct the operation.

For instance, in some implementations, the exemplary operation O45 may include the operation of O4515 for outputting the indication of the directional orientation for origination of the second sound in audio form. An exemplary implementation may include the outputting module M4515 configured to direct the operation.

For instance, in some implementations, the exemplary operation O45 may include the operation of O4516 for outputting the indication of the directional orientation for origination of the second sound as synthesized speech. An exemplary implementation may include the outputting module M4516 configured to direct the operation.

For instance, in some implementations, the exemplary operation O45 may include the operation of O4517 for outputting the indication of the directional orientation for origination of the second sound as an electromechanical vibration. An exemplary implementation may include the outputting module M4517 configured to direct the operation.

For instance, in some implementations, the exemplary operation O45 may include the operation of O4518 for outputting the indication of the directional orientation for origination of the second sound though an interface incorporated into a steering wheel of a vehicle. An exemplary implementation may include the outputting module M4518 configured to direct the operation.

For instance, in some implementations, the exemplary operation O45 may include the operation of O4519 for outputting the indication of the directional orientation for origination of the second sound as a projection. An exemplary implementation may include the outputting module M4519 configured to direct the operation.

For instance, in some implementations, the exemplary operation O45 may include the operation of O4520 for outputting the indication of the directional orientation for origination of the second sound as a heads-up display. An exemplary implementation may include the outputting module M4510 configured to direct the operation.

For instance, in some implementations, the exemplary operation O45 may include the operation of O4521 for outputting the indication of the directional orientation for origination of the second sound on a portion of a windshield. An exemplary implementation may include the outputting module M4521 configured to direct the operation.

For instance, in some implementations, the exemplary operation O45 may include the operation of O4522 for outputting the indication of the directional orientation for origination of the second sound on a portion of a vehicle. An exemplary implementation may include the outputting module M4522 configured to direct the operation.

For instance, in some implementations, the exemplary operation O45 may include the operation of O4523 for outputting the indication of the directional orientation for origination of the second sound through ear-buds. An exemplary implementation may include the outputting module M4523 configured to direct the operation.

For instance, in some implementations, the exemplary operation O45 may include the operation of O4524 for outputting the indication of the directional orientation for origination of the second sound through a radio system. An exemplary implementation may include the outputting module M4524 configured to direct the operation.

For instance, in some implementations, the exemplary operation O45 may include the operation of O4525 for outputting the indication of the directional orientation for origination of the second sound through a personal data assistant. An exemplary implementation may include the outputting module M4525 configured to direct the operation.

For instance, in some implementations, the exemplary operation O45 may include the operation of O4526 for outputting the indication of the directional orientation for origination of the second sound through an iPod-like device. An exemplary implementation may include the outputting module M4526 configured to direct the operation.

For instance, in some implementations, the exemplary operation O45 may include the operation of O4527 for outputting the indication of the directional orientation for origination of the second sound through a computer. An exemplary implementation may include the outputting module M4527 configured to direct the operation.

For instance, in some implementations, the exemplary operation O45 may include the operation of O4528 for outputting the indication of the directional orientation for origination of the second sound through headphones. An exemplary implementation may include the outputting module M4528 configured to direct the operation.

For instance, in some implementations, the exemplary operation O45 may include the operation of O4529 for outputting the indication of the directional orientation for origination of the second sound through loudspeakers. An exemplary implementation may include the outputting module M4529 configured to direct the operation.

For instance, in some implementations, the exemplary operation O45 may include the operation of O4530 for outputting the indication of the directional orientation for origination of the second sound through a graphics display. An exemplary implementation may include the outputting module M4530 configured to direct the operation.

For instance, in some implementations, the exemplary operation O45 may include the operation of O4531 for outputting via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the outputting module M4531 configured to direct the operation.

An operational flow O50 as shown represents exemplary operations. Some of the figures may have various examples of operational flows. It should be understood that the operational flows may be executed in a number of environments and contexts, including versions and modified versions of the figures and other versions as well. Furthermore, although the various operational flows are presented in the sequence(s) illustrated, it should be understood that the various operations may be performed in other orders than those which are illustrated, or may be performed concurrently.

In figures that follow, various operations may be depicted in a box-within-a-box manner. Such depictions may indicate that an operation in an internal box may comprise an optional exemplary implementation of the operational step illustrated in one or more external boxes. However, it should be understood that internal box operations may be viewed as independent operations separate from any associated external boxes and may be performed in any sequence with respect to all other illustrated operations, or may be performed concurrently.

The operational flow O50 can move to operation O51 where receiving detection of one or more conditions may be executed. An exemplary implementation may include the receiving module M51 configured to direct the operation. For instance, the compute/control 210 of the audio/sound device 200 can receive detection such as through the GPS component 242d of the input/sensing 240 of one or more conditions such as location of the audio/sound device 200 such as at a person's work environment.

The operational flow O50 can move to operation O52 where selecting one or more characteristics as one or more selected characteristics, via at least in part one or more computing devices, based at least in part on receiving the detection of one or more conditions, the one or more selected characteristics to be subject for detection in one or more sounds may be executed. An exemplary implementation may include the selecting module M52 configured to direct the operation. For instance, the compute/control 210 of the audio/sound device 200 can select one or more sound patterns such as that of particular machinery or voices of particular co-workers based at least in part on receiving the detection of GPS location of the audio/sound device 200 being at a person's work environment.

The operational flow O50 can move to operation O53 where receiving detection, via at least in part one or more computing devices, of a first event regarding a first sound involving the one or more selected characteristics to be subject for detection in one or more sounds in a first manner may be executed. An exemplary implementation may include the receiving module M53 configured to direct the operation. For instance, the compute/control 210 of the audio/sound device 200 can receive detection through the acoustic component 242i of the input/sensing 240 that a first event of an appearance of background sound such as factory noise as a first sound is occurring involving such characteristics in a first manner as lacking the selected one or more sound patterns of particular machinery or one or more voice patterns of co-workers.

The operational flow O50 can move to operation O54 where generating, via at least in part one or more computing devices, a first generated audio signal to alter hearing of the first sound by a listener based at least in part on receiving the detection of a first event regarding a first sound involving the one or more selected characteristics in the first manner may be executed. An exemplary implementation may include the generating module M54 configured to direct the operation. For instance, the compute/control 210 of the audio/sound device 200 can generate a first generated audio signal such as an anti-noise signal to cancel out the hearing of the first sound such as the background sound such as the factory noise based upon the detection of the factory noise.

The operational flow O50 can move to operation O55 where receiving detection, via at least in part one or more computing devices, of a first event regarding a second sound involving the one or more selected characteristics in a second manner other than the first manner may be executed. An exemplary implementation may include the receiving module M55 configured to direct the operation. For instance, the compute/control 210 of the audio/sound device 200 can receive detection through the acoustic component 242i of the input/sensing 240 that a first event of an appearance of the selected one or more sound patterns of particular machinery or one or more voice patterns of co-workers as a second sound as occurring involving such characteristics in a second manner as including the selected one or more sound patterns of particular machinery or one or more voice patterns of co-workers.

Illustrations of various implementations of the exemplary operations O51, O52, O53, O54, and O55 are found in the figures.

For instance, in some implementations, the exemplary operation O51 may include the operation of O5101 for receiving detection of inertial reference system data. An exemplary implementation may include the receiving module M5101 configured to direct the operation.

For instance, in some implementations, the exemplary operation O51 may include the operation of O5102 for receiving detection of barometric pressure data. An exemplary implementation may include the receiving module M5102 configured to direct the operation.

For instance, in some implementations, the exemplary operation O51 may include the operation of O5103 for receiving detection of altimeter data. An exemplary implementation may include the receiving module M5103 configured to direct the operation.

For instance, in some implementations, the exemplary operation O51 may include the operation of O5104 for receiving detection of accelerometer data. An exemplary implementation may include the receiving module M5104 configured to direct the operation.

For instance, in some implementations, the exemplary operation O51 may include the operation of O5105 for receiving detection of compass data. An exemplary implementation may include the receiving module M5105 configured to direct the operation.

For instance, in some implementations, the exemplary operation O51 may include the operation of O5106 for receiving detection of mote sensor data. An exemplary implementation may include the receiving module M5106 configured to direct the operation.

For instance, in some implementations, the exemplary operation O51 may include the operation of O5107 for receiving detection of ambient sound data. An exemplary implementation may include the receiving module M5101 configured to direct the operation.

For instance, in some implementations, the exemplary operation O51 may include the operation of O5108 for receiving detection of one or more user commands. An exemplary implementation may include the receiving module M5108 configured to direct the operation.

For instance, in some implementations, the exemplary operation O51 may include the operation of O5109 for receiving detection of instant messaging data. An exemplary implementation may include the receiving module M5109 configured to direct the operation.

For instance, in some implementations, the exemplary operation O51 may include the operation of O5110 for receiving detection of ambient lighting data. An exemplary implementation may include the receiving module M5110 configured to direct the operation.

For instance, in some implementations, the exemplary operation O51 may include the operation of O5111 for receiving detection of cell phone data. An exemplary implementation may include the receiving module M5111 configured to direct the operation.

For instance, in some implementations, the exemplary operation O51 may include the operation of O5112 for receiving detection of Bluetooth data. An exemplary implementation may include the receiving module M5112 configured to direct the operation.

For instance, in some implementations, the exemplary operation O51 may include the operation of O5113 for receiving detection of service set identifier (SSID) data. An exemplary implementation may include the receiving module M5113 configured to direct the operation.

For instance, in some implementations, the exemplary operation O51 may include the operation of O5114 for receiving detection of time zone data. An exemplary implementation may include the receiving module M5114 configured to direct the operation.

For instance, in some implementations, the exemplary operation O51 may include the operation of O5115 for receiving detection of time of day data. An exemplary implementation may include the receiving module M5115 configured to direct the operation.

For instance, in some implementations, the exemplary operation O51 may include the operation of O5116 for receiving detection of calendar data. An exemplary implementation may include the receiving module M5116 configured to direct the operation.

For instance, in some implementations, the exemplary operation O51 may include the operation of O5117 for receiving detection of one or more spoken words. An exemplary implementation may include the receiving module M5117 configured to direct the operation.

For instance, in some implementations, the exemplary operation O51 may include the operation of O5118 for receiving detection of Doppler data. An exemplary implementation may include the receiving module M5118 configured to direct the operation.

For instance, in some implementations, the exemplary operation O51 may include the operation of O5119 for receiving detection of one or more location data. An exemplary implementation may include the receiving module M5119 configured to direct the operation.

For instance, in some implementations, the exemplary operation O51 may include the operation of O5120 for receiving detection of global positioning system data. An exemplary implementation may include the receiving module M5120 configured to direct the operation.

For instance, in some implementations, the exemplary operation O51 may include the operation of O5121 for receiving detection of an activation of a touch control. An exemplary implementation may include the receiving module M5121 configured to direct the operation.

For instance, in some implementations, the exemplary operation O51 may include the operation of O5122 for receiving detection of a presence of a traffic control signal. An exemplary implementation may include the receiving module M5122 configured to direct the operation.

For instance, in some implementations, the exemplary operation O51 may include the operation of O5123 for receiving detection of a presence of one or more radar sensing signals. An exemplary implementation may include the receiving module M5123 configured to direct the operation.

For instance, in some implementations, the exemplary operation O51 may include the operation of O5124 for receiving detection of a presence of one or more laser sensing signals. An exemplary implementation may include the receiving module M5124 configured to direct the operation.

For instance, in some implementations, the exemplary operation O51 may include the operation of O5125 for receiving detection of one or more changes in historically monitored data. An exemplary implementation may include the receiving module M5125 configured to direct the operation.

For instance, in some implementations, the exemplary operation O51 may include the operation of O5126 for receiving the detection of one or more conditions from one or more mote sensors. An exemplary implementation may include the receiving module M5126 configured to direct the operation.

For instance, in some implementations, the exemplary operation O52 may include the operation of O5201 for selecting the one or more characteristics to include a fluctuation in amplitude of one or more sounds. An exemplary implementation may include the selecting module M5201 configured to direct the operation.

For instance, in some implementations, the exemplary operation O52 may include the operation of O5202 for selecting the one or more characteristics to include an increase in amplitude of one or more sounds. An exemplary implementation may include the selecting module M5202 configured to direct the operation.

For instance, in some implementations, the exemplary operation O52 may include the operation of O5203 for selecting the one or more characteristics to include a decrease in amplitude of one or more sounds. An exemplary implementation may include the selecting module M5203 configured to direct the operation.

For instance, in some implementations, the exemplary operation O52 may include the operation of O5204 for selecting the one or more characteristics to include one or more sounds. An exemplary implementation may include the selecting module M5204 configured to direct the operation.

For instance, in some implementations, the exemplary operation O52 may include the operation of O5205 for selecting the one or more characteristics to include one or more repeated sounds. An exemplary implementation may include the selecting module M5205 configured to direct the operation.

For instance, in some implementations, the exemplary operation O52 may include the operation of O5206 for selecting the one or more characteristics to include one or more changes in sound. An exemplary implementation may include the selecting module M5206 configured to direct the operation.

For instance, in some implementations, the exemplary operation O52 may include the operation of O5207 for selecting the one or more characteristics to include one or more vocabulary words. An exemplary implementation may include the selecting module M5207 configured to direct the operation.

For instance, in some implementations, the exemplary operation O52 may include the operation of O5208 for selecting the one or more characteristics to include one or more audio frequencies. An exemplary implementation may include the selecting module M5208 configured to direct the operation.

For instance, in some implementations, the exemplary operation O52 may include the operation of O5209 for selecting the one or more characteristics to include one or more sounds of particular human voices. An exemplary implementation may include the selecting module M5209 configured to direct the operation.

For instance, in some implementations, the exemplary operation O52 may include the operation of O5210 for selecting the one or more characteristics to include one or more sounds of sirens. An exemplary implementation may include the selecting module M5210 configured to direct the operation.

For instance, in some implementations, the exemplary operation O52 may include the operation of O5211 for selecting via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the selecting module M5211 configured to direct the operation.

For instance, in some implementations, the exemplary operation O53 may include the operation of O5301 for receiving the first sound from an ambient environment. An exemplary implementation may include the receiving module M5301 configured to direct the operation.

For instance, in some implementations, the exemplary operation O53 may include the operation of O5302 for receiving the first sound as a monitored sound. An exemplary implementation may include the receiving module M5302 configured to direct the operation.

For instance, in some implementations, the exemplary operation O53 may include the operation of O5303 for receiving the first sound from a coupled audio device. An exemplary implementation may include the receiving module M5303 configured to direct the operation.

For instance, in some implementations, the exemplary operation O53 may include the operation of O5304 for receiving the first sound from one or more speakers. An exemplary implementation may include the receiving module M5304 configured to direct the operation.

For instance, in some implementations, the exemplary operation O53 may include the operation of O5305 for receiving the first sound with one or more microphones. An exemplary implementation may include the receiving module M5305 configured to direct the operation.

For instance, in some implementations, the exemplary operation O53 may include the operation of O5306 for receiving the first sound with one or more electronic connections. An exemplary implementation may include the receiving module M5306 configured to direct the operation.

For instance, in some implementations, the exemplary operation O53 may include the operation of O5307 for receiving the first sound from one or more speakers. An exemplary implementation may include the receiving module M5307 configured to direct the operation.

For instance, in some implementations, the exemplary operation O21 may include the operation of O5307A for receiving detection of the first event regarding the first sound in a first manner that is opposite to the second manner. An exemplary implementation may include the receiving module M5307A configured to direct the operation.

For instance, in some implementations, the exemplary operation O53 may include the operation of O5308 for receiving detection of the first event regarding the first sound as an absence of the one or more characteristics in the first sound. An exemplary implementation may include the receiving module M5308 configured to direct the operation.

For instance, in some implementations, the exemplary operation O53 may include the operation of O5309 for receiving detection of the first event regarding the first sound as a change of the one or more characteristics in the first sound. An exemplary implementation may include the receiving module M5309 configured to direct the operation.

For instance, in some implementations, the exemplary operation O53 may include the operation of O5310 for receiving detection of the first event regarding the first sound as an appearance of the one or more characteristics in the first sound. An exemplary implementation may include the receiving module M5310 configured to direct the operation.

For instance, in some implementations, the exemplary operation O53 may include the operation of O5311 for receiving detection of the first event regarding the first sound involving the one or more characteristics as including one or more repetitive sounds. An exemplary implementation may include the receiving module M5311 configured to direct the operation.

For instance, in some implementations, the exemplary operation O53 may include the operation of O5312 for receiving detection of the first event regarding the first sound involving the one or more characteristics as including one or more sounds from one or more machines. An exemplary implementation may include the receiving module M5312 configured to direct the operation.

For instance, in some implementations, the exemplary operation O53 may include the operation of O5313 for receiving detection of the first event regarding the first sound involving the one or more characteristics as including speech from a human. An exemplary implementation may include the receiving module M5313 configured to direct the operation.

For instance, in some implementations, the exemplary operation O53 may include the operation of O5314 for receiving detection of the first event regarding the first sound involving the one or more characteristics as including sound from a living creature. An exemplary implementation may include the receiving module M5314 configured to direct the operation.

For instance, in some implementations, the exemplary operation O53 may include the operation of O5315 for receiving detection of the first event regarding the first sound involving the one or more characteristics as including sound of an engine abnormality. An exemplary implementation may include the receiving module M5315 configured to direct the operation.

For instance, in some implementations, the exemplary operation O53 may include the operation of O5316 for receiving detection of the first event regarding the first sound involving the one or more characteristics as including sound of an emergency warning. An exemplary implementation may include the receiving module M5316 configured to direct the operation.

For instance, in some implementations, the exemplary operation O53 may include the operation of O5317 for receiving detection of the first event regarding the first sound involving the one or more characteristics as including sound of a weather update. An exemplary implementation may include the receiving module M5317 configured to direct the operation.

For instance, in some implementations, the exemplary operation O53 may include the operation of O5318 for receiving, through an electronic signal, detection of the first event regarding the first sound involving one or more characteristics. An exemplary implementation may include the receiving module M5318 configured to direct the operation.

For instance, in some implementations, the exemplary operation O53 may include the operation of O5319 for receiving, through one or more microphones, detection of the first event regarding the first sound involving one or more characteristics. An exemplary implementation may include the receiving module M5319 configured to direct the operation.

For instance, in some implementations, the exemplary operation O53 may include the operation of O5320 for receiving, through an audio signal from an audio device, detection of the first event regarding the first sound involving one or more characteristics. An exemplary implementation may include the receiving module M5320 configured to direct the operation.

For instance, in some implementations, the exemplary operation O53 may include the operation of O5321 for receiving, through a traffic control signal from an emergency vehicle, detection of the first event regarding the first sound involving one or more characteristics. An exemplary implementation may include the receiving module M5321 configured to direct the operation.

For instance, in some implementations, the exemplary operation O53 may include the operation of O5322 for receiving, through performance of a table lookup to compare one or more portions of the first sound with one or more characteristics of sound in a database, detection of the first event regarding the first sound involving one or more characteristics. An exemplary implementation may include the receiving module M5322 configured to direct the operation.

For instance, in some implementations, the exemplary operation O53 may include the operation of O5323 for receiving, through performance of a spectral analysis of the first sound, detection of the first event regarding the first sound involving one or more characteristics. An exemplary implementation may include the receiving module M5323 configured to direct the operation.

For instance, in some implementations, the exemplary operation O53 may include the operation of O5324 for receiving, through an historical log associated with the first sound, detection of the first event regarding the first sound involving one or more characteristics. An exemplary implementation may include the receiving module M5324 configured to direct the operation.

For instance, in some implementations, the exemplary operation O53 may include the operation of O5325 for receiving, through information from an accelerometer, a barometer, a motion detector or a combination thereof, detection of the first event regarding the first sound involving one or more characteristics. An exemplary implementation may include the receiving module M5325 configured to direct the operation.

For instance, in some implementations, the exemplary operation O53 may include the operation of O5326 for receiving detection via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the receiving module M5326 configured to direct the operation.

For instance, in some implementations, the exemplary operation O54 may include the operation of O5401 for generating the first generated audio signal to be received to mute the first sound heard by the listener. An exemplary implementation may include the generating module M5401 configured to direct the operation.

For instance, in some implementations, the exemplary operation O54 may include the operation of O5402 for generating the first generated audio signal to be received to emit sound opposite in form to the first sound from speakers positioned to cancel amplitude of the first sound heard by the listener. An exemplary implementation may include the generating module M5402 configured to direct the operation.

For instance, in some implementations, the exemplary operation O54 may include the operation of O5403 for generating the first generated audio signal to be received to emit sound from speakers positioned to attenuate amplitude of the first sound heard by the listener. An exemplary implementation may include the generating module M5403 configured to direct the operation.

For instance, in some implementations, the exemplary operation O54 may include the operation of O5404 for generating the first generated audio signal to be received by a cell phone. An exemplary implementation may include the generating module M5404 configured to direct the operation.

For instance, in some implementations, the exemplary operation O54 may include the operation of O5405 for generating the first generated audio signal to be received by an amplifier system. An exemplary implementation may include the generating module M5405 configured to direct the operation.

For instance, in some implementations, the exemplary operation O54 may include the operation of O5406 for generating the first generated audio signal to be received by a two-way radio. An exemplary implementation may include the generating module M5406 configured to direct the operation.

For instance, in some implementations, the exemplary operation O54 may include the operation of O5407 for generating the first generated audio signal to be received by a computer. An exemplary implementation may include the generating module M5407 configured to direct the operation.

For instance, in some implementations, the exemplary operation O54 may include the operation of O5408 for generating the first generated audio signal to control speakers. An exemplary implementation may include the generating module M5408 configured to direct the operation.

For instance, in some implementations, the exemplary operation O54 may include the operation of O5409 for generating the first generated audio signal to modify an audio signal generated from reception of the first sound. An exemplary implementation may include the generating module M5409 configured to direct the operation.

For instance, in some implementations, the exemplary operation O54 may include the operation of O5410 for generating the first generated audio signal through in part a table lookup of a database. An exemplary implementation may include the generating module M5410 configured to direct the operation.

For instance, in some implementations, the exemplary operation O54 may include the operation of O5411 for generating the first generated audio signal through in part a spectral analysis of the first sound. An exemplary implementation may include the generating module M5411 configured to direct the operation.

For instance, in some implementations, the exemplary operation O54 may include the operation of O5412 for generating the first generated audio signal through in part a recognition of the first sound. An exemplary implementation may include the generating module M5412 configured to direct the operation.

For instance, in some implementations, the exemplary operation O54 may include the operation of O5413 for generating via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the generating module M5413 configured to direct the operation.

For instance, in some implementations, the exemplary operation O55 may include the operation of O5501 for receiving the second sound from an ambient environment. An exemplary implementation may include the receiving module M5501 configured to direct the operation.

For instance, in some implementations, the exemplary operation O55 may include the operation of O5502 for receiving the second sound as a monitored sound. An exemplary implementation may include the receiving module M5502 configured to direct the operation.

For instance, in some implementations, the exemplary operation O55 may include the operation of O5503 for receiving the second sound from a coupled audio device. An exemplary implementation may include the receiving module M5503 configured to direct the operation.

For instance, in some implementations, the exemplary operation O55 may include the operation of O5504 for receiving the second sound from one or more speakers. An exemplary implementation may include the receiving module M5504 configured to direct the operation.

For instance, in some implementations, the exemplary operation O55 may include the operation of O5505 for receiving the second sound with one or more microphones. An exemplary implementation may include the receiving module M5505 configured to direct the operation.

For instance, in some implementations, the exemplary operation O55 may include the operation of O5506 for receiving the second sound with one or more electronic connections. An exemplary implementation may include the receiving module M5506 configured to direct the operation.

For instance, in some implementations, the exemplary operation O55 may include the operation of O5507 for receiving the second sound from one or more speakers. An exemplary implementation may include the receiving module M5507 configured to direct the operation.

For instance, in some implementations, the exemplary operation O55 may include the operation of O5508 for receiving detection of the first event regarding the second sound as an absence of the one or more characteristics in the second sound. An exemplary implementation may include the receiving module M5508 configured to direct the operation.

For instance, in some implementations, the exemplary operation O55 may include the operation of O5509 for receiving detection of the first event regarding the second sound as a change of the one or more characteristics in the second sound. An exemplary implementation may include the receiving module M5509 configured to direct the operation.

For instance, in some implementations, the exemplary operation O55 may include the operation of O5510 for receiving detection of the first event regarding the second sound as an appearance of the one or more characteristics in the second sound. An exemplary implementation may include the receiving module M5510 configured to direct the operation.

For instance, in some implementations, the exemplary operation O55 may include the operation of O5511 for receiving detection of the first event regarding the second sound involving the one or more characteristics as including one or more repetitive sounds. An exemplary implementation may include the receiving module M5511 configured to direct the operation.

For instance, in some implementations, the exemplary operation O55 may include the operation of O5512 for receiving detection of the first event regarding the second sound involving the one or more characteristics as including one or more sounds from one or more machines. An exemplary implementation may include the receiving module M5512 configured to direct the operation.

For instance, in some implementations, the exemplary operation O55 may include the operation of O5513 for receiving detection of the first event regarding the second sound involving the one or more characteristics as including speech from a human. An exemplary implementation may include the receiving module M5513 configured to direct the operation.

For instance, in some implementations, the exemplary operation O55 may include the operation of O5514 for receiving detection of the first event regarding the second sound involving the one or more characteristics as including sound from a living creature. An exemplary implementation may include the receiving module M5514 configured to direct the operation.

For instance, in some implementations, the exemplary operation O55 may include the operation of O5515 for receiving detection of the first event regarding the second sound involving the one or more characteristics as including sound of an engine abnormality. An exemplary implementation may include the receiving module M5515 configured to direct the operation.

For instance, in some implementations, the exemplary operation O55 may include the operation of O5516 for receiving detection of the first event regarding the second sound involving the one or more characteristics as including sound of an emergency warning. An exemplary implementation may include the receiving module M5516 configured to direct the operation.

For instance, in some implementations, the exemplary operation O55 may include the operation of O5517 for receiving detection of the first event regarding the second sound involving the one or more characteristics as including sound of a weather update. An exemplary implementation may include the receiving module M5517 configured to direct the operation.

For instance, in some implementations, the exemplary operation O55 may include the operation of O5518 for receiving, through an electronic signal, detection of the first event regarding the second sound involving one or more characteristics. An exemplary implementation may include the receiving module M5518 configured to direct the operation.

For instance, in some implementations, the exemplary operation O55 may include the operation of O5519 for receiving, through one or more microphones, detection of the first event regarding the second sound involving one or more characteristics. An exemplary implementation may include the receiving module M5519 configured to direct the operation.

For instance, in some implementations, the exemplary operation O55 may include the operation of O5520 for receiving, through an audio signal from an audio device, detection of the first event regarding the second sound involving one or more characteristics. An exemplary implementation may include the receiving module M5520 configured to direct the operation.

For instance, in some implementations, the exemplary operation O55 may include the operation of O5521 for receiving, through a traffic control signal from an emergency vehicle, detection of the first event regarding the second sound involving one or more characteristics. An exemplary implementation may include the receiving module M5521 configured to direct the operation.

For instance, in some implementations, the exemplary operation O55 may include the operation of O5522 for receiving, through performance of a table lookup to compare one or more portions of the second sound with one or more characteristics of sound in a database, detection of the first event regarding the second sound involving one or more characteristics. An exemplary implementation may include the receiving module M5522 configured to direct the operation.

For instance, in some implementations, the exemplary operation O55 may include the operation of O5523 for receiving, through performance of a spectral analysis of the second sound, detection of the first event regarding the second sound involving one or more characteristics. An exemplary implementation may include the receiving module M5523 configured to direct the operation.

For instance, in some implementations, the exemplary operation O55 may include the operation of O5524 for receiving, through an historical log associated with the second sound, detection of the first event regarding the second sound involving one or more characteristics. An exemplary implementation may include the receiving module M5524 configured to direct the operation.

For instance, in some implementations, the exemplary operation O55 may include the operation of O5525 for receiving, through information from an accelerometer, a barometer, a motion detector or a combination thereof, detection of the first event regarding the second sound involving one or more characteristics. An exemplary implementation may include the receiving module M5525 configured to direct the operation.

For instance, in some implementations, the exemplary operation O55 may include the operation of O5526 for receiving detection via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the receiving module M5526 configured to direct the operation.

An operational flow O60 as shown represents exemplary operations. Some of the figures may have various examples of operational flows. It should be understood that the operational flows may be executed in a number of environments and contexts, including versions and modified versions of the figures and other versions as well. Furthermore, although the various operational flows are presented in the sequence(s) illustrated, it should be understood that the various operations may be performed in other orders than those which are illustrated, or may be performed concurrently.

In figures that follow, various operations may be depicted in a box-within-a-box manner. Such depictions may indicate that an operation in an internal box may comprise an optional exemplary implementation of the operational step illustrated in one or more external boxes. However, it should be understood that internal box operations may be viewed as independent operations separate from any associated external boxes and may be performed in any sequence with respect to all other illustrated operations, or may be performed concurrently.

The operational flow O60 can move to operation O61 where receiving detection, via at least in part one or more computing devices, of a first event regarding a first sound involving one or more characteristics in a first manner may be executed. An exemplary implementation may include the receiving module M61 configured to direct the operation. For instance, the compute/control 210 of the audio/sound device 200 can receive detection through the acoustic component 242i of the input/sensing 240 that a first event of an appearance of background sound such as cockpit noise as a first sound is occurring involving such characteristics such as jet engine noise in a first manner to include the jet engine noise.

The operational flow O60 can move to operation O62 where generating, via at least in part one or more computing devices, a first generated audio signal to alter hearing of the first sound by a listener based at least in part on receiving the detection of a first event regarding a first sound involving one or more characteristics in a first manner may be executed. An exemplary implementation may include the generating module M62 configured to direct the operation. For instance, the compute/control 210 of the audio/sound device 200 can generate a first generated audio signal such as an anti-noise signal to cancel out the hearing of the first sound such as the jet engine noise based upon the detection of the jet engine noise.

The operational flow O60 can move to operation O63 where receiving detection of one or more conditions may be executed. An exemplary implementation may include the receiving module M63 configured to direct the operation. For instance, the compute/control 210 of the audio/sound device 200 can receive detection through the accelerometer 244j of the input/sensing 240 a change in acceleration due to a decent of a airplane housing the audio/sound device 200 has occurred.

The operational flow O60 can move to operation O64 where outputting an indication based upon detection of the one or more conditions may be executed. For instance, the compute/control 210 of the audio/sound device 200 can generate through the vibration out component 230e a vibrational indication that the plane has change acceleration status thereby indicating start of a decent.

Illustrations of various implementations of the exemplary operations O61, O62, O63, and O64 are found in the figures.

For instance, in some implementations, the exemplary operation O61 may include the operation of O6101 for receiving the first sound from an ambient environment. An exemplary implementation may include the receiving module M6101 configured to direct the operation.

For instance, in some implementations, the exemplary operation O61 may include the operation of O6102 for receiving the first sound as a monitored sound. An exemplary implementation may include the receiving module M6102 configured to direct the operation.

For instance, in some implementations, the exemplary operation O61 may include the operation of O6103 for receiving the first sound from a coupled audio device. An exemplary implementation may include the receiving module M6103 configured to direct the operation.

For instance, in some implementations, the exemplary operation O61 may include the operation of O6104 for receiving the first sound from one or more speakers. An exemplary implementation may include the receiving module M6104 configured to direct the operation.

For instance, in some implementations, the exemplary operation O61 may include the operation of O6105 for receiving the first sound with one or more microphones. An exemplary implementation may include the receiving module M6105 configured to direct the operation.

For instance, in some implementations, the exemplary operation O61 may include the operation of O6106 for receiving the first sound with one or more electronic connections. An exemplary implementation may include the receiving module M6106 configured to direct the operation.

For instance, in some implementations, the exemplary operation O61 may include the operation of O6107 for receiving the first sound from one or more speakers. An exemplary implementation may include the receiving module M6107 configured to direct the operation.

For instance, in some implementations, the exemplary operation O21 may include the operation of O6107A for receiving detection of the first event regarding the first sound in a first manner that is opposite to the second manner. An exemplary implementation may include the receiving module M6107A configured to direct the operation.

For instance, in some implementations, the exemplary operation O61 may include the operation of O6108 for receiving detection of the first event regarding the first sound as an absence of the one or more characteristics in the first sound. An exemplary implementation may include the receiving module M6108 configured to direct the operation.

For instance, in some implementations, the exemplary operation O61 may include the operation of O6109 for receiving detection of the first event regarding the first sound as a change of the one or more characteristics in the first sound. An exemplary implementation may include the receiving module M6109 configured to direct the operation.

For instance, in some implementations, the exemplary operation O61 may include the operation of O6110 for receiving detection of the first event regarding the first sound as an appearance of the one or more characteristics in the first sound. An exemplary implementation may include the receiving module M6110 configured to direct the operation.

For instance, in some implementations, the exemplary operation O61 may include the operation of O6111 for receiving detection of the first event regarding the first sound involving the one or more characteristics as including one or more repetitive sounds. An exemplary implementation may include the receiving module M6111 configured to direct the operation.

For instance, in some implementations, the exemplary operation O61 may include the operation of O6112 for receiving detection of the first event regarding the first sound involving the one or more characteristics as including one or more sounds from one or more machines. An exemplary implementation may include the receiving module M6112 configured to direct the operation.

For instance, in some implementations, the exemplary operation O61 may include the operation of O6113 for receiving detection of the first event regarding the first sound involving the one or more characteristics as including speech from a human. An exemplary implementation may include the receiving module M6113 configured to direct the operation.

For instance, in some implementations, the exemplary operation O61 may include the operation of O6114 for receiving detection of the first event regarding the first sound involving the one or more characteristics as including sound from a living creature. An exemplary implementation may include the receiving module M6114 configured to direct the operation.

For instance, in some implementations, the exemplary operation O61 may include the operation of O6115 for receiving detection of the first event regarding the first sound involving the one or more characteristics as including sound of an engine abnormality. An exemplary implementation may include the receiving module M6115 configured to direct the operation.

For instance, in some implementations, the exemplary operation O61 may include the operation of O6116 for receiving detection of the first event regarding the first sound involving the one or more characteristics as including sound of an emergency warning. An exemplary implementation may include the receiving module M6116 configured to direct the operation.

For instance, in some implementations, the exemplary operation O61 may include the operation of O6117 for receiving detection of the first event regarding the first sound involving the one or more characteristics as including sound of a weather update. An exemplary implementation may include the receiving module M6117 configured to direct the operation.

For instance, in some implementations, the exemplary operation O61 may include the operation of O6118 for receiving, through an electronic signal, detection of the first event regarding the first sound involving one or more characteristics. An exemplary implementation may include the receiving module M6118 configured to direct the operation.

For instance, in some implementations, the exemplary operation O61 may include the operation of O6119 for receiving, through one or more microphones, detection of the first event regarding the first sound involving one or more characteristics. An exemplary implementation may include the receiving module M6119 configured to direct the operation.

For instance, in some implementations, the exemplary operation O61 may include the operation of O6120 for receiving, through an audio signal from an audio device, detection of the first event regarding the first sound involving one or more characteristics. An exemplary implementation may include the receiving module M6120 configured to direct the operation.

For instance, in some implementations, the exemplary operation O61 may include the operation of O6121 for receiving, through a traffic control signal from an emergency vehicle, detection of the first event regarding the first sound involving one or more characteristics. An exemplary implementation may include the receiving module M6121 configured to direct the operation.

For instance, in some implementations, the exemplary operation O61 may include the operation of O6122 for receiving, through performance of a table lookup to compare one or more portions of the first sound with one or more characteristics of sound in a database, detection of the first event regarding the first sound involving one or more characteristics. An exemplary implementation may include the receiving module M6122 configured to direct the operation.

For instance, in some implementations, the exemplary operation O61 may include the operation of O6123 for receiving, through performance of a spectral analysis of the first sound, detection of the first event regarding the first sound involving one or more characteristics. An exemplary implementation may include the receiving module M6123 configured to direct the operation.

For instance, in some implementations, the exemplary operation O61 may include the operation of O6124 for receiving, through an historical log associated with the first sound, detection of the first event regarding the first sound involving one or more characteristics. An exemplary implementation may include the receiving module M6124 configured to direct the operation.

For instance, in some implementations, the exemplary operation O61 may include the operation of O6125 for receiving, through information from an accelerometer, a barometer, a motion detector or a combination thereof, detection of the first event regarding the first sound involving one or more characteristics. An exemplary implementation may include the receiving module M6125 configured to direct the operation.

For instance, in some implementations, the exemplary operation O61 may include the operation of O6126 for receiving detection via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the receiving module M6126 configured to direct the operation.

For instance, in some implementations, the exemplary operation O62 may include the operation of O6201 for generating the first generated audio signal to be received to mute the first sound heard by the listener. An exemplary implementation may include the generating module M6201 configured to direct the operation.

For instance, in some implementations, the exemplary operation O62 may include the operation of O6202 for generating the first generated audio signal to be received to emit sound opposite in form to the first sound from speakers positioned to cancel amplitude of the first sound heard by the listener. An exemplary implementation may include the generating module M6202 configured to direct the operation.

For instance, in some implementations, the exemplary operation O62 may include the operation of O6203 for generating the first generated audio signal to be received to emit sound from speakers positioned to attenuate amplitude of the first sound heard by the listener. An exemplary implementation may include the generating module M6203 configured to direct the operation.

For instance, in some implementations, the exemplary operation O62 may include the operation of O6204 for generating the first generated audio signal to be received by a cell phone. An exemplary implementation may include the generating module M6204 configured to direct the operation.

For instance, in some implementations, the exemplary operation O62 may include the operation of O6205 for generating the first generated audio signal to be received by an amplifier system. An exemplary implementation may include the generating module M6205 configured to direct the operation.

For instance, in some implementations, the exemplary operation O62 may include the operation of O6206 for generating the first generated audio signal to be received by a two-way radio. An exemplary implementation may include the generating module M6206 configured to direct the operation.

For instance, in some implementations, the exemplary operation O62 may include the operation of O6207 for generating the first generated audio signal to be received by a computer. An exemplary implementation may include the generating module M6207 configured to direct the operation.

For instance, in some implementations, the exemplary operation O62 may include the operation of O6208 for generating the first generated audio signal to control speakers. An exemplary implementation may include the generating module M6208 configured to direct the operation.

For instance, in some implementations, the exemplary operation O62 may include the operation of O6209 for generating the first generated audio signal to modify an audio signal generated from reception of the first sound. An exemplary implementation may include the generating module M6209 configured to direct the operation.

For instance, in some implementations, the exemplary operation O62 may include the operation of O6210 for generating the first generated audio signal through in part a table lookup of a database. An exemplary implementation may include the generating module M6210 configured to direct the operation.

For instance, in some implementations, the exemplary operation O62 may include the operation of O6211 for generating the first generated audio signal through in part a spectral analysis of the first sound. An exemplary implementation may include the generating module M6211 configured to direct the operation.

For instance, in some implementations, the exemplary operation O62 may include the operation of O6212 for generating the first generated audio signal through in part a recognition of the first sound. An exemplary implementation may include the generating module M6212 configured to direct the operation.

For instance, in some implementations, the exemplary operation O62 may include the operation of O6213 for generating via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the generating module M6213 configured to direct the operation.

For instance, in some implementations, the exemplary operation O63 may include the operation of O6301 for receiving detection of inertial reference system data. An exemplary implementation may include the receiving module M6301 configured to direct the operation.

For instance, in some implementations, the exemplary operation O63 may include the operation of O6302 for receiving detection of barometric pressure data. An exemplary implementation may include the receiving module M6302 configured to direct the operation.

For instance, in some implementations, the exemplary operation O63 may include the operation of O6303 for receiving detection of altimeter data. An exemplary implementation may include the receiving module M6303 configured to direct the operation.

For instance, in some implementations, the exemplary operation O63 may include the operation of O6304 for receiving detection of accelerometer data. An exemplary implementation may include the receiving module M6304 configured to direct the operation.

For instance, in some implementations, the exemplary operation O63 may include the operation of O6305 for receiving detection of compass data. An exemplary implementation may include the receiving module M6305 configured to direct the operation.

For instance, in some implementations, the exemplary operation O63 may include the operation of O6306 for receiving detection of mote sensor data. An exemplary implementation may include the receiving module M6306 configured to direct the operation.

For instance, in some implementations, the exemplary operation O63 may include the operation of O6307 for receiving detection of ambient sound data. An exemplary implementation may include the receiving module M6307 configured to direct the operation.

For instance, in some implementations, the exemplary operation O63 may include the operation of O6308 for receiving detection of one or more user commands. An exemplary implementation may include the receiving module M6308 configured to direct the operation.

For instance, in some implementations, the exemplary operation O63 may include the operation of O6309 for receiving detection of instant messaging data. An exemplary implementation may include the receiving module M6309 configured to direct the operation.

For instance, in some implementations, the exemplary operation O63 may include the operation of O6310 for receiving detection of ambient lighting data. An exemplary implementation may include the receiving module M6310 configured to direct the operation.

For instance, in some implementations, the exemplary operation O63 may include the operation of O6311 for receiving detection of cell phone data. An exemplary implementation may include the receiving module M6311 configured to direct the operation.

For instance, in some implementations, the exemplary operation O63 may include the operation of O6312 for receiving detection of Bluetooth data. An exemplary implementation may include the receiving module M6312 configured to direct the operation.

For instance, in some implementations, the exemplary operation O63 may include the operation of O6313 for receiving detection of service set identifier (SSID) data. An exemplary implementation may include the receiving module M6313 configured to direct the operation.

For instance, in some implementations, the exemplary operation O63 may include the operation of O6314 for receiving detection of time zone data. An exemplary implementation may include the receiving module M6314 configured to direct the operation.

For instance, in some implementations, the exemplary operation O63 may include the operation of O6315 for receiving detection of time of day data. An exemplary implementation may include the receiving module M6315 configured to direct the operation.

For instance, in some implementations, the exemplary operation O63 may include the operation of O6316 for receiving detection of calendar data. An exemplary implementation may include the receiving module M6316 configured to direct the operation.

For instance, in some implementations, the exemplary operation O63 may include the operation of O6317 for receiving detection of one or more spoken words. An exemplary implementation may include the receiving module M6317 configured to direct the operation.

For instance, in some implementations, the exemplary operation O63 may include the operation of O6318 for receiving detection of Doppler data. An exemplary implementation may include the receiving module M6318 configured to direct the operation.

For instance, in some implementations, the exemplary operation O63 may include the operation of O6319 for receiving detection of one or more location data. An exemplary implementation may include the receiving module M6319 configured to direct the operation.

For instance, in some implementations, the exemplary operation O63 may include the operation of O6320 for receiving detection of global positioning system data. An exemplary implementation may include the receiving module M6320 configured to direct the operation.

For instance, in some implementations, the exemplary operation O63 may include the operation of O6321 for receiving detection of an activation of a touch control. An exemplary implementation may include the receiving module M6321 configured to direct the operation.

For instance, in some implementations, the exemplary operation O63 may include the operation of O6322 for receiving detection of a presence of a traffic control signal. An exemplary implementation may include the receiving module M6322 configured to direct the operation.

For instance, in some implementations, the exemplary operation O63 may include the operation of O6323 for receiving detection of a presence of one or more radar sensing signals. An exemplary implementation may include the receiving module M6323 configured to direct the operation.

For instance, in some implementations, the exemplary operation O63 may include the operation of O6324 for receiving detection of a presence of one or more laser sensing signals. An exemplary implementation may include the receiving module M6324 configured to direct the operation.

For instance, in some implementations, the exemplary operation O63 may include the operation of O6325 for receiving detection of a change in historically monitored data. An exemplary implementation may include the receiving module M6325 configured to direct the operation.

For instance, in some implementations, the exemplary operation O64 may include the operation of O6401 for outputting the indication to notify of an appearance of the one or more conditions. An exemplary implementation may include the outputting module M6401 configured to direct the operation.

For instance, in some implementations, the exemplary operation O64 may include the operation of O6402 for outputting the indication to notify of an absence of the one or more conditions. An exemplary implementation may include the outputting module M6402 configured to direct the operation.

For instance, in some implementations, the exemplary operation O64 may include the operation of O6403 for outputting the indication to notify of a change of the one or more conditions. An exemplary implementation may include the outputting module M6403 configured to direct the operation.

For instance, in some implementations, the exemplary operation O64 may include the operation of O6404 for outputting the indication to notify of the existence of the one or more characteristics of the second sound. An exemplary implementation may include the outputting module M6404 configured to direct the operation.

For instance, in some implementations, the exemplary operation O64 may include the operation of O6405 for outputting the indication to be received by a cell phone. An exemplary implementation may include the outputting module M6405 configured to direct the operation.

For instance, in some implementations, the exemplary operation O64 may include the operation of O6406 for outputting the indication to be received by an amplifier system. An exemplary implementation may include the outputting module M6406 configured to direct the operation.

For instance; in some implementations, the exemplary operation O64 may include the operation of O6407 for outputting the indication to be received by a two-way radio. An exemplary implementation may include the outputting module M6407 configured to direct the operation.

For instance, in some implementations, the exemplary operation O64 may include the operation of O6408 for outputting the indication to be received by a computer. An exemplary implementation may include the outputting module M6408 configured to direct the operation.

For instance, in some implementations, the exemplary operation O64 may include the operation of O6409 for outputting the indication to control speakers. An exemplary implementation may include the outputting module M6409 configured to direct the operation.

For instance, in some implementations, the exemplary operation O64 may include the operation of O6410 for outputting the indication through in part a table lookup of a database. An exemplary implementation may include the outputting module M6410 configured to direct the operation.

For instance, in some implementations, the exemplary operation O64 may include the operation of O6411 for outputting the indication through in part a spectral analysis of the second sound. An exemplary implementation may include the outputting module M6411 configured to direct the operation.

For instance, in some implementations, the exemplary operation O64 may include the operation of O6412 for outputting the indication through in part a recognition of the second sound. An exemplary implementation may include the outputting module M6412 configured to direct the operation.

For instance, in some implementations, the exemplary operation O64 may include the operation of O6413 for outputting the indication on a visual display. An exemplary implementation may include the outputting module M6413 configured to direct the operation.

For instance, in some implementations, the exemplary operation O64 may include the operation of O6414 for outputting the indication as a textual display. An exemplary implementation may include the outputting module M6414 configured to direct the operation.

For instance, in some implementations, the exemplary operation O64 may include the operation of O6415 for outputting the indication in audio form. An exemplary implementation may include the outputting module M6415 configured to direct the operation.

For instance, in some implementations, the exemplary operation O64 may include the operation of O6416 for outputting the indication as synthesized speech. An exemplary implementation may include the outputting module M6416 configured to direct the operation.

For instance, in some implementations, the exemplary operation O64 may include the operation of O6417 for outputting the indication as an electromechanical vibration. An exemplary implementation may include the outputting module M6417 configured to direct the operation.

For instance, in some implementations, the exemplary operation O64 may include the operation of O6418 for outputting the indication though an interface incorporated into a steering wheel of a vehicle. An exemplary implementation may include the outputting module M6418 configured to direct the operation.

For instance, in some implementations, the exemplary operation O64 may include the operation of O6419 for outputting the indication as a projection. An exemplary implementation may include the outputting module M6419 configured to direct the operation.

For instance, in some implementations, the exemplary operation O64 may include the operation of O6420 for outputting the indication as a heads-up display. An exemplary implementation may include the outputting module M6420 configured to direct the operation.

For instance, in some implementations, the exemplary operation O64 may include the operation of O6421 for outputting the indication on a portion of a windshield. An exemplary implementation may include the outputting module M6421 configured to direct the operation.

For instance, in some implementations, the exemplary operation O64 may include the operation of O6422 for outputting the indication on a portion of a vehicle. An exemplary implementation may include the outputting module M6422 configured to direct the operation.

For instance, in some implementations, the exemplary operation O64 may include the operation of O6423 for outputting the indication through ear-buds. An exemplary implementation may include the outputting module M6423 configured to direct the operation.

For instance, in some implementations, the exemplary operation O64 may include the operation of O6424 for outputting the indication through a radio system. An exemplary implementation may include the outputting module M6424 configured to direct the operation.

For instance, in some implementations, the exemplary operation O64 may include the operation of O6425 for outputting the indication through a personal data assistant. An exemplary implementation may include the outputting module M6425 configured to direct the operation.

For instance, in some implementations, the exemplary operation O64 may include the operation of O6426 for outputting the indication through an iPod-like device. An exemplary implementation may include the outputting module M6426 configured to direct the operation.

For instance, in some implementations, the exemplary operation O64 may include the operation of O6427 for outputting the indication through a computer. An exemplary implementation may include the outputting module M6427 configured to direct the operation.

For instance, in some implementations, the exemplary operation O64 may include the operation of O6428 for outputting the indication through headphones. An exemplary implementation may include the outputting module M6428 configured to direct the operation.

For instance, in some implementations, the exemplary operation O64 may include the operation of O6429 for outputting the indication through loudspeakers. An exemplary implementation may include the outputting module M6429 configured to direct the operation.

For instance, in some implementations, the exemplary operation O64 may include the operation of O6430 for outputting the indication through a graphics display. An exemplary implementation may include the outputting module M6430 configured to direct the operation.

An operational flow O70 as shown represents exemplary operations. Some of the figures may have various examples of operational flows. It should be understood that the operational flows may be executed in a number of environments and contexts, including versions and modified versions of the figures and other versions as well. Furthermore, although the various operational flows are presented in the sequence(s) illustrated, it should be understood that the various operations may be performed in other orders than those which are illustrated, or may be performed concurrently.

In figures that follow, various operations may be depicted in a box-within-a-box manner. Such depictions may indicate that an operation in an internal box may comprise an optional exemplary implementation of the operational step illustrated in one or more external boxes. However, it should be understood that internal box operations may be viewed as independent operations separate from any associated external boxes and may be performed in any sequence with respect to all other illustrated operations, or may be performed concurrently.

The operational flow O70 can move to operation O71 where receiving detection, via at least in part one or more computing devices, of a first event regarding a first sound as originating from a directional orientation other than a selected directional orientation may be executed. An exemplary implementation may include the receiving module M71 configured to direct the operation. For instance, the compute/control 210 of the audio/sound device 200 can receive detection through the triangulation component 242t of the input/sensing 240 that a first event such as an appearance of a first sound such as a car alarm of a first car as originating from a directional orientation other than a selected directional orientation such as a northeast orientation that is other than a selected southwest orientation from the audio/sound device 200.

The operational flow O70 can move to operation O72 where generating, via at least in part one or more computing devices, a first generated audio signal to alter in a first manner hearing of the first sound by a listener based at least in part on receiving the detection of a first event regarding a first sound as originating from a directional orientation other than the selected directional orientation may be executed. An exemplary implementation may include the generating module M72 configured to direct the operation. For instance, the compute/control 210 of the audio/sound device 200 can generate a first generated audio signal such as an anti-noise signal to cancel out the hearing of the first sound such as the car alarm of the first car located in a northeast orientation that is other than the selected southwest orientation from the audio/sound device 200.

The operational flow O70 can move to operation O73 where receiving detection, via at least in part one or more computing devices, of a first event regarding a second sound involving one or more characteristics and as originating from the selected directional orientation may be executed. An exemplary implementation may include the receiving module M73 configured to direct the operation. For instance, the compute/control 210 of the audio/sound device 200 can receive detection through the triangulation component 242t of the input/sensing 240 that a first event such as an appearance of a second sound such as a car alarm of a second car as originating from a directional orientation that is the selected southwest orientation from the audio/sound device 200.

The operational flow O70 can move to operation O74 where if generating, via at least in part one or more computing devices, a second generated audio signal to alter hearing of the second sound by a listener, then generating the second generated audio signal to alter in a manner other than the first manner hearing of the second sound based at least in part on receiving the detection of a first event regarding the second sound as originating from the selected directional orientation may be executed. An exemplary implementation may include the generating module M74 configured to direct the operation. For instance, the compute/control 210 of the audio/sound device 200 can generate a second generated audio signal such as an amplified signal to amplify the hearing of the second sound such as the car alarm of the second car located in the selected southwest orientation from the audio/sound device 200.

Illustrations of various implementations of the exemplary operations O71, O72, O73, and O74 are found in the figures.

For instance, in some implementations, the exemplary operation O71 may include the operation of O7101 for receiving the first sound from an ambient environment. An exemplary implementation may include the receiving module M7101 configured to direct the operation.

For instance, in some implementations, the exemplary operation O71 may include the operation of O7102 for receiving the first sound as a monitored sound. An exemplary implementation may include the receiving module M7102 configured to direct the operation.

For instance, in some implementations, the exemplary operation O71 may include the operation of 0:7103 for receiving the first sound from a coupled audio device. An exemplary implementation may include the receiving module M7103 configured to direct the operation.

For instance, in some implementations, the exemplary operation O71 may include the operation of O7104 for receiving the first sound from one or more speakers. An exemplary implementation may include the receiving module M7104 configured to direct the operation.

For instance, in some implementations, the exemplary operation O71 may include the operation of O7105 for receiving the first sound with one or more microphones. An exemplary implementation may include the receiving module M7105 configured to direct the operation.

For instance, in some implementations, the exemplary operation O71 may include the operation of O7106 for receiving the first sound with one or more electronic connections. An exemplary implementation may include the receiving module M7106 configured to direct the operation.

For instance, in some implementations, the exemplary operation O71 may include the operation of O7107 for receiving the first sound from one or more speakers. An exemplary implementation may include the receiving module M7107 configured to direct the operation.

For instance, in some implementations, the exemplary operation O71 may include the operation of O7108 for receiving detection of the first event regarding the first sound as a disappearance of the first sound. An exemplary implementation may include the receiving module M7108 configured to direct the operation.

For instance, in some implementations, the exemplary operation O71 may include the operation of O7109 for receiving detection of the first event regarding the first sound as a change in the first sound. An exemplary implementation may include the receiving module M7109 configured to direct the operation.

For instance, in some implementations, the exemplary operation O71 may include the operation of O7110 for receiving detection of the first event regarding the first sound as an appearance of the first sound. An exemplary implementation may include the receiving module M7110 configured to direct the operation.

For instance, in some implementations, the exemplary operation O71 may include the operation of O7111 for receiving detection of the first event regarding the first sound as including one or more repetitive sounds. An exemplary implementation may include the receiving module M7111 configured to direct the operation.

For instance, in some implementations, the exemplary operation O71 may include the operation of O7112 for receiving detection of the first event regarding the first sound as including sounds from one or more machines. An exemplary implementation may include the receiving module M7112 configured to direct the operation.

For instance, in some implementations, the exemplary operation O71 may include the operation of O7113 for receiving detection of the first event regarding the first sound as including speech from a human. An exemplary implementation may include the receiving module M7113 configured to direct the operation.

For instance, in some implementations, the exemplary operation O71 may include the operation of O7114 for receiving detection of the first event regarding the first sound as including sound from a living creature. An exemplary implementation may include the receiving module M7114 configured to direct the operation.

For instance, in some implementations, the exemplary operation O71 may include the operation of O7115 for receiving detection of the first event regarding the first sound as including sound of an engine abnormality. An exemplary implementation may include the receiving module M7115 configured to direct the operation.

For instance, in some implementations, the exemplary operation O71 may include the operation of O7116 for receiving detection of the first event regarding the first sound as including sound of an emergency warning. An exemplary implementation may include the receiving module M7116 configured to direct the operation.

For instance, in some implementations, the exemplary operation O71 may include the operation of O7117 for receiving detection of the first event regarding the first sound as including sound of a weather update. An exemplary implementation may include the receiving module M7117 configured to direct the operation.

For instance, in some implementations, the exemplary operation O71 may include the operation of O7118 for receiving, through an electronic signal, detection of the first event regarding the first sound. An exemplary implementation may include the receiving module M7118 configured to direct the operation.

For instance, in some implementations, the exemplary operation O71 may include the operation of O7119 for receiving, through one or more microphones, detection of the first event regarding the first sound. An exemplary implementation may include the receiving module M7119 configured to direct the operation.

For instance, in some implementations, the exemplary operation O71 may include the operation of O7120 for receiving, through an audio signal from an audio device, detection of the first event regarding the first sound. An exemplary implementation may include the receiving module M7120 configured to direct the operation.

For instance, in some implementations, the exemplary operation O71 may include the operation of O7121 for receiving, through a traffic control signal from an emergency vehicle, detection of the first event regarding the first sound. An exemplary implementation may include the receiving module M7121 configured to direct the operation.

For instance, in some implementations, the exemplary operation O71 may include the operation of O7122 for receiving, through performance of a table lookup to compare one or more portions of the first sound with one or more characteristics of sound in a database, detection of the first event regarding the first sound. An exemplary implementation may include the receiving module M7122 configured to direct the operation.

For instance, in some implementations, the exemplary operation O71 may include the operation of O7123 for receiving, through performance of a spectral analysis of the first sound, detection of the first event regarding the first sound. An exemplary implementation may include the receiving module M7123 configured to direct the operation.

For instance, in some implementations, the exemplary operation O71 may include the operation of O7124 for receiving, through an historical log associated with the first sound, detection of the first event regarding the first sound. An exemplary implementation may include the receiving module M7124 configured to direct the operation.

For instance, in some implementations, the exemplary operation O71 may include the operation of O7125 for O receiving, through information from an accelerometer, a barometer, a motion detector or a combination thereof, detection of the first event regarding the first sound. An exemplary implementation may include the receiving module M7125 configured to direct the operation.

For instance, in some implementations, the exemplary operation O71 may include the operation of O7126 for receiving detection of the first event regarding the first sound as originating from a directional orientation other than the selected directional orientation using an estimation of one or more differences in time in which the first sound was received between two or more microphones. An exemplary implementation may include the receiving module M7126 configured to direct the operation.

For instance, in some implementations, the exemplary operation O71 may include the operation of O7127 for receiving detection of the first event regarding the first sound as originating from a directional orientation other than the selected directional orientation expressed in terms of speed of an object emitting the first sound relative to a listener. An exemplary implementation may include the receiving module M7127 configured to direct the operation.

For instance, in some implementations, the exemplary operation O71 may include the operation of O7128 for receiving detection of the first event regarding the first sound as originating from a directional orientation other than the selected directional orientation expressed in terms of absolute speed an object emitting the first sound. An exemplary implementation may include the receiving module M7128 configured to direct the operation.

For instance, in some implementations, the exemplary operation O71 may include the operation of O7129 for receiving detection of the first event regarding the first sound as originating from a directional orientation other than the selected directional orientation expressed in terms of velocity of an object emitting the first sound relative to a listener. An exemplary implementation may include the receiving module M7129 configured to direct the operation.

For instance, in some implementations, the exemplary operation O71 may include the operation of O7130 for receiving detection of the first event regarding the first sound as originating from a directional orientation other than the selected directional orientation expressed in terms of absolute velocity of an object emitting the first sound. An exemplary implementation may include the receiving module M7130 configured to direct the operation.

For instance, in some implementations, the exemplary operation O71 may include the operation of O7131 for receiving detection of the first event regarding the first sound as originating from a directional orientation other than the selected directional orientation expressed in terms of distance of an object emitting the first sound from a listener. An exemplary implementation may include the receiving module M7131 configured to direct the operation.

For instance, in some implementations, the exemplary operation O71 may include the operation of O7132 for receiving detection of the first event regarding the first sound as originating from a directional orientation other than the selected directional orientation expressed in terms of azimuth of an object emitting the first sound relative to a listener. An exemplary implementation may include the receiving module M7132 configured to direct the operation.

For instance, in some implementations, the exemplary operation O71 may include the operation of O7133 for receiving detection of the first event regarding the first sound as originating from a directional orientation other than the selected directional orientation expressed in terms of absolute elevation of an object emitting the first sound. An exemplary implementation may include the receiving module M7133 configured to direct the operation.

For instance, in some implementations, the exemplary operation O71 may include the operation of O7134 for receiving detection of the first event regarding the first sound as originating from a directional orientation other than the selected directional orientation expressed in terms of elevation of an object emitting the first sound relative to a listener. An exemplary implementation may include the receiving module M7134 configured to direct the operation.

For instance, in some implementations, the exemplary operation O71 may include the operation of O7135 for receiving detection of the first event regarding the first sound as originating from a directional orientation other than the selected directional orientation expressed in terms of compass direction of an object emitting the first sound from a listener. An exemplary implementation may include the receiving module M7135 configured to direct the operation.

For instance, in some implementations, the exemplary operation O71 may include the operation of O7136 for receiving detection of the first event regarding the first sound as originating from a directional orientation other than the selected directional orientation expressed in terms of street address of an object emitting the first sound. An exemplary implementation may include the receiving module M7136 configured to direct the operation.

For instance, in some implementations, the exemplary operation O71 may include the operation of O7137 for receiving detection of the first event regarding the first sound as originating from a directional orientation other than the selected directional orientation using an estimation of the directional orientation for origination based at least in part on global positioning system (GPS) data. An exemplary implementation may include the receiving module M7137 configured to direct the operation.

For instance, in some implementations, the exemplary operation O71 may include the operation of O7138 for receiving detection of the first event regarding the first sound as originating from a directional orientation other than the selected directional orientation using an estimation of the directional orientation for origination based at least in part on an emergency beacon. An exemplary implementation may include the receiving module M7138 configured to direct the operation.

For instance, in some implementations, the exemplary operation O71 may include the operation of O7139 for receiving detection of the first event regarding the first sound as originating from a directional orientation other than the selected directional orientation using an estimation of the directional orientation for origination based at least in part on audio recognition of the second sound. An exemplary implementation may include the receiving module M7139 configured to direct the operation.

For instance, in some implementations, the exemplary operation O71 may include the operation of O7140 for receiving detection of the first event regarding the first sound as originating from a directional orientation other than the selected directional orientation, the selected directional orientation being selected through one or more user selections. An exemplary implementation may include the receiving module M7140 configured to direct the operation.

For instance, in some implementations, the exemplary operation O71 may include the operation of O7141 for receiving detection of the first event regarding the first sound as originating from a directional orientation other than the selected directional orientation, the selected directional orientation being selected based at least in part upon one or more sensed conditions. An exemplary implementation may include the receiving module M7141 configured to direct the operation.

For instance, in some implementations, the exemplary operation O71 may include the operation of O7142 for receiving detection via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the receiving module M7142 configured to direct the operation.

For instance, in some implementations, the exemplary operation O72 may include the operation of O7201 for generating the first generated audio signal to be received to mute the first sound heard by the listener after receiving the detection of a first event regarding a first sound as originating from a directional orientation other than the selected directional orientation. An exemplary implementation may include the generating module M7201 configured to direct the operation.

For instance, in some implementations, the exemplary operation O72 may include the operation of O7202 for generating the first generated audio signal to be received to emit sound opposite in form to the first sound from speakers positioned to cancel amplitude of the first sound heard by the listener after receiving the detection of a first event regarding a first sound as originating from a directional orientation other than the selected directional orientation. An exemplary implementation may include the generating module M7202 configured to direct the operation.

For instance, in some implementations, the exemplary operation O72 may include the operation of O7203 for generating the first generated audio signal to be received to emit sound from speakers positioned to attenuate amplitude of the first sound heard by the listener after receiving the detection of a first event regarding a first sound as originating from a directional orientation other than the selected directional orientation. An exemplary implementation may include the generating module M7203 configured to direct the operation.

For instance, in some implementations, the exemplary operation O72 may include the operation of O7204 for generating the first generated audio signal to be received by a cell phone after receiving the detection of a first event regarding a first sound as originating from a directional orientation other than the selected directional orientation. An exemplary implementation may include the generating module M7204 configured to direct the operation.

For instance, in some implementations, the exemplary operation O72 may include the operation of O7205 for generating the first generated audio signal to be received by an amplifier system after receiving the detection of a first event regarding a first sound as originating from a directional orientation other than the selected directional orientation. An exemplary implementation may include the generating module M7205 configured to direct the operation.

For instance, in some implementations, the exemplary operation O72 may include the operation of O7206 for generating the first generated audio signal to be received by a two-way radio after receiving the detection of a first event regarding a first sound as originating from a directional orientation other than the selected directional orientation. An exemplary implementation may include the generating module M7206 configured to direct the operation.

For instance, in some implementations, the exemplary operation O72 may include the operation of O7207 for generating the first generated audio signal to be received by a computer after receiving the detection of a first event regarding a first sound as originating from a directional orientation other than the selected directional orientation. An exemplary implementation may include the generating module M7207 configured to direct the operation.

For instance, in some implementations, the exemplary operation O72 may include the operation of O7208 for generating the first generated audio signal to control speakers after receiving the detection of a first event regarding a first sound as originating from a directional orientation other than the selected directional orientation. An exemplary implementation may include the generating module M7208 configured to direct the operation.

For instance, in some implementations, the exemplary operation O72 may include the operation of O7209 for generating the first generated audio signal to modify an audio signal generated from reception of the first sound after receiving the detection of a first event regarding a first sound as originating from a directional orientation other than the selected directional orientation. An exemplary implementation may include the generating module M7209 configured to direct the operation.

For instance, in some implementations, the exemplary operation O72 may include the operation of O7210 for generating the first generated audio signal through in part a table lookup of a database after receiving the detection of a first event regarding a first sound as originating from a directional orientation other than the selected directional orientation. An exemplary implementation may include the generating module M7210 configured to direct the operation.

For instance, in some implementations, the exemplary operation O72 may include the operation of O7211 for generating the first generated audio signal through in part a spectral analysis of the first sound after receiving the detection of a first event regarding a first sound as originating from a directional orientation other than the selected directional orientation. An exemplary implementation may include the generating module M7211 configured to direct the operation.

For instance, in some implementations, the exemplary operation O72 may include the operation of O7212 for generating the first generated audio signal through in part a recognition of the first sound after receiving the detection of a first event regarding a first sound as originating from a directional orientation other than the selected directional orientation. An exemplary implementation may include the generating module M7212 configured to direct the operation.

For instance, in some implementations, the exemplary operation O72 may include the operation of O7213 for generating via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the generating module M7213 configured to direct the operation.

For instance, in some implementations, the exemplary operation O73 may include the operation of O7301 for receiving the second sound from an ambient environment. An exemplary implementation may include the receiving module M7301 configured to direct the operation.

For instance, in some implementations, the exemplary operation O73 may include the operation of O7302 for receiving the second sound as a monitored sound. An exemplary implementation may include the receiving module M73012 configured to direct the operation.

For instance, in some implementations, the exemplary operation O73 may include the operation of O7303 for receiving the second sound from a coupled audio device. An exemplary implementation may include the receiving module M7303 configured to direct the operation.

For instance, in some implementations, the exemplary operation O73 may include the operation of O7304 for receiving the second sound from one or more speakers. An exemplary implementation may include the receiving module M7304 configured to direct the operation.

For instance, in some implementations, the exemplary operation O73 may include the operation of O7305 for receiving the second sound with one or more microphones. An exemplary implementation may include the receiving module M7305 configured to direct the operation.

For instance, in some implementations, the exemplary operation O73 may include the operation of O7306 for receiving the second sound with one or more electronic connections. An exemplary implementation may include the receiving module M7306 configured to direct the operation.

For instance, in some implementations, the exemplary operation O73 may include the operation of O7307 for receiving the second sound from one or more speakers. An exemplary implementation may include the receiving module M7307 configured to direct the operation.

For instance, in some implementations, the exemplary operation O73 may include the operation of O7308 for receiving detection of the first event regarding the second sound as an absence of the one or more characteristics in the second sound. An exemplary implementation may include the receiving module M7308 configured to direct the operation.

For instance, in some implementations, the exemplary operation O73 may include the operation of O7309 for receiving detection of the first event regarding the second sound as a change of the one or more characteristics in the second sound. An exemplary implementation may include the receiving module M7309 configured to direct the operation.

For instance, in some implementations, the exemplary operation O73 may include the operation of O7310 for receiving detection of the first event regarding the second sound as an appearance of the one or more characteristics in the second sound. An exemplary implementation may include the receiving module M7310 configured to direct the operation.

For instance, in some implementations, the exemplary operation O73 may include the operation of O7311 for receiving detection of the first event regarding the second sound involving the one or more characteristics as including one or more repetitive sounds. An exemplary implementation may include the receiving module M7311 configured to direct the operation.

For instance, in some implementations, the exemplary operation O73 may include the operation of O7312 for receiving detection of the first event regarding the second sound involving the one or more characteristics as including one or more sounds from one or more machines. An exemplary implementation may include the receiving module M7312 configured to direct the operation.

For instance, in some implementations, the exemplary operation O73 may include the operation of O7313 for receiving detection of the first event regarding the second sound involving the one or more characteristics as including speech from a human. An exemplary implementation may include the receiving module M7313 configured to direct the operation.

For instance, in some implementations, the exemplary operation O73 may include the operation of O7314 for receiving detection of the first event regarding the second sound involving the one or more characteristics as including sound from a living creature. An exemplary implementation may include the receiving module M7314 configured to direct the operation.

For instance, in some implementations, the exemplary operation O73 may include the operation of O7315 for receiving detection of the first event regarding the second sound involving the one or more characteristics as including sound of an engine abnormality. An exemplary implementation may include the receiving module M7315 configured to direct the operation.

For instance, in some implementations, the exemplary operation O73 may include the operation of O7316 for receiving detection of the first event regarding the second sound involving the one or more characteristics as including sound of an emergency warning. An exemplary implementation may include the receiving module M7316 configured to direct the operation.

For instance, in some implementations, the exemplary operation O73 may include the operation of O7317 for receiving detection of the first event regarding the second sound involving the one or more characteristics as including sound of a weather update. An exemplary implementation may include the receiving module M7317 configured to direct the operation.

For instance, in some implementations, the exemplary operation O73 may include the operation of O7318 for receiving, through an electronic signal, detection of the first event regarding the second sound involving one or more characteristics. An exemplary implementation may include the receiving module M7318 configured to direct the operation.

For instance, in some implementations, the exemplary operation O73 may include the operation of O7319 for receiving, through one or more microphones, detection of the first event regarding the second sound involving one or more characteristics. An exemplary implementation may include the receiving module M7319 configured to direct the operation.

For instance, in some implementations, the exemplary operation O73 may include the operation of O7320 for receiving, through an audio signal from an audio device, detection of the first event regarding the second sound involving one or more characteristics. An exemplary implementation may include the receiving module M7320 configured to direct the operation.

For instance, in some implementations, the exemplary operation O73 may include the operation of O7321 for receiving, through a traffic control signal from an emergency vehicle, detection of the first event regarding the second sound involving one or more characteristics. An exemplary implementation may include the receiving module M7321 configured to direct the operation.

For instance, in some implementations, the exemplary operation O73 may include the operation of O7322 for receiving, through performance of a table lookup to compare one or more portions of the second sound with one or more characteristics of sound in a database, detection of the first event regarding the second sound involving one or more characteristics. An exemplary implementation may include the receiving module M7322 configured to direct the operation.

For instance, in some implementations, the exemplary operation O73 may include the operation of O7323 for receiving, through performance of a spectral analysis of the second sound, detection of the first event regarding the second sound involving one or more characteristics. An exemplary implementation may include the receiving module M7323 configured to direct the operation.

For instance, in some implementations, the exemplary operation O73 may include the operation of O7324 for receiving, through an historical log associated with the second sound, detection of the first event regarding the second sound involving one or more characteristics. An exemplary implementation may include the receiving module M7324 configured to direct the operation.

For instance, in some implementations, the exemplary operation O73 may include the operation of O7325 for receiving, through information from an accelerometer, a barometer, a motion detector or a combination thereof, detection of the first event regarding the second sound involving one or more characteristics. An exemplary implementation may include the receiving module M7325 configured to direct the operation.

For instance, in some implementations, the exemplary operation O73 may include the operation of O7326 for receiving detection of the first event regarding the first sound as originating from a directional orientation other than the selected directional orientation using an estimation of one or more differences in time in which the first sound was received between two or more microphones. An exemplary implementation may include the receiving module M7326 configured to direct the operation.

For instance, in some implementations, the exemplary operation O73 may include the operation of O7327 for receiving detection of the first event regarding the first sound as originating from a directional orientation other than the selected directional orientation expressed in terms of speed of an object emitting the first sound relative to a listener. An exemplary implementation may include the receiving module M7327 configured to direct the operation.

For instance, in some implementations, the exemplary operation O73 may include the operation of O7328 for receiving detection of the first event regarding the first sound as originating from a directional orientation other than the selected directional orientation expressed in terms of absolute speed an object emitting the first sound. An exemplary implementation may include the receiving module M7328 configured to direct the operation.

For instance, in some implementations, the exemplary operation O73 may include the operation of O7329 for receiving detection of the first event regarding the first sound as originating from a directional orientation other than the selected directional orientation expressed in terms of velocity of an object emitting the first sound relative to a listener. An exemplary implementation may include the receiving module M7329 configured to direct the operation.

For instance, in some implementations, the exemplary operation O73 may include the operation of O7330 for receiving detection of the first event regarding the first sound as originating from a directional orientation other than the selected directional orientation expressed in terms of absolute velocity of an object emitting the first sound. An exemplary implementation may include the receiving module M7330 configured to direct the operation.

For instance, in some implementations, the exemplary operation O73 may include the operation of O7331 for receiving detection of the first event regarding the first sound as originating from a directional orientation other than the selected directional orientation expressed in terms of distance of an object emitting the first sound from a listener. An exemplary implementation may include the receiving module M7331 configured to direct the operation.

For instance, in some implementations, the exemplary operation O73 may include the operation of O7332 for receiving detection of the first event regarding the first sound as originating from a directional orientation other than the selected directional orientation expressed in terms of azimuth of an object emitting the first sound relative to a listener. An exemplary implementation may include the receiving module M7332 configured to direct the operation.

For instance, in some implementations, the exemplary operation O73 may include the operation of O7333 for receiving detection of the first event regarding the first sound as originating from a directional orientation other than the selected directional orientation expressed in terms of absolute elevation of an object emitting the first sound. An exemplary implementation may include the receiving module M7333 configured to direct the operation.

For instance, in some implementations, the exemplary operation O73 may include the operation of O7334 for receiving detection of the first event regarding the first sound as originating from a directional orientation other than the selected directional orientation expressed in terms of elevation of an object emitting the first sound relative to a listener. An exemplary implementation may include the receiving module M7334 configured to direct the operation.

For instance, in some implementations, the exemplary operation O73 may include the operation of O7335 for receiving detection of the first event regarding the first sound as originating from a directional orientation other than the selected directional orientation expressed in terms of compass direction of an object emitting the first sound from a listener. An exemplary implementation may include the receiving module M7335 configured to direct the operation.

For instance, in some implementations, the exemplary operation O73 may include the operation of O7336 for receiving detection of the first event regarding the first sound as originating from a directional orientation other than the selected directional orientation expressed in terms of street address of an object emitting the first sound. An exemplary implementation may include the receiving module M7336 configured to direct the operation.

For instance, in some implementations, the exemplary operation O73 may include the operation of O7337 for receiving detection of the first event regarding the first sound as originating from a directional orientation other than the selected directional orientation using an estimation of the directional orientation for origination based at least in part on global positioning system (GPS) data. An exemplary implementation may include the receiving module M7337 configured to direct the operation.

For instance, in some implementations, the exemplary operation O73 may include the operation of O7338 for receiving detection of the first event regarding the first sound as originating from a directional orientation other than the selected directional orientation using an estimation of the directional orientation for origination based at least in part on an emergency beacon. An exemplary implementation may include the receiving module M7338 configured to direct the operation.

For instance, in some implementations, the exemplary operation O73 may include the operation of O7339 for receiving detection of the first event regarding the first sound as originating from a directional orientation other than the selected directional orientation using an estimation of the directional orientation for origination based at least in part on audio recognition of the second sound. An exemplary implementation may include the receiving module M7339 configured to direct the operation.

For instance, in some implementations, the exemplary operation O73 may include the operation of O7340 for receiving detection of the first event regarding the second sound involving one or more characteristics and as originating from a directional orientation other than the selected directional orientation, the selected directional orientation being selected through one or more user selections. An exemplary implementation may include the receiving module M7340 configured to direct the operation.

For instance, in some implementations, the exemplary operation O73 may include the operation of O7341 for receiving detection of the first event regarding the second sound involving one or more characteristics and as originating from a directional orientation other than the selected directional orientation, the selected directional orientation being selected based at least in part upon one or more sensed conditions. An exemplary implementation may include the receiving module M7341 configured to direct the operation.

For instance, in some implementations, the exemplary operation O73 may include the operation of O7342 for receiving detection via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the receiving module M7342 configured to direct the operation.

For instance, in some implementations, the exemplary operation O74 may include the operation of O7401 for generating the second generated audio signal to be received to mute the second sound heard by the listener after receiving the detection of a first event regarding a second sound as originating from the selected directional orientation. An exemplary implementation may include the generating module M7401 configured to direct the operation.

For instance, in some implementations, the exemplary operation O74 may include the operation of O7402 for generating the second generated audio signal to be received to emit sound opposite in form to the second sound from speakers positioned to cancel amplitude of the second sound heard by the listener after receiving the detection of a first event regarding a second sound as originating from the selected directional orientation. An exemplary implementation may include the generating module M7402 configured to direct the operation.

For instance, in some implementations, the exemplary operation O74 may include the operation of O7403 for generating the second generated audio signal to be received to emit sound from speakers positioned to attenuate amplitude of the second sound heard by the listener after receiving the detection of a first event regarding a second sound as originating from the selected directional orientation. An exemplary implementation may include the generating module M7403 configured to direct the operation.

For instance, in some implementations, the exemplary operation O74 may include the operation of O7404 for generating the second generated audio signal to be received by a cell phone after receiving the detection of a first event regarding a second sound as originating from the selected directional orientation. An exemplary implementation may include the generating module M7404 configured to direct the operation.

For instance, in some implementations, the exemplary operation O74 may include the operation of O7405 for generating the second generated audio signal to be received by an amplifier system after receiving the detection of a first event regarding a second sound as originating from the selected directional orientation. An exemplary implementation may include the generating module M7405 configured to direct the operation.

For instance, in some implementations, the exemplary operation O74 may include the operation of O7406 for generating the second generated audio signal to be received by a two-way radio after receiving the detection of a first event regarding a second sound as originating from the selected directional orientation. An exemplary implementation may include the generating module M7406 configured to direct the operation.

For instance, in some implementations, the exemplary operation O74 may include the operation of O7407 for generating the second generated audio signal to be received by a computer after receiving the detection of a first event regarding a second sound as originating from the selected directional orientation. An exemplary implementation may include the generating module M7407 configured to direct the operation.

For instance, in some implementations, the exemplary operation O74 may include the operation of O7408 for generating the second generated audio signal to control speakers after receiving the detection of a first event regarding a second sound as originating from the selected directional orientation. An exemplary implementation may include the generating module M7408 configured to direct the operation.

For instance, in some implementations, the exemplary operation O74 may include the operation of O7409 for generating the second generated audio signal to modify an audio signal generated from reception of the second sound after receiving the detection of a first event regarding a second sound as originating from the selected directional orientation. An exemplary implementation may include the generating module M7409 configured to direct the operation.

For instance, in some implementations, the exemplary operation O74 may include the operation of O7410 for generating the second generated audio signal through in part a table lookup of a database after receiving the detection of a first event regarding a second sound as originating from the selected directional orientation. An exemplary implementation may include the generating module M7410 configured to direct the operation.

For instance, in some implementations, the exemplary operation O74 may include the operation of O7411 for generating the second generated audio signal through in part a spectral analysis of the second sound after receiving the detection of a first event regarding a second sound as originating from the selected directional orientation. An exemplary implementation may include the generating module M7411 configured to direct the operation.

For instance, in some implementations, the exemplary operation O74 may include the operation of O7412 for generating the second generated audio signal through in part a recognition of the second sound after receiving the detection of a first event regarding a second sound as originating from the selected directional orientation. An exemplary implementation may include the generating module M7412 configured to direct the operation.

For instance, in some implementations, the exemplary operation O74 may include the operation of O7413 for generating via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the generating module M7413 configured to direct the operation.

An operational flow O80 as shown represents exemplary operations. Some of the figures may have various examples of operational flows. It should be understood that the operational flows may be executed in a number of environments and contexts, including versions and modified versions of the figures and other versions as well. Furthermore, although the various operational flows are presented in the sequence(s) illustrated, it should be understood that the various operations may be performed in other orders than those which are illustrated, or may be performed concurrently.

In figures that follow, various operations may be depicted in a box-within-a-box manner. Such depictions may indicate that an operation in an internal box may comprise an optional exemplary implementation of the operational step illustrated in one or more external boxes. However, it should be understood that internal box operations may be viewed as independent operations separate from any associated external boxes and may be performed in any sequence with respect to all other illustrated operations, or may be performed concurrently.

The operational flow O80 can move to operation O81 where receiving one or more audio signals having been generated by one or more electronic devices may be executed. An exemplary implementation may include the receiving module M81 configured to direct the operation. For instance, the compute/control 210 of the audio/sound device 200 can receive one or more audio signals such as audio music signals through the wireless component 222b of the communication 220, the audio signals having been generated by one or more electronic devices such as an electronic music player integrated into an entertainment center.

The operational flow O80 can move to operation O82 where receiving detection, via at least in part one or more computing devices, of a first event regarding a first sound involving one or more characteristics in a first manner and as being associated with the one or more audio signals may be executed. An exemplary implementation may include the receiving module M82 configured to direct the operation. For instance, the compute/control 210 of the audio/sound device 200 can receive detection through the acoustic component 242i of the input/sensing 240 that a first event of an appearance of undesirable music as a first sound is occurring involving such characteristics as an extreme volume level in a first manner such as including extreme volume and one or more sound patterns of wildly accentuated drum beats.

The operational flow O80 can move to operation O83 where generating, via at least in part one or more computing devices, a first generated audio signal to alter hearing of the first sound by a listener based at least in part on receiving the detection of a first event regarding a first sound involving one or more characteristics in a first manner and as being associated with the one or more audio signals may be executed. An exemplary implementation may include the generating module M83 configured to direct the operation. For instance, the compute/control 210 of the audio/sound device 200 can generate a first generated audio signal such as an anti-noise signal to cancel out the hearing of the first sound such as the undesirable music based at least in part on receiving the detection of a first event regarding a first sound involving one or more characteristics such as the extreme volume and the sound pattern and as being associated with one or more sound patterns of wildly accentuated drum beats.

The operational flow O80 can move to operation O84 where receiving detection, via at least in part one or more computing devices, of a first event regarding a second sound involving the one or more characteristics in a second manner other than the first manner may be executed. An exemplary implementation may include the receiving module M84 configured to direct the operation. For instance, the compute/control 210 of the audio/sound device 200 can receive detection through the acoustic component 242i of the input/sensing 240 that a first event of an appearance of a baby crying as a second sound involving such characteristics as an audio pattern in a second manner other than the first manner such as including the audio pattern of a baby crying.

Illustrations of various implementations of the exemplary operations O81, O82, O83, and O84 are found in the figures.

For instance, in some implementations, the exemplary operation O81 may include the operation of O8101 for receiving the one or more audio signals from one or more Blue Tooth devices coupled to one or more second electronic devices. An exemplary implementation may include the receiving module M8101 configured to direct the operation.

For instance, in some implementations, the exemplary operation O81 may include the operation of O8102 for receiving the one or more audio signals from one or more remote devices coupled to one or more second electronic devices. An exemplary implementation may include the receiving module M8102 configured to direct the operation.

For instance, in some implementations, the exemplary operation O81 may include the operation of O8103 for receiving the one or more audio signals from one or more electronic devices coupled to one or more microphones. An exemplary implementation may include the receiving module M8103 configured to direct the operation.

For instance, in some implementations, the exemplary operation O81 may include the operation of O8104 for receiving the one or more audio signals from one or more electronic devices coupled to one or more headsets. An exemplary implementation may include the receiving module M8104 configured to direct the operation.

For instance, in some implementations, the exemplary operation O81 may include the operation of O8105 for receiving the one or more audio signals from one or more computers. An exemplary implementation may include the receiving module M8105 configured to direct the operation.

For instance, in some implementations, the exemplary operation O81 may include the operation of O8106 for receiving the one or more audio signals from one or more television sets. An exemplary implementation may include the receiving module M8106 configured to direct the operation.

For instance, in some implementations, the exemplary operation O81 may include the operation of O8107 for receiving the one or more audio signals from one or more radio receivers. An exemplary implementation may include the receiving module M8107 configured to direct the operation.

For instance, in some implementations, the exemplary operation O81 may include the operation of O8108 for receiving the one or more audio signals from one or more compact disc players. An exemplary implementation may include the receiving module M8108 configured to direct the operation.

For instance, in some implementations, the exemplary operation O81 may include the operation of O8109 for receiving the one or more audio signals from one or more video players. An exemplary implementation may include the receiving module M8109 configured to direct the operation.

For instance, in some implementations, the exemplary operation O81 may include the operation of O8110 for receiving the one or more audio signals from one or more personal data assistants. An exemplary implementation may include the receiving module M8110 configured to direct the operation.

For instance, in some implementations, the exemplary operation O81 may include the operation of O8111 for receiving the one or more audio signals from one or more iPod-devices. An exemplary implementation may include the receiving module M8111 configured to direct the operation.

For instance, in some implementations, the exemplary operation O82 may include the operation of O8201 for receiving the first sound having one or more portions thereof being generated from the one or more audio signals. An exemplary implementation may include the receiving module M8201 configured to direct the operation.

For instance, in some implementations, the exemplary operation O82 may include the operation of O8202 for receiving the first sound having been generated by the one or more electronic devices that generated the one or more audio signals. An exemplary implementation may include the receiving module M8202 configured to direct the operation.

For instance, in some implementations, the exemplary operation O82 may include the operation of O8203 for receiving the first sound from an ambient environment. An exemplary implementation may include the receiving module M8203 configured to direct the operation.

For instance, in some implementations, the exemplary operation O82 may include the operation of O8204 for receiving the first sound as a monitored sound. An exemplary implementation may include the receiving module M8204 configured to direct the operation.

For instance, in some implementations, the exemplary operation O82 may include the operation of O8205 for receiving the first sound from a coupled audio device. An exemplary implementation may include the receiving module M8205 configured to direct the operation.

For instance, in some implementations, the exemplary operation O82 may include the operation of O8206 for receiving the first sound from one or more speakers. An exemplary implementation may include the receiving module M8206 configured to direct the operation.

For instance, in some implementations, the exemplary operation O82 may include the operation of O8207 for receiving the first sound with one or more microphones. An exemplary implementation may include the receiving module M8207 configured to direct the operation.

For instance, in some implementations, the exemplary operation O82 may include the operation of O8208 for receiving the first sound with one or more electronic connections. An exemplary implementation may include the receiving module M8208 configured to direct the operation.

For instance, in some implementations, the exemplary operation O82 may include the operation of O8209 for receiving the first sound from one or more speakers. An exemplary implementation may include the receiving module M8209 configured to direct the operation.

For instance, in some implementations, the exemplary operation O82 may include the operation of O8210 for receiving detection of the first event regarding the first sound as an absence of the one or more characteristics in the first sound. An exemplary implementation may include the receiving module M8210 configured to direct the operation.

For instance, in some implementations, the exemplary operation O82 may include the operation of O8211 for receiving detection of the first event regarding the first sound as a change of the one or more characteristics in the first sound. An exemplary implementation may include the receiving module M8211 configured to direct the operation.

For instance, in some implementations, the exemplary operation O82 may include the operation of O8212 for receiving detection of the first event regarding the first sound as an appearance of the one or more characteristics in the first sound. An exemplary implementation may include the receiving module M8212 configured to direct the operation.

For instance, in some implementations, the exemplary operation O82 may include the operation of O8213 for receiving detection of the first event regarding the first sound involving the one or more characteristics as including one or more repetitive sounds. An exemplary implementation may include the receiving module M8213 configured to direct the operation.

For instance, in some implementations, the exemplary operation O82 may include the operation of O8214 for receiving detection of the first event regarding the first sound involving the one or more characteristics as including one or more sounds from one or more machines. An exemplary implementation may include the receiving module M8214 configured to direct the operation.

For instance, in some implementations, the exemplary operation O82 may include the operation of O8215 for receiving detection of the first event regarding the first sound involving the one or more characteristics as including speech from a human. An exemplary implementation may include the receiving module M8215 configured to direct the operation.

For instance, in some implementations, the exemplary operation O82 may include the operation of O8216 for receiving detection of the first event regarding the first sound involving the one or more characteristics as including sound from a living creature. An exemplary implementation may include the receiving module M8216 configured to direct the operation.

For instance, in some implementations, the exemplary operation O82 may include the operation of O8217 for receiving detection of the first event regarding the first sound involving the one or more characteristics as including sound of an engine abnormality. An exemplary implementation may include the receiving module M8217 configured to direct the operation.

For instance, in some implementations, the exemplary operation O82 may include the operation of O8218 for receiving detection of the first event regarding the first sound involving the one or more characteristics as including sound of an emergency warning. An exemplary implementation may include the receiving module M8218 configured to direct the operation.

For instance, in some implementations, the exemplary operation O82 may include the operation of O8219 for receiving detection of the first event regarding the first sound involving the one or more characteristics as including sound of a weather update. An exemplary implementation may include the receiving module M8219 configured to direct the operation.

For instance, in some implementations, the exemplary operation O82 may include the operation of O8220 for receiving, through an electronic signal, detection of the first event regarding the first sound involving one or more characteristics. An exemplary implementation may include the receiving module M8220 configured to direct the operation.

For instance, in some implementations, the exemplary operation O82 may include the operation of O8221 for receiving, through one or more microphones, detection of the first event regarding the first sound involving one or more characteristics. An exemplary implementation may include the receiving module M8221 configured to direct the operation.

For instance, in some implementations, the exemplary operation O82 may include the operation of O8222 for receiving, through an audio signal from an audio device, detection of the first event regarding the first sound involving one or more characteristics. An exemplary implementation may include the receiving module M8222 configured to direct the operation.

For instance, in some implementations, the exemplary operation O82 may include the operation of O8222 for receiving, through a traffic control signal from an emergency vehicle, detection of the first event regarding the first sound involving one or more characteristics. An exemplary implementation may include the receiving module M8222 configured to direct the operation.

For instance, in some implementations, the exemplary operation O82 may include the operation of O8224 for receiving, through performance of a table lookup to compare one or more portions of the first sound with one or more characteristics of sound in a database, detection of the first event regarding the first sound involving one or more characteristics. An exemplary implementation may include the receiving module M8224 configured to direct the operation.

For instance, in some implementations, the exemplary operation O82 may include the operation of O8225 for receiving, through performance of a spectral analysis of the first sound, detection of the first event regarding the first sound involving one or more characteristics. An exemplary implementation may include the receiving module M8225 configured to direct the operation.

For instance, in some implementations, the exemplary operation O82 may include the operation of O8226 for receiving, through an historical log associated with the first sound, detection of the first event regarding the first sound involving one or more characteristics. An exemplary implementation may include the receiving module M8226 configured to direct the operation.

For instance, in some implementations, the exemplary operation O82 may include the operation of O8227 for receiving, through information from an accelerometer, a barometer, a motion detector or a combination thereof, detection of the first event regarding the first sound involving one or more characteristics. An exemplary implementation may include the receiving module M8227 configured to direct the operation.

For instance, in some implementations, the exemplary operation O82 may include the operation of O8228 for receiving detection via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the receiving module M8228 configured to direct the operation.

For instance, in some implementations, the exemplary operation O83 may include the operation of O8301 for generating the first generated audio signal to alter hearing of the first sound by a listener based at least in part on the one or more audio signals containing identification information for one or more portions of the first sound. An exemplary implementation may include the generating module M8301 configured to direct the operation.

For instance, in some implementations, the exemplary operation O82 may include the operation of O8302 for generating the first generated audio signal to alter hearing of the first sound by a listener based at least in part on the one or more audio signals containing waveforms of one or more portions of the first sound. An exemplary implementation may include the generating module M8302 configured to direct the operation.

For instance, in some implementations, the exemplary operation O83 may include the operation of O8303 for generating the first generated audio signal to be received to mute the first sound heard by the listener. An exemplary implementation may include the generating module M8303 configured to direct the operation.

For instance, in some implementations, the exemplary operation O83 may include the operation of O8304 for generating the first generated audio signal to be received to emit sound opposite in form to the first sound from speakers positioned to cancel amplitude of the first sound heard by the listener. An exemplary implementation may include the generating module M8304 configured to direct the operation.

For instance, in some implementations, the exemplary operation O83 may include the operation of O8305 for generating the first generated audio signal to be received to emit sound from speakers positioned to attenuate amplitude of the first sound heard by the listener. An exemplary implementation may include the generating module M8305 configured to direct the operation.

For instance, in some implementations, the exemplary operation O83 may include the operation of O8306 for generating the first generated audio signal to be received by a cell phone. An exemplary implementation may include the generating module M8306 configured to direct the operation.

For instance, in some implementations, the exemplary operation O83 may include the operation of O8307 for generating the first generated audio signal to be received by an amplifier system. An exemplary implementation may include the generating module M8307 configured to direct the operation.

For instance, in some implementations, the exemplary operation O83 may include the operation of O8308 for generating the first generated audio signal to be received by a two-way radio. An exemplary implementation may include the generating module M8308 configured to direct the operation.

For instance, in some implementations, the exemplary operation O83 may include the operation of O8309 for generating the first generated audio signal to be received by a computer. An exemplary implementation may include the generating module M8309 configured to direct the operation.

For instance, in some implementations, the exemplary operation O83 may include the operation of O8310 for generating the first generated audio signal to control speakers. An exemplary implementation may include the generating module M8310 configured to direct the operation.

For instance, in some implementations, the exemplary operation O83 may include the operation of O8311 for generating the first generated audio signal to modify an audio signal generated from reception of the first sound. An exemplary implementation may include the generating module M8311 configured to direct the operation.

For instance, in some implementations, the exemplary operation O83 may include the operation of O8312 for generating the first generated audio signal through in part a table lookup of a database. An exemplary implementation may include the generating module M8312 configured to direct the operation.

For instance, in some implementations, the exemplary operation O83 may include the operation of O8313 for generating the first generated audio signal through in part a spectral analysis of the first sound. An exemplary implementation may include the generating module M8313 configured to direct the operation.

For instance, in some implementations, the exemplary operation O83 may include the operation of O8314 for generating the first generated audio signal through in part a recognition of the first sound. An exemplary implementation may include the generating module M8314 configured to direct the operation.

For instance, in some implementations, the exemplary operation O83 may include the operation of O8315 for generating via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the generating module M8315 configured to direct the operation.

For instance, in some implementations, the exemplary operation O84 may include the operation of O8401 for receiving the second sound from an ambient environment. An exemplary implementation may include the receiving module M8401 configured to direct the operation.

For instance, in some implementations, the exemplary operation O84 may include the operation of O8402 for receiving the second sound as a monitored sound. An exemplary implementation may include the receiving module M8402 configured to direct the operation.

For instance, in some implementations, the exemplary operation O84 may include the operation of O8403 for receiving the second sound from a coupled audio device. An exemplary implementation may include the receiving module M8403 configured to direct the operation.

For instance, in some implementations, the exemplary operation O84 may include the operation of O8404 for receiving the second sound from one or more speakers. An exemplary implementation may include the receiving module M8404 configured to direct the operation.

For instance, in some implementations, the exemplary operation O84 may include the operation of O8405 for receiving the second sound with one or more microphones. An exemplary implementation may include the receiving module M8405 configured to direct the operation.

For instance, in some implementations, the exemplary operation O84 may include the operation of O8406 for receiving the second sound with one or more electronic connections. An exemplary implementation may include the receiving module M8406 configured to direct the operation.

For instance, in some implementations, the exemplary operation O84 may include the operation of O8407 for receiving the second sound from one or more speakers. An exemplary implementation may include the receiving module M8407 configured to direct the operation.

For instance, in some implementations, the exemplary operation O84 may include the operation of O8408 for receiving detection of the first event regarding the second sound as an absence of the one or more characteristics in the second sound. An exemplary implementation may include the receiving module M8408 configured to direct the operation.

For instance, in some implementations, the exemplary operation O84 may include the operation of O8409 for receiving detection of the first event regarding the second sound as a change of the one or more characteristics in the second sound. An exemplary implementation may include the receiving module M8409 configured to direct the operation.

For instance, in some implementations, the exemplary operation O84 may include the operation of O8410 for receiving detection of the first event regarding the second sound as an appearance of the one or more characteristics in the second sound. An exemplary implementation may include the receiving module M8410 configured to direct the operation.

For instance, in some implementations, the exemplary operation O84 may include the operation of O8411 for receiving detection of the first event regarding the second sound involving the one or more characteristics as including one or more repetitive sounds. An exemplary implementation may include the receiving module M8411 configured to direct the operation.

For instance, in some implementations, the exemplary operation O84 may include the operation of O8412 for receiving detection of the first event regarding the second sound involving the one or more characteristics as including one or more sounds from one or more machines. An exemplary implementation may include the receiving module M8412 configured to direct the operation.

For instance, in some implementations, the exemplary operation O84 may include the operation of O8413 for receiving detection of the first event regarding the second sound involving the one or more characteristics as including speech from a human. An exemplary implementation may include the receiving module M8413 configured to direct the operation.

For instance, in some implementations, the exemplary operation O84 may include the operation of O8414 for receiving detection of the first event regarding the second sound involving the one or more characteristics as including sound from a living creature. An exemplary implementation may include the receiving module M8414 configured to direct the operation.

For instance, in some implementations, the exemplary operation O84 may include the operation of O8415 for receiving detection of the first event regarding the second sound involving the one or more characteristics as including sound of an engine abnormality. An exemplary implementation may include the receiving module M8415 configured to direct the operation.

For instance, in some implementations, the exemplary operation O84 may include the operation of O8416 for receiving detection of the first event regarding the second sound involving the one or more characteristics as including sound of an emergency warning. An exemplary implementation may include the receiving module M8416 configured to direct the operation.

For instance, in some implementations, the exemplary operation O84 may include the operation of O8417 for receiving detection of the first event regarding the second sound involving the one or more characteristics as including sound of a weather update. An exemplary implementation may include the receiving module M8417 configured to direct the operation.

For instance, in some implementations, the exemplary operation O84 may include the operation of O8418 for receiving, through an electronic signal, detection of the first event regarding the second sound involving one or more characteristics. An exemplary implementation may include the receiving module M8418 configured to direct the operation.

For instance, in some implementations, the exemplary operation O84 may include the operation of O8419 for receiving, through one or more microphones, detection of the first event regarding the second sound involving one or more characteristics. An exemplary implementation may include the receiving module M8419 configured to direct the operation.

For instance, in some implementations, the exemplary operation O84 may include the operation of O8420 for receiving, through an audio signal from an audio device, detection of the first event regarding the second sound involving one or more characteristics. An exemplary implementation may include the receiving module M8420 configured to direct the operation.

For instance, in some implementations, the exemplary operation O84 may include the operation of O8421 for receiving, through a traffic control signal from an emergency vehicle, detection of the first event regarding the second sound involving one or more characteristics. An exemplary implementation may include the receiving module M8421 configured to direct the operation.

For instance, in some implementations, the exemplary operation O84 may include the operation of O8422 for receiving, through performance of a table lookup to compare one or more portions of the second sound with one or more characteristics of sound in a database, detection of the first event regarding the second sound involving one or more characteristics. An exemplary implementation may include the receiving module M8422 configured to direct the operation.

For instance, in some implementations, the exemplary operation O84 may include the operation of O8423 for receiving, through performance of a spectral analysis of the second sound, detection of the first event regarding the second sound involving one or more characteristics. An exemplary implementation may include the receiving module M8423 configured to direct the operation.

For instance, in some implementations, the exemplary operation O84 may include the operation of O8424 for receiving, through an historical log associated with the second sound, detection of the first event regarding the second sound involving one or more characteristics. An exemplary implementation may include the receiving module M8424 configured to direct the operation.

For instance, in some implementations, the exemplary operation O84 may include the operation of O8425 for receiving, through information from an accelerometer, a barometer, a motion detector or a combination thereof, detection of the first event regarding the second sound involving one or more characteristics. An exemplary implementation may include the receiving module M8425 configured to direct the operation.

For instance, in some implementations, the exemplary operation O84 may include the operation of O8426 for receiving detection via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the receiving module M8426 configured to direct the operation.

An operational flow O90 as shown represents exemplary operations. Some of the figures may have various examples of operational flows. It should be understood that the operational flows may be executed in a number of environments and contexts, including versions and modified versions of the figures and other versions as well. Furthermore, although the various operational flows are presented in the sequence(s) illustrated, it should be understood that the various operations may be performed in other orders than those which are illustrated, or may be performed concurrently.

In figures that follow, various operations may be depicted in a box-within-a-box manner. Such depictions may indicate that an operation in an internal box may comprise an optional exemplary implementation of the operational step illustrated in one or more external boxes. However, it should be understood that internal box operations may be viewed as independent operations separate from any associated external boxes and may be performed in any sequence with respect to all other illustrated operations, or may be performed concurrently.

The operational flow O90 can move to operation O91 where receiving detection of a first event of a first sound, the first event of the first sound detected, via at least in part one or more computing devices, as involving one or more repetitive components may be executed. An exemplary implementation may include the receiving module M91 configured to direct the operation. For instance, the compute/control 210 of the audio/sound device 200 can receive detection through the acoustic component 242i of the input/sensing 240 that a first event of an appearance of a construction noise such as a jack hammer being operated as a first sound involving one or more repetitive components such as the sound pattern of the jack hammer repeating.

The operational flow O90 can move to operation O92 where storing identification information based at least in part upon receiving the detection of the first event of the first sound as involving one or more repetitive components may be executed. An exemplary implementation may include the storing module M92 configured to direct the operation. For instance, the compute/control 210 of the audio/sound device 200 can store identification information such as the sound pattern of the jack hammer along with time and location of occurrence into the storage 214.

The operational flow O90 can move to operation O93 where generating, using at least in part one or more computing devices, a first generated audio signal to alter reception of the first sound based at least in part on storing the identification information may be executed. An exemplary implementation may include the generating module M93 configured to direct the operation. For instance, the compute/control 210 of the audio/sound device 200 can generate a first generated audio signal such as an anti-noise signal to cancel out the hearing of the first sound such as the jack hammer based at least in part upon the sound pattern stored in the storage 214.

Illustrations of various implementations of the exemplary operations O91, O92, and O93 are found in the figures.

For instance, in some implementations, the exemplary operation O91 may include the operation of O9101 for receiving the first sound from an ambient environment. An exemplary implementation may include the receiving module M9101 configured to direct the operation.

For instance, in some implementations, the exemplary operation O91 may include the operation of O9102 for receiving the first sound as a monitored sound. An exemplary implementation may include the receiving module M9102 configured to direct the operation.

For instance, in some implementations, the exemplary operation O91 may include the operation of O9103 for receiving the first sound from a coupled audio device. An exemplary implementation may include the receiving module M9103 configured to direct the operation.

For instance, in some implementations, the exemplary operation O91 may include the operation of O9104 for receiving the first sound from one or more speakers. An exemplary implementation may include the receiving module M9104 configured to direct the operation.

For instance, in some implementations, the exemplary operation O91 may include the operation of O9105 for receiving the first sound with one or more microphones. An exemplary implementation may include the receiving module M9105 configured to direct the operation.

For instance, in some implementations, the exemplary operation O91 may include the operation of O9106 for receiving the first sound with one or more electronic connections. An exemplary implementation may include the receiving module M9106 configured to direct the operation.

For instance, in some implementations, the exemplary operation O91 may include the operation of O9107 for receiving the first sound from one or more speakers. An exemplary implementation may include the receiving module M9107 configured to direct the operation.

For instance, in some implementations, the exemplary operation O91 may include the operation of O9108 for receiving detection of the first event regarding the first sound as an absence of the one or more repetitive components in the first sound. An exemplary implementation may include the receiving module M9108 configured to direct the operation.

For instance, in some implementations, the exemplary operation O91 may include the operation of O9109 for receiving detection of the first event regarding the first sound as a change of the one or more repetitive components in the first sound. An exemplary implementation may include the receiving module M9109 configured to direct the operation.

For instance, in some implementations, the exemplary operation O91 may include the operation of O9110 for receiving detection of the first event regarding the first sound as an appearance of the one or more repetitive components in the first sound. An exemplary implementation may include the receiving module M9110 configured to direct the operation.

For instance, in some implementations, the exemplary operation O91 may include the operation of O9111 for receiving detection of the first event regarding the first sound involving the one or more repetitive components as including one or more repetitive sounds. An exemplary implementation may include the receiving module M9111 configured to direct the operation.

For instance, in some implementations, the exemplary operation O91 may include the operation of O9112 for receiving detection of the first event regarding the first sound involving the one or more repetitive components as including one or more sounds from one or more machines. An exemplary implementation may include the receiving module M9112 configured to direct the operation.

For instance, in some implementations, the exemplary operation O91 may include the operation of O9113 for receiving detection of the first event regarding the first sound involving the one or more repetitive components as including speech from a human. An exemplary implementation may include the receiving module M9113 configured to direct the operation.

For instance, in some implementations, the exemplary operation O91 may include the operation of O9114 for receiving detection of the first event regarding the first sound involving the one or more repetitive components as including sound from a living creature. An exemplary implementation may include the receiving module M9114 configured to direct the operation.

For instance, in some implementations, the exemplary operation O91 may include the operation of O9115 for receiving detection of the first event regarding the first sound involving the one or more repetitive components as including sound of an engine abnormality. An exemplary implementation may include the receiving module M9115 configured to direct the operation.

For instance, in some implementations, the exemplary operation O91 may include the operation of O9116 for receiving detection of the first event regarding the first sound involving the one or more repetitive components as including sound of an emergency warning. An exemplary implementation may include the receiving module M9116 configured to direct the operation.

For instance, in some implementations, the exemplary operation O91 may include the operation of O9117 for receiving detection of the first event regarding the first sound involving the one or more repetitive components as including sound of a weather update. An exemplary implementation may include the receiving module M9117 configured to direct the operation.

For instance, in some implementations, the exemplary operation O91 may include the operation of O9118 for receiving, through an electronic signal, detection of the first event regarding the first sound involving one or more repetitive components. An exemplary implementation may include the receiving module M9118 configured to direct the operation.

For instance, in some implementations, the exemplary operation O91 may include the operation of O9119 for receiving, through one or more microphones, detection of the first event regarding the first sound involving one or more repetitive components. An exemplary implementation may include the receiving module M9119 configured to direct the operation.

For instance, in some implementations, the exemplary operation O91 may include the operation of O9120 for receiving, through an audio signal from an audio device, detection of the first event regarding the first sound involving one or more repetitive components. An exemplary implementation may include the receiving module M9120 configured to direct the operation.

For instance, in some implementations, the exemplary operation O91 may include the operation of O9121 for receiving, through a traffic control signal from an emergency vehicle, detection of the first event regarding the first sound involving one or more repetitive components. An exemplary implementation may include the receiving module M9121 configured to direct the operation.

For instance, in some implementations, the exemplary operation O91 may include the operation of O9122 for receiving, through performance of a table lookup to compare one or more portions of the first sound with one or more repetitive components of sound in a database, detection of the first event regarding the first sound involving one or more repetitive components. An exemplary implementation may include the receiving module M9122 configured to direct the operation.

For instance, in some implementations, the exemplary operation O91 may include the operation of O9123 for receiving, through performance of a spectral analysis of the first sound, detection of the first event regarding the first sound involving one or more repetitive components. An exemplary implementation may include the receiving module M9123 configured to direct the operation.

For instance, in some implementations, the exemplary operation O91 may include the operation of O9124 for receiving, through an historical log associated with the first sound, detection of the first event regarding the first sound involving one or more repetitive components. An exemplary implementation may include the receiving module M9124 configured to direct the operation.

For instance, in some implementations, the exemplary operation O91 may include the operation of O9125 for receiving, through information from an accelerometer, a barometer, a motion detector or a combination thereof, detection of the first event regarding the first sound involving one or more repetitive components. An exemplary implementation may include the receiving module M9125 configured to direct the operation.

For instance, in some implementations, the exemplary operation O91 may include the operation of O9126 for receiving detection via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the receiving module M9126 configured to direct the operation.

For instance, in some implementations, the exemplary operation O92 may include the operation of O9201 for storing the identification information as to frequency of the one or more repetitive components. An exemplary implementation may include the storing module M9201 configured to direct the operation.

For instance, in some implementations, the exemplary operation O92 may include the operation of O9202 for storing the identification information as to one or more wave patterns for one or more cycles of the one or more repetitive components. An exemplary implementation may include the storing module M9202 configured to direct the operation.

For instance, in some implementations, the exemplary operation O92 may include the operation of O9203 for storing the identification information associating one or more devices with the first event of the first sound involving one or more repetitive components. An exemplary implementation may include the storing module M9203 configured to direct the operation.

For instance, in some implementations, the exemplary operation O92 may include the operation of O9204 for storing the identification information in device memory. An exemplary implementation may include the storing module M9204 configured to direct the operation.

For instance, in some implementations, the exemplary operation O92 may include the operation of O9205 for storing the identification information in one or more computers. An exemplary implementation may include the storing module M9205 configured to direct the operation.

For instance, in some implementations, the exemplary operation O92 may include the operation of O9206 for storing the identification information in one or more databases. An exemplary implementation may include the storing module M9206 configured to direct the operation.

For instance, in some implementations, the exemplary operation O92 may include the operation of O9207 for storing the identification information as instructions for processing of the repetitive components. An exemplary implementation may include the storing module M9207 configured to direct the operation.

For instance, in some implementations, the exemplary operation O93 may include the operation of O9301 for generating the first generated audio signal to be received to mute the first sound heard by the listener. An exemplary implementation may include the generating module M9301 configured to direct the operation.

For instance, in some implementations, the exemplary operation O93 may include the operation of O9302 for generating the first generated audio signal to be received to emit sound opposite in form to the first sound from speakers positioned to cancel amplitude of the first sound heard by the listener. An exemplary implementation may include the generating module M9302 configured to direct the operation.

For instance, in some implementations, the exemplary operation O93 may include the operation of O9303 for generating the first generated audio signal to be received to emit sound from speakers positioned to attenuate amplitude of the first sound heard by the listener. An exemplary implementation may include the generating module M9303 configured to direct the operation.

For instance, in some implementations, the exemplary operation O93 may include the operation of O9304 for generating the first generated audio signal to be received by a cell phone. An exemplary implementation may include the generating module M9304 configured to direct the operation.

For instance, in some implementations, the exemplary operation O93 may include the operation of O9305 for generating the first generated audio signal to be received by an amplifier system. An exemplary implementation may include the generating module M9305 configured to direct the operation.

For instance, in some implementations, the exemplary operation O93 may include the operation of O9306 for generating the first generated audio signal to be received by a two-way radio. An exemplary implementation may include the generating module M9306 configured to direct the operation.

For instance, in some implementations, the exemplary operation O93 may include the operation of O9307 for generating the first generated audio signal to be received by a computer. An exemplary implementation may include the generating module M9307 configured to direct the operation.

For instance, in some implementations, the exemplary operation O93 may include the operation of O9308 for generating the first generated audio signal to control speakers. An exemplary implementation may include the generating module M9308 configured to direct the operation.

For instance, in some implementations, the exemplary operation O93 may include the operation of O9309 for generating the first generated audio signal to modify an audio signal generated from reception of the first sound. An exemplary implementation may include the generating module M9309 configured to direct the operation.

For instance, in some implementations, the exemplary operation O93 may include the operation of O9310 for generating the first generated audio signal through in part a table lookup of a database. An exemplary implementation may include the generating module M9310 configured to direct the operation.

For instance, in some implementations, the exemplary operation O93 may include the operation of O9311 for generating the first generated audio signal through in part a spectral analysis of the first sound. An exemplary implementation may include the generating module M9311 configured to direct the operation.

For instance, in some implementations, the exemplary operation O93 may include the operation of O9312 for generating the first generated audio signal through in part a recognition of the first sound. An exemplary implementation may include the generating module M9312 configured to direct the operation.

For instance, in some implementations, the exemplary operation O93 may include the operation of O9313 for generating via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the generating module M9313 configured to direct the operation.

An operational flow O100 as shown represents exemplary operations. Some of the figures may have various examples of operational flows. It should be understood that the operational flows may be executed in a number of environments and contexts, including versions and modified versions of the figures and other versions as well. Furthermore, although the various operational flows are presented in the sequence(s) illustrated, it should be understood that the various operations may be performed in other orders than those which are illustrated, or may be performed concurrently.

In figures that follow, various operations may be depicted in a box-within-a-box manner. Such depictions may indicate that an operation in an internal box may comprise an optional exemplary implementation of the operational step illustrated in one or more external boxes. However, it should be understood that internal box operations may be viewed as independent operations separate from any associated external boxes and may be performed in any sequence with respect to all other illustrated operations, or may be performed concurrently.

The operational flow O100 can move to operation O101 receiving detection, via at least in part one or more computing devices, of a first event regarding a first sound involving one or more characteristics in a first manner may be executed. An exemplary implementation may include the receiving module M101 configured to direct the operation. For instance, the compute/control 210 of the audio/sound device 200 can receive detection through the acoustic component 242i of the input/sensing 240 that a first event of an appearance of background sound such as traffic noise as a first sound involving such characteristics as an audio pattern of a desired sound such as a siren in a first manner such as not including the audio pattern of the desired sound such as the siren.

The operational flow O100 can move to operation O102 generating, via at least in part one or more computing devices, a first generated audio signal to alter hearing of the first sound by a listener based at least in part on receiving the detection of a first event regarding a first sound involving one or more characteristics in a first manner may be executed. An exemplary implementation may include the generating module M102 configured to direct the operation. For instance, the compute/control 210 of the audio/sound device 200 can generate a first generated audio signal such as an anti-noise signal to cancel out the hearing of the first sound such as the traffic noise based upon the detection of the traffic noise as not including the audio pattern of the desired sound such as the siren.

The operational flow O100 can move to operation O103 receiving detection, via at least in part one or more computing devices, of a first event regarding a second sound involving the one or more characteristics in a second manner other than the first manner may be executed. An exemplary implementation may include the receiving module M103 configured to direct the operation. For instance, the compute/control 210 of the audio/sound device 200 can receive detection through the acoustic component 242i of the input/sensing 240 that a first event of an appearance of desired sound as the second sound such as a siren of an emergency vehicle involving one or more characteristics such as the audio pattern of the desired sound such as the siren in a second manner such as including the audio pattern of the desired sound such as the siren other than the first manner such as not including the audio pattern of the desired sound such as the siren.

The operational flow O100 can move to operation O104 receiving an audio signal from an electronic device may be executed. An exemplary implementation may include the receiving module M104 configured to direct the operation. For instance, the compute/control 210 of the audio/sound device 200 can receive through the communication component 220 an audio signal such as an audio signal containing broadcast information of a radio show from an electronic device such as radio receiver internally integrated such as the RF component 242f.

The operational flow O100 can move to operation O105 modifying, via at least in part one or more computing devices, the audio signal based at least in part on receiving detection of the second sound may be executed. An exemplary implementation may include the modifying module M105 configured to direct the operation. For instance, the compute/control 210 of the audio/sound device 200 can modify the modify the audio signal of the radio broadcast such as change the volume level of the radio broadcast in synch with the volume level of the detected siren.

Illustrations of various implementations of the exemplary operations O101, O102, O103, O104, and O105 are found in the figures.

For instance, in some implementations, the exemplary operation O101 may include the operation of O10101 for receiving the first sound from an ambient environment. An exemplary implementation may include the receiving module M10101 configured to direct the operation.

For instance, in some implementations, the exemplary operation O101 may include the operation of O10102 for receiving the first sound as a monitored sound. An exemplary implementation may include the receiving module M10102 configured to direct the operation.

For instance, in some implementations, the exemplary operation O101 may include the operation of O010103 for receiving the first sound from a coupled audio device. An exemplary implementation may include the receiving module M10103 configured to direct the operation.

For instance, in some implementations, the exemplary operation O101 may include the operation of O10104 for receiving the first sound from one or more speakers. An exemplary implementation may include the receiving module M10104 configured to direct the operation.

For instance, in some implementations, the exemplary operation O101 may include the operation of O10105 for receiving the first sound with one or more microphones. An exemplary implementation may include the receiving module M10105 configured to direct the operation.

For instance, in some implementations, the exemplary operation O101 may include the operation of O10106 for receiving the first sound with one or more electronic connections. An exemplary implementation may include the receiving module M10106 configured to direct the operation.

For instance, in some implementations, the exemplary operation O101 may include the operation of O10107 for receiving the first sound from one or more speakers. An exemplary implementation may include the receiving module M10107 configured to direct the operation.

For instance, in some implementations, the exemplary operation O21 may include the operation of O10107A for receiving detection of the first event regarding the first sound in a first manner that is opposite to the second manner. An exemplary implementation may include the receiving module M10107A configured to direct the operation.

For instance, in some implementations, the exemplary operation O101 may include the operation of O10108 for receiving detection of the first event regarding the first sound as an absence of the one or more characteristics in the first sound. An exemplary implementation may include the receiving module M10108 configured to direct the operation.

For instance, in some implementations, the exemplary operation O101 may include the operation of O10109 for receiving detection of the first event regarding the first sound as a change of the one or more characteristics in the first sound. An exemplary implementation may include the receiving module M10109 configured to direct the operation.

For instance, in some implementations, the exemplary operation O101 may include the operation of O10110 for receiving detection of the first event regarding the first sound as an appearance of the one or more characteristics in the first sound. An exemplary implementation may include the receiving module M10110 configured to direct the operation.

For instance, in some implementations, the exemplary operation O101 may include the operation of O10111 for receiving detection of the first event regarding the first sound involving the one or more characteristics as including one or more repetitive sounds. An exemplary implementation may include the receiving module M10111 configured to direct the operation.

For instance, in some implementations, the exemplary operation O101 may include the operation of O10112 for receiving detection of the first event regarding the first sound involving the one or more characteristics as including one or more sounds from one or more machines. An exemplary implementation may include the receiving module M10112 configured to direct the operation.

For instance, in some implementations, the exemplary operation O101 may include the operation of O10113 for receiving detection of the first event regarding the first sound involving the one or more characteristics as including speech from a human. An exemplary implementation may include the receiving module M10113 configured to direct the operation.

For instance, in some implementations, the exemplary operation O101 may include the operation of O10114 for receiving detection of the first event regarding the first sound involving the one or more characteristics as including sound from a living creature. An exemplary implementation may include the receiving module M10114 configured to direct the operation.

For instance, in some implementations, the exemplary operation O101 may include the operation of O10115 for receiving detection of the first event regarding the first sound involving the one or more characteristics as including sound of an engine abnormality. An exemplary implementation may include the receiving module M10115 configured to direct the operation.

For instance, in some implementations, the exemplary operation O101 may include the operation of O10116 for receiving detection of the first event regarding the first sound involving the one or more characteristics as including sound of an emergency warning. An exemplary implementation may include the receiving module M10116 configured to direct the operation.

For instance, in some implementations, the exemplary operation O101 may include the operation of O10117 for receiving detection of the first event regarding the first sound involving the one or more characteristics as including sound of a weather update. An exemplary implementation may include the receiving module M10117 configured to direct the operation.

For instance, in some implementations, the exemplary operation O101 may include the operation of O10118 for receiving, through an electronic signal, detection of the first event regarding the first sound involving one or more characteristics. An exemplary implementation may include the receiving module M10118 configured to direct the operation.

For instance, in some implementations, the exemplary operation O101 may include the operation of O10119 for receiving, through one or more microphones, detection of the first event regarding the first sound involving one or more characteristics. An exemplary implementation may include the receiving module M10119 configured to direct the operation.

For instance, in some implementations, the exemplary operation O101 may include the operation of O10120 for receiving, through an audio signal from an audio device, detection of the first event regarding the first sound involving one or more characteristics. An exemplary implementation may include the receiving module M10120 configured to direct the operation.

For instance, in some implementations, the exemplary operation O101 may include the operation of O10121 for receiving, through a traffic control signal from an emergency vehicle, detection of the first event regarding the first sound involving one or more characteristics. An exemplary implementation may include the receiving module M10121 configured to direct the operation.

For instance, in some implementations, the exemplary operation O101 may include the operation of O10122 for receiving, through performance of a table lookup to compare one or more portions of the first sound with one or more characteristics of sound in a database, detection of the first event regarding the first sound involving one or more characteristics. An exemplary implementation may include the receiving module M10122 configured to direct the operation.

For instance, in some implementations, the exemplary operation O101 may include the operation of O10123 for receiving, through performance of a spectral analysis of the first sound, detection of the first event regarding the first sound involving one or more characteristics. An exemplary implementation may include the receiving module M10123 configured to direct the operation.

For instance, in some implementations, the exemplary operation O101 may include the operation of O10124 for receiving, through an historical log associated with the first sound, detection of the first event regarding the first sound involving one or more characteristics. An exemplary implementation may include the receiving module M10124 configured to direct the operation.

For instance, in some implementations, the exemplary operation O101 may include the operation of O10125 for receiving, through information from an accelerometer, a barometer, a motion detector or a combination thereof, detection of the first event regarding the first sound involving one or more characteristics. An exemplary implementation may include the receiving module M10125 configured to direct the operation.

For instance, in some implementations, the exemplary operation O101 may include the operation of O10126 for receiving detection via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the receiving module M10126 configured to direct the operation.

For instance, in some implementations, the exemplary operation O102 may include the operation of O10201 for generating the first generated audio signal to be received to mute the first sound heard by the listener. An exemplary implementation may include the generating module M10201 configured to direct the operation.

For instance, in some implementations, the exemplary operation O102 may include the operation of O10202 for generating the first generated audio signal to be received to emit sound opposite in form to the first sound from speakers positioned to cancel amplitude of the first sound heard by the listener. An exemplary implementation may include the generating module M10202 configured to direct the operation.

For instance, in some implementations, the exemplary operation O102 may include the operation of O10203 for generating the first generated audio signal to be received to emit sound from speakers positioned to attenuate amplitude of the first sound heard by the listener. An exemplary implementation may include the generating module M10203 configured to direct the operation.

For instance, in some implementations, the exemplary operation O102 may include the operation of P10204 for generating the first generated audio signal to be received by a cell phone. An exemplary implementation may include the generating module M10204 configured to direct the operation.

For instance, in some implementations, the exemplary operation O102 may include the operation of O10205 for generating the first generated audio signal to be received by an amplifier system. An exemplary implementation may include the generating module M10205 configured to direct the operation.

For instance, in some implementations, the exemplary operation O102 may include the operation of O10206 for generating the first generated audio signal to be received by a two-way radio. An exemplary implementation may include the generating module M10206 configured to direct the operation.

For instance, in some implementations, the exemplary operation O102 may include the operation of O10207 for generating the first generated audio signal to be received by a computer. An exemplary implementation may include the generating module M10207 configured to direct the operation.

For instance, in some implementations, the exemplary operation O102 may include the operation of O10208 for generating the first generated audio signal to control speakers. An exemplary implementation may include the generating module M10208 configured to direct the operation.

For instance, in some implementations, the exemplary operation O102 may include the operation of O10209 for generating the first generated audio signal to modify an audio signal generated from reception of the first sound. An exemplary implementation may include the generating module M10209 configured to direct the operation.

For instance, in some implementations, the exemplary operation O102 may include the operation of O10210 for generating the first generated audio signal through in part a table lookup of a database. An exemplary implementation may include the generating module M10210 configured to direct the operation.

For instance, in some implementations, the exemplary operation O102 may include the operation of O10211 for generating the first generated audio signal through in part a spectral analysis of the first sound. An exemplary implementation may include the generating module M10211 configured to direct the operation.

For instance, in some implementations, the exemplary operation O102 may include the operation of O10212 for generating the first generated audio signal through in part a recognition of the first sound. An exemplary implementation may include the generating module M10212 configured to direct the operation.

For instance, in some implementations, the exemplary operation O102 may include the operation of O10213 for generating via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the generating module M10213 configured to direct the operation.

For instance, in some implementations, the exemplary operation O103 may include the operation of O10301 for receiving the second sound from an ambient environment. An exemplary implementation may include the receiving module M10301 configured to direct the operation.

For instance, in some implementations, the exemplary operation O103 may include the operation of O10302 for receiving the second sound as a monitored sound. An exemplary implementation may include the receiving module M10302 configured to direct the operation.

For instance, in some implementations, the exemplary operation O103 may include the operation of O10303 for receiving the second sound from a coupled audio device. An exemplary implementation may include the receiving module M10303 configured to direct the operation.

For instance, in some implementations, the exemplary operation O103 may include the operation of O10304 for receiving the second sound from one or more speakers. An exemplary implementation may include the receiving module M10304 configured to direct the operation.

For instance, in some implementations, the exemplary operation O103 may include the operation of O10305 for receiving the second sound with one or more microphones. An exemplary implementation may include the receiving module M10305 configured to direct the operation.

For instance, in some implementations, the exemplary operation O103 may include the operation of O10306 for receiving the second sound with one or more electronic connections. An exemplary implementation may include the receiving module M10306 configured to direct the operation.

For instance, in some implementations, the exemplary operation O103 may include the operation of O10307 for receiving the second sound from one or more speakers. An exemplary implementation may include the receiving module M10307 configured to direct the operation.

For instance, in some implementations, the exemplary operation O103 may include the operation of O10308 for receiving detection of the first event regarding the second sound as an absence of the one or more characteristics in the second sound. An exemplary implementation may include the receiving module M10308 configured to direct the operation.

For instance, in some implementations, the exemplary operation O103 may include the operation of O10309 for receiving detection of the first event regarding the second sound as a change of the one or more characteristics in the second sound. An exemplary implementation may include the receiving module M10309 configured to direct the operation.

For instance, in some implementations, the exemplary operation O103 may include the operation of O10310 for receiving detection of the first event regarding the second sound as an appearance of the one or more characteristics in the second sound. An exemplary implementation may include the receiving module M10310 configured to direct the operation.

For instance, in some implementations, the exemplary operation O103 may include the operation of O10311 for receiving detection of the first event regarding the second sound involving the one or more characteristics as including one or more repetitive sounds. An exemplary implementation may include the receiving module M10311 configured to direct the operation.

For instance, in some implementations, the exemplary operation O103 may include the operation of O10312 for receiving detection of the first event regarding the second sound involving the one or more characteristics as including one or more sounds from one or more machines. An exemplary implementation may include the receiving module M10312 configured to direct the operation.

For instance, in some implementations, the exemplary operation O103 may include the operation of O10313 for receiving detection of the first event regarding the second sound involving the one or more characteristics as including speech from a human. An exemplary implementation may include the receiving module M10313 configured to direct the operation.

For instance, in some implementations, the exemplary operation O103 may include the operation of O10314 for receiving detection of the first event regarding the second sound involving the one or more characteristics as including sound from a living creature. An exemplary implementation may include the receiving module M10314 configured to direct the operation.

For instance, in some implementations, the exemplary operation O103 may include the operation of O10315 for receiving detection of the first event regarding the second sound involving the one or more characteristics as including sound of an engine abnormality. An exemplary implementation may include the receiving module M10315 configured to direct the operation.

For instance, in some implementations, the exemplary operation O103 may include the operation of O10316 for receiving detection of the first event regarding the second sound involving the one or more characteristics as including sound of an emergency warning. An exemplary implementation may include the receiving module M10316 configured to direct the operation.

For instance, in some implementations, the exemplary operation O103 may include the operation of O10317 for receiving detection of the first event regarding the second sound involving the one or more characteristics as including sound of a weather update. An exemplary implementation may include the receiving module M10317 configured to direct the operation.

For instance, in some implementations, the exemplary operation O103 may include the operation of O10318 for receiving, through an electronic signal, detection of the first event regarding the second sound involving one or more characteristics. An exemplary implementation may include the receiving module M10318 configured to direct the operation.

For instance, in some implementations, the exemplary operation O103 may include the operation of O10319 for receiving, through one or more microphones, detection of the first event regarding the second sound involving one or more characteristics. An exemplary implementation may include the receiving module M10319 configured to direct the operation.

For instance, in some implementations, the exemplary operation O103 may include the operation of O10320 for receiving, through an audio signal from an audio device, detection of the first event regarding the second sound involving one or more characteristics. An exemplary implementation may include the receiving module M10320 configured to direct the operation.

For instance, in some implementations, the exemplary operation O103 may include the operation of O10321 for receiving, through a traffic control signal from an emergency vehicle, detection of the first event regarding the second sound involving one or more characteristics. An exemplary implementation may include the receiving module M10321 configured to direct the operation.

For instance, in some implementations, the exemplary operation O103 may include the operation of O10322 for receiving, through performance of a table lookup to compare one or more portions of the second sound with one or more characteristics of sound in a database, detection of the first event regarding the second sound involving one or more characteristics. An exemplary implementation may include the receiving module M10322 configured to direct the operation.

For instance, in some implementations, the exemplary operation O103 may include the operation of O10323 for receiving, through performance of a spectral analysis of the second sound, detection of the first event regarding the second sound involving one or more characteristics. An exemplary implementation may include the receiving module M10323 configured to direct the operation.

For instance, in some implementations, the exemplary operation O103 may include the operation of O10324 for receiving, through an historical log associated with the second sound, detection of the first event regarding the second sound involving one or more characteristics. An exemplary implementation may include the receiving module M10324 configured to direct the operation.

For instance, in some implementations, the exemplary operation O103 may include the operation of O10325 for receiving, through information from an accelerometer, a barometer, a motion detector or a combination thereof, detection of the first event regarding the second sound involving one or more characteristics. An exemplary implementation may include the receiving module M10325 configured to direct the operation.

For instance, in some implementations, the exemplary operation O103 may include the operation of O10326 for receiving detection via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the receiving module M10326 configured to direct the operation.

For instance, in some implementations, the exemplary operation O104 may include the operation of O10401 for receiving the audio signal from one or more radio devices. An exemplary implementation may include the receiving module M10401 configured to direct the operation.

For instance, in some implementations, the exemplary operation O104 may include the operation of O10402 for receiving the audio signal from one or more Internet devices. An exemplary implementation may include the receiving module M10402 configured to direct the operation.

For instance, in some implementations, the exemplary operation O104 may include the operation of O10403 for receiving the audio signal from one or more satellite receiving devices. An exemplary implementation may include the receiving module M10403 configured to direct the operation.

For instance, in some implementations, the exemplary operation O104 may include the operation of O10404 for receiving the audio signal from one or more. An exemplary implementation may include the receiving module M10404 configured to direct the operation.

For instance, in some implementations, the exemplary operation O104 may include the operation of O10405 for receiving the audio signal from one or more computers. An exemplary implementation may include the receiving module M10405 configured to direct the operation.

For instance, in some implementations, the exemplary operation O104 may include the operation of O10406 for receiving the audio signal from one or more iPod devices. An exemplary implementation may include the receiving module M10406 configured to direct the operation.

For instance, in some implementations, the exemplary operation O104 may include the operation of O10407 for receiving the audio signal from one or more personal data for assistant devices. An exemplary implementation may include the receiving module M10407 configured to direct the operation.

For instance, in some implementations, the exemplary operation O104 may include the operation of O10408 for receiving the audio signal from one or more mobile devices. An exemplary implementation may include the receiving module M10408 configured to direct the operation.

For instance, in some implementations, the exemplary operation O104 may include the operation of O10409 for internally receiving, within an electronic device, the audio signal from one or more electronic components of an electronic device. An exemplary implementation may include the receiving module M10409 configured to direct the operation.

For instance, in some implementations, the exemplary operation O104 may include the operation of O10410 for externally receiving, external from an electronic device, the audio signal from one or more electronic components of an electronic device. An exemplary implementation may include the receiving module M10410 configured to direct the operation.

For instance, in some implementations, the exemplary operation O104 may include the operation of O10411 for modifying via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the modifying module M10411 configured to direct the operation.

For instance, in some implementations, the exemplary operation O105 may include the operation of O10501 for modifying the audio signal by auto-tuning the audio signal to the second sound. An exemplary implementation may include the modifying module M10501 configured to direct the operation.

For instance, in some implementations, the exemplary operation O105 may include the operation of O10502 for modifying the audio signal by adjusting the amplitude level of the second sound to track the amplitude level of the second sound. An exemplary implementation may include the modifying module M10502 configured to direct the operation.

For instance, in some implementations, the exemplary operation O105 may include the operation of O10503 for modifying the audio signal to mute the audio signal. An exemplary implementation may include the modifying module M10503 configured to direct the operation.

For instance, in some implementations, the exemplary operation O105 may include the operation of O10504 for modifying the audio signal to attenuate amplitude of the audio signal. An exemplary implementation may include the modifying module M10504 configured to direct the operation.

For instance, in some implementations, the exemplary operation O105 may include the operation of O10505 for modifying the audio signal to amplify the audio signal. An exemplary implementation may include the modifying module M10505 configured to direct the operation.

For instance, in some implementations, the exemplary operation O105 may include the operation of O10506 for transmitting the first generated audio signal to be received by a cell phone. An exemplary implementation may include the transmitting module M10506 configured to direct the operation.

For instance, in some implementations, the exemplary operation O105 may include the operation of O10507 for transmitting the first generated audio signal to be received by an amplifier system. An exemplary implementation may include the transmitting module M10507 configured to direct the operation.

For instance, in some implementations, the exemplary operation O105 may include the operation of O10508 for transmitting the first generated audio signal to be received by a two-way radio. An exemplary implementation may include the transmitting module M10508 configured to direct the operation.

For instance, in some implementations, the exemplary operation O105 may include the operation of O10509 for transmitting the first generated audio signal to be received by a computer. An exemplary implementation may include the transmitting module M10509 configured to direct the operation.

For instance, in some implementations, the exemplary operation O105 may include the operation of O10510 for transmitting the first generated audio signal to control speakers. An exemplary implementation may include the transmitting module M10510 configured to direct the operation.

For instance, in some implementations, the exemplary operation O105 may include the operation of O10511 for transmitting the first generated audio signal to modify an audio signal generated from reception of the first sound. An exemplary implementation may include the transmitting module M10511 configured to direct the operation.

For instance, in some implementations; the exemplary operation O105 may include the operation of O10512 for modifying the first generated audio signal through in part a table lookup of a database. An exemplary implementation may include the modifying module M10512 configured to direct the operation.

For instance, in some implementations, the exemplary operation O105 may include the operation of O10513 for modifying the first generated audio signal through in part a spectral analysis of the first sound. An exemplary implementation may include the modifying module M10513 configured to direct the operation.

For instance, in some implementations, the exemplary operation O105 may include the operation of O10514 for modifying the first generated audio signal through in part a recognition of the first sound. An exemplary implementation may include the modifying module M10514 configured to direct the operation.

For instance, in some implementations, the exemplary operation O105 may include the operation of O10514A for modifying via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the modifying module M10514A configured to direct the operation.

An operational flow O110 as shown represents exemplary operations. Some of the figures may have various examples of operational flows. It should be understood that the operational flows may be executed in a number of environments and contexts, including versions and modified versions of the figures and other versions as well. Furthermore, although the various operational flows are presented in the sequence(s) illustrated, it should be understood that the various operations may be performed in other orders than those which are illustrated, or may be performed concurrently.

In figures that follow, various operations may be depicted in a box-within-a-box manner. Such depictions may indicate that an operation in an internal box may comprise an optional exemplary implementation of the operational step illustrated in one or more external boxes. However, it should be understood that internal box operations may be viewed as independent operations separate from any associated external boxes and may be performed in any sequence with respect to all other illustrated operations, or may be performed concurrently.

The operational flow O110 can move to operation O111 selecting one or more operational states, via at least in part one or more computing devices, based at least in part on receiving the detection of one or more conditions may be executed. An exemplary implementation may include the selecting module M111 configured to direct the operation. For instance, the compute/control 210 of the audio/sound device 200 can select a first operational state such as operation for a house environment based upon receive detection of one or more conditions such as location based upon GPS coordinates.

The operational flow O110 can move to operation O112 receiving detection, via at least in part one or more computing devices, of a first event regarding a first sound involving one or more characteristics in a first manner may be executed. An exemplary implementation may include the receiving module M112 configured to direct the operation. For instance, the compute/control 210 of the audio/sound device 200 can receive detection through the acoustic component 242i of the input/sensing 240 that a first event such as an appearance of a first sound such as a sound of a vacuum cleaner involving one or more characteristics such as a sound pattern of a baby crying in a first manner such as not including the sound pattern of the baby crying.

The operational flow O110 can move to operation O113 receiving detection, via at least in part one or more computing devices, of a first event regarding a second sound involving the one or more characteristics in a second manner other than the first manner may be executed. An exemplary implementation may include the receiving module M113 configured to direct the operation. For instance, the compute/control 210 of the audio/sound device 200 can receive detection through the acoustic component 242i of the input/sensing 240 that a first event such as an appearance of a second sound such as a sound of a baby crying involving one or more characteristics such as a sound pattern of a baby crying in a second manner such as including the sound pattern of the baby crying other than the first manner such as not including the sound pattern of the baby crying.

The operational flow O110 can move to operation O114 conditionally generating, via at least in part one or more computing devices, a first generated audio signal, whether the first generated audio signal is generated being dependent upon which of the one or more operational states has been selected, when generated, the first generated audio signal configured to alter hearing of the first sound by a listener based at least in part on receiving the detection of the first event regarding the first sound involving the one or more characteristics in the first manner may be executed. An exemplary implementation may include the generating module M114 configured to direct the operation. For instance, the compute/control 210 of the audio/sound device 200 can generate a first generated audio signal such as an anti-noise signal to cancel out the hearing of the first sound such as the sound of the vacuum cleaner since the house environment operational state was selected.

The operational flow O110 can move to operation O115 conditionally generating, via at least in part one or more computing devices, a second generated audio signal, whether the second generated audio signal is generated being dependent upon which of the one or more operational states has been selected, when generated, the second generated audio signal configured to alter hearing of the second sound by a listener based at least in part on receiving the detection of the first event regarding the second sound involving the one or more characteristics in the second manner other than the first manner may be executed. An exemplary implementation may include the generating module M115 configured to direct the operation. For instance, the compute/control 210 of the audio/sound device 200 can generate a second generated audio signal such as an amplify signal to amplify the hearing of the second sound such as the sound of the baby crying since the house environment operational state was selected.

The operational flow O110 can move to operation O116 conditionally altering output of an audio device signal, via at least in part one or more computing devices, the altering output of the audio device signal being dependent upon which of the one or more operational states has been selected, when the altering output of the audio device signal occurs, altering output of the audio device signal based at least in part upon receiving the detection of the first event regarding the second sound involving the one or more characteristics in the second manner other than the first manner may be executed. An exemplary implementation may include the altering module M116 configured to direct the operation. For instance, the compute/control 210 of the audio/sound device 200 can attenuate output of an mp3 audio player in order the crying baby can be better heard since the house environment operational state was selected.

Illustrations of various implementations of the exemplary operations O111, O112, O113, O114, and O115 are found in the figures.

For instance, in some implementations, the exemplary operation O111 may include the operation of O11101 for selecting a first set of one or more operational states for first one or more users and selecting a second set of one of more operational states for second one or more users. An exemplary implementation may include the selecting module M11101 configured to direct the operation.

For instance, in some implementations, the exemplary operation O111 may include the operation of O11102 for selecting one or more operational states to give priority for designated sounds to be heard instead of ambient sounds. An exemplary implementation may include the selecting module M11102 configured to direct the operation.

For instance, in some implementations, the exemplary operation O111 may include the operation of O11103 for selecting one or more operational states to give priority for designated sounds to be heard instead of an audio signal. An exemplary implementation may include the selecting module M11103 configured to direct the operation.

For instance, in some implementations, the exemplary operation O111 may include the operation of O11104 for selecting one or more operational states to give priority for audio signals to be heard instead of ambient sounds. An exemplary implementation may include the selecting module M11104 configured to direct the operation.

For instance, in some implementations, the exemplary operation O111 may include the operation of O11105 for selecting one or more operational states to give priority for some sounds to be heard instead of other sounds. An exemplary implementation may include the selecting module M11105 configured to direct the operation.

For instance, in some implementations, the exemplary operation O111 may include the operation of O11106 for selecting one or more operational states based on receiving detection of inertial reference system data. An exemplary implementation may include the selecting module M11106 configured to direct the operation.

For instance, in some implementations, the exemplary operation O111 may include the operation of O11107 for selecting one or more operational states based on receiving detection of barometric pressure data. An exemplary implementation may include the selecting module M11107 configured to direct the operation.

For instance, in some implementations, the exemplary operation O111 may include the operation of O11108 for selecting one or more operational states based on receiving detection of altimeter data. An exemplary implementation may include the selecting module M11108 configured to direct the operation.

For instance, in some implementations, the exemplary operation O111 may include the operation of O11109 for selecting one or more operational states based on receiving detection of accelerometer data. An exemplary implementation may include the selecting module M11109 configured to direct the operation.

For instance, in some implementations, the exemplary operation O111 may include the operation of O11110 for selecting one or more operational states based on receiving detection of compass data. An exemplary implementation may include the selecting module M11110 configured to direct the operation.

For instance, in some implementations, the exemplary operation O111 may include the operation of O11111 for selecting one or more operational states based on receiving detection of mote sensor data. An exemplary implementation may include the selecting module M11111 configured to direct the operation.

For instance, in some implementations, the exemplary operation O111 may include the operation of O11112 for selecting one or more operational states based on receiving detection of ambient sound data. An exemplary implementation may include the selecting module M11112 configured to direct the operation.

For instance, in some implementations, the exemplary operation O111 may include the operation of O11113 for selecting one or more operational states based on receiving detection of one or more user commands. An exemplary implementation may include the selecting module M11113 configured to direct the operation.

For instance, in some implementations, the exemplary operation O111 may include the operation of O11114 for selecting one or more operational states based on receiving detection of instant messaging data. An exemplary implementation may include the selecting module M11114 configured to direct the operation.

For instance, in some implementations, the exemplary operation O111 may include the operation of O11115 for selecting one or more operational states based on receiving detection of ambient lighting data. An exemplary implementation may include the selecting module M11115 configured to direct the operation.

For instance, in some implementations, the exemplary operation O111 may include the operation of O11116 for selecting one or more operational states based on receiving detection of cell phone data. An exemplary implementation may include the selecting module M11116 configured to direct the operation.

For instance, in some implementations, the exemplary operation O111 may include the operation of O11117 for selecting one or more operational states based on receiving detection of Bluetooth data. An exemplary implementation may include the selecting module M11117 configured to direct the operation.

For instance, in some implementations, the exemplary operation O111 may include the operation of O11118 for selecting one or more operational states based on receiving detection of service set identifier (SSID) data. An exemplary implementation may include the selecting module M11118 configured to direct the operation.

For instance, in some implementations, the exemplary operation O111 may include the operation of O11119 for selecting one or more operational states based on receiving detection of time zone data. An exemplary implementation may include the selecting module M11119 configured to direct the operation.

For instance, in some implementations, the exemplary operation O111 may include the operation of O11120 for selecting one or more operational states based on receiving detection of time of day data. An exemplary implementation may include the selecting module M11120 configured to direct the operation.

For instance, in some implementations, the exemplary operation O111 may include the operation of O11121 for selecting one or more operational states based on receiving detection of calendar data. An exemplary implementation may include the selecting module M11121 configured to direct the operation.

For instance, in some implementations, the exemplary operation O111 may include the operation of O11122 for selecting one or more operational states based on receiving detection of one or more spoken words. An exemplary implementation may include the selecting module M11122 configured to direct the operation.

For instance, in some implementations, the exemplary operation O111 may include the operation of O11123 for selecting one or more operational states based on receiving detection of Doppler data. An exemplary implementation may include the selecting module M11123 configured to direct the operation.

For instance, in some implementations, the exemplary operation O111 may include the operation of O11124 for selecting one or more operational states based on receiving detection of one or more location data. An exemplary implementation may include the selecting module M11124 configured to direct the operation.

For instance, in some implementations, the exemplary operation O111 may include the operation of O11125 for selecting one or more operational states based on receiving detection of global positioning system data. An exemplary implementation may include the selecting module M11125 configured to direct the operation.

For instance, in some implementations, the exemplary operation O111 may include the operation of O11126 for selecting one or more operational states based on receiving detection of an activation of a touch control. An exemplary implementation may include the selecting module M11126 configured to direct the operation.

For instance, in some implementations, the exemplary operation O111 may include the operation of O11127 for selecting one or more operational states based on receiving detection of a presence of a traffic control signal. An exemplary implementation may include the selecting module M11127 configured to direct the operation.

For instance, in some implementations, the exemplary operation O111 may include the operation of O11128 for selecting one or more operational states based on receiving detection of a presence of one or more radar sensing signals. An exemplary implementation may include the selecting module M11128 configured to direct the operation.

For instance, in some implementations, the exemplary operation O111 may include the operation of O11129 for selecting one or more operational states based on receiving detection of a presence of one or more laser sensing signals. An exemplary implementation may include the selecting module M11129 configured to direct the operation.

For instance, in some implementations, the exemplary operation O111 may include the operation of O11130 for selecting one or more operational states based on receiving detection of one or more changes in historically monitored data. An exemplary implementation may include the selecting module M11130 configured to direct the operation.

For instance, in some implementations, the exemplary operation O111 may include the operation of O11131 for selecting one or more operational states based on receiving the detection of one or more conditions from one or more mote sensors. An exemplary implementation may include the selecting module M11131 configured to direct the operation.

For instance, in some implementations, the exemplary operation O111 may include the operation of O11132 for selecting via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the selecting module M11132 configured to direct the operation.

For instance, in some implementations, the exemplary operation O112 may include the operation of O11201 for receiving the first sound from an ambient environment. An exemplary implementation may include the receiving module M11201 configured to direct the operation.

For instance, in some implementations, the exemplary operation O112 may include the operation of O11202 for receiving the first sound as a monitored sound. An exemplary implementation may include the receiving module M11202 configured to direct the operation.

For instance, in some implementations, the exemplary operation O112 may include the operation of O11203 for receiving the first sound from a coupled audio device. An exemplary implementation may include the receiving module M11203 configured to direct the operation.

For instance, in some implementations, the exemplary operation O112 may include the operation of O11204 for receiving the first sound from one or more speakers. An exemplary implementation may include the receiving module M11204 configured to direct the operation.

For instance, in some implementations, the exemplary operation O112 may include the operation of O11205 for receiving the first sound with one or more microphones. An exemplary implementation may include the receiving module M11205 configured to direct the operation.

For instance, in some implementations, the exemplary operation O112 may include the operation of O11206 for receiving the first sound with one or more electronic connections. An exemplary implementation may include the receiving module M11206 configured to direct the operation.

For instance, in some implementations, the exemplary operation O112 may include the operation of O11207 for receiving the first sound from one or more speakers. An exemplary implementation may include the receiving module M11207 configured to direct the operation.

For instance, in some implementations, the exemplary operation O21 may include the operation of O11207A for receiving detection of the first event regarding the first sound in a first manner that is opposite to the second manner. An exemplary implementation may include the receiving module M11207A configured to direct the operation.

For instance, in some implementations, the exemplary operation O112 may include the operation of O11208 for receiving detection of the first event regarding the first sound as an absence of the one or more characteristics in the first sound. An exemplary implementation may include the receiving module M11208 configured to direct the operation.

For instance, in some implementations, the exemplary operation O112 may include the operation of O11209 for receiving detection of the first event regarding the first sound as a change of the one or more characteristics in the first sound. An exemplary implementation may include the receiving module M11209 configured to direct the operation.

For instance, in some implementations, the exemplary operation O112 may include the operation of O11210 for receiving detection of the first event regarding the first sound as an appearance of the one or more characteristics in the first sound. An exemplary implementation may include the receiving module M11210 configured to direct the operation.

For instance, in some implementations, the exemplary operation O112 may include the operation of O11211 for receiving detection of the first event regarding the first sound involving the one or more characteristics as including one or more repetitive sounds. An exemplary implementation may include the receiving module M11211 configured to direct the operation.

For instance, in some implementations, the exemplary operation O112 may include the operation of O11212 for receiving detection of the first event regarding the first sound involving the one or more characteristics as including one or more sounds from one or more machines. An exemplary implementation may include the receiving module M11212 configured to direct the operation.

For instance, in some implementations, the exemplary operation O112 may include the operation of O11213 for receiving detection of the first event regarding the first sound involving the one or more characteristics as including speech from a human. An exemplary implementation may include the receiving module M11213 configured to direct the operation.

For instance, in some implementations, the exemplary operation O112 may include the operation of O11214 for receiving detection of the first event regarding the first sound involving the one or more characteristics as including sound from a living creature. An exemplary implementation may include the receiving module M11214 configured to direct the operation.

For instance, in some implementations, the exemplary operation O112 may include the operation of O11215 for receiving detection of the first event regarding the first sound involving the one or more characteristics as including sound of an engine abnormality. An exemplary implementation may include the receiving module M11215 configured to direct the operation.

For instance, in some implementations, the exemplary operation O112 may include the operation of O11216 for receiving detection of the first event regarding the first sound involving the one or more characteristics as including sound of an emergency warning. An exemplary implementation may include the receiving module M11216 configured to direct the operation.

For instance, in some implementations, the exemplary operation O112 may include the operation of O11217 for receiving detection of the first event regarding the first sound involving the one or more characteristics as including sound of a weather update. An exemplary implementation may include the receiving module M11217 configured to direct the operation.

For instance, in some implementations, the exemplary operation O112 may include the operation of O11218 for receiving, through an electronic signal, detection of the first event regarding the first sound involving one or more characteristics. An exemplary implementation may include the receiving module M11218 configured to direct the operation.

For instance, in some implementations, the exemplary operation O112 may include the operation of O11219 for receiving, through one or more microphones, detection of the first event regarding the first sound involving one or more characteristics. An exemplary implementation may include the receiving module M11219 configured to direct the operation.

For instance, in some implementations, the exemplary operation O112 may include the operation of O11220 for receiving, through an audio signal from an audio device, detection of the first event regarding the first sound involving one or more characteristics. An exemplary implementation may include the receiving module M11220 configured to direct the operation.

For instance, in some implementations, the exemplary operation O112 may include the operation of O11221 for receiving, through a traffic control signal from an emergency vehicle, detection of the first event regarding the first sound involving one or more characteristics. An exemplary implementation may include the receiving module M11221 configured to direct the operation.

For instance, in some implementations, the exemplary operation O112 may include the operation of O11222 for receiving, through performance of a table lookup to compare one or more portions of the first sound with one or more characteristics of sound in a database, detection of the first event regarding the first sound involving one or more characteristics. An exemplary implementation may include the receiving module M11222 configured to direct the operation.

For instance, in some implementations, the exemplary operation O112 may include the operation of O11222 for receiving, through performance of a spectral analysis of the first sound, detection of the first event regarding the first sound involving one or more characteristics. An exemplary implementation may include the receiving module M11222 configured to direct the operation.

For instance, in some implementations, the exemplary operation O112 may include the operation of O11224 for receiving, through an historical log associated with the first sound, detection of the first event regarding the first sound involving one or more characteristics. An exemplary implementation may include the receiving module M11224 configured to direct the operation.

For instance, in some implementations, the exemplary operation O112 may include the operation of O11225 for receiving, through information from an accelerometer, a barometer, a motion detector or a combination thereof, detection of the first event regarding the first sound involving one or more characteristics. An exemplary implementation may include the receiving module M11225 configured to direct the operation.

For instance, in some implementations, the exemplary operation O112 may include the operation of O11226 for receiving detection via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the receiving module M11226 configured to direct the operation.

For instance, in some implementations, the exemplary operation O113 may include the operation of O11301 for receiving the second sound from an ambient environment. An exemplary implementation may include the receiving module M11301 configured to direct the operation.

For instance, in some implementations, the exemplary operation O113 may include the operation of O11302 for receiving the second sound as a monitored sound. An exemplary implementation may include the receiving module M11302 configured to direct the operation.

For instance, in some implementations, the exemplary operation O113 may include the operation of O11303 for receiving the second sound from a coupled audio device. An exemplary implementation may include the receiving module M11303 configured to direct the operation.

For instance, in some implementations, the exemplary operation O113 may include the operation of O11304 for receiving the second sound from one or more speakers. An exemplary implementation may include the receiving module M11304 configured to direct the operation.

For instance, in some implementations, the exemplary operation O113 may include the operation of O11305 for receiving the second sound with one or more microphones. An exemplary implementation may include the receiving module M11305 configured to direct the operation.

For instance, in some implementations, the exemplary operation O113 may include the operation of O11306 for receiving the second sound with one or more electronic connections. An exemplary implementation may include the receiving module M11306 configured to direct the operation.

For instance, in some implementations, the exemplary operation O113 may include the operation of O11307 for receiving the second sound from one or more speakers. An exemplary implementation may include the receiving module M11307 configured to direct the operation.

For instance, in some implementations, the exemplary operation O113 may include the operation of O11308 for receiving detection of the first event regarding the second sound as an absence of the one or more characteristics in the second sound. An exemplary implementation may include the receiving module M11308 configured to direct the operation.

For instance, in some implementations, the exemplary operation O113 may include the operation of O11309 for receiving detection of the first event regarding the second sound as a change of the one or more characteristics in the second sound. An exemplary implementation may include the receiving module M11309 configured to direct the operation.

For instance, in some implementations, the exemplary operation O113 may include the operation of O11310 for receiving detection of the first event regarding the second sound as an appearance of the one or more characteristics in the second sound. An exemplary implementation may include the receiving module M11310 configured to direct the operation.

For instance, in some implementations, the exemplary operation O113 may include the operation of O11311 for receiving detection of the first event regarding the second sound involving the one or more characteristics as including one or more repetitive sounds. An exemplary implementation may include the receiving module M11311 configured to direct the operation.

For instance, in some implementations, the exemplary operation O113 may include the operation of O11312 for receiving detection of the first event regarding the second sound involving the one or more characteristics as including one or more sounds from one or more machines. An exemplary implementation may include the receiving module M11312 configured to direct the operation.

For instance, in some implementations, the exemplary operation O113 may include the operation of O11313 for receiving detection of the first event regarding the second sound involving the one or more characteristics as including speech from a human. An exemplary implementation may include the receiving module M11313 configured to direct the operation.

For instance, in some implementations, the exemplary operation O113 may include the operation of O11314 for receiving detection of the first event regarding the second sound involving the one or more characteristics as including sound from a living creature. An exemplary implementation may include the receiving module M11314 configured to direct the operation.

For instance, in some implementations, the exemplary operation O113 may include the operation of O11315 for receiving detection of the first event regarding the second sound involving the one or more characteristics as including sound of an engine abnormality. An exemplary implementation may include the receiving module M11315 configured to direct the operation.

For instance, in some implementations, the exemplary operation O113 may include the operation of O11316 for receiving detection of the first event regarding the second sound involving the one or more characteristics as including sound of an emergency warning. An exemplary implementation may include the receiving module M11316 configured to direct the operation.

For instance, in some implementations, the exemplary operation O113 may include the operation of O11317 for receiving detection of the first event regarding the second sound involving the one or more characteristics as including sound of a weather update. An exemplary implementation may include the receiving module M11317 configured to direct the operation.

For instance, in some implementations, the exemplary operation O113 may include the operation of O11318 for receiving, through an electronic signal, detection of the first event regarding the second sound involving one or more characteristics. An exemplary implementation may include the receiving module M11318 configured to direct the operation.

For instance, in some implementations, the exemplary operation O113 may include the operation of O11319 for receiving, through one or more microphones, detection of the first event regarding the second sound involving one or more characteristics. An exemplary implementation may include the receiving module M11319 configured to direct the operation.

For instance, in some implementations, the exemplary operation O113 may include the operation of O11320 for receiving, through an audio signal from an audio device, detection of the first event regarding the second sound involving one or more characteristics. An exemplary implementation may include the receiving module M11320 configured to direct the operation.

For instance, in some implementations, the exemplary operation O113 may include the operation of O11321 for receiving, through a traffic control signal from an emergency vehicle, detection of the first event regarding the second sound involving one or more characteristics. An exemplary implementation may include the receiving module M11321 configured to direct the operation.

For instance, in some implementations, the exemplary operation O113 may include the operation of O11322 for receiving, through performance of a table lookup to compare one or more portions of the second sound with one or more characteristics of sound in a database, detection of the first event regarding the second sound involving one or more characteristics. An exemplary implementation may include the receiving module M11322 configured to direct the operation.

For instance, in some implementations, the exemplary operation O113 may include the operation of O11323 for receiving, through performance of a spectral analysis of the second sound, detection of the first event regarding the second sound involving one or more characteristics. An exemplary implementation may include the receiving module M11323 configured to direct the operation.

For instance, in some implementations, the exemplary operation O113 may include the operation of O11324 for receiving, through an historical log associated with the second sound, detection of the first event regarding the second sound involving one or more characteristics. An exemplary implementation may include the receiving module M11324 configured to direct the operation.

For instance, in some implementations, the exemplary operation O113 may include the operation of O11325 for receiving, through information from an accelerometer, a barometer, a motion detector or a combination thereof, detection of the first event regarding the second sound involving one or more characteristics. An exemplary implementation may include the receiving module M11325 configured to direct the operation.

For instance, in some implementations, the exemplary operation O113 may include the operation of O11326 for receiving detection via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the receiving module M11326 configured to direct the operation.

For instance, in some implementations, the exemplary operation O114 may include the operation of O11401 for conditionally generating the first generated audio signal to mute the first sound heard by the listener based at least in part on receiving the detection of the first event regarding the first sound involving the one or more characteristics in the first manner. An exemplary implementation may include the generating module M11401 configured to direct the operation.

For instance, in some implementations, the exemplary operation O114 may include the operation of O11402 for conditionally, generating the first generated audio signal to be received to emit sound opposite in form to the first sound from speakers positioned to cancel amplitude of the first sound heard by the listener. An exemplary implementation may include the generating module M11402 configured to direct the operation.

For instance, in some implementations, the exemplary operation O114 may include the operation of O11403 for conditionally generating the first generated audio signal to be received to emit sound from speakers positioned to attenuate amplitude of the first sound heard by the listener. An exemplary implementation may include the generating module M11403 configured to direct the operation.

For instance, in some implementations, the exemplary operation O114 may include the operation of O11404 for conditionally generating the first generated audio signal to be received by a cell phone. An exemplary implementation may include the generating module M11404 configured to direct the operation.

For instance, in some implementations, the exemplary operation O114 may include the operation of O11405 for conditionally generating the first generated audio signal to be received by an amplifier system. An exemplary implementation may include the generating module M11405 configured to direct the operation.

For instance, in some implementations, the exemplary operation O114 may include the operation of O11406 for conditionally generating the first generated audio signal to be received by a two-way radio. An exemplary implementation may include the generating module M11406 configured to direct the operation.

For instance, in some implementations, the exemplary operation O114 may include the operation of O11407 for conditionally generating the first generated audio signal to be received by a computer. An exemplary implementation may include the generating module M11407 configured to direct the operation.

For instance, in some implementations, the exemplary operation O114 may include the operation of O11408 for conditionally generating the first generated audio signal to control speakers. An exemplary implementation may include the generating module M11408 configured to direct the operation.

For instance, in some implementations, the exemplary operation O114 may include the operation of O11409 for conditionally generating the first generated audio signal to modify an audio signal generated from reception of the first sound. An exemplary implementation may include the generating module M11409 configured to direct the operation.

For instance, in some implementations, the exemplary operation O114 may include the operation of O11410 for conditionally generating the first generated audio signal through in part a table lookup of a database. An exemplary implementation may include the generating module M11410 configured to direct the operation.

For instance, in some implementations, the exemplary operation O114 may include the operation of O11411 for conditionally generating the first generated audio signal through in part a spectral analysis of the first sound. An exemplary implementation may include the generating module M11411 configured to direct the operation.

For instance, in some implementations, the exemplary operation O114 may include the operation of O11412 for conditionally generating the first generated audio signal through in part a recognition of the first sound. An exemplary implementation may include the generating module M11412 configured to direct the operation.

For instance, in some implementations, the exemplary operation O114 may include the operation of O11413 for conditionally generating via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the generating module M11413 configured to direct the operation.

For instance, in some implementations, the exemplary operation O115 may include the operation of O11501 for conditionally generating the second generated audio signal to mute the second sound heard by the listener based at least in part on receiving the detection of the first event regarding the second sound involving the one or more characteristics in the second manner other than the first manner. An exemplary implementation may include the generating module M11501 configured to direct the operation.

For instance, in some implementations, the exemplary operation O115 may include the operation of O11502 for conditionally, generating the second generated audio signal to be received to emit sound opposite in form to the second sound from speakers positioned to cancel amplitude of the second sound heard by the listener based at least in part on receiving the detection of the first event regarding the second sound involving the one or more characteristics in the second manner other than the first manner. An exemplary implementation may include the generating module M11502 configured to direct the operation.

For instance, in some implementations, the exemplary operation O115 may include the operation of O11503 for conditionally generating the second generated audio signal to be received to emit sound from speakers positioned to attenuate amplitude of the second sound heard by the listener based at least in part on receiving the detection of the first event regarding the second sound involving the one or more characteristics in the second manner other than the first manner. An exemplary implementation may include the generating module M11503 configured to direct the operation.

For instance, in some implementations, the exemplary operation O115 may include the operation of O11504 for conditionally generating the second generated audio signal to be received by a cell phone. An exemplary implementation may include the generating module M11504 configured to direct the operation.

For instance, in some implementations, the exemplary operation O115 may include the operation of O11505 for conditionally generating the second generated audio signal to be received by an amplifier system. An exemplary implementation may include the generating module M11505 configured to direct the operation.

For instance, in some implementations, the exemplary operation O115 may include the operation of O11506 for conditionally generating the second generated audio signal to be received by a two-way radio. An exemplary implementation may include the generating module M11506 configured to direct the operation.

For instance, in some implementations, the exemplary operation O115 may include the operation of O11507 for conditionally generating the second generated audio signal to be received by a computer. An exemplary implementation may include the generating module M11507 configured to direct the operation.

For instance, in some implementations, the exemplary operation O115 may include the operation of O11508 for conditionally generating the second generated audio signal to control speakers. An exemplary implementation may include the generating module M11508 configured to direct the operation.

For instance, in some implementations, the exemplary operation O115 may include the operation of O11509 for conditionally generating the second generated audio signal to modify an audio signal generated from reception of the second sound. An exemplary implementation may include the generating module M11509 configured to direct the operation.

For instance, in some implementations, the exemplary operation O115 may include the operation of O11510 for conditionally generating the second generated audio signal through in part a table lookup of a database. An exemplary implementation may include the generating module M11510 configured to direct the operation.

For instance, in some implementations, the exemplary operation O115 may include the operation of O11511 for conditionally generating the second generated audio signal through in part a spectral analysis of the second sound. An exemplary implementation may include the generating module M11511 configured to direct the operation.

For instance, in some implementations, the exemplary operation O115 may include the operation of O11512 for conditionally generating the second generated audio signal through in part a recognition of the second sound. An exemplary implementation may include the generating module M11512 configured to direct the operation.

For instance, in some implementations, the exemplary operation O115 may include the operation of O11513 for conditionally generating via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the generating module M11513 configured to direct the operation.

For instance, in some implementations, the exemplary operation O116 may include the operation of O11601 for conditionally altering the output of the audio device signal by adjusting the amplitude level of the second sound to track the amplitude level of the second sound. An exemplary implementation may include the altering module M11601 configured to direct the operation.

For instance, in some implementations, the exemplary operation O116 may include the operation of O11602 for conditionally altering the output of the audio device signal by muting the audio device signal. An exemplary implementation may include the altering module M11602 configured to direct the operation.

For instance, in some implementations, the exemplary operation O116 may include the operation of O11603 for conditionally altering the output of the audio device signal by attenuating amplitude of the audio device signal. An exemplary implementation may include the altering module M11603 configured to direct the operation.

For instance, in some implementations, the exemplary operation O116 may include the operation of O11604 for conditionally altering the output of the audio device signal by amplifying the audio device signal. An exemplary implementation may include the altering module M11604 configured to direct the operation.

For instance, in some implementations, the exemplary operation O116 may include the operation of O11605 for conditionally altering the output of the audio device signal to be received by a cell phone. An exemplary implementation may include the altering module M11605 configured to direct the operation.

For instance, in some implementations, the exemplary operation O116 may include the operation of O11606 for conditionally altering the output of the audio device signal to be received by an amplifier system. An exemplary implementation may include the altering module M11606 configured to direct the operation.

For instance, in some implementations, the exemplary operation O116 may include the operation of O11607 for conditionally altering the output of the audio device signal to be received by a two-way radio. An exemplary implementation may include the altering module M11607 configured to direct the operation.

For instance, in some implementations, the exemplary operation O116 may include the operation of O11608 for conditionally altering the output of the audio device signal to be received by a computer. An exemplary implementation may include the altering module M11608 configured to direct the operation.

For instance, in some implementations, the exemplary operation O116 may include the operation of O11609 for conditionally altering the output of the audio device signal to control speakers. An exemplary implementation may include the altering module M11609 configured to direct the operation.

For instance, in some implementations, the exemplary operation O116 may include the operation of O11610 for conditionally altering the output of the audio device signal through in part a table lookup of a database. An exemplary implementation may include the altering module M11610 configured to direct the operation.

For instance, in some implementations, the exemplary operation O116 may include the operation of O11611 for conditionally altering the output of the audio device signal through in part a spectral analysis of the first sound. An exemplary implementation may include the altering module M11611 configured to direct the operation.

For instance, in some implementations, the exemplary operation O116 may include the operation of O11612 for conditionally altering the output of the audio device signal through in part a recognition of the second sound. An exemplary implementation may include the altering module M11612 configured to direct the operation.

For instance, in some implementations, the exemplary operation O116 may include the operation of O11613 for conditionally altering via the one or more computing devices including one or more processors, one or more central processing units, one or more digital signal processors, one or more application specific integrated circuits, one or more field programmable gate arrays, one or more controllers, one or more microprocessors, or a combination thereof. An exemplary implementation may include the altering module M11613 configured to direct the operation.

### CONCLUSION

This disclosure provides a number of embodiments of the audio/sound device 100. The embodiments of the audio/sound as described with respect to this disclosure are intended to be illustrative in nature, and not limiting its scope.

Those having skill in the art will recognize that the state of the art in computer, controller, communications, networking, and other similar technologies has progressed to the point where there is little distinction left between hardware, firmware, and/or software implementations of aspects of systems, such as may be utilized in certain embodiments of the audio/sound device. The use of hardware, firmware, and/or software can therefore generally represent (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle can vary with the context in which the processes and/or systems and/or other technologies are deployed. For example, if an implementer determines that speed and accuracy are paramount, the implementer and/or designer of certain embodiments of the audio/sound device may opt for mainly a hardware and/or firmware vehicle. In alternate embodiments, if flexibility is paramount, the implementer and/or designer may opt for mainly a software implementation. In yet other embodiments, the implementer and/or designer may opt for some combination of hardware, software, and/or firmware. Hence, there are several possible techniques by which the processes and/or devices and/or other technologies described herein may be effected, none of which is inherently superior to the other in that any vehicle to be utilized is a choice dependent upon the context in which the personalized device can be deployed and the specific concerns (e.g., speed, flexibility, or predictability) of the implementer, any of which may vary.

The foregoing detailed description has set forth various embodiments of the devices and/or processes via the use of block diagrams, flowcharts, and/or examples.

Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), Digital Signal Processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

All of the above U.S. patents, U.S. patent application publications, U.S. patent applications, foreign patents, foreign patent applications and non-patent publications referred to in this specification and/or listed in any Application Data Sheet, are incorporated herein by reference, in their entireties.

It is to be understood by those skilled in the art that, in general, the terms used in the disclosure, including the drawings and the appended claims (and especially as used in the bodies of the appended claims), are generally intended as “open” terms. For example, the term “including” should be interpreted as “including but not limited to”; the term “having” should be interpreted as “having at least”; and the term “includes” should be interpreted as “includes, but is not limited to”; etc. In this disclosure and the appended claims, the terms “a”, “the”, and “at least one” positioned prior to one or more goods, items, and/or services are intended to apply inclusively to either one or a plurality of those goods, items, and/or services.

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that could have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that could have A alone, B alone, C alone, A and B together, A and C together, B and C together, and/or A, B, and C together, etc.).

Those skilled in the art will appreciate that the herein-described specific exemplary processes and/or devices and/or technologies are representative of more general processes and/or devices and/or technologies taught elsewhere herein, such as in the claims filed herewith and/or elsewhere in the present application.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method comprising:
receiving detection, via at least in part one or more computing devices, of a first event regarding a first sound involving one or more characteristics;
recording first audio information at a first original recording rate from an audio device based at least in part upon receiving the detection of a first event regarding a first sound involving one or more characteristics;
receiving detection, via at least in part one or more computing devices, of a second event regarding the first sound;
recording second audio information at a second original recording rate from the audio device based at least in part upon the receiving detection of the second event regarding the first sound;
outputting at a rate faster than the first original recording rate the recording of the first audio information based at least in part upon receiving detection of the second event regarding the first sound; and
outputting at a rate faster than the second original recording rate the recording of the second audio information based at least in part upon completion of the outputting of the first audio information.

2.-1037. (canceled)

1038. A system comprising:
circuitry for receiving detection, via at least in part one or more computing devices, of a first event regarding a first sound involving one or more characteristics;
circuitry for recording first audio information at a first original recording rate from an audio device based at least in part upon receiving the detection of a first event regarding a first sound involving one or more characteristics;
circuitry for receiving detection, via at least in part one or more computing devices, of a second event regarding the first sound;
circuitry for recording second audio information at a second original recording rate from the audio device based at least in part upon the receiving detection of the second event regarding the first sound;
circuitry for outputting at a rate faster than the first original recording rate the recording of the first audio information based at least in part upon receiving detection of the second event regarding the first sound; and
circuitry for outputting at a rate faster than the second original recording rate the recording of the second audio information based at least in part upon completion of the outputting of the first audio information.

1039. The system of claim 1038 wherein circuitry for receiving detection, via at least in part one or more computing devices, of a first event regarding a first sound involving one or more characteristics comprises:
circuitry for receiving the first sound from an ambient environment.

1040. (canceled)

1041. The system of claim 1038 wherein circuitry for receiving detection, via at least in part one or more computing devices, of a first event regarding a first sound involving one or more characteristics comprises:
circuitry for receiving the first sound from a coupled audio device.

1042. The system of claim 1038 wherein circuitry for receiving detection, via at least in part one or more computing devices, of a first event regarding a first sound involving one or more characteristics comprises:
circuitry for receiving the first sound from one or more speakers.

1043. (canceled)

1044. The system of claim 1038 wherein circuitry for receiving detection, via at least in part one or more computing devices, of a first event regarding a first sound involving one or more characteristics comprises:
circuitry for receiving the first sound with one or more electronic connections.

1045. (canceled)

1046. The system of claim 1038 wherein circuitry for receiving detection, via at least in part one or more computing devices, of a first event regarding a first sound involving one or more characteristics comprises:
circuitry for receiving detection of the first event regarding the first sound as a change of the one or more characteristics in the first sound.

1047. (canceled)

1048. The system of claim 1038 wherein circuitry for receiving detection, via at least in part one or more computing devices, of a first event regarding a first sound involving one or more characteristics comprises:
circuitry for receiving detection of the first event regarding the first sound involving the one or more characteristics as including one or more repetitive sounds.

1049. (canceled)

1050. The system of claim 1038 wherein circuitry for receiving detection, via at least in part one or more computing devices, of a first event regarding a first sound involving one or more characteristics comprises:
circuitry for receiving detection of the first event regarding the first sound involving the one or more characteristics as including speech from a human.

1051. The system of claim 1038 wherein circuitry for receiving detection, via at least in part one or more computing devices, of a first event regarding a first sound involving one or more characteristics comprises:
circuitry for receiving detection of the first event regarding the first sound involving the one or more characteristics as including sound from a living creature.

1052. (canceled)

1053. The system of claim 1038 wherein circuitry for receiving detection, via at least in part one or more computing devices, of a first event regarding a first sound involving one or more characteristics comprises:
circuitry for receiving detection of the first event regarding the first sound involving the one or more characteristics as including sound of an emergency warning.

1054. (canceled)

1055. The system of claim 1038 wherein circuitry for receiving detection, via at least in part one or more computing devices, of a first event regarding a first sound involving one or more characteristics comprises:
circuitry for receiving, through an electronic signal, detection of the first event regarding the first sound involving one or more characteristics.

1056. (canceled)

1057. The system of claim 1038 wherein circuitry for receiving detection, via at least in part one or more computing devices, of a first event regarding a first sound involving one or more characteristics comprises:
circuitry for receiving, through an audio signal from an audio device, detection of the first event regarding the first sound involving one or more characteristics.

1058. (canceled)

1059. The system of claim 1038 wherein circuitry for receiving detection, via at least in part one or more computing devices, of a first event regarding a first sound involving one or more characteristics comprises:
circuitry for receiving, through performance of a table lookup to compare one or more portions of the first sound with one or more characteristics of sound in a database, detection of the first event regarding the first sound involving one or more characteristics.

1060. (canceled)

1061. The system of claim 1038 wherein circuitry for receiving detection, via at least in part one or more computing devices, of a first event regarding a first sound involving one or more characteristics comprises:
circuitry for receiving, through an historical log associated with the first sound, detection of the first event regarding the first sound involving one or more characteristics.

1062. (canceled)

1063. The system of claim 1038 wherein circuitry for receiving detection, via at least in part one or more computing devices, of a first event regarding a first sound involving one or more characteristics comprises:
circuitry for receiving detection via the one or more computing devices including one or more processors, one or more central processing units, one or more digital signal processors, one or more application specific integrated circuits, one or more field programmable gate arrays, one or more controllers, one or more microprocessors, or a combination thereof.

1064. (canceled)

1065. The system of claim 1038 wherein circuitry for recording first audio information at a first original recording rate from an audio device based at least in part upon receiving the detection of a first event regarding a first sound involving one or more characteristics comprises:
circuitry for recording the first audio information from a podcast being received by the audio device.

1066. (canceled)

1067. The system of claim 1038 wherein circuitry for recording first audio information at a first original recording rate from an audio device based at least in part upon receiving the detection of a first event regarding a first sound involving one or more characteristics comprises:
circuitry for recording the first audio information at the first original recording rate as a real time recording rate.

1068. (canceled)

1069. The system of claim 1038 wherein circuitry for recording first audio information at a first original recording rate from an audio device based at least in part upon receiving the detection of a first event regarding a first sound involving one or more characteristics comprises:
circuitry for recording the first audio information as human speech.

1070. (canceled)

1071. The system of claim 1038 wherein circuitry for recording first audio information at a first original recording rate from an audio device based at least in part upon receiving the detection of a first event regarding a first sound involving one or more characteristics comprises:
circuitry for recording the first audio information to an electronic memory.

1072. (canceled)

1073. The system of claim 1038 wherein circuitry for recording first audio information at a first original recording rate from an audio device based at least in part upon receiving the detection of a first event regarding a first sound involving one or more characteristics comprises:
circuitry for recording the first audio information from the audio device being located in a vehicle.

1074. (canceled)

1075. The system of claim 1038 wherein circuitry for receiving detection, via at least in part one or more computing devices, of a second event regarding the first sound comprises:
circuitry for receiving the first sound as a monitored sound.

1076. (canceled)

1077. The system of claim 1038 wherein circuitry for receiving detection, via at least in part one or more computing devices, of a second event regarding the first sound comprises:
circuitry for receiving the first sound from one or more networks.

1078. The system of claim 1038 wherein circuitry for receiving detection, via at least in part one or more computing devices, of a second event regarding the first sound comprises:
circuitry for receiving the first sound with one or more microphones.

1079. (canceled)

1080. (canceled)

1081. The system of claim 1038 wherein circuitry for receiving detection, via at least in part one or more computing devices, of a second event regarding the first sound comprises:
circuitry for receiving detection of the second event regarding the first sound as an absence of the one or more characteristics in the first sound.

1082. (canceled)

1083. The system of claim 1038 wherein circuitry for receiving detection, via at least in part one or more computing devices, of a second event regarding the first sound comprises:
circuitry for receiving detection of the second event regarding the first sound as an appearance of the one or more characteristics in the first sound.

1084. (canceled)

1085. The system of claim 1038 wherein circuitry for receiving detection, via at least in part one or more computing devices, of a second event regarding the first sound comprises:
circuitry for receiving detection of the second event regarding the first sound involving the one or more characteristics as including one or more sounds from one or more machines.

1086. (canceled)

1087. (canceled)

1088. The system of claim 1038 wherein circuitry for receiving detection, via at least in part one or more computing devices, of a second event regarding the first sound comprises:
circuitry for receiving detection of the second event regarding the first sound involving the one or more characteristics as including sound of an engine abnormality.

1089. (canceled)

1090. The system of claim 1038 wherein circuitry for receiving detection, via at least in part one or more computing devices, of a second event regarding the first sound comprises:
circuitry for receiving detection of the second event regarding the first sound involving the one or more characteristics as including sound of a weather update.

1091. (canceled)

1092. The system of claim 1038 wherein circuitry for receiving detection, via at least in part one or more computing devices, of a second event regarding the first sound comprises:
circuitry for receiving, through one or more microphones, detection of the second event regarding the first sound involving one or more characteristics.

1093. (canceled)

1094. The system of claim 1038 wherein circuitry for receiving detection, via at least in part one or more computing devices, of a second event regarding the first sound comprises:
circuitry for receiving, through a traffic control signal from an emergency vehicle, detection of the second event regarding the first sound involving one or more characteristics.

1095. (canceled)

1096. The system of claim 1038 wherein circuitry for receiving detection, via at least in part one or more computing devices, of a second event regarding the first sound comprises:
circuitry for receiving, through performance of a spectral analysis of the first sound, detection of the second event regarding the first sound involving one or more characteristics.

1097. (canceled)

1098. The system of claim 1038 wherein circuitry for receiving detection, via at least in part one or more computing devices, of a second event regarding the first sound comprises:
circuitry for receiving, through information from an accelerometer, a barometer, a motion detector or a combination thereof, detection of the second event regarding the first sound involving one or more characteristics.

1099. (canceled)

1100. The system of claim 1038 wherein circuitry for recording second audio information at a second original recording rate from the audio device based at least in part upon the receiving detection of the second event regarding the first sound comprises:
circuitry for recording the second audio information from a radio broadcast being received by the audio device.

1101. (canceled)

1102. The system of claim 1038 wherein circuitry for recording second audio information at a second original recording rate from the audio device based at least in part upon the receiving detection of the second event regarding the first sound comprises:
circuitry for recording the second audio information from a cell phone communication being communicated through the audio device.

1103. The system of claim 1038 wherein circuitry for recording second audio information at a second original recording rate from the audio device based at least in part upon the receiving detection of the second event regarding the first sound comprises:
circuitry for recording the second audio information at the first original recording rate as a real time recording rate.

1104. The system of claim 1038 wherein circuitry for recording second audio information at a second original recording rate from the audio device based at least in part upon the receiving detection of the second event regarding the first sound comprises:
circuitry for recording the second audio information as a musical performance.

1105. (canceled)

1106. The system of claim 1038 wherein circuitry for recording second audio information at a second original recording rate from the audio device based at least in part upon the receiving detection of the second event regarding the first sound comprises:
circuitry for recording the second audio information as computer generated audio information.

1107. (canceled)

1108. The system of claim 1038 wherein circuitry for recording second audio information at a second original recording rate from the audio device based at least in part upon the receiving detection of the second event regarding the first sound comprises:
circuitry for recording the second audio information to a database.

1109. (canceled)

1110. The system of claim 1038 wherein circuitry for outputting at a rate faster than the first original recording rate the recording of the first audio information based at least in part upon receiving detection of the second event regarding the first sound comprises:
circuitry for outputting at the rate faster than the first original recording rate at least in part to synchronize to a real time broadcast of audio information from the audio device.

1111. The system of claim 1038 wherein circuitry for outputting at a rate faster than the first original recording rate the recording of the first audio information based at least in part upon receiving detection of the second event regarding the first sound comprises:
circuitry for outputting at a rate based at least in part upon total time duration of the recording of the first audio information.

1112. The system of claim 1038 wherein circuitry for outputting at a rate faster than the first original recording rate the recording of the first audio information based at least in part upon receiving detection of the second event regarding the first sound comprises:
circuitry for outputting using pitch compensation to adjust pitch of the first audio information being played at the rate faster than the first original recording rate.

1113. The system of claim 1038 wherein circuitry for outputting at a rate faster than the first original recording rate the recording of the first audio information based at least in part upon receiving detection of the second event regarding the first sound comprises:
circuitry for outputting using variable speed control selectable by a listener of the first audio information being played at a rate faster than the first original recording rate.

1114. The system of claim 1038 wherein circuitry for outputting at a rate faster than the first original recording rate the recording of the first audio information based at least in part upon receiving detection of the second event regarding the first sound comprises:
circuitry for outputting using one or more speakers located inside of an automobile.

1115. The system of claim 1038 wherein circuitry for outputting at a rate faster than the first original recording rate the recording of the first audio information based at least in part upon receiving detection of the second event regarding the first sound comprises:
circuitry for outputting using one or more speakers integrated into one or more headphones.

1116. (canceled)

1117. The system of claim 1038 wherein circuitry for outputting at a rate faster than the first original recording rate the recording of the first audio information based at least in part upon receiving detection of the second event regarding the first sound comprises:
circuitry for outputting using one or more speakers in a performance hall.

1118. The system of claim 1038 wherein circuitry for outputting at a rate faster than the first original recording rate the recording of the first audio information based at least in part upon receiving detection of the second event regarding the first sound comprises:
circuitry for outputting using one or more speakers integrated with an entertainment center.

1119. The system of claim 1038 wherein circuitry for outputting at a rate faster than the first original recording rate the recording of the first audio information based at least in part upon receiving detection of the second event regarding the first sound comprises:
circuitry for outputting using one or more speakers integrated into a vehicle.

1120. The system of claim 1038 wherein circuitry for outputting at a rate faster than the second original recording rate the recording of the second audio information based at least in part upon completion of the outputting of the first audio information comprises:
circuitry for outputting at the rate faster than the second original recording rate to at least in part to synchronize to a real time broadcast of audio information from the audio device.

1121. The system of claim 1038 wherein circuitry for outputting at a rate faster than the second original recording rate the recording of the second audio information based at least in part upon completion of the outputting of the first audio information comprises:
circuitry for outputting at a rate based at least in part upon total time duration of the recording of the first audio information.

1122. The system of claim 1038 wherein circuitry for outputting at a rate faster than the second original recording rate the recording of the second audio information based at least in part upon completion of the outputting of the first audio information comprises:
circuitry for outputting using pitch compensation to adjust pitch of the first audio information being played at the rate faster than the first original recording rate.

1123. The system of claim 1038 wherein circuitry for outputting at a rate faster than the second original recording rate the recording of the second audio information based at least in part upon completion of the outputting of the first audio information comprises:
circuitry for outputting using variable speed control selectable by a listener of the first audio information being played at a rate faster than the first original recording rate.

1124. The system of claim 1038 wherein circuitry for outputting at a rate faster than the second original recording rate the recording of the second audio information based at least in part upon completion of the outputting of the first audio information comprises:
circuitry for outputting using one or more speakers located inside of an automobile.

1125. The system of claim 1038 wherein circuitry for outputting at a rate faster than the second original recording rate the recording of the second audio information based at least in part upon completion of the outputting of the first audio information comprises:
circuitry for outputting using one or more speakers integrated into one or more headphones.

1126. The system of claim 1038 wherein circuitry for outputting at a rate faster than the second original recording rate the recording of the second audio information based at least in part upon completion of the outputting of the first audio information comprises:
circuitry for outputting using one or more speakers integrated into one or more earbuds.

1127. (canceled)

1128. The system of claim 1038 wherein circuitry for outputting at a rate faster than the second original recording rate the recording of the second audio information based at least in part upon completion of the outputting of the first audio information comprises:
circuitry for outputting using one or more speakers integrated with an entertainment center.

1129.-2074. (canceled)

2075. A system comprising:
one or more receiving modules configured for receiving detection, via at least in part one or more computing devices, of a first event regarding a first sound involving one or more characteristics;
one or more recording modules configured for recording first audio information at a first original recording rate from an audio device based at least in part upon receiving the detection of a first event regarding a first sound involving one or more characteristics;
one or more receiving modules configured for receiving detection, via at least in part one or more computing devices, of a second event regarding the first sound;
one or more recording modules configured for recording second audio information at a second original recording rate from the audio device based at least in part upon the receiving detection of the second event regarding the first sound;
one or more outputting modules configured for outputting at a rate faster than the first original recording rate the recording of the first audio information based at least in part upon receiving detection of the second event regarding the first sound; and
one or more outputting modules configured for outputting at a rate faster than the second original recording rate the recording of the second audio information based at least in part upon completion of the outputting of the first audio information.

2076.-3133. (canceled)
